(19) United States
(12) Patent Application Publication
(10) Pub. No.: US 2024/0185350 A1
(43) Pub. Date: Jun. 6, 2024

(54) SYSTEM, METHOD, AND APPARATUS FOR OPERATING A WEALTH MANAGEMENT PLATFORM

(71) Applicant: NIW AP, LLC, PLANO, TX (US)

(72) Inventors: Judy Lane, Frisco, TX (US); Daen Wombwell, Plano, TX (US); Grace Barnard, Plano, TX (US)

(21) Appl. No.: 18/534,425

(22) Filed: Dec. 8, 2023

Related U.S. Application Data
(63) Continuation of application No. 18/311,202, filed on May 2, 2023.
(60) Provisional application No. 63/337,484, filed on May 2, 2022.
(60) Provisional application No. 63/416,326, filed on Oct. 14, 2022.

(51) Int. Cl. G06Q 40/06

(52) U.S. Cl. CPC G06Q 40/06

(57) ABSTRACT

An apparatus includes a client addition circuit configured to receive a group addition request associated with at least one identified user. An apparatus includes a group assignment circuit configured to add the at least one identified user to an existing enrollment group within an online platform or create a new enrollment group and add the at least one identified user to the new enrollment group, responsive to the received group addition request. An apparatus includes an enrollment execution circuit structured to implement enrollment of users within the existing enrollment group or the new enrollment group.

### CROSS-REFERENCE TO RELATED APPLICATIONS

This application is a continuation of and claims priority to U.S. patent application Ser. No. 18/311,202 filed May 2, 2023, Publication No. 20230351515 and entitled “SYSTEM, METHOD, AND APPARATUS FOR OPERATING A WEALTH MANAGEMENT PLATFORM” (NIWC-0003-U01).

U.S. patent application Ser. No. 18/311,202 claims benefit of U.S. Provisional Patent Applications No. 63/337,484, filed 2 May 2022, and entitled “SYSTEM, METHOD, AND APPARATUS FOR OPERATING A WEALTH MANAGEMENT PLATFORM” (NIWC-0001-P01); and 63/416,326, filed 14 Oct. 2022, and entitled “SYSTEM, METHOD, AND APPARATUS FOR PERFORMING SMART ILLUSTRATIONS FOR A WEALTH MANAGEMENT PLATFORM” (NIWC-0002-P01). Each of the foregoing applications is incorporated herein by reference in its entirety for all purposes.

### BACKGROUND

Previously known wealth management systems, and specifically wealth management systems for enrolling, maintaining, and servicing client engagement with a wealth management platform, suffer from a number of drawbacks. Wealth management engagement with clients and/or supported persons within the wealth management ecosystem are not integrated, with numerous hand-offs between different entities occurring throughout the process, and with limited oversight and support to ensure the process progresses. Previously known systems have numerous inputs that have intense manual input from experts, adding cost and delay to the entire engagement process. Accordingly, previously known systems have high failure rates (e.g., a client is not practically able to engage the process due to the time delays and work burden associated with engagement), and multiple failure points where the process is terminated or delayed without the control or knowledge of stakeholders in the process. For example, a typical engagement may include interactions with multiple companies (e.g., insurance, investment companies, banks, underwriters, etc.) in a serial arrangement, where one part of the process cannot be commenced until an earlier part of the process is completed. The downstream process participants may not have visibility to the progress at earlier parts of the process, and may not even be aware that an engagement process is underway. Accordingly, participants in the process, including clients and servicers, participate reactively to the process, adding further delay at each step. Additionally, if the process is stuck, for example with a servicer that has not completed some aspect of the process, previously known systems are subject to downstream participants having no awareness that the process exists or is stuck. In previously known systems, a highly manual review of the process by an owner, and/or direct pushing by the client, may be required to move the process along. As a result, process delays can be significant, for example 40 days or more for completion of a typical engagement process for a client with a wealth management service, and with a high attrition rate where clients that desire the services end up failing to engage, either because the process is not successful in a manner that is out of the client's control, or because the client loses interest or makes alternate arrangements during the significant delay period.

Previously known wealth management systems suffer from a number of additional drawbacks even after successful enrollment and/or engagement. Previously known systems utilize a number of service providers to support ongoing management operations, where the service providers may not be aware of the wealth management process at all from the client's perspective—for example an insurance service provider will not have visibility to the insurance product as a part of the whole wealth management system for the client, and will not be in a position to determine whether the insurance product has performed successfully according to the plan, or even if the insurance product still supports the plan as the client situation changes over time, and as other components of the plan have variability in the performance of those components. Further, previously known wealth management systems do not readily track the performance of the plan over time, including tracking whether the plan has performed as expected, especially as a whole in view of the variability of performance of individual aspects. Accordingly, ongoing aspects of the plan, including communicating the value of the plan, determining whether the client's interests continue to be protected, and/or determining whether the client's goals are being achieved, range between impossible to achieve (e.g., there is no participant in the wealth management planning ecosystem for the client that has the information to make a holistic and historical assessment of the plan performance and client situation) to extremely resource intensive (e.g., an expert has to undertake a manual review of the client situation, with uncertainty whether all information has actually been obtained). Because wealth management planning can be a years-long effort, and literally a life-long effort, the time delay between analysis periods significantly exacerbates these issues. Unless an expert makes a concerted effort to individually track each client plan, long-term review is unlikely to occur at all, and if it does occur it is subject to missing information, and high expense in time, money, and effort to complete.

Further, wealth management systems would benefit from support over long periods of time, where there may be no participant in the ecosystem that is well suited to provide all of the support that is needed. For example, certain paperwork needs to be completed periodically, often based on events that are years apart, such as updates of beneficiary designations, changes for tax planning due to life changes or events, or the like. Previously known systems rely on manual inputs and ad hoc review and management, resulting in lost paperwork, missing information, aging of contact information, replacement of contact points with various providers and participants in the wealth management ecosystem, or the like. As a result, support for wealth management systems over time is sub-optimal at best, and often gets omitted completely, increasing the risk that the plan will not perform as intended when life events occur, and that the performance of the corpus of products in the plan will vary significantly from the clients goals and needs over time.

### SUMMARY

In some aspects, the techniques described herein relate to an apparatus including: an access initialization circuit structured to interpret at least one user class value for a user accessing an online platform having a plurality of wealth management functions, wherein the at least one user class value corresponds to at least one class of a plurality of user classes, the plurality of user classes including a client class, an agent class, and an administrator class; an access management circuit structured to determine a scheduled access profile in response to the at least one user class value, wherein the scheduled access profile includes a permitted functions description indicative of at least one permitted wealth management function within the plurality of wealth management functions accessible to the user, and a user interface circuit structured to implement a user interface that includes a session menu region and an activity region, the user interface configured to provide scheduled access to the at least one permitted wealth management function in response to the scheduled access profile.

### BRIEF DESCRIPTION OF THE FIGURES

FIG. 1 depicts an example system including a wealth management platform.

FIG. 2 depicts an example data store.

FIG. 3 depicts an example tranche management controller.

FIG. 4 depicts an example group management controller.

FIG. 5 depicts an example user interface circuit.

FIG. 6 depicts an example client engagement controller.

FIG. 7 depicts an example analytics controller.

FIG. 8 depicts an example of an illustration controller.

FIGS. 9A-9B depict aspects of an example enrollment process.

FIGS. 10A-10B depict aspects of an example enrollment process.

FIGS. 11A-11B depict aspects of a user interface.

FIGS. 12A-12B depict aspects of a user interface.

FIGS. 13A-13B depict aspects of a user interface.

FIGS. 14A-14B depict aspects of a user interface.

FIGS. 15A-15B depict aspects of a user interface.

FIGS. 16A-16B depict aspects of a user interface.

FIGS. 17A-17B depict aspects of a user interface.

FIGS. 18A-18B depict aspects of a user interface.

FIGS. 19A-19B depict aspects of a user interface.

FIGS. 20A-20B depict an example dashboard for an IMO.

FIG. 21 depicts an example dashboard.

FIGS. 22-23 depicts an example dashboard.

FIGS. 24 A-24B depict examples of user interfaces that include an agent listing view.

FIGS. 25A-25B depict examples of user interfaces that include an agent listing view.

FIGS. 26A-26B depict an example of a user interface that includes participant details.

FIGS. 27-32 depict example interfaces with a group display.

FIGS. 33A-33B depict an example dashboard related to the group display.

FIGS. 34A-34B depict an example carrier information interface.

FIGS. 35A-35B depict an example of information for a number of client users.

FIGS. 36A-36B depict an example interface with client listing.

FIGS. 37A-37B depict example interfaces with client detail.

FIGS. 38A-38B depict example interfaces with client detail.

FIGS. 39A-39B depict example interfaces with client detail.

FIGS. 40A-40D depict an example process overview dashboard.

FIGS. 41A-41B depict an example action tab.

FIGS. 42A-42B depict an example sales summary.

FIGS. 43A-43C depict an example of financial tracking for a tranche.

FIGS. 44 A-44B depict example interfaces with a brief financial overview for a group.

FIGS. 45A-45B depict example interfaces with a brief financial overview for a group.

FIGS. 46A-46B depict an example help interface.

FIGS. 47A-47B depict an example notifications interface.

FIGS. 48A-48B depict an example tranche management interface.

FIGS. 49A-49B depict an example estimation interface.

FIGS. 50A-50C depict an example illustration for a generic client.

FIGS. 51A-51B depict an example illustration display.

FIGS. 52A-52B depict an example another embodiment of an illustration.

FIGS. 53 A-53B depict aspects of certain elements of an estimator.

FIGS. 54A-54B depict aspects of certain elements of an estimator.

FIGS. 55A-55B depict an example estimator assumptions interface.

FIGS. 56A-56B depict an example strategy management user interface.

FIGS. 57A-57B depict an example activity tracking interface.

FIGS. 58A-58B depict an example admin activity log.

FIGS. 59A-59B depict an example interface for pre-enrollment contacts.

FIGS. 60A-60B depict an example interface for pre-enrollment contacts.

FIGS. 61A-61B depict an example agent link reporting interface.

FIGS. 62A-62B depict an example marketing email interface.

FIGS. 63A-63B depict an example ticket management interface.

FIGS. 64 A-64B depict example enrollment landing pages.

FIGS. 65A-65B depict example enrollment landing pages.

FIGS. 66A-66C depict example illustrations.

FIGS. 67A-67C depict example illustrations.

FIGS. 68A-68B depict an example payment notification interface.

FIGS. 69A-69B depict an example document summary page.

FIGS. 70A-70D depict an example client detail page.

FIGS. 71A-71B depict an example initial interface for claims and distributions.

FIGS. 72A-72B depict an example contact user interface.

FIGS. 73A-73B depict an example benefits estimator interface.

FIG. 74 depicts an example workflow to perform illustration operations.

FIGS. 75-77 depict examples of illustrations.

FIGS. 78A-78B depict an example comparative illustration.

FIG. 79 depicts an example workflow for performing the stress test.

FIG. 80 depicts an example API call.

FIG. 81 depicts an example workflow for providing a number of reports related to smart illustration generation.

FIG. 82 depicts an example workflow for a test illustration.

FIG. 83 depicts an example interface for entering plan information for preparing a plan.

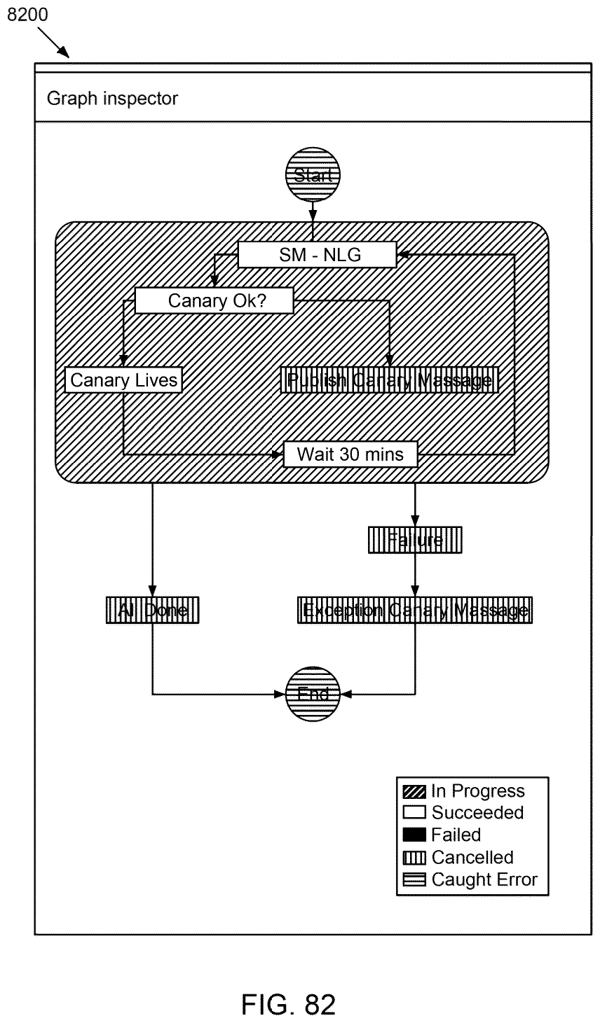

FIG. 82 depicts an example workflow for a test illustration.

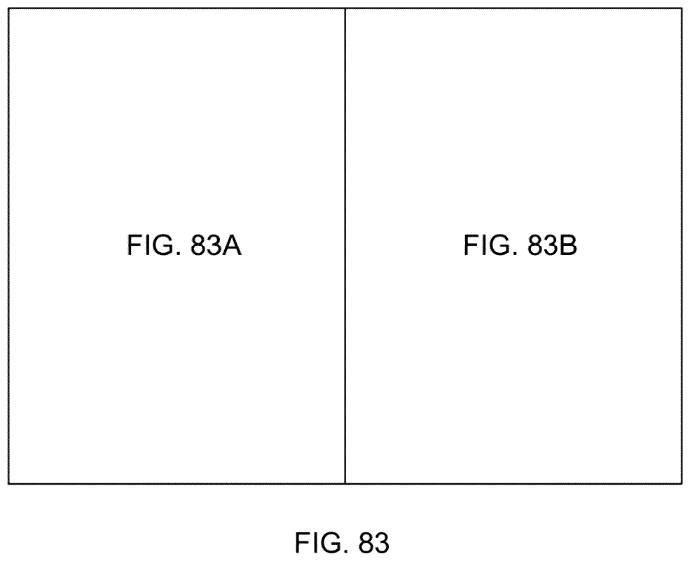

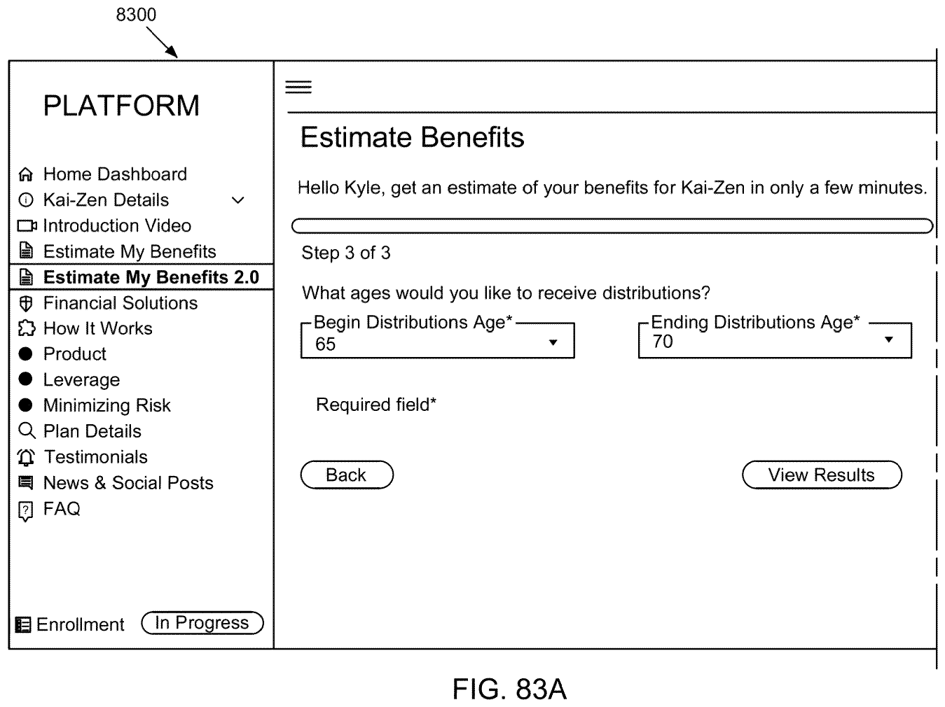

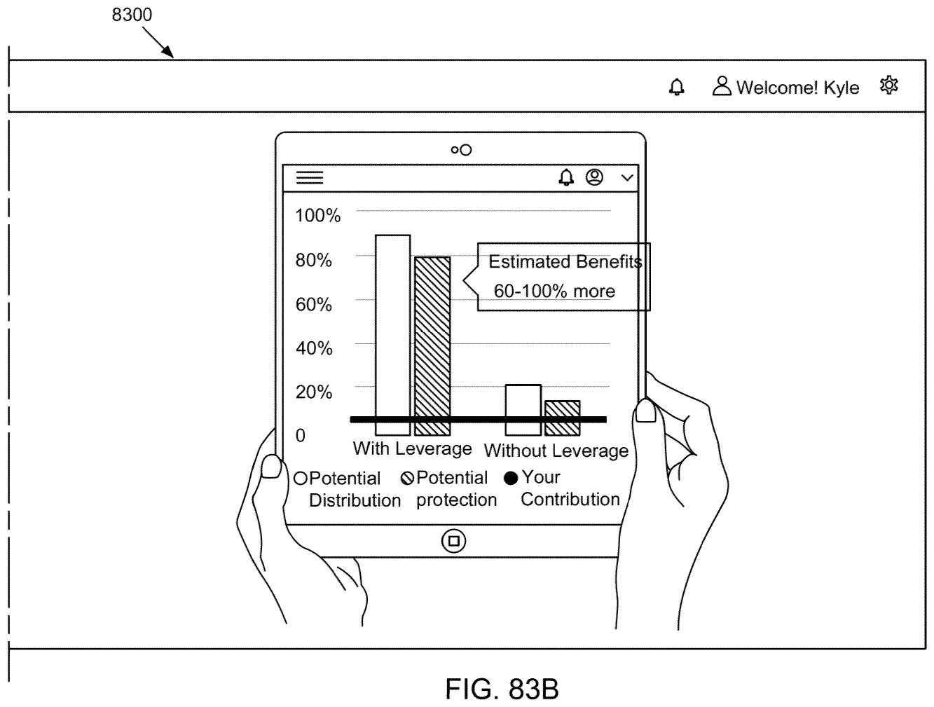

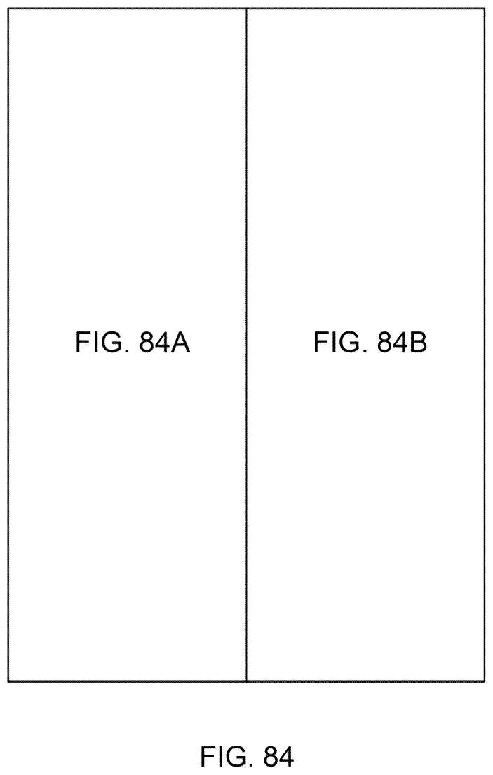

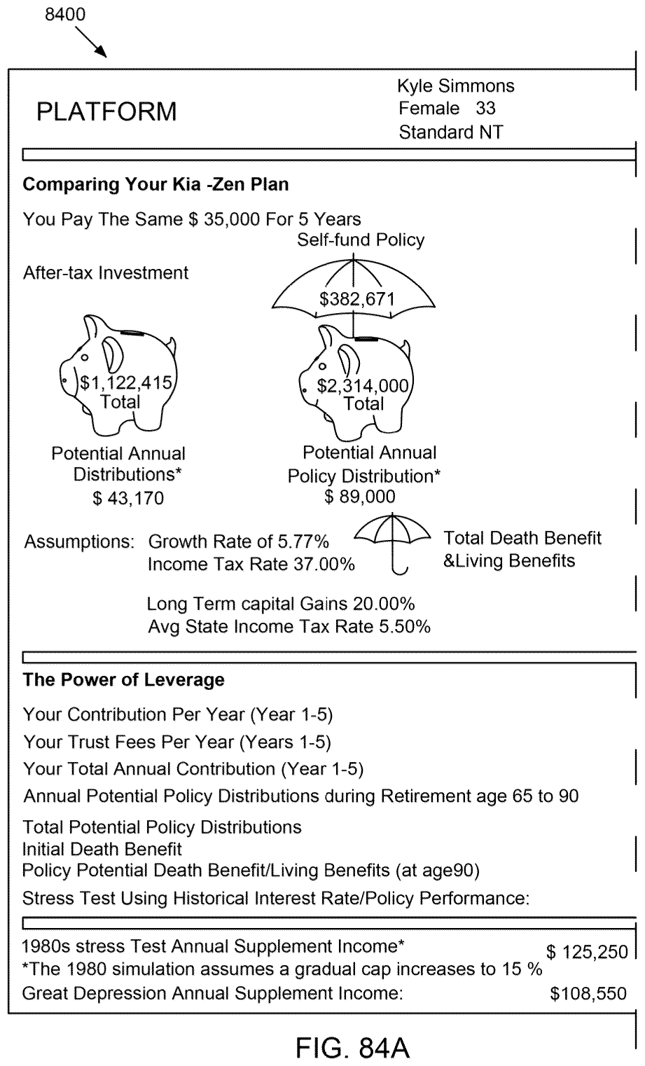

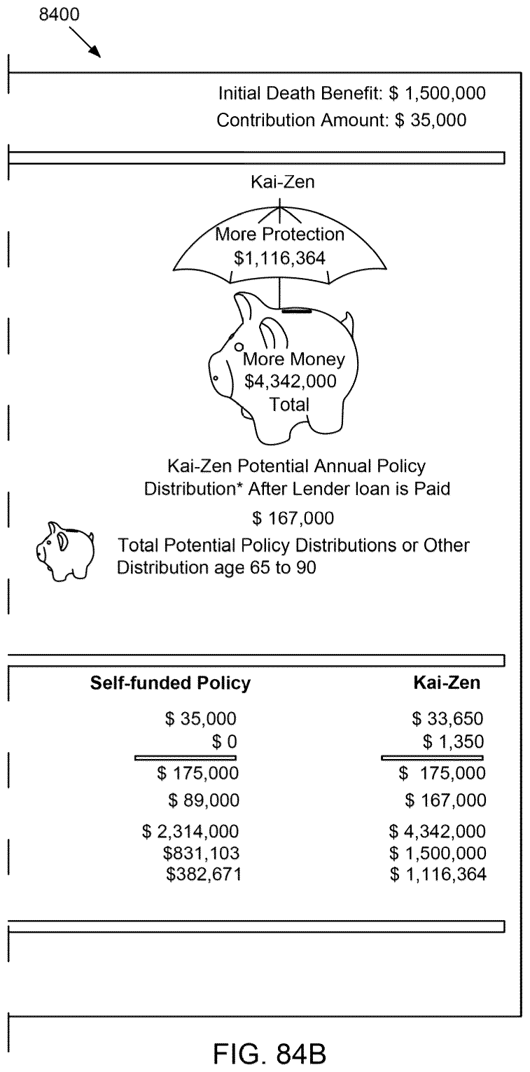

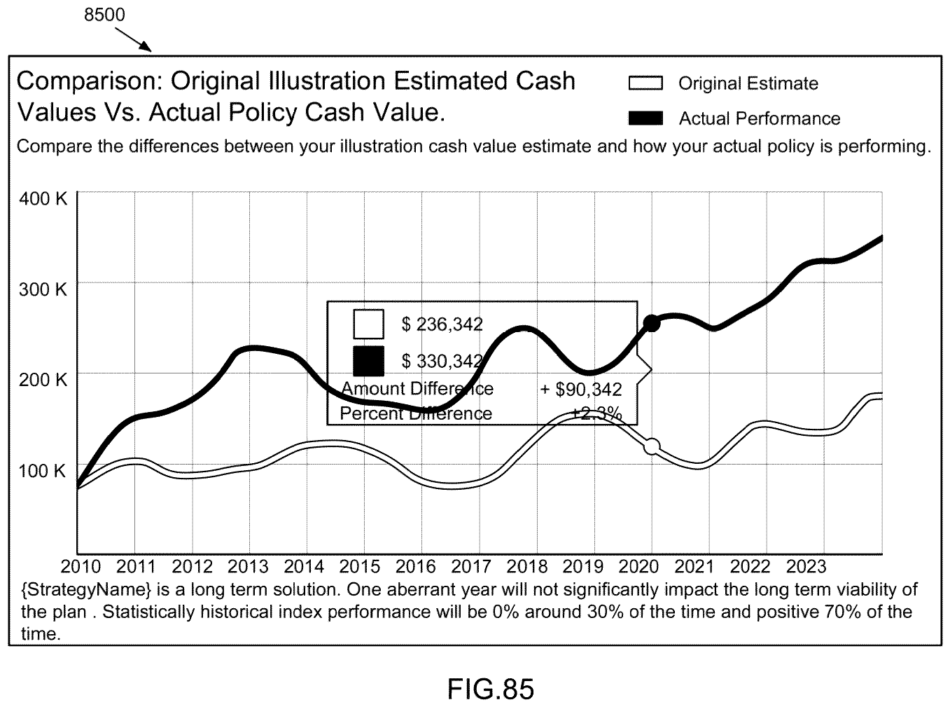

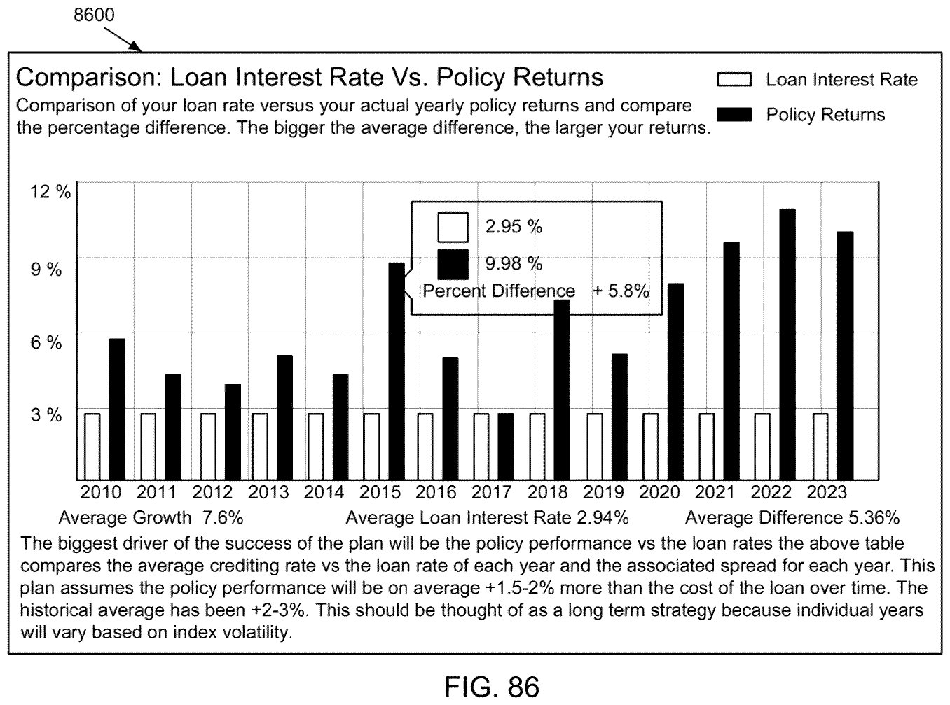

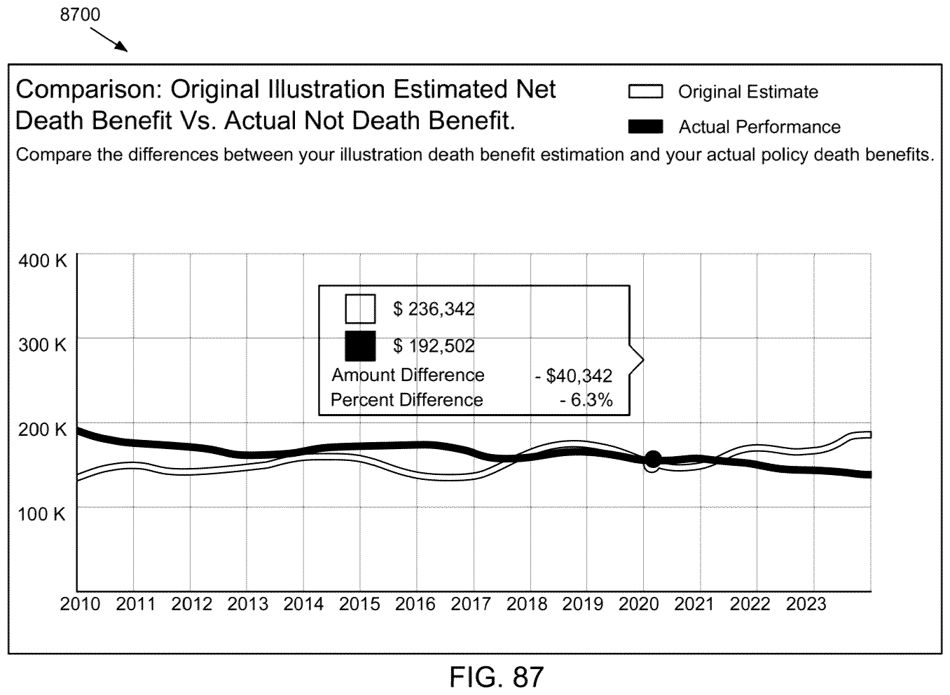

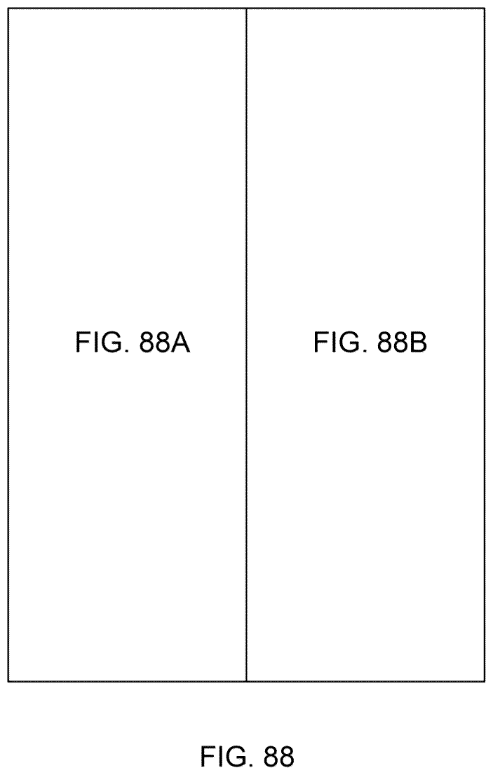

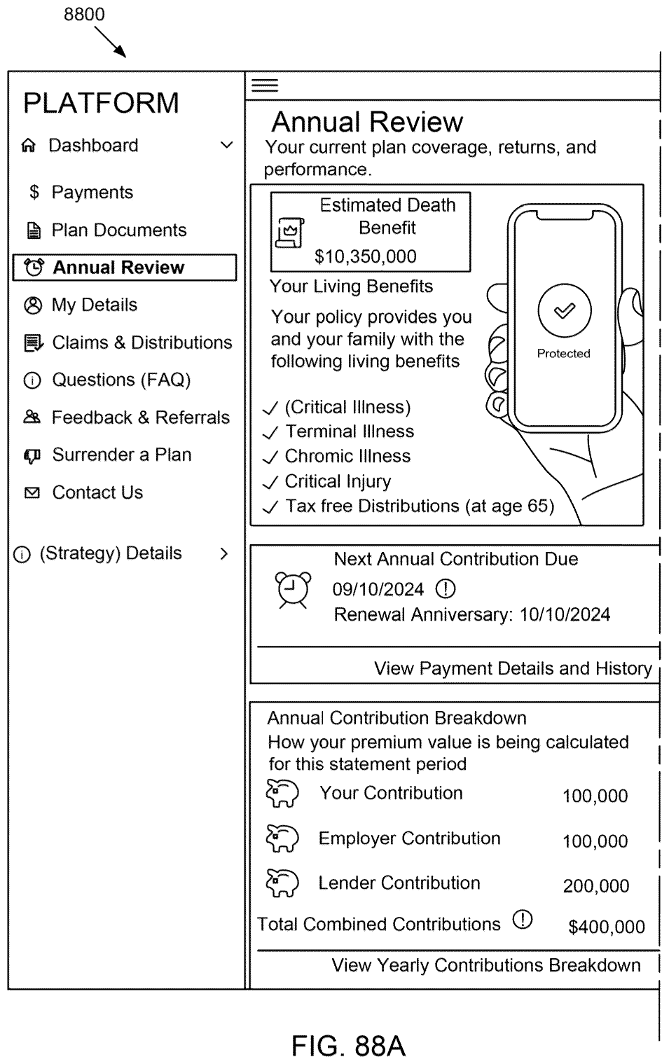

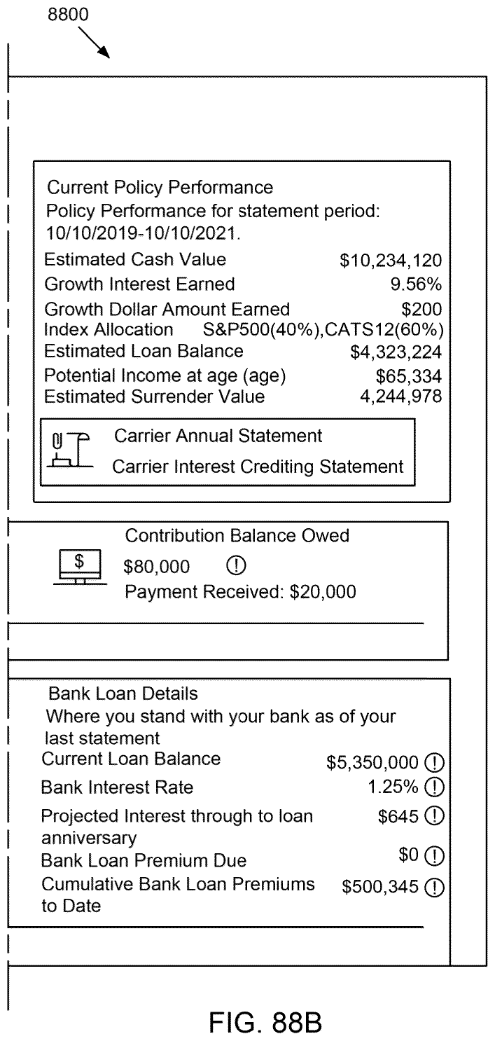

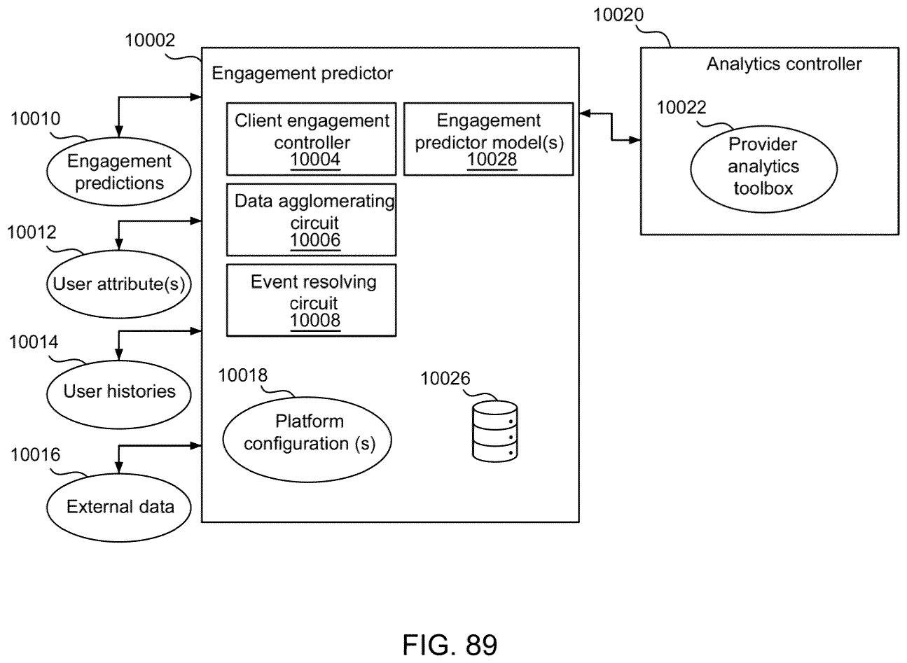

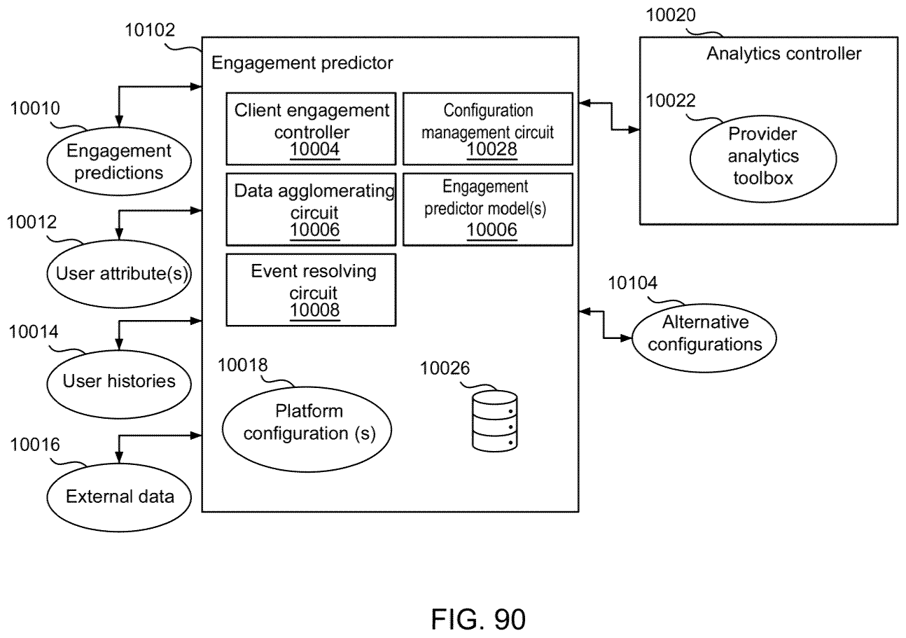

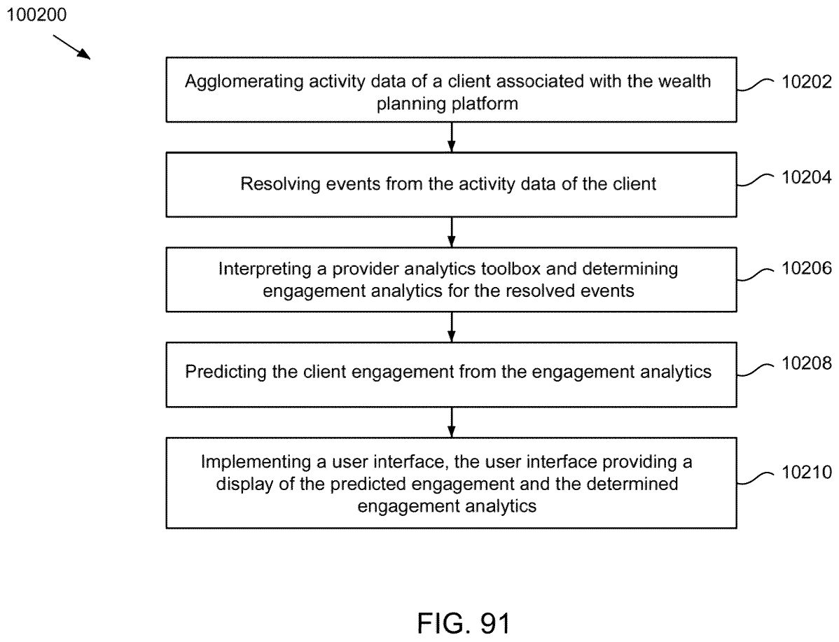

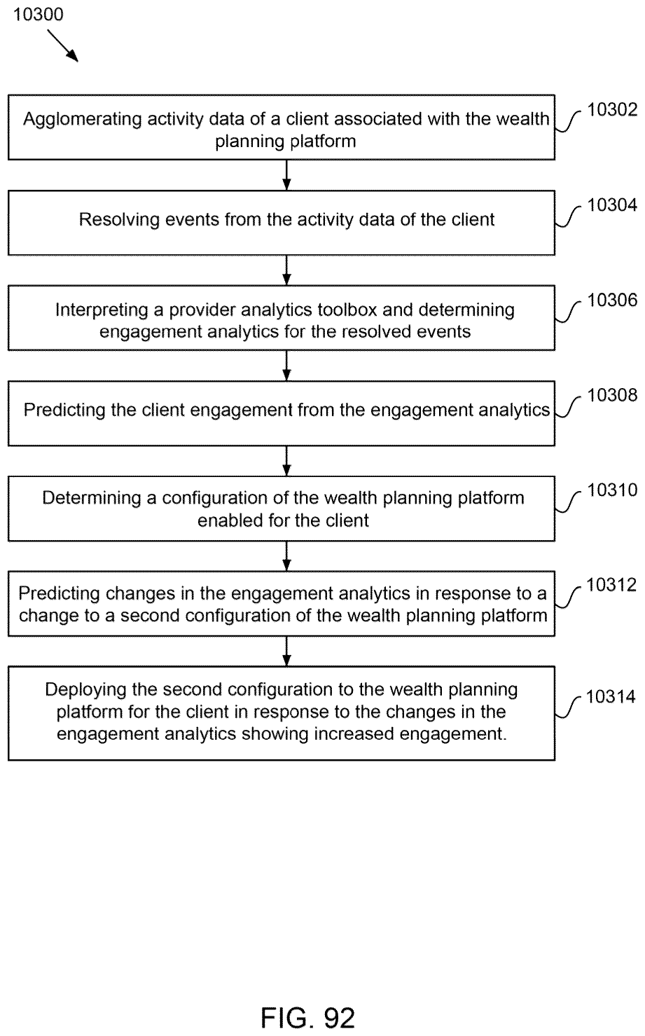

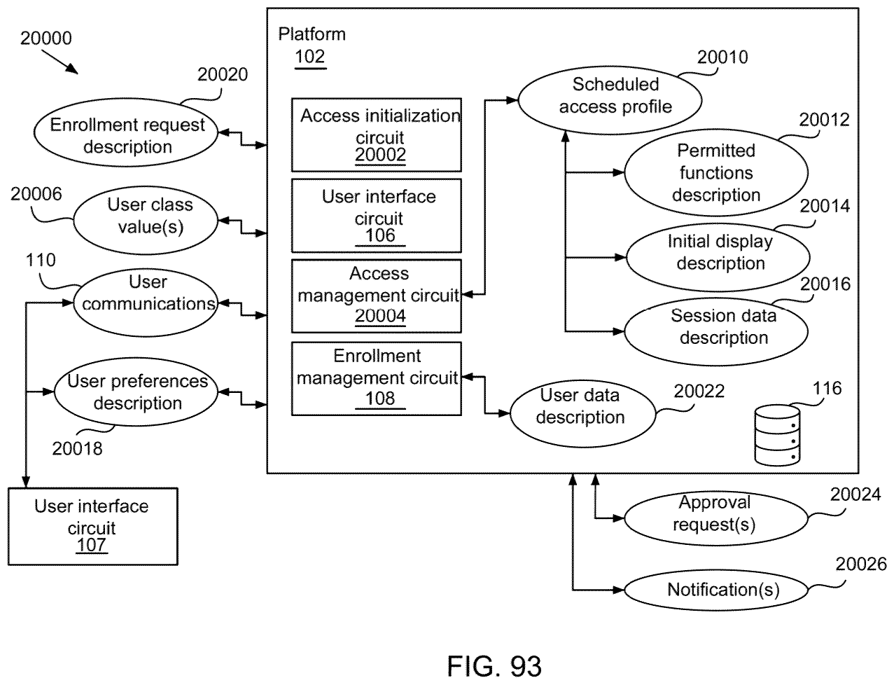

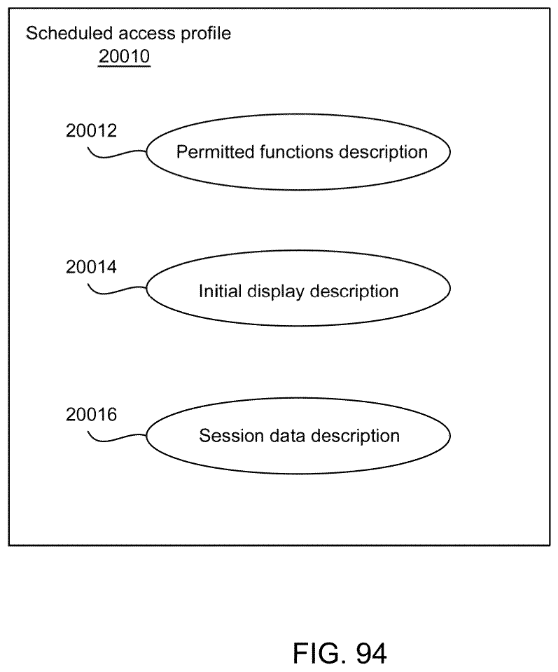

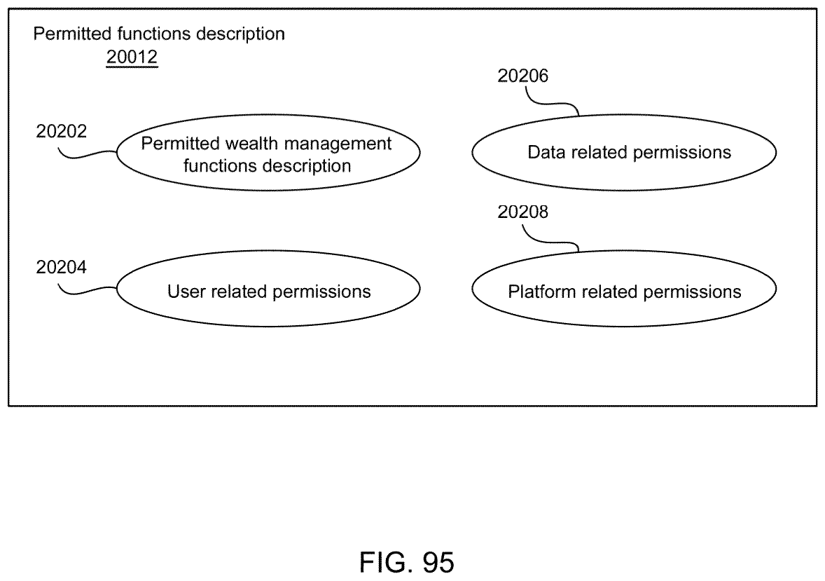

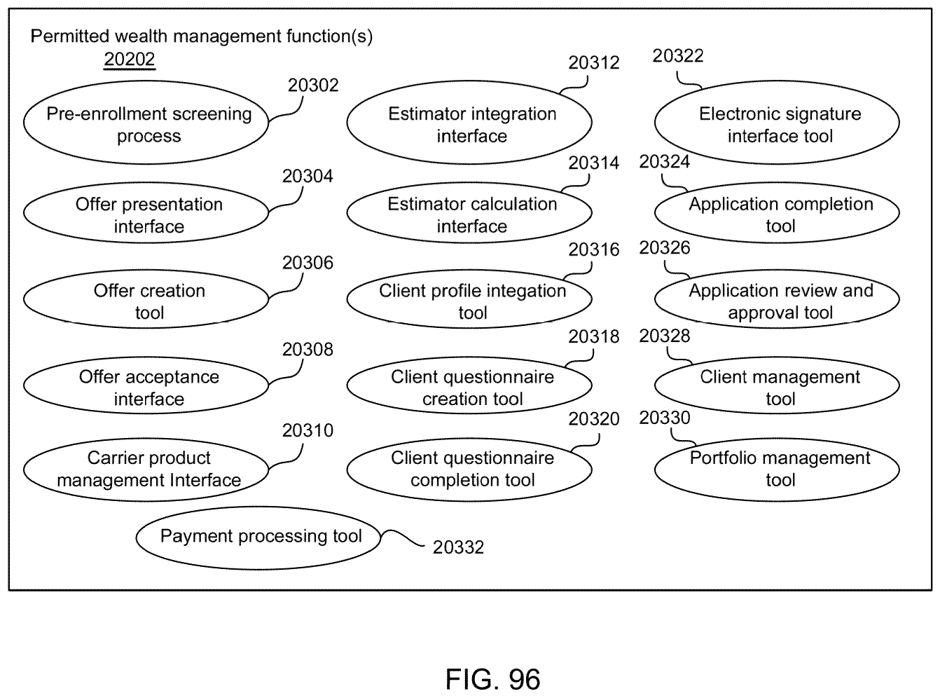

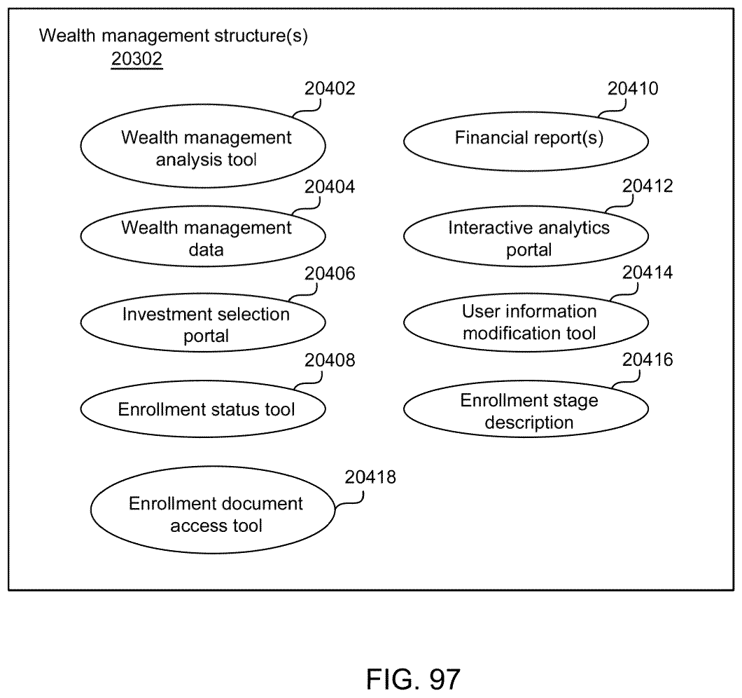

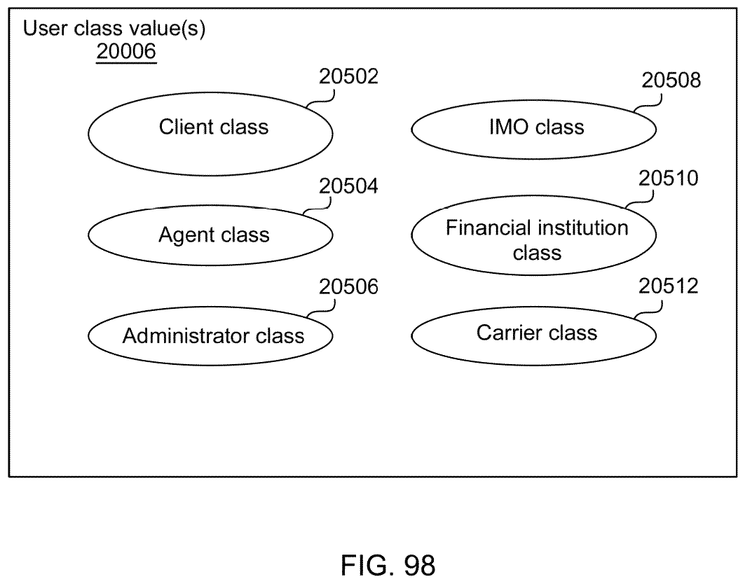

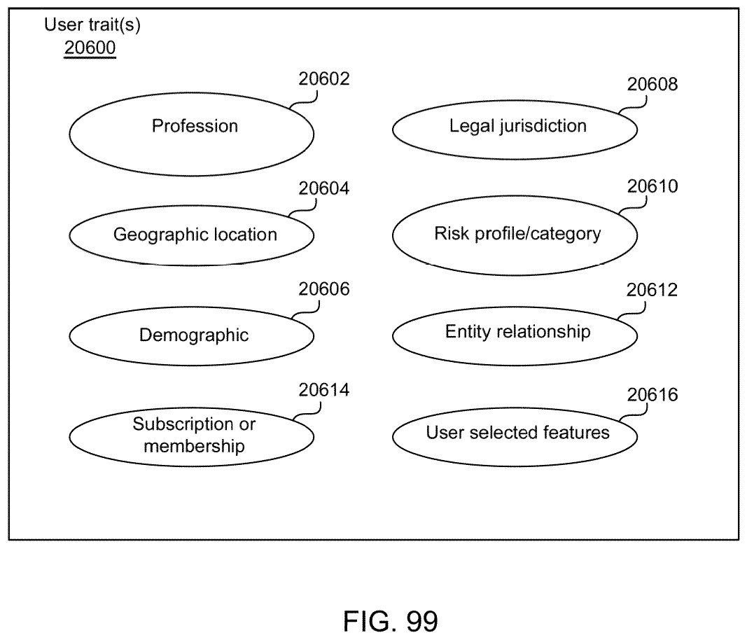

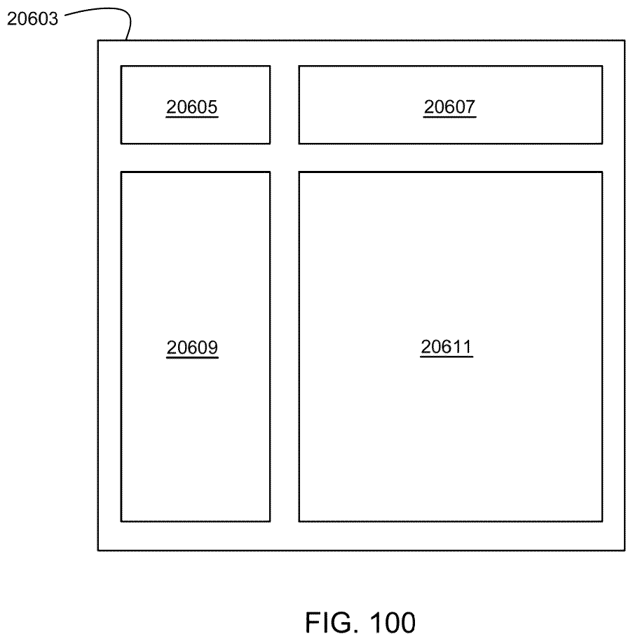

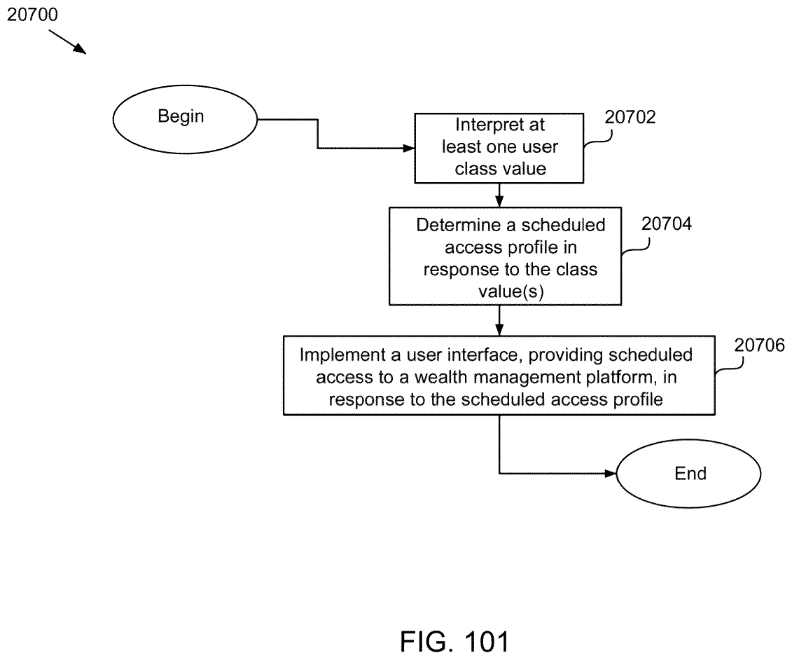

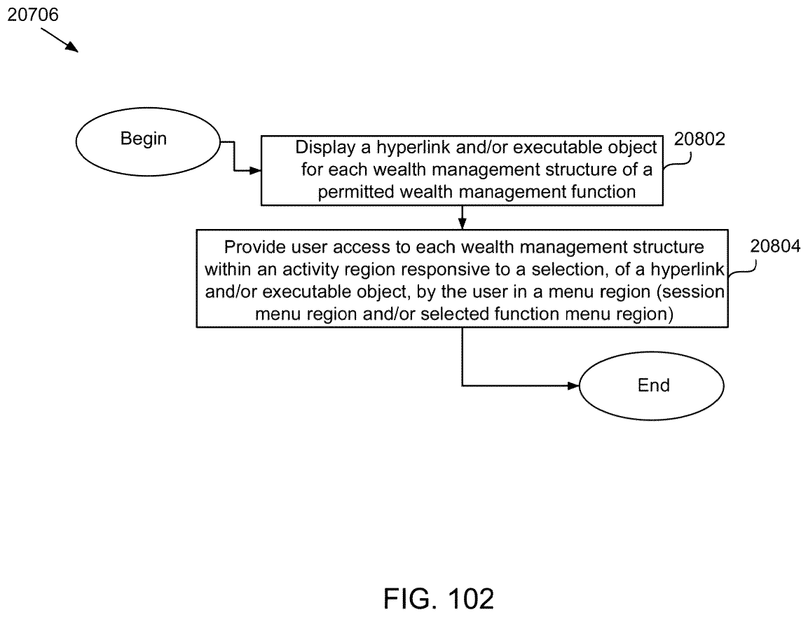

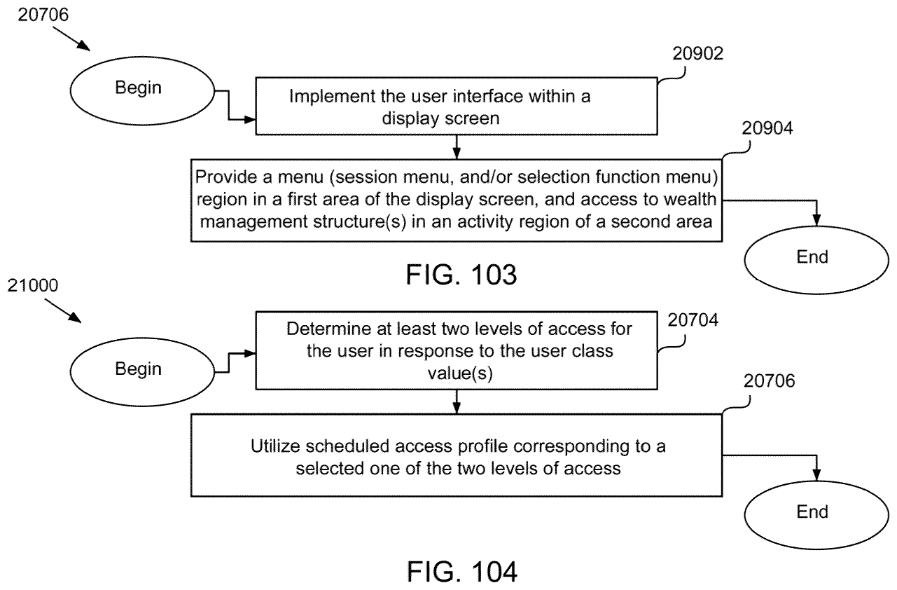

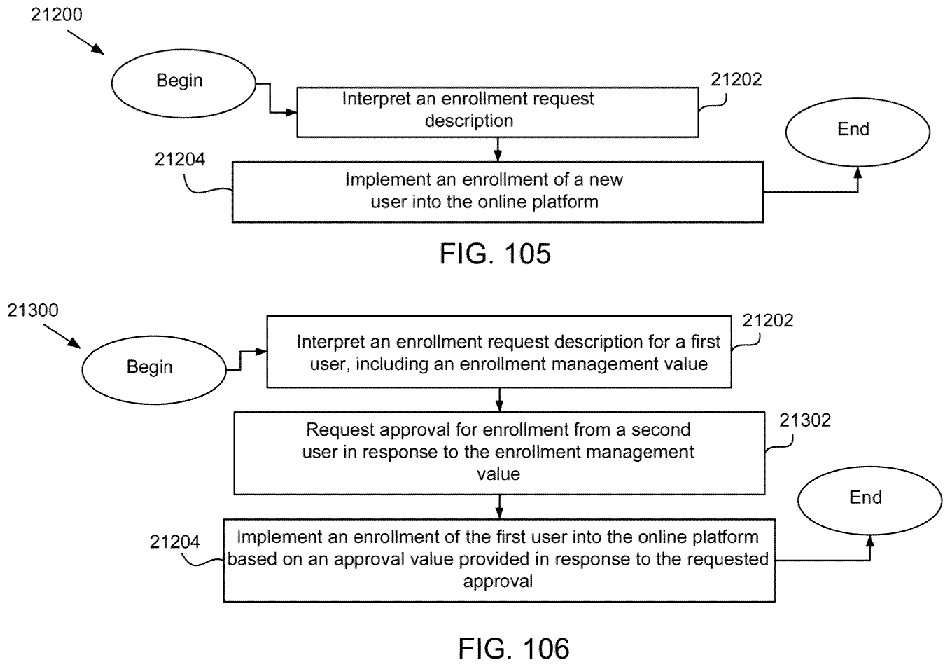

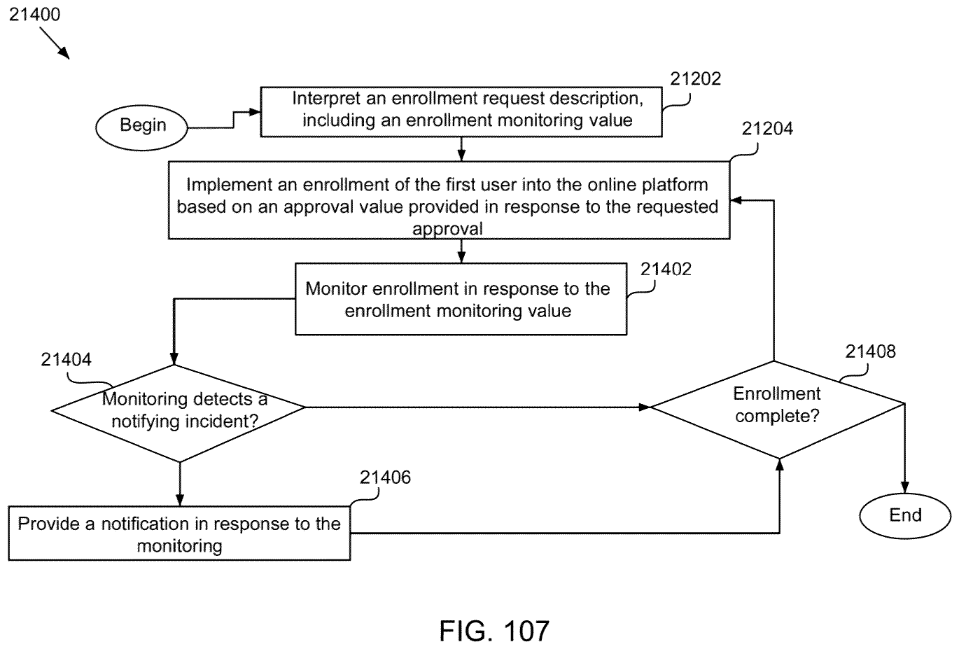

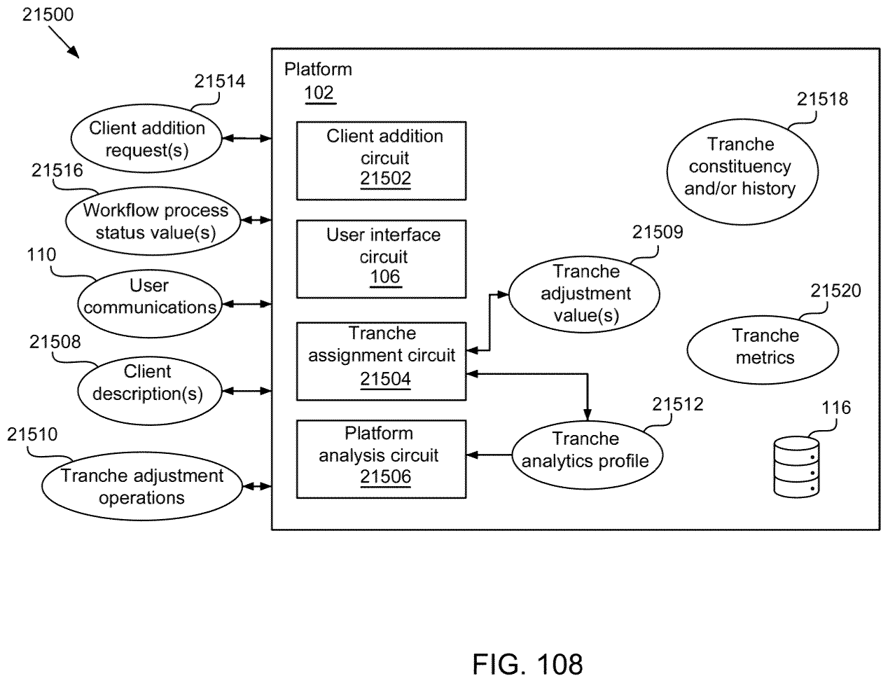

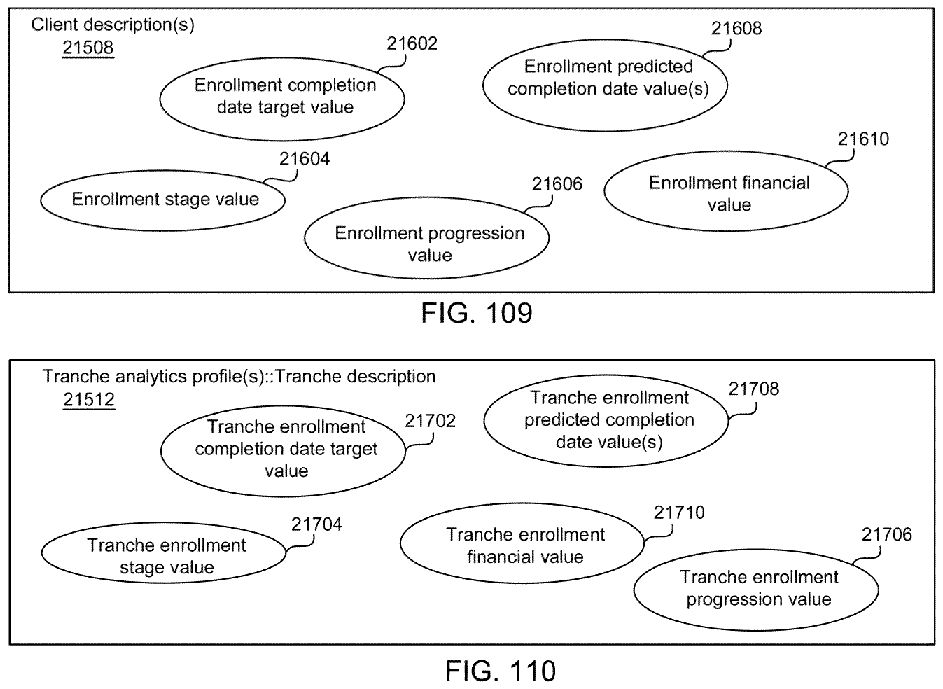

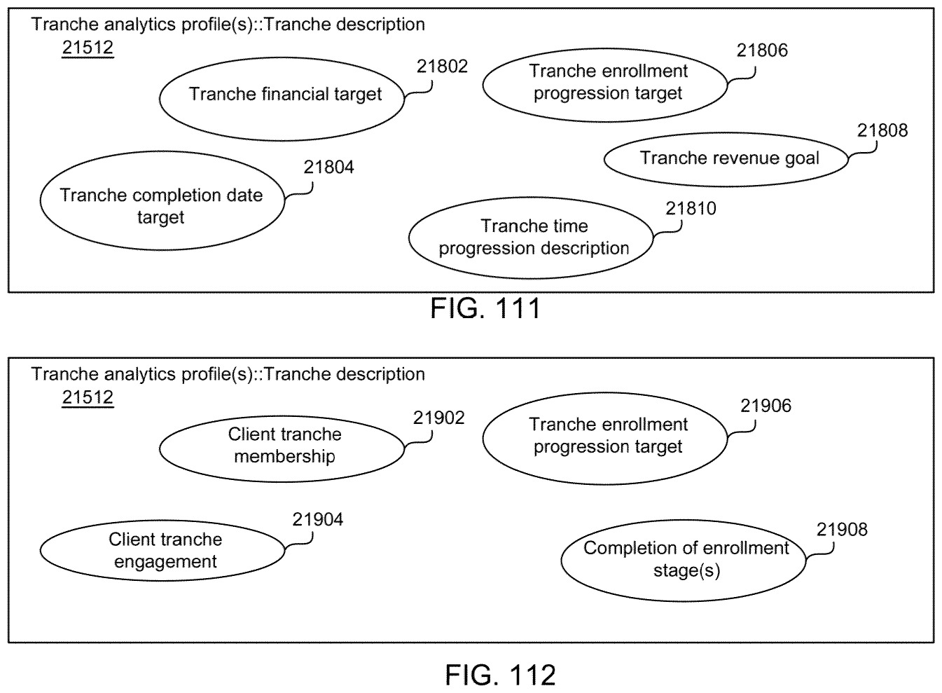

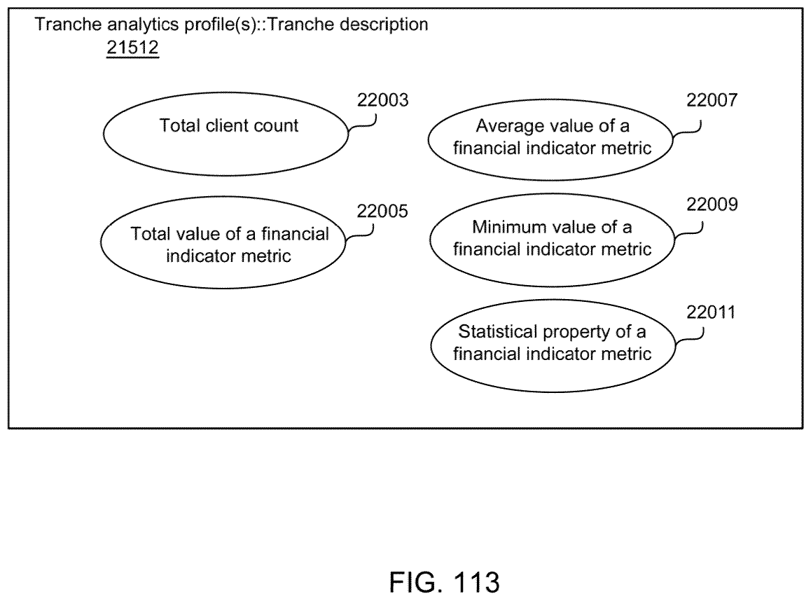

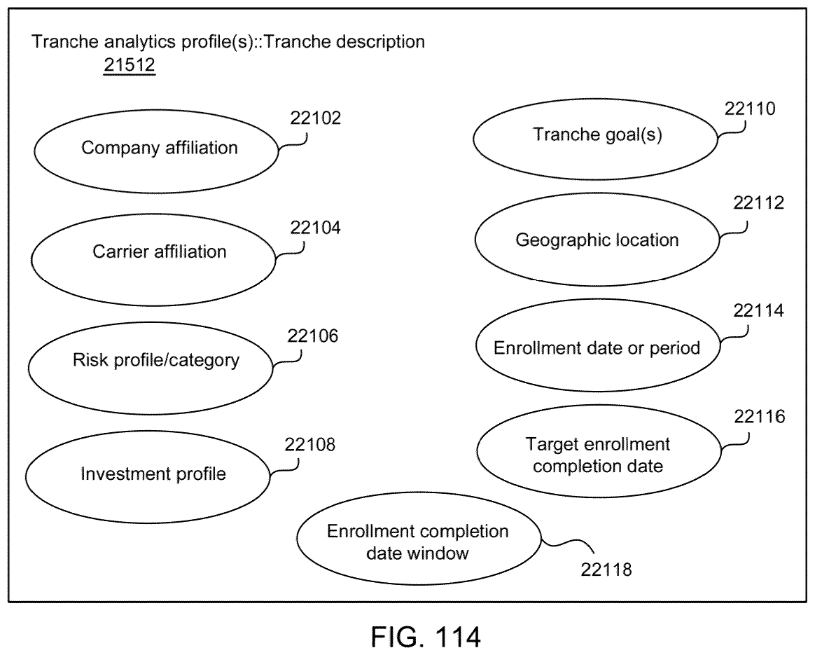

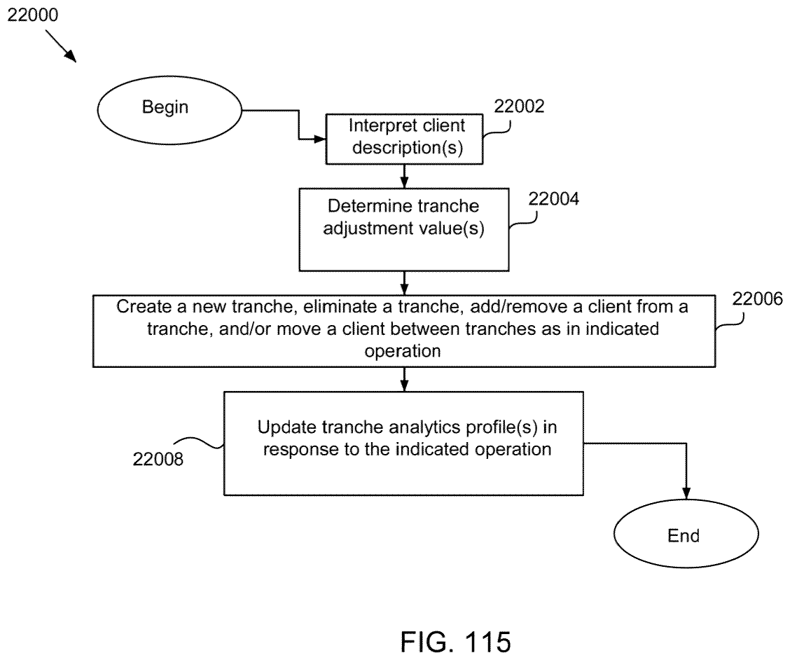

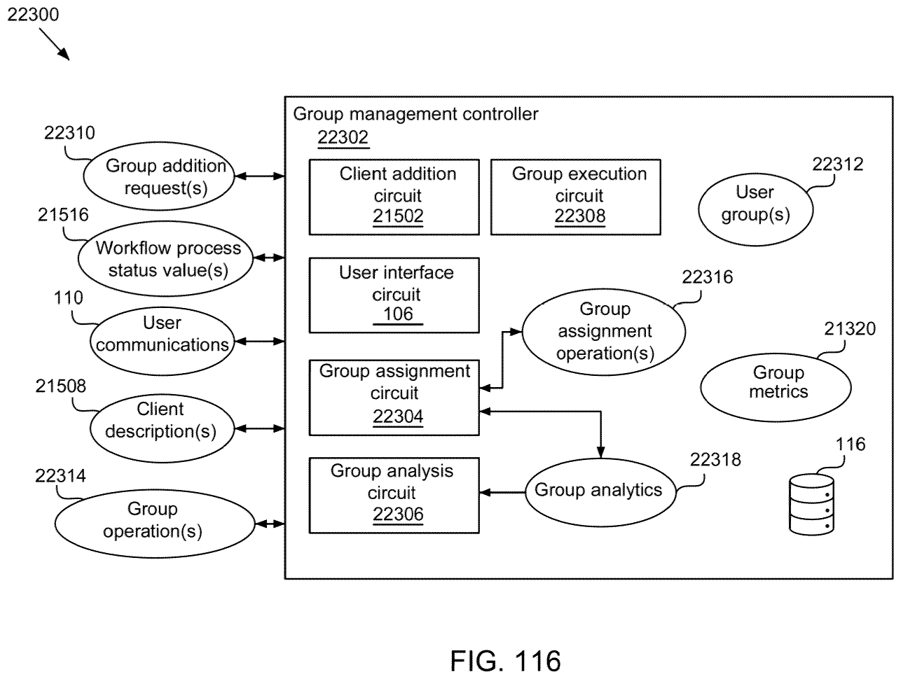

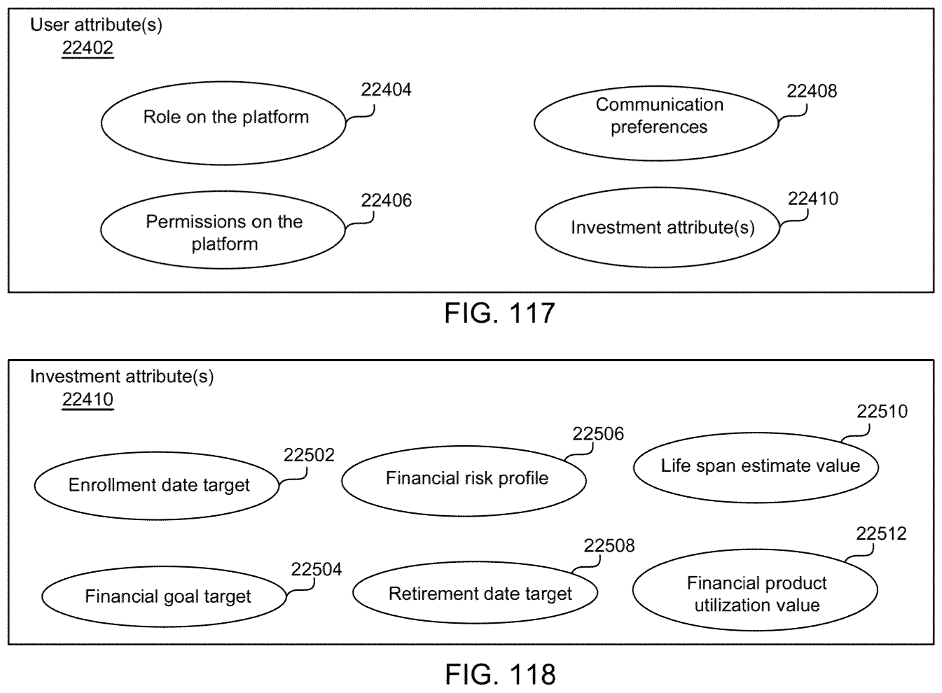

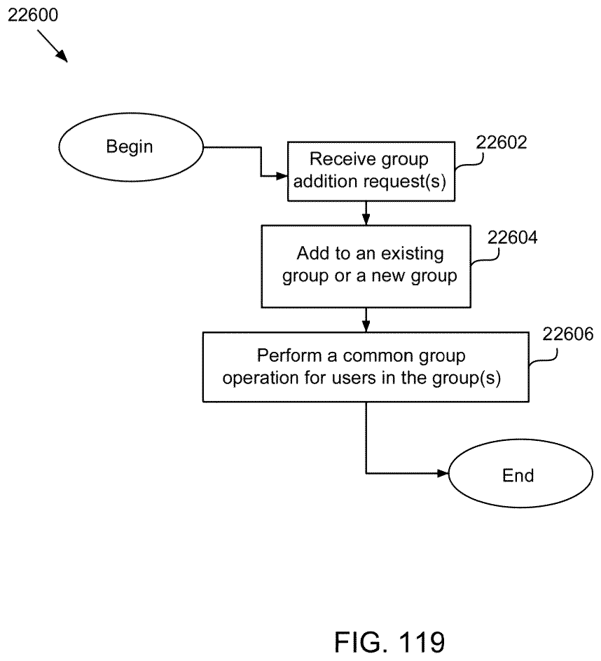

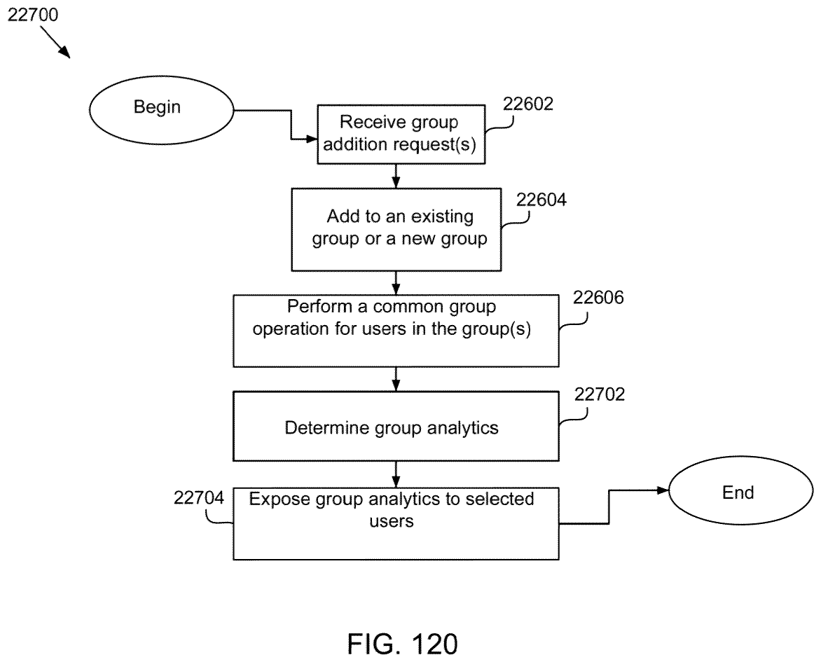

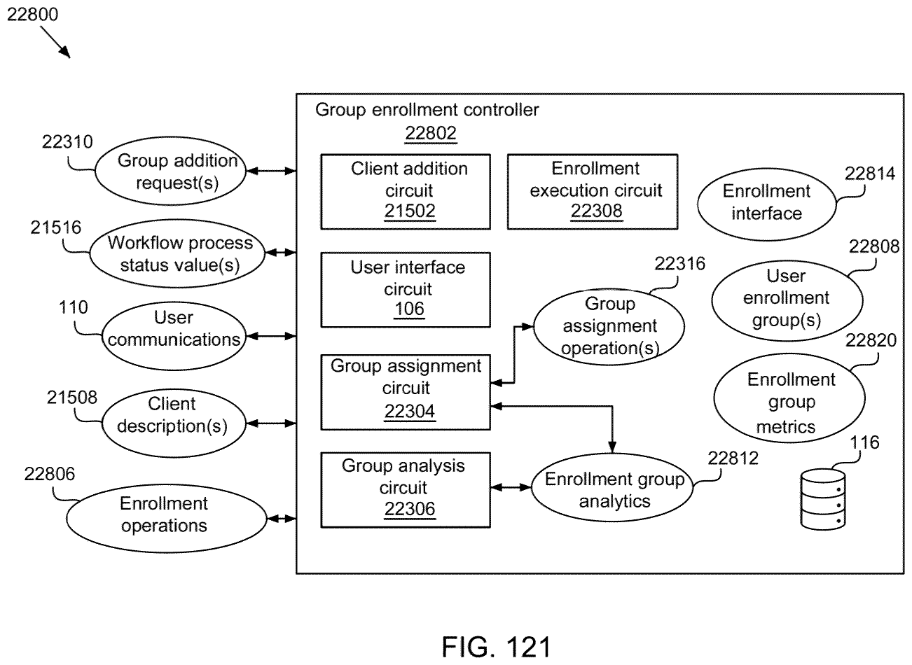

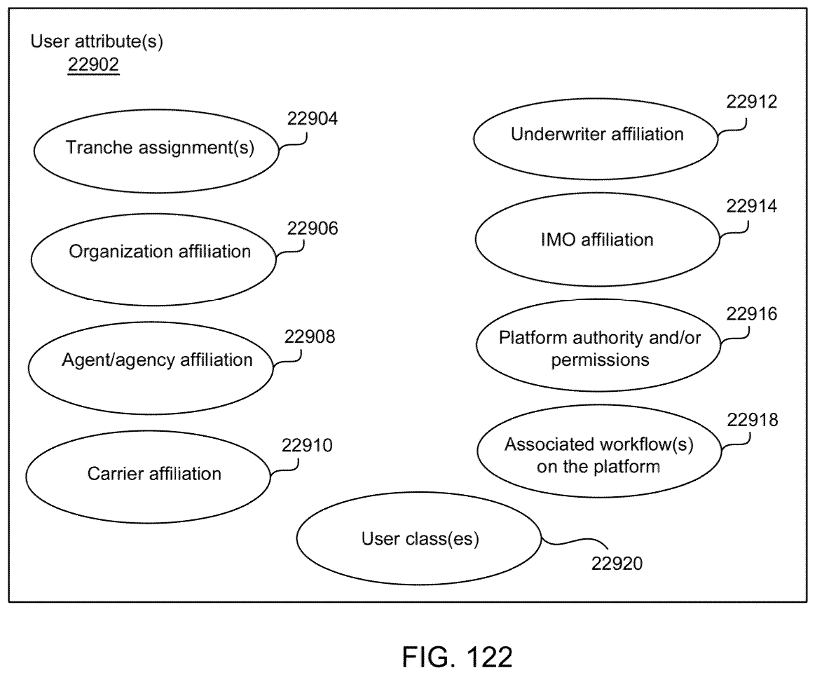

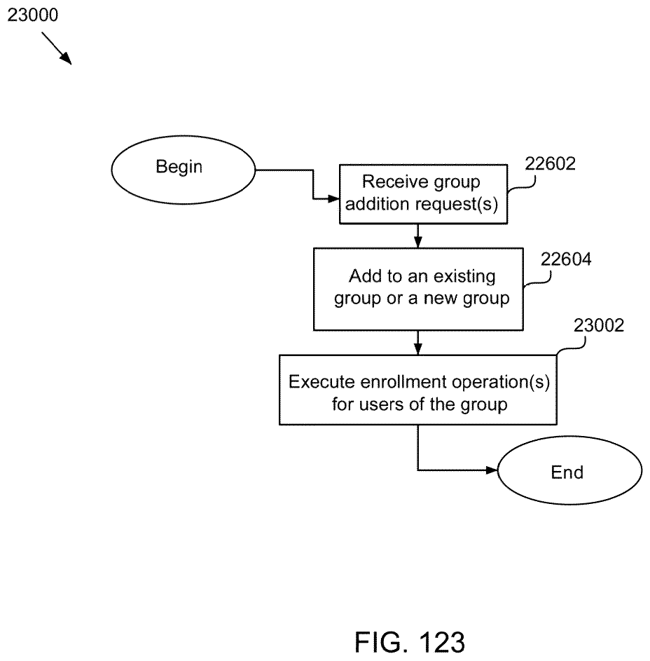

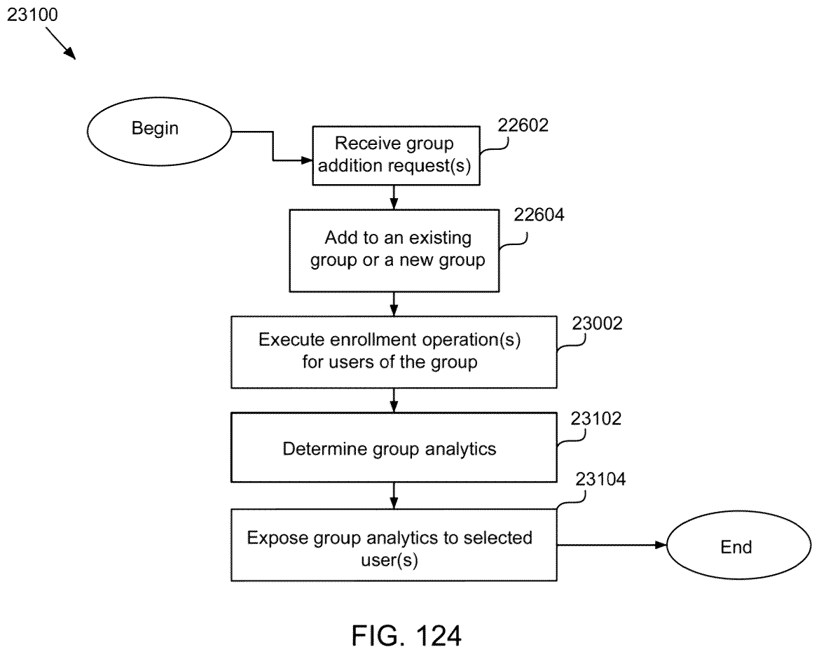

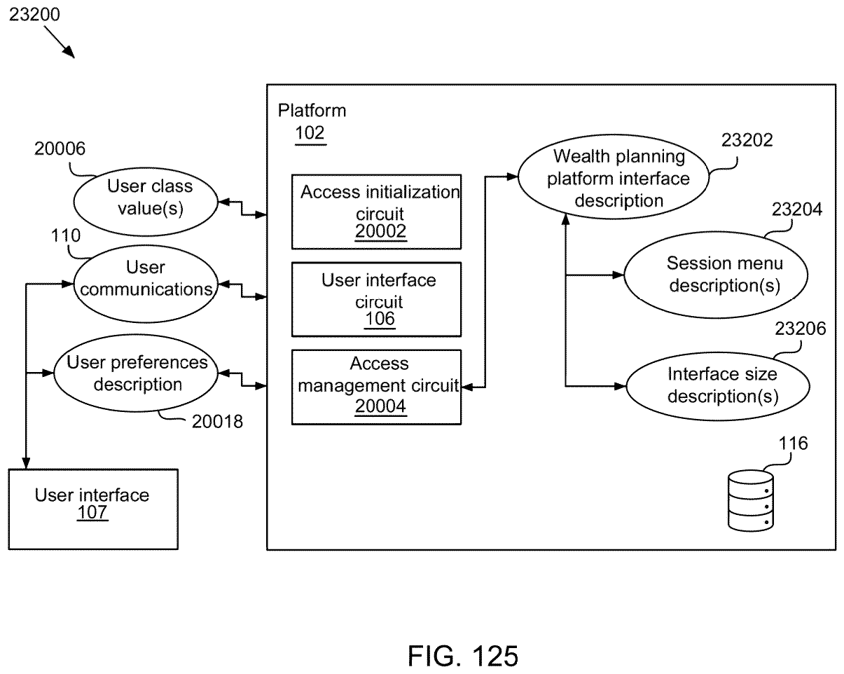

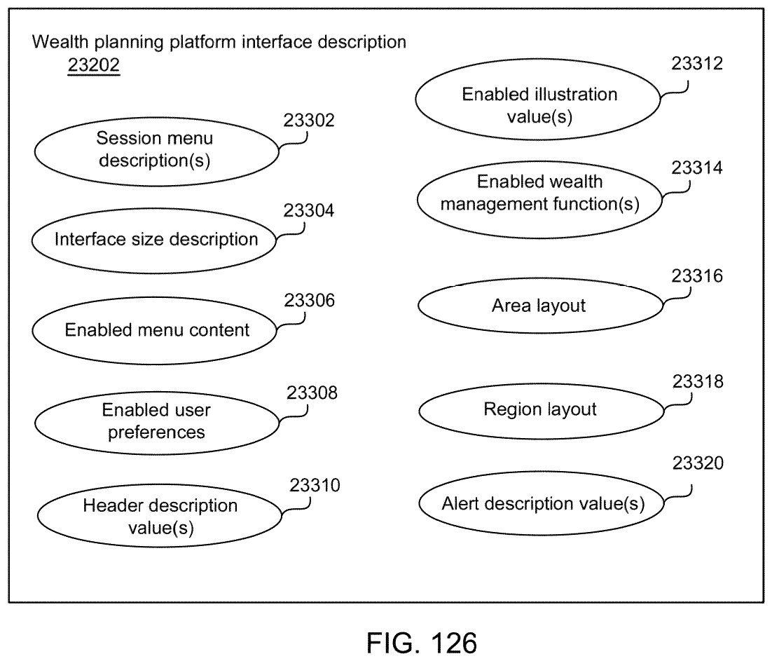

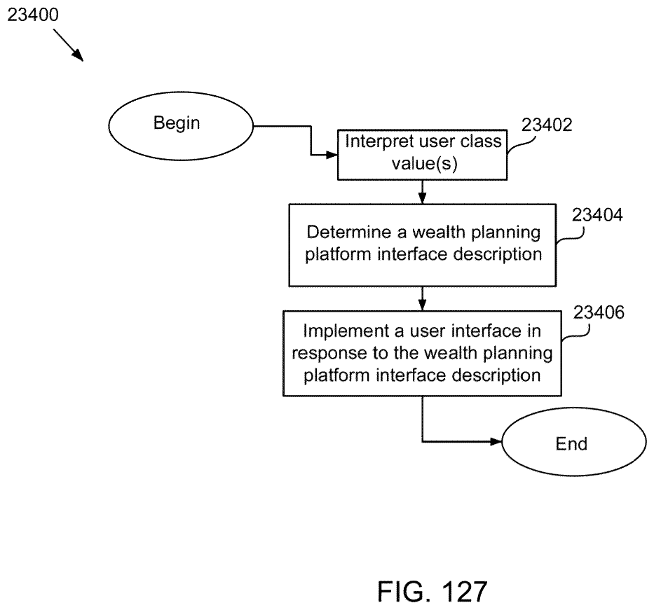

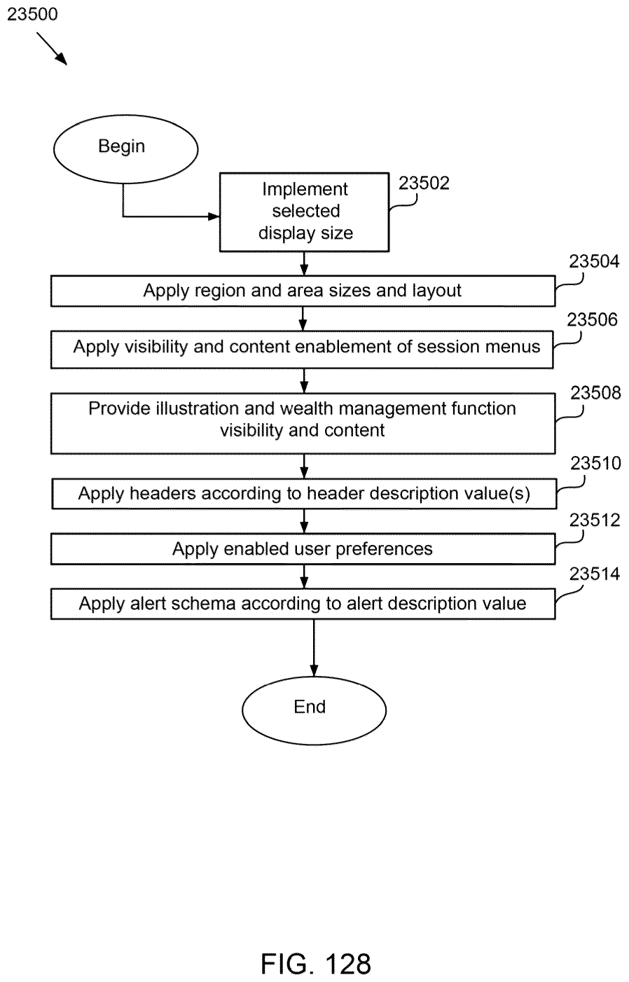

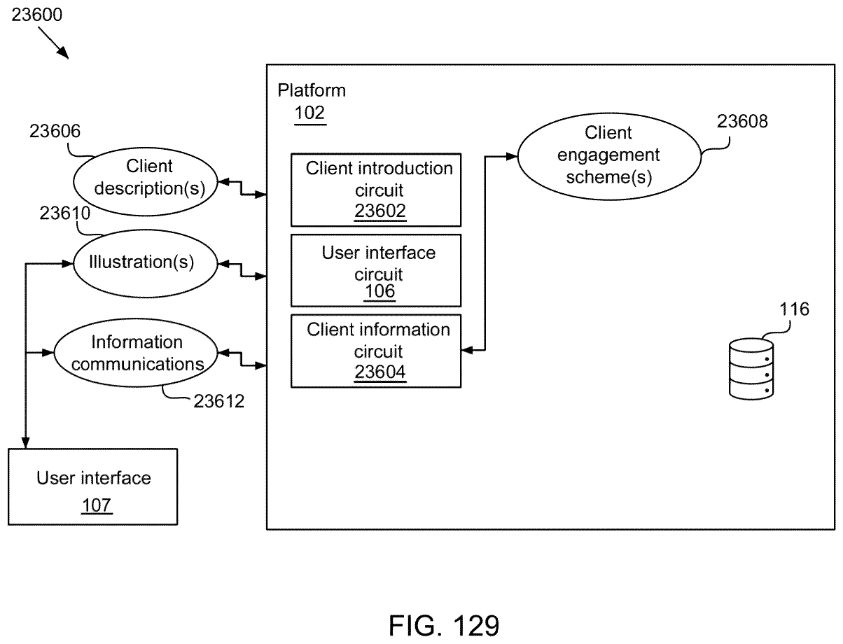

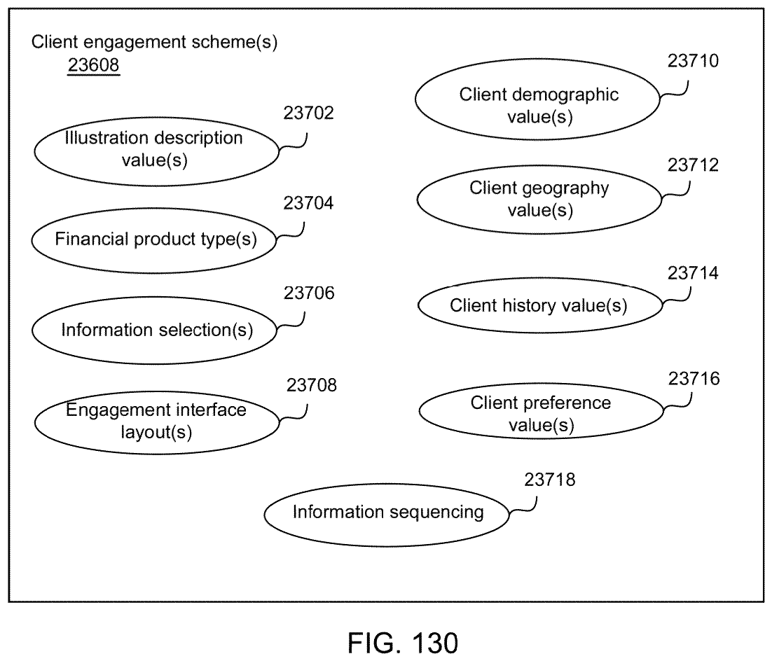

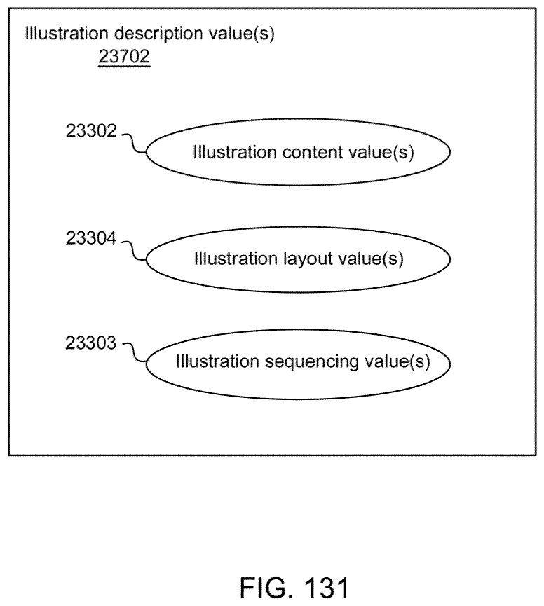

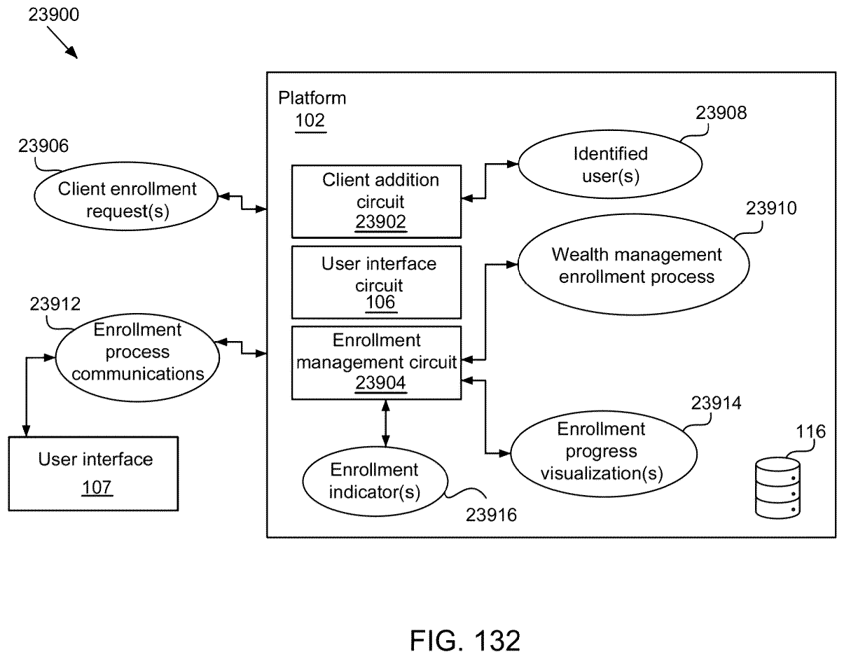

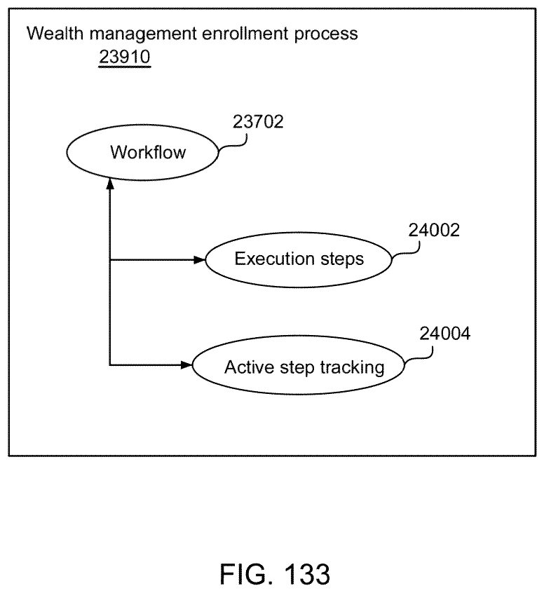

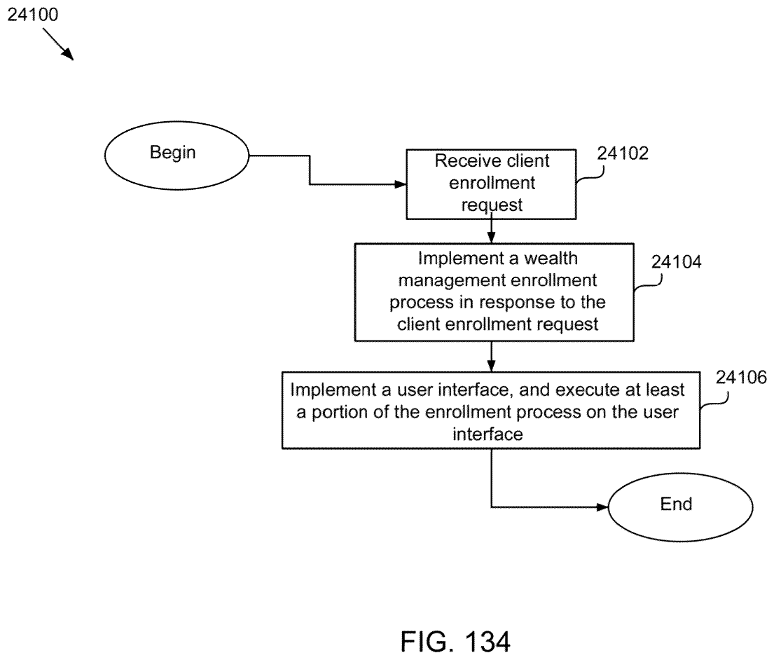

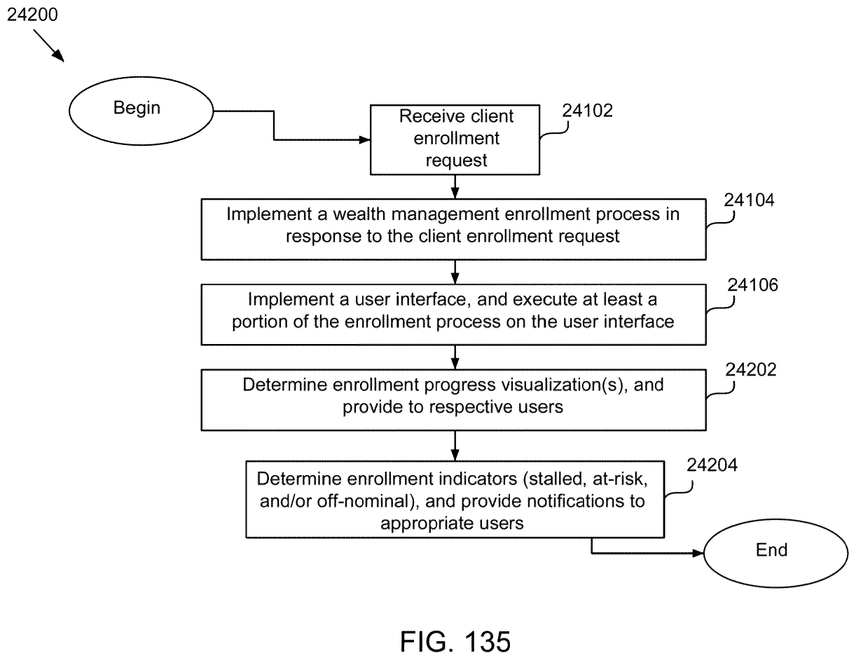

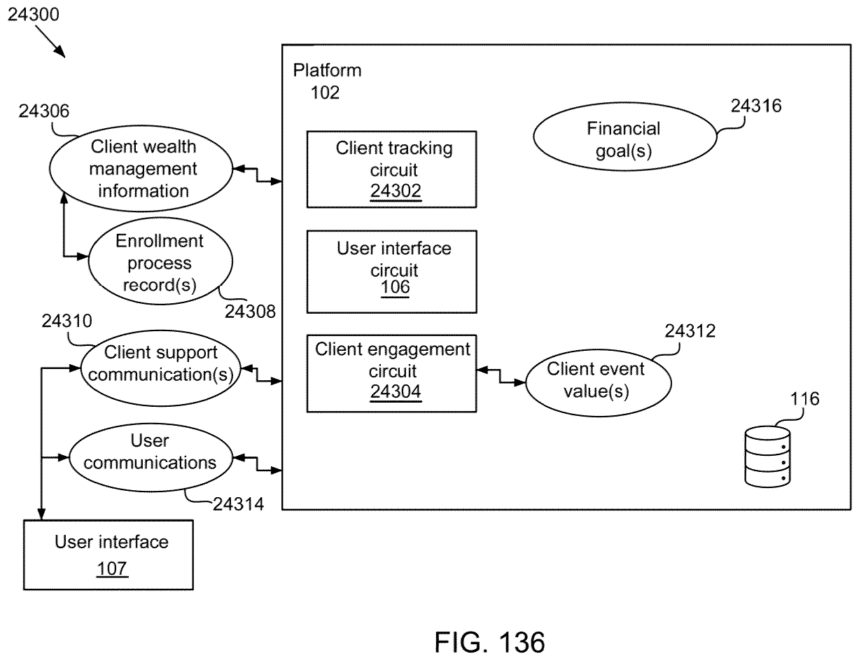

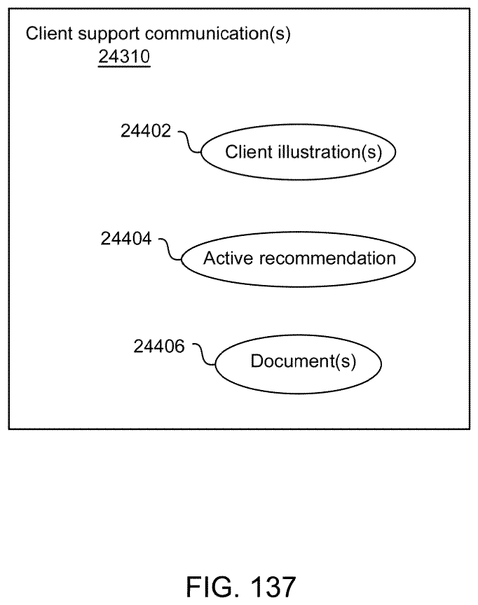

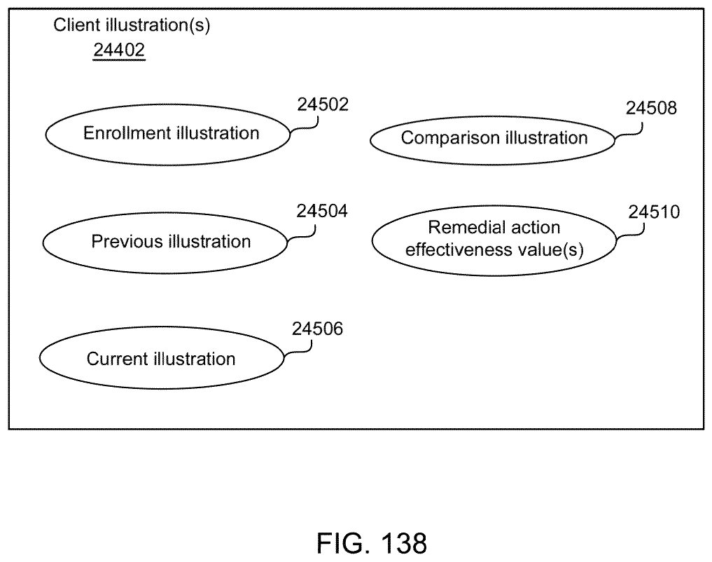

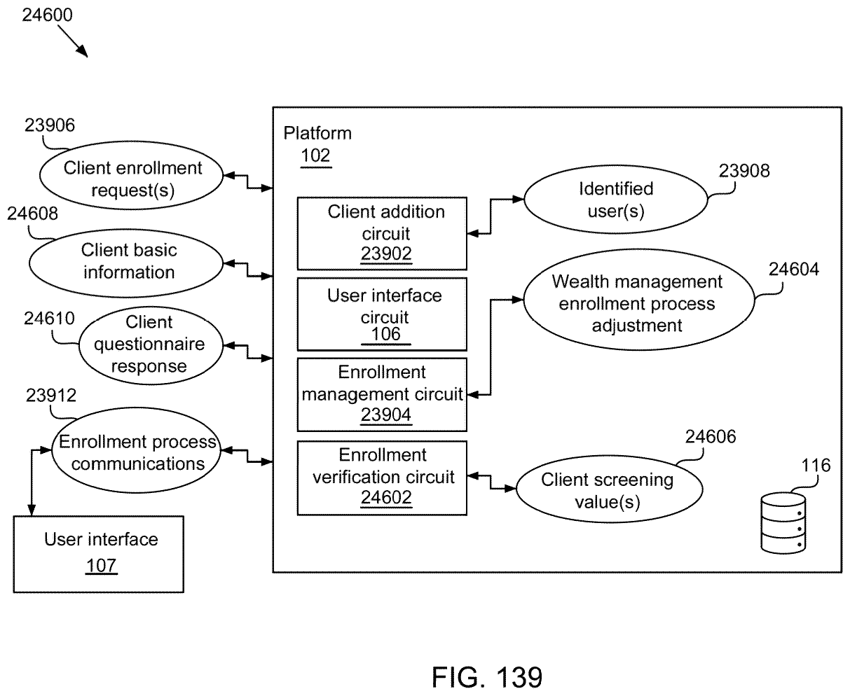

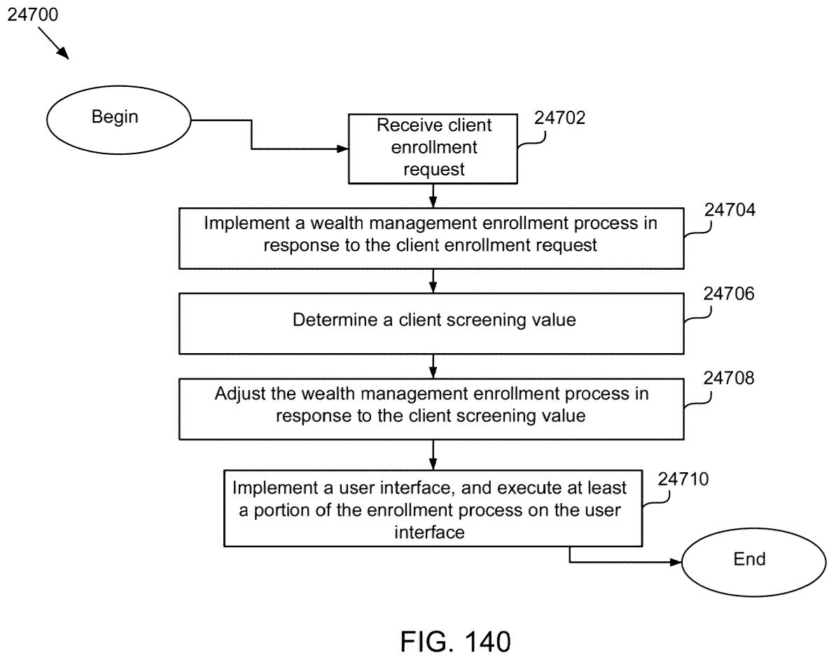

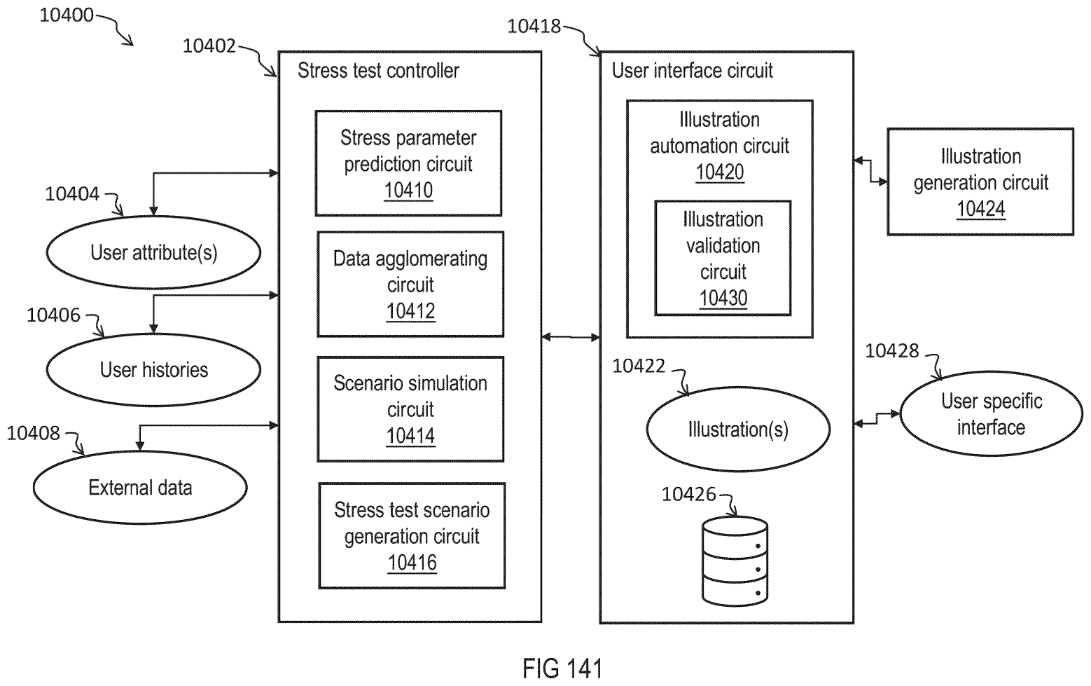

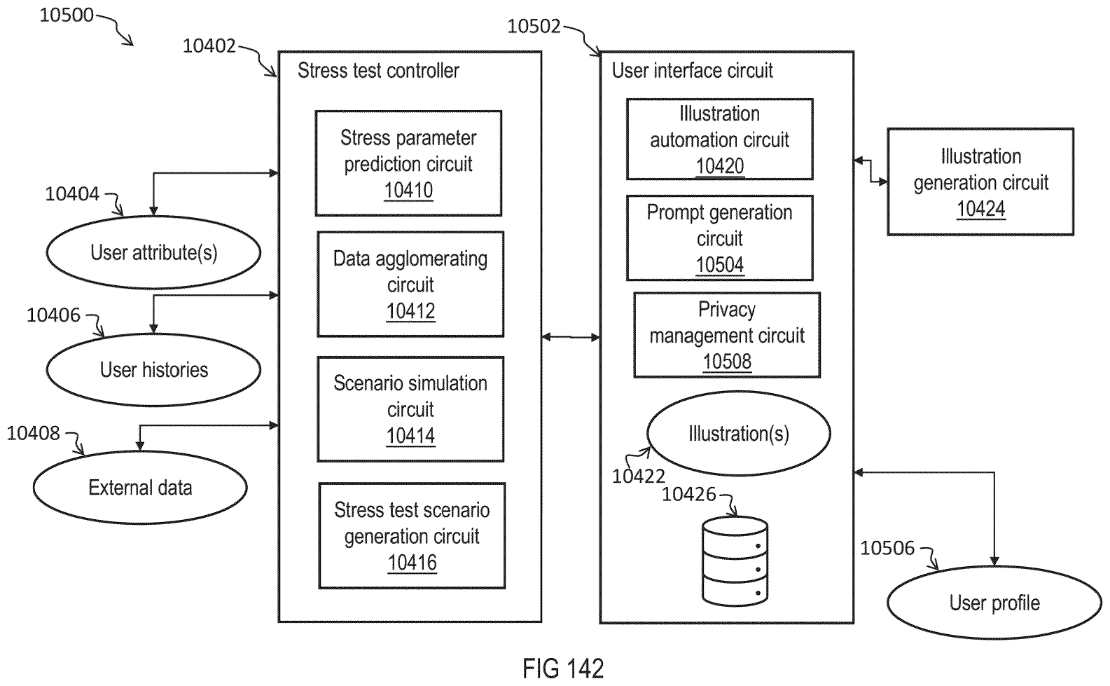

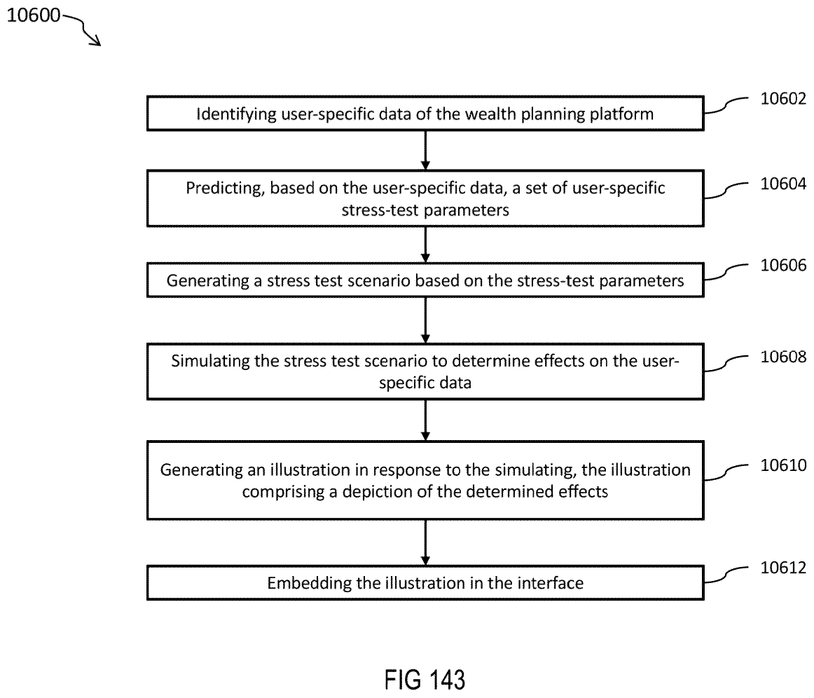

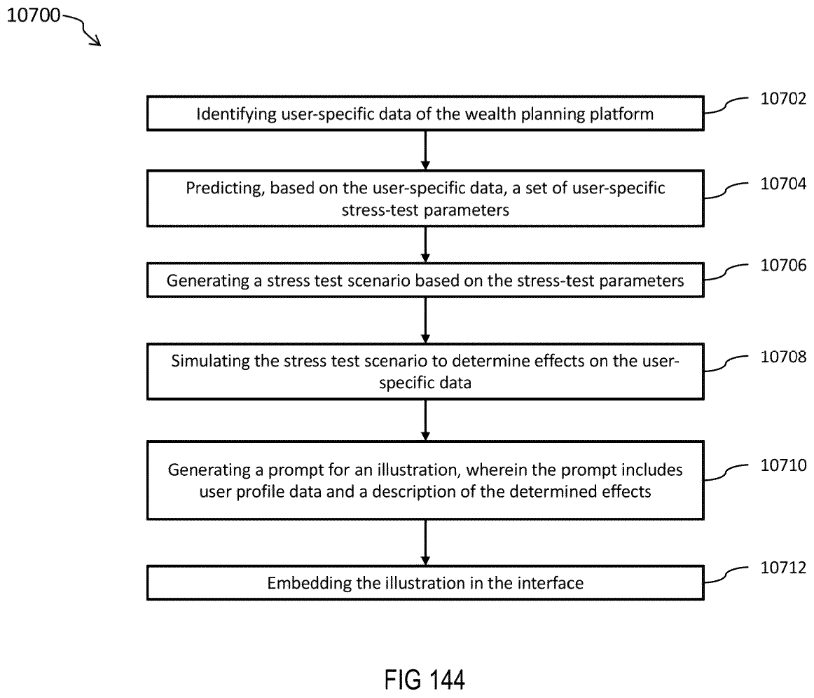

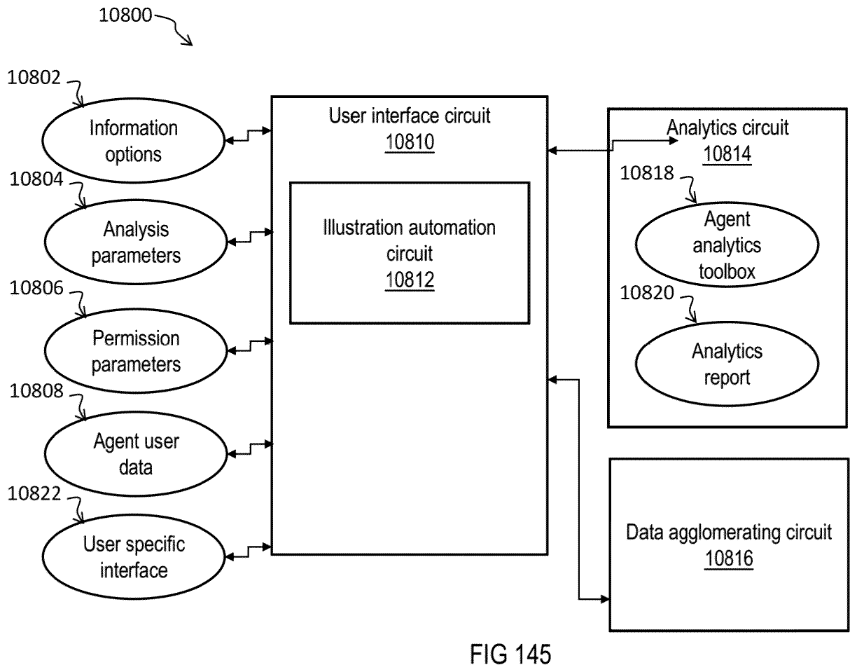

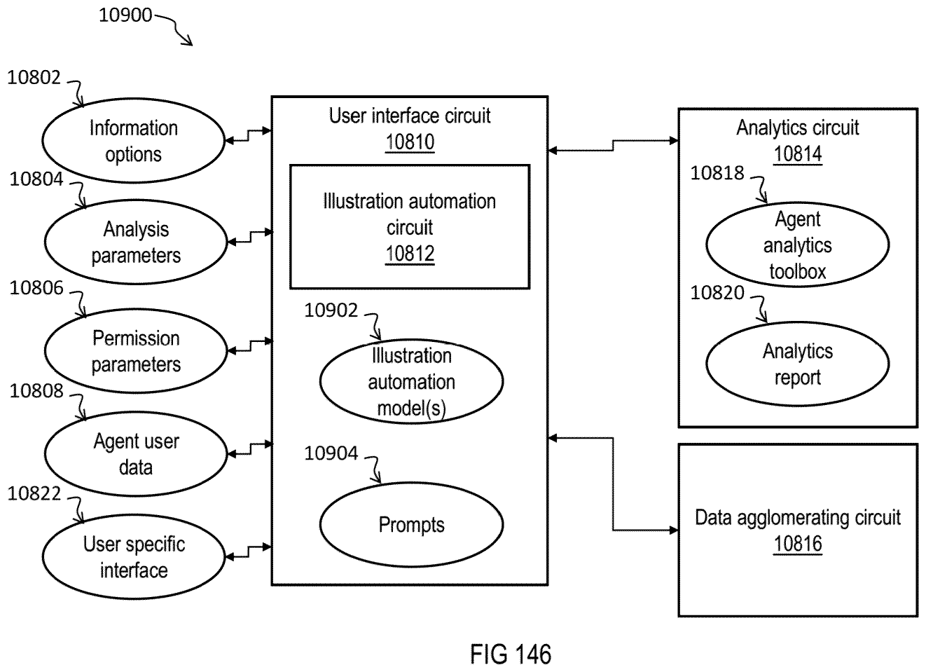

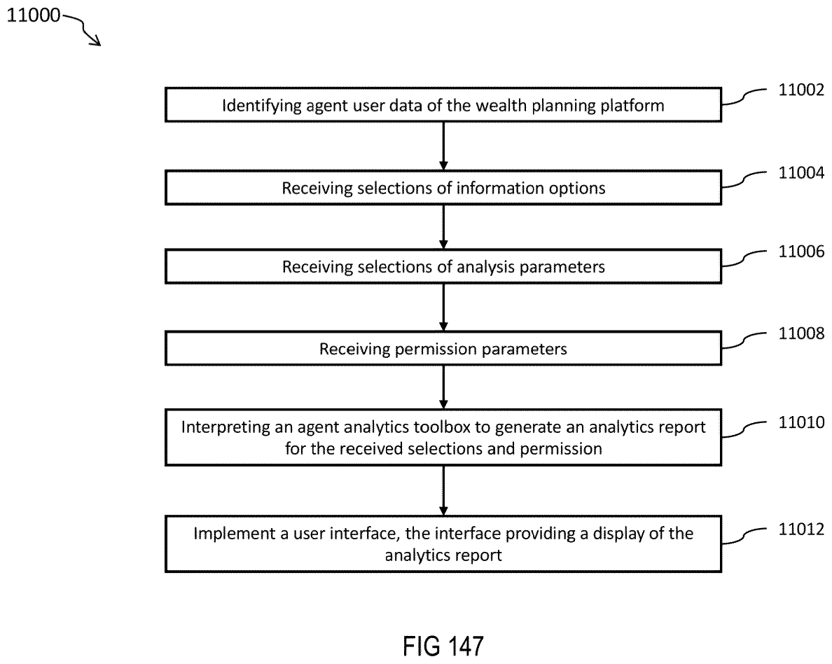

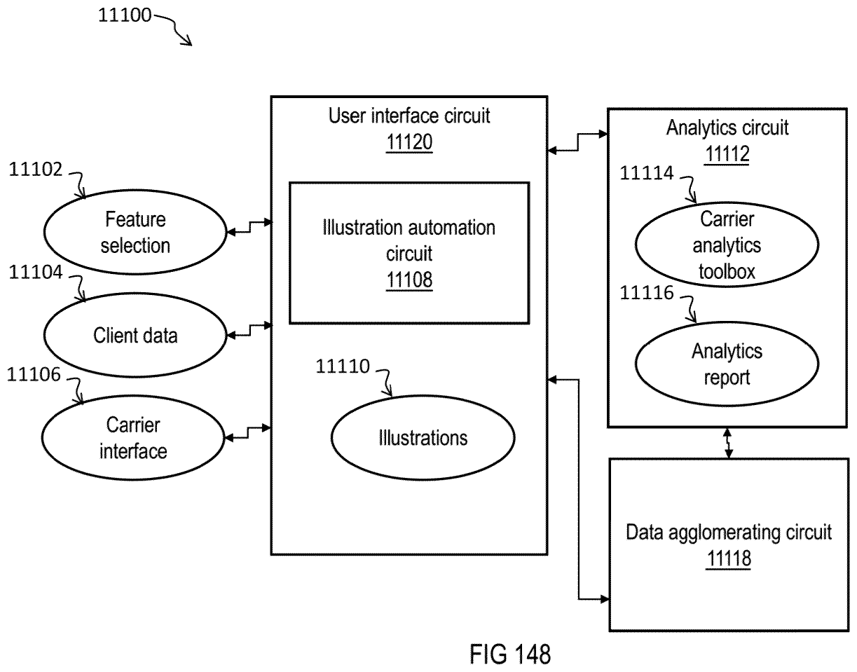

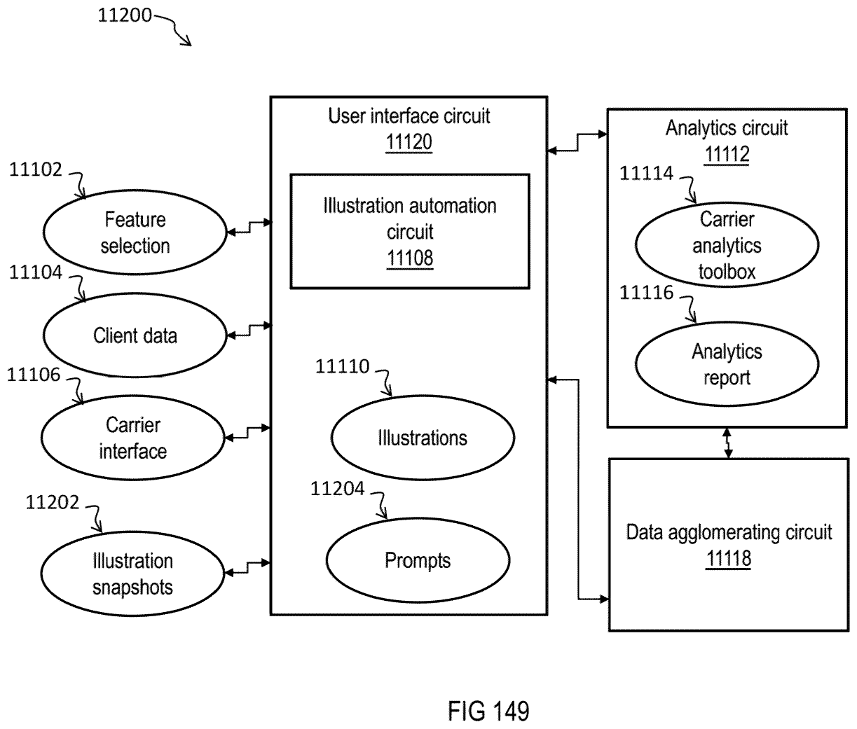

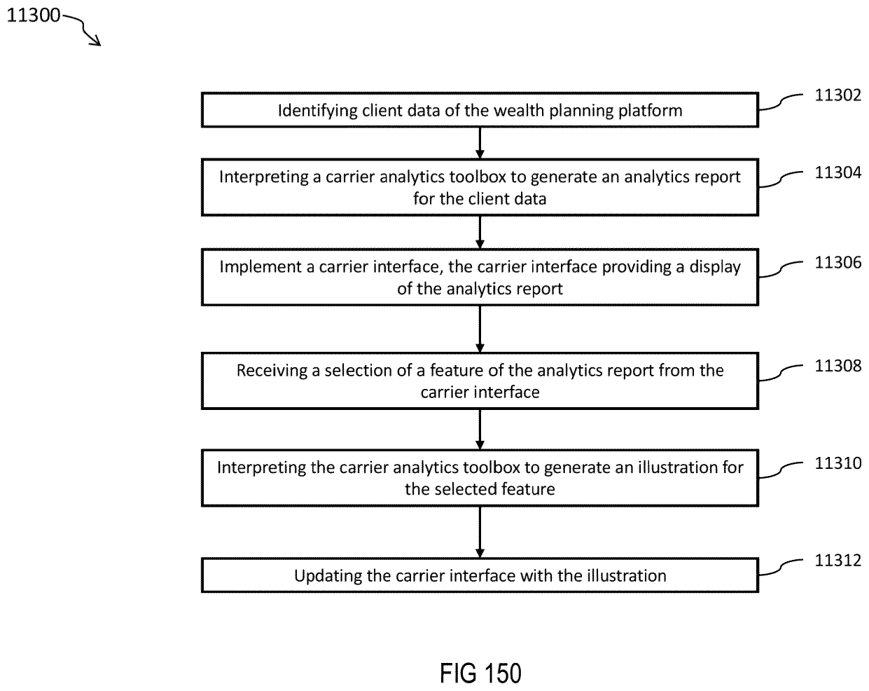

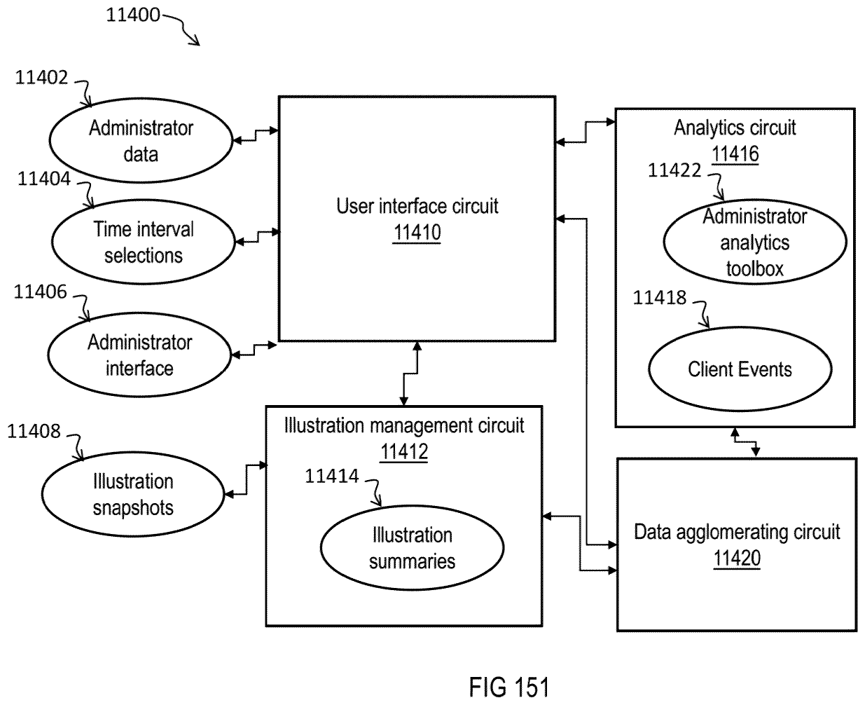

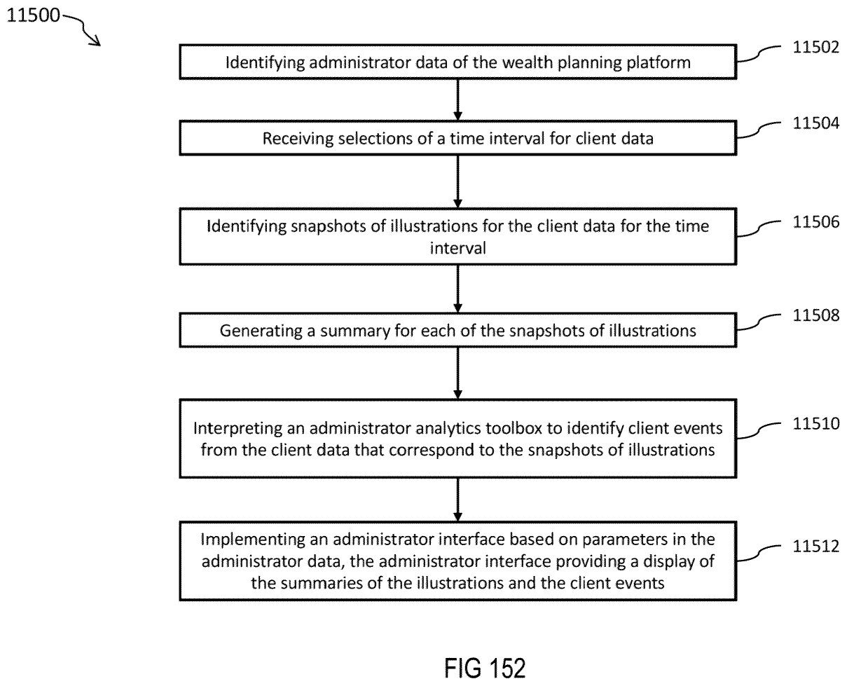

FIGS. 83 A-83B depict aspects of example reports.

FIGS. 84A-84B depict aspects of example reports.

FIGS. 85A-85B depict aspects of example reports.

FIGS. 86A-86B depict aspects of example reports.

FIGS. 87A-87B depict aspects of example reports.

FIGS. 88A-88B depict aspects of example reports.

FIG. 89 depicts an example engagement predictor.

FIG. 90 depicts another example engagement predictor.

FIG. 91 depicts an example method for predicting client engagement with a wealth planning platform.

FIG. 92 depicts an example method for predicting client engagement and adjusting a configuration in response to the predicted engagement.

FIG. 93 depicts an example system for providing scheduled access to a wealth planning platform.

FIG. 94 depicts an example scheduled access profile.

FIG. 95 depicts an example permitted functions description.

FIG. 96 depicts an example of wealth management functions.

FIG. 97 depicts an example of wealth management structures.

FIG. 98 depicts an example of user class values.

FIG. 99 depicts an example user trait values.

FIG. 100 depicts an example user interface circuit withing a display screen.

FIG. 101 depicts an example procedure for implementing a user interface to provide scheduled access to different user classes on a wealth management platform.

FIG. 102 depicts an example procedure for providing scheduled access to a wealth management platform.

FIG. 103 depicts an example procedure for providing scheduled access to a wealth management platform.

FIG. 104 depicts an example procedure for providing at least two different levels of access.

FIG. 105 depicts an example procedure to implement an enrollment process for a new user.

FIG. 106 depicts an example procedure to implement an enrollment process for a new user.

FIG. 107 depicts an example procedure for implementing an enrollment process for a user.

FIG. 108 depicts an example system for creating and managing tranches.

FIG. 109 depicts an example client description.

FIGS. 110-114 depict aspects of example tranche analytics profiles.

FIG. 115 depicts an example procedure for updating tranche analytics.

FIG. 116 depicts an example system for creating and managing groups of users.

FIG. 117 depicts an example attribute of the users for a group.

FIG. 118 depicts example investment attributes.

FIG. 119 depicts an example procedure that includes an operation to receive group addition request(s), and an operation to add an identified user to an existing group, or to create a new group for the identified user.

FIG. 120 depicts an example procedure that includes an operation to determine group analytics for the existing group or the new group and an operation to expose the group analytics to selected users on the platform.

FIG. 121 depicts an example system for performing a group enrollment.

FIG. 122 depicts an example user attributes.

FIG. 123 depicts an example procedure for executing enrollment operations for a group.

FIG. 124 depicts an example procedure for providing group analytics to a user on a platform.

FIG. 125 depicts an example system for configuring an interface.

FIG. 126 depicts an example wealth planning platform interface description.

FIG. 127 depicts an example procedure for implementing a user interface based on a user class value.

FIG. 128 depicts an example procedure for implementing a user interface.

FIG. 129 depicts an example system for selecting and utilizing distinct client engagement schemes.

FIG. 130 depicts aspects of a client engagement scheme.

FIG. 131 depicts an example illustration description value.

FIG. 132 depicts an example system for managing a workflow and promoting progress of the workflow.

FIG. 133 depicts aspects of an example wealth management enrollment process.

FIG. 134 depicts an example procedure for implementing a user interface and executing an enrollment process.

FIG. 135 depicts an example procedure to determine enrollment indicators for enrollment issues.

FIG. 136 depicts an example system for providing longitudinal servicing support.

FIG. 137 depicts an example client illustration.

FIG. 138 depicts an example enrollment illustration.

FIG. 139 depicts an example system for providing early enrollment screening operations.

FIG. 140 depicts an example procedure for performing client screening for a user interface.

FIG. 141 depicts an example apparatus for the customization of an interface.

FIG. 142 depicts another example apparatus for the customization of an interface.

FIG. 143 depicts an example method for the customization of an interface.

FIG. 144 depicts an example method for customization of an interface using prompts.

FIG. 145 depicts an example apparatus for the customization of an interface.

FIG. 146 depicts another example apparatus for the customization of an interface.

FIG. 147 depicts an example method for the customization of an interface.

FIG. 148 depicts an example apparatus for the customization of a carrier interface.

FIG. 149 depicts another example apparatus customization of a carrier interface.

FIG. 150 depicts an example method for the customization of a carrier interface.

FIG. 151 depicts an example apparatus for the customization of an interface for an administrator in a wealth planning platform.

FIG. 152 depicts an example method for the customization of an interface.

### DETAILED DESCRIPTION

Without limitation to any other aspect of the present disclosure, aspects of the disclosure herein provide for improved execution of a wealth management platform, improved enrollment and engagement with clients and servicers within the wealth management ecosystem, and improved servicing, including longitudinal support over the life cycle of the wealth management servicing event. The present disclosure is described in the context of a wealth management platform, or a wealth planning platform, for clarity of the present description. Numerous other processes have similar challenges to the wealth management and/or wealth planning context, which are also addressed by the aspects, features, operations, and/or systems described herein. For example, processes that have serial dependent steps with hand-offs between numerous entities, and/or processes involving entities that have limited communication, visibility, and/or accountability between each other (e.g., “siloed” groups within a company, processes that involve numerous institutions such as licensing, grants, permitting processes, and/or certain manufacturing processes) are also applicable targets for the platform and/or other aspects of the present disclosure. In certain embodiments, processes that involve primary users (e.g., users that are seeking the direct benefit of the process) that may not have a sophisticated understanding of the features and/or aspects of the process, and where another class of users are useful in caretaking the primary user through the process, may also benefit from the platform, features, and aspects of the present disclosure. For example, embodiments of the present disclosure promote greater visibility and control of the process for the primary user, while beneficially linking in the caretaking user to assist in implementing, tracking, and servicing the process, promoting greater control for the primary user while still protecting the primary user from pitfalls that may occur from providing direct control to the primary user.

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains.

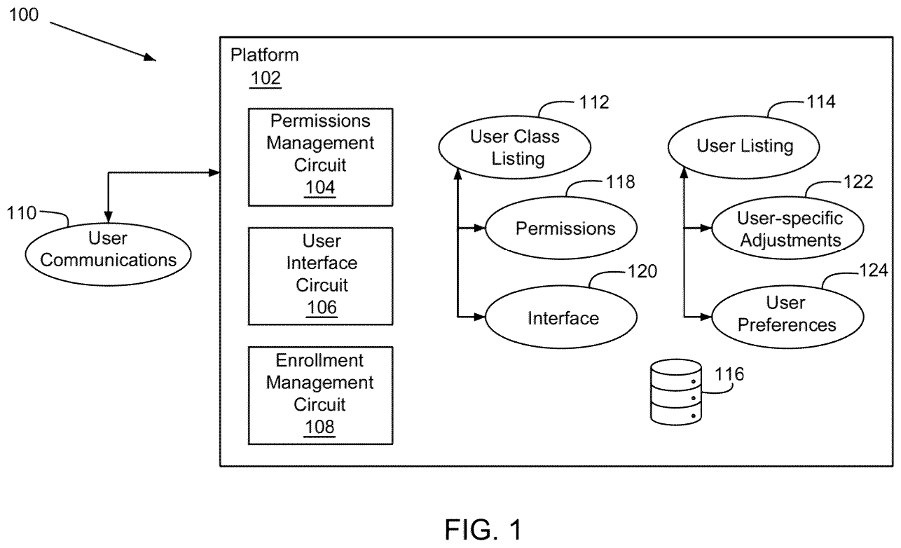

A number of embodiments of a wealth planning platform are set forth in FIGS. 1-8, which provide some basic functionality for aspects of the present disclosure. These examples are capable of performing a number of operations that may be utilized in systems, platforms, controllers, and/or apparatuses of the present disclosure, and/or that may be used to perform certain operations here. The embodiments depicted in FIGS. 1-8 may be utilized, in whole or part, with any other embodiments throughout the present disclosure.

Referencing FIG. 1, an example system 100 including a wealth management platform 102 is schematically depicted. The example platform 102 may be utilized with, included as a part of, and/or may include portions of embodiments throughout the present disclosure, to support the systems, methods, and apparatus herein for operating a wealth management ecosystem to support achieving client financial goals, reducing risks, and ensuring that the plan supports these over time and over the life cycle of the plan. Aspects of the present disclosure incidentally provide tools for execution of financial protection and wealth development for clients in many embodiments and contexts. However, the aspects of the present disclosure include technical aspects that support and execute operations for a complex process with multiple hand-offs, with diffuse “ownership” of the process across multiple organizations with varying goals and interests, and over long periods of time with sporadic periods of high activity combined with extended periods with low or no activity. Further, aspects of the present disclosure include technical aspects that support and execute operations for processes that include multi-faceted aspects (e.g., financial performance, current cash value, basis tracking, tax treatment, etc.) that are difficult to define at a given point in time, but include further complications such as tracking past performance, predicting or estimating future outcomes including non-linear inputs such as regulatory treatment, currency fluctuations, inflation, changing tax treatment, and/or changes in the availability of process inputs such as financial product types, or the like. Additionally, aspects of the present disclosure include technical aspects that support and execute operations for tracking performance of predictions, and/or for tracking the trajectory of predictions themselves (e.g., comparing the outcome of a 2010 prediction to the outcome of a 2015 prediction for the same corpus of instruments and assets). The aspects of the present disclosure support processes that have challenges that relate to multiple industries, contexts, or the like, and are not limited to a wealth management system or process. Further, the aspects of embodiments herein do not depend upon the financial nature, per se, of the processes and systems that are enhanced thereby.

Certain aspects of the present disclosure include, reference, and/or are described in relation to a circuit, controller, component, module, platform, computing device, and/or terminology similar to any of the foregoing. Specific examples of these aspects (“devices”, in this paragraph, to simplify the present description) are provided for clarity of the description, and to provide a context for describing features, aspects, capabilities, operations, or the like for specific embodiments of the present disclosure. However, the specific implementations of these devices, including depictions of example devices as a single device or a specific distribution of devices, are not limiting to the present disclosure. Any such device may be, without limitation: a single device; a distributed device; a device that is positioned, in whole or part, on other devices of the present disclosure; and/or a device that incorporates, in whole or part, other devices. The examples of such devices in the present disclosure are provided to illustrate certain capabilities and/or functions of the devices, and any implementation of devices configured to perform one or more of the described operations is contemplated herein to embody all or a portion of such devices. Example and non-limiting device embodiments include one or more of: any sensor present in a system configured to provide one or more parameters utilized by the device; any actuator present in a system configured to respond to one or more parameters utilized by the device; any hardware configured to be responsive to system conditions to perform one or more operations of the device; a distributed computing device, including devices at least intermittently communicatively coupled and configured to perform one or more operations of the device; any output device such as a display screen, printer, and/or audio output device; any input device such as a mouse, keyboard, touch screen, and/or audio input device; instructions stored on a non-transient computer readable medium configured such that a processor executing the instructions thereby performs one or more operations of the device; a logic circuit; a programmable logic circuit; a processor, a memory device of any type; and/or network communication resource(s) of any type.

In the example of FIG. 1, an example platform includes a permissions management circuit 104 configured to perform operations to provide scheduled access to users of the platform. Permissions management may be performed based upon the role of the user in the system (e.g., a client, an agent, a carrier, an underwriter, or the like), defined or adjusted by another user of the system (e.g., an agent may give certain permissions to a client; an administrator may give certain permissions to one carrier versus another carrier, and/or a supervisor of an agent may give varying permissions according to the experience, goal, training, etc. available to the agent, etc.).

In certain embodiments, and without limitation to any other aspect of the present disclosure, the application of permissions by the permissions management circuit 104 includes adjusting any one or more of multiple aspects of interactions for relevant users with the wealth management platform, for example determining or adjusting: which user interface is utilized for interactions with the user, which menus and/or menu options appear on the interface for the user, which analysis, data visualization, and/or illustration elements are available to the user, the ability of the user to adjust preferences on the platform (e.g., configuring messaging and/or notification parameters, data that will be shown, options that can be selected, etc.); and/or the ability of the user to adjust any of these for other users.

In certain embodiments, the permissions management circuit 104 accesses a user class listing 112, for example a listing of user classes such as an agent, carrier, underwriter, independent marketing organization (IMO, sometimes referenced as an insurance marketing organization), bank or other financial institution related user, an administrator (e.g., a user associated with the operation and/or support of the platform, and/or a user having certain rights to manage the experience of other users, such as a supervisor for a group of agents or other users, an IT user, etc.). The example permissions management circuit accesses the user class listing 112, and determines which user class applies to a specific user accessing the platform, applying the permissions 118 and interfaces 120 for that user according to the user class. In certain embodiments, the user class for the user may be defined by another user, for example where an agent invites a client to the platform 102, where the user class for the client may be set by the agent in the process of creating the invitation. The user class listing 112 may include a user class for any type of user as noted, but may additionally or alternatively use a class system that provides configured access to the platform for a group of users where those users share a common attribute that makes the implementation of a user class for that group more efficient to operate on the platform, and/or that can be utilized to ensure the users of the class get the correct information on the platform, have a similar shared experience on the platform, and/or that allows for another user to conveniently configure the user experience for the class. For example, a user class could be utilized for clients having a certain profession (e.g., attorneys, doctors, business owners, self-employed users, contractors, exempt employees, hourly employees, etc.), based on attributes of the user (e.g., geographic location, demographic group, relevant jurisdiction for the user, indicated risk profile for the user, etc.), according to attributes of an entity related to the user (e.g., agents of a first company having a first user class, and agents of a second company having a second user class), and/or based on interactions with the platform (e.g., allowing users to self-select a user class, for example from a selected group of templates; based on a subscription or other criteria with the platform; and/or behavior based such as applying a selected user class to individuals that consistently access certain features, data, illustrations, or the like on the platform). In certain embodiments, the user class may be utilized to fully define the user experience for the user, and/or may be utilized to apply defaults, to limit certain selections, to make certain recommendations, or a combination of these.

The example platform includes a user interface circuit 106 that implements a user interface for a user accessing the platform. The user interface may be selected based on the user class for the user, and/or may be adjusted for user-specific aspects, for example stored on a user listing 114 having user-specific adjustments 122, user preferences 124, or the like. In the example, the user listing is described in relation to individual users, but may additionally or alternatively be applied to specific groups of users, such as users in a particular tranche, holding certain assets, associated with a particular company, or the like. The user-specific adjustments 122 may be applied by the user (e.g., through selections, preferences, or behavior on the platform), by another user (e.g., a supervisor, administrator, agent, etc.), and/or applied in response to events (e.g., a change of a company name, sale of a company, a change in regulations, etc., where the adjustments may be applied to relevant users). In certain embodiments, user-specific adjustments 122 to the user interface may be temporary (e.g., expiring at a selected time, in response to a change of the underlying conditions, etc.), persistent (e.g., applying until they are later changed), and/or may be event driven (e.g., updated based on later user behavior, removed or adjusted when an event causing the initial adjustment is no longer relevant, etc.). The example user interface circuit 106 utilizes user communications 110 to interact with the user, whether receiving user inputs or sending notifications, messages, updating the display of the user interface, or the like. In certain embodiments, the user interface 106 for the user may be exercised as a web portal, a mobile application, a website, a proprietary program (e.g., a program installed on a computer accessible to the user), or the like. In certain embodiments, the user interface 106 may be varied according to the particular access method, for example where a mobile application includes less capability for the user than another access type such as a web portal implementation. The access to the platform 102 for a particular user may be controlled by a login, authentication, or other access control system as understood in the art. In certain embodiments, the access control may be adjusted based on the type of access, and the user interface may be adjusted based on both the type of access and/or the authorization—for example allowing a user limited access in response to a basic login, and greater access for a login using two-factor authentication, etc. In certain embodiments, some capabilities on the platform may additionally or alternatively have aspects utilizing authentication from another user—for example a user changing their own permissions, user class, enrollment stage, etc., may have an available interface to request these changes, but such changes may be subject to approval by a second user.

In certain embodiments, the platform may utilize a permissions schedule based on user class(es), and/or an interface schedule based on the user class(es). In certain embodiments, the user interface circuit 106 implements the user interface for each user based upon the applicable permissions schedule(s) and/or the applicable interface schedule(s), which may be adjusted for a particular user as set forth throughout the present disclosure. The example of FIG. 1 is described in the context of a wealth planning platform for clarity of the present description, and is applicable to a wealth planning platform. However, the description referencing FIG. 1, and other descriptions throughout the present disclosure, are applicable to many other applications. Example applications for the example of FIG. 1, and other examples throughout the present disclosure, include, without limitation: a real estate platform, an online servicing platform of any type, and/or any platform utilized to interact with and/or control a workflow, including workflows with multiple user types having distinct relationships or duties with the workflow and platform, and/or workflows having multiple touch points with the process by different users or user classes. In certain embodiments, example applications for the example of FIG. 1, and other examples throughout the present disclosure, include applications having workflows with at least some of the workflow steps in serial, including where there are hand-offs between at least some of the steps between distinct users or user classes. In certain embodiments, example applications for the example of FIG. 1, and other examples throughout the present disclosure, include applications having an extended life span, for example with long-term servicing elements of the workflow that may last months or years.

In certain embodiments, utilization of the platform 102 by a user may be by invitation only, for example a client user may be able to utilize the platform for plan enrollment, management, analysis, and/or servicing upon being invited to the platform by another relevant user, for example invitation provided by an agent, a carrier, a financial advisor, or the like. In certain embodiments, a platform 102 may be configured to allow full or partial utilization of the platform through direct access, for example by visiting a website, registering with a web portal, accessing through a mobile application, or the like. In certain embodiments, access to the platform 102 without an invitation may result in providing a contact for the requesting user to an authorized user, for example by determining an appropriate agent, carrier, or the like, where the platform facilitates contact between the requesting user and the authorized user. In certain embodiments, a requesting user may have some access to aspects of the platform 102, for example allowing the user to get example illustrations of a wealth plan, access to a list of appropriate carriers and/or agents for the user, and/or descriptions of the enrollment process, analytics or other data visualization aspects, and/or descriptions of servicing features and/or benefits of using the platform. The determination of the platform access profile—for example whether a user can access the platform by request and/or by invitation, and the consequent features and/or aspects available to the user, is a design selection by the administrator of the platform. One of skill in the art, having the benefit of the present disclosure and information readily available when contemplating a wealth management platform (and/or a wealth planning platform, a process control platform, and/or a distributed serial process control platform), can readily determine the access type and feature capability appropriate for the platform. Certain considerations for determining the access type and feature capability for the platform include, without limitation: the purpose of the platform; regulatory requirements related to the content of the platform 102; the utility to a casual user of direct access to the platform, including access with or without a caretaker user (e.g., an agent or other guide to help the user); the likelihood that a casual user of the platform will be able to directly access beneficial processes on the platform; indicated platform characteristics from a machine learning, artificial intelligence (AI), and/or iterative improvement process (e.g., settings for platform access and/or feature capability for the user, including which features should be available directly to the user, which features should be coordinated with a caretaker, and/or invitation vs. direct access for the entire platform and/or individual features thereof; correlated with successful outcomes, such as completion of enrollment, persistence with planned activities, and/or success indicators such as financial outcomes, risk management, and the like); and/or the type of process and/or features supported on the platform (e.g., a platform implementation of a proprietary internal process such as a manufacturing process, or a process protected under a trade secret, may suggest an invitation only type of access configuration, where a process applicable to the public, where a casual user is likely to successfully engage the process, may suggest an open direct access configuration).

The example of FIG. 1 includes an enrollment management circuit 108 structured to implement an enrollment process, for example an enrollment process for a wealth planning platform. The enrollment process is further set forth throughout the present disclosure, and any aspects of the enrollment process may be implemented, in whole or part, by the enrollment management circuit 108, and/or the enrollment management circuit 108 interacting with users, user interfaces, or the like. An example enrollment process includes an operation to initialize a user with the platform 102, for example to import the user information (e.g., name, identifier, contact information, address, occupation, income description, asset description, etc.), to set up user login or authorization information, or the like. In certain embodiments, initialization of the user may be performed, in whole or part, by an agent or representative before the user engages the platform 102—for example by an insurance agent, financial advisor, or the like, which may be performed before invitation of the user to access the platform 102, as a part of inviting the user to the platform 102, and/or after invitation of the user to the platform 102. In certain embodiments, aspects of the user information may be determined from publicly available and/or otherwise available (e.g., by a subscription to a proprietary database) information about the user. In certain embodiments, information for the initialization may be deemed preliminary until confirmed by the user accessing the platform. An example enrollment process includes an operation to determine aspects about the user that are relevant to the enrollment process, such as the goals of the user, beneficiaries related to the enrollment, or other information that guides the enrollment process and/or later management of the enrollment and/or managing of the user account after enrollment is completed. An example enrollment process determines which other users of the platform 102 have activities or responsibilities related to the primary user (e.g., where the primary user is a client or other beneficiary of the process, such as the person or entity on whose behalf the process is being implemented). For example, a wealth management product may include investments, insurance, tax planning operations, annuities, loans or other financial instruments, or the like, that may require approvals, underwriting, signatures and/or approvals by the primary user, etc. In certain embodiments, operations of the enrollment process may be performed serially, for example progressing from an approval from the primary user to request a product, underwriting or other assessments to confirm the applicability of the user for the product as well as the cost or other information about the product, further approval from the user, agent, carrier, or other parties to proceed with acquisition and implementation of the product, ongoing payments or confirmation for the product, or the like. In certain embodiments, some process elements are performed serially with hand-offs to various users that may not be directly associated with each other, and/or that may not have awareness of the entire process. In certain embodiments, some process elements are performed in parallel, for example a process flow to implement a life insurance product, and a separate process flow to implement a long-term health care product. In certain embodiments, parallel processes may be performed entirely independently, and in certain embodiments, parallel processes may have dependencies for planning purposes even if they are independent processes for implementation purposes (e.g., an investment product may have a life insurance component for wealth planning purposes, where the investment product only makes sense for the user in the context of the life insurance product being implemented, but the technical implementation of these products is otherwise separate and the related entities—for example a bank and a life insurance company—do not require that the other product be approved or even available for the user, in such embodiments, depending upon the configuration of the system by an agent, administrator, financial planner, or the like, final approval of the products may be withheld until the other product is approved, which implementation will be enforced by the platform without further intervention from users of the platform). Due to the complexity of the enrollment workflow, and the multiple hand-offs between different users during the enrollment workflow, the operations of the platform 102 to control notifications, provide appropriate dashboards for each user, to provide reports to interested and authorized parties, and the like, the time for completion of the enrollment utilizing the platform and/or other aspects of the present disclosure is greatly reduced, and the confidence that a complete and correct enrollment that meets the initial goals of the process as indicated by the agent, financial planner, primary user, or the like is greatly increased. Additionally, embodiments of the present disclosure enhance the ability of certain users, for example the primary user, a product carrier, an agent, and/or a financial planner, to quickly determine the current status of the enrollment process workflow, which user(s) have actions due, an estimated time of completion of the enrollment, an estimated likelihood of success of the enrollment, a confirmation of a match between the plan versus the actual outcome from the enrollment, and/or differences between the plan versus the actual outcome from the enrollment (e.g., where the outcome relates to investment types and/or amounts, insurance types and/or amounts, cost targets (e.g., fees, premiums, etc.), and/or timing targets). The example capabilities with regard to the enrollment process may be available, without limitation to any other aspect of the present disclosure, to other workflows related to the platform, such as periodic updates to the plan, servicing of the plan, performance of the plan, adjustments to the plan, or the like.

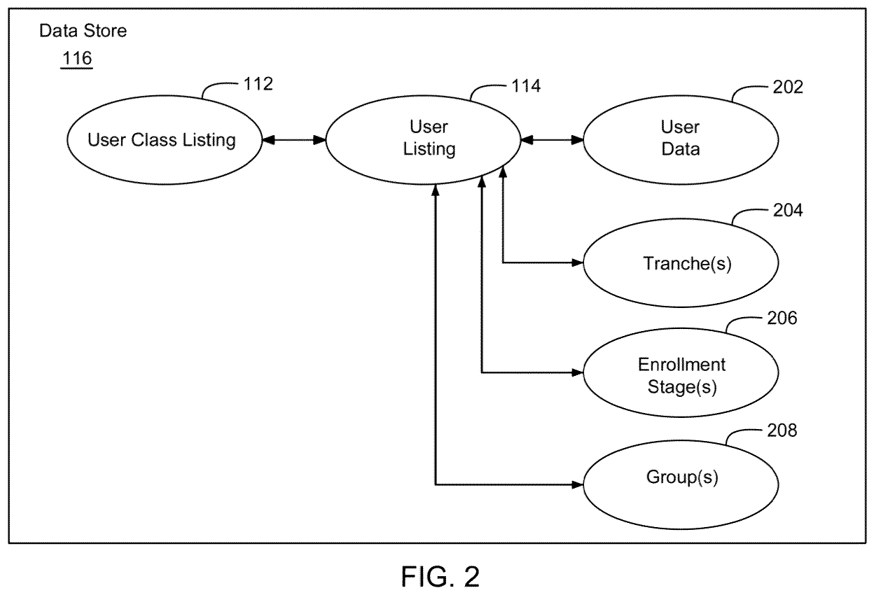

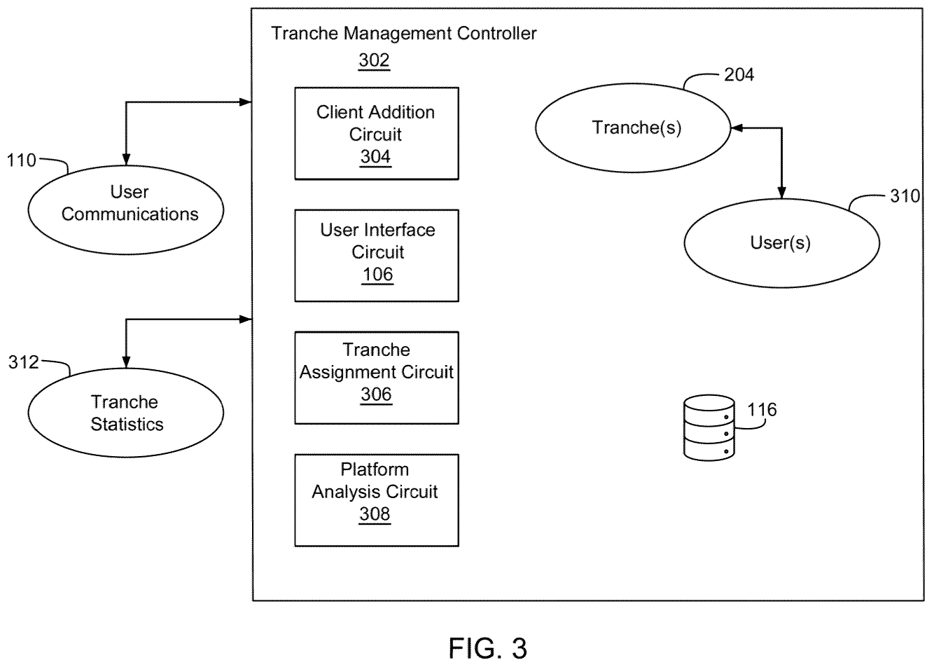

Referencing FIG. 2, an example data store 116, for example on the platform 102 and/or accessible by the platform 102, includes data related to the platform 102, such as the user class listing 112, user listing 114, associated permissions, which enrollment stage(s) 206 are applicable to the user, which tranche 204 (e.g., reference FIG. 3 and the related description) is applicable to the user, and/or which group(s) 208 for which the user is a member. In certain embodiments, the data store 116 may include any other information related to the platform 102, such as documentation, performance data, data utilized for any analysis or illustration set forth herein, user preference information, and/or data utilized by a machine learning, artificial intelligence, and/or iterative improvement component herein. The data store 116 is depicted as a single component, but may be distributed among several components, provided as a separate service (e.g., cloud storage based), or combinations of these.

Referencing FIG. 3, an example tranche management controller 302 is schematically depicted. The example tranche management controller 302 may be utilized with a platform 102, and/or included as a part of the platform 102. The example controller 302 includes a client addition circuit 304 that receives a client addition request (e.g., as a user communication 110) to add a client (or user, primary user, and/or beneficial user) to the platform 102, for example to begin an enrollment process for the client. The client addition request may be provided by the client (e.g., accessing the platform, and requesting product(s) and/or service(s)), by an agent (e.g., beginning enrollment at the request of the client, and/or as a part of initiating engagement with the client), and/or by the platform 102 (e.g., as a part of assigning a client to an initial tranche, moving a client between tranches, etc.). The example controller 302 includes a tranche assignment circuit 306 that adds the client to a tranche 204, and/or creates a new tranche 204 including the client as a part of the new tranche, in response to the client addition request.

A tranche 204, as utilized herein, should be understood broadly. A tranche 204 includes a group of users 310 (e.g., clients) that will be tracked, at least partially, together in a group to manage enrollment workflows or the like. The group of users 310 in a tranche may be related (e.g., a group of users from a company, using a certain carrier, having a similar attribute such as risk profile, investment mix, goals, state of residence, or the like) or entirely unrelated, where the tranche 204 is utilized as an organizing concept for tracking, metrics, or the like. In certain embodiments, a tranche 204 includes a group of users 310 having a same enrollment date, and/or an enrollment date within a specified time window. In certain embodiments, a tranche 204 includes a group of users 310 having a same target enrollment completion date, and/or a target enrollment completion date within a specified time window. In certain embodiments, more than one tranche 204 may be utilized even for a given time frame, for example to limit a number of users per tranche 204, to limit a managed financial target within the tranche 204 (e.g., a total investment amount, a unit count on certain products, etc.). In certain embodiments, the addition of a user to a tranche 204 may be performed for improved operation of the enrollment process flow, for example if Carrier A has only a single relevant client in Tranche A, that client may be moved to another tranche 204 having more clients using Carrier A, for efficiency of the enrollment workflow process management, to improve the look, feel, or relevancy of statistical analysis for a tranche 204, or the like.

An example tranche assignment circuit 306 determines if a tranche move is indicated, for example whether a specific user should be moved from one tranche 204 to another tranche 204. For example, if the execution of the workflow process for a user is delayed relative to the rest of a given tranche 204, the tranche assignment circuit 306 may determine that the user should be moved from the current tranche to another tranche where users are expected to complete the enrollment process closer to the now delayed date for expected enrollment completion for that user. In certain embodiments, the tranches 204 may be enforced simply, for example where the date of the user matches a time window for a different tranche 204 due to process delays and/or unexpected advancement, the tranche assignment circuit 306 moves that user to the new tranche 204 with the matching time window. In certain embodiments, the movement between tranches 204 may depend upon more sophisticated criteria, for example moving the user in response to an expected completion date exceeding the average for the current tranche 204 by a specified amount (e.g., three days, two standard deviations, half the distance of a normal time difference between adjacent tranches 204, etc.). The criteria to assign a user to a tranche 204, and/or to move users between tranches 204, may depend upon the purpose of the tranches 204 for the particular system, the analysis related to tranches 204 that is performed by users of the system (e.g., asset-based tranche assignments, time-based tranche assignments, and/or product-based tranche assignments may each have distinct criteria for tranche creation and/or tranche movement).

In certain embodiments, the tranche assignment circuit 306 may provide notifications in response to the tranche movement, and/or may provide a tranche movement recommendation, and wait for the tranche movement until a user approves the recommendation and/or does not respond to the recommendation for a period of time. In certain embodiments, a tranche movement notification may be provided to any user, such as the primary user, an agent, a carrier, an administrator, or the like. In certain embodiments, one or more users may not have any visibility to which tranche 204 a user is positioned with, for example a primary user or client may not know which tranche 204 they are in, and may not even be aware of the existence of the tranche 204 as an organizing concept, and accordingly the tranche assignment circuit 306 may not provide such a user with any notification of the move.

An example tranche assignment circuit 306 adjusts and/or updates statistics 312, analytics, metrics, or the like, for the platform 102 based on the tranche movement. For example, a performance statistic 312 for Tranche A may be updated in response to a user moving from Tranche A to Tranche B, for example with updates to total client count within the tranche 204, assets managed within the tranche 204, enrollment performance statistics within the tranche 204, or the like. In certain embodiments, one or more statistical elements from before the tranche movement may be preserved, for example to track true timeliness information with regard to enrollments for the tranche 204, or the like. In certain embodiments, statistical information related to moved users between tranches 204 may be moved to, and/or added to, the new tranche 204, which may be an alternative to and/or an addition to keeping the information related to the new tranche 204. Operations to keep both data sets available allow for numerous operations to improve the performance of the platform 102, and/or to provide relevant statistics 312 to interested users of the platform. For example, statistics 312 related to moved users may allow for determination of effects on enrollment from user movement between tranches 204 (e.g., which may allow the system to determine whether tranche movement affects the outcomes of the enrollment, whether other attributes of moved users appear to have a correlation with the tranche movement which may help improve initial enrollment timeline estimate determination, etc.), allow for appropriate statistical determinations for relevant users (e.g., true time lag between enrollment initiation and completion, revenue projections, or the like), and/or may be utilized as a second order indicator of other potential improvements in the platform operations (e.g., determining whether particular agents, carriers, underwriters, etc. are causing enrollment delays, have sensitivity to certain client or plan attributes resulting in delays, and/or whether tranche movement has unexpected consequences such as reduced plan performance, etc.).

An example tranche assignment circuit 306 determines that a tranche movement is imminent (e.g., within a threshold distance of a tranche movement indicator), and may provide notifications (e.g., to an agent, a user having an action item due for the particular client, etc.) and/or other responses (e.g., escalated notifications, notifications to other parties such as a supervising party, and/or updated notifications to a different location such as a text or e-mail, and/or changes to the enrollment workflow such as performing some operations in parallel, showing adjusted statistics if the user is moved to an interested party, etc.), which may allow other users to escalate, determine if the tranche movement is detrimental to the client or another user of the platform, or the like.

Notifications, as utilized herein, should be understood broadly. In certain embodiments, a notification includes a direct contact or communication with a user, such as using an e-mail, text, message on a messaging application, phone notification, or the like. In certain embodiments, a notification includes an indirect contact or communication, such as a highlighted notification on a dashboard of a user interface of the platform 102, a message in a messages portion of a user interface of the platform 102, and/or provision of a message directly to an inbox (e.g., directly to a voice mail for a user, rather than making a potentially more intrusive call to the user). Notifications may be configured and provided to any user of the platform 102, including primary users (e.g., clients), agents, carriers, underwriters, IMOs, administrators, or the like. In certain embodiments, a notification may be provided to a selected contact location, for example selected by the user, a supervisor, and/or an administrator related to the user. In certain embodiments, notifications may be provided directly to a supervisor, platform manager, or other entity related to the user. In certain embodiments, a notification may be indirect, such as an update to a user of a statistic, analysis, and/or illustration, where the content of the notification is reflected in the update but not necessarily provided as a direct aspect of the communication that is readily divisible from the remainder of the communication.

An example platform analysis circuit 308 updates analytics 312 on the tranche 204 in response to the tranche movement, and/or in response to an imminent tranche movement. For example, enrollment statistics 312 for the tranche 204 (e.g., timeliness, enrollment stage(s) descriptions, revenue related to the tranche, etc.) may be updated and communicated to the relevant users, and/or made available to the relevant users, based on the movement of clients between tranches, and/or based upon tranche movements that are contemplated, recommended, and/or that appear likely to occur.

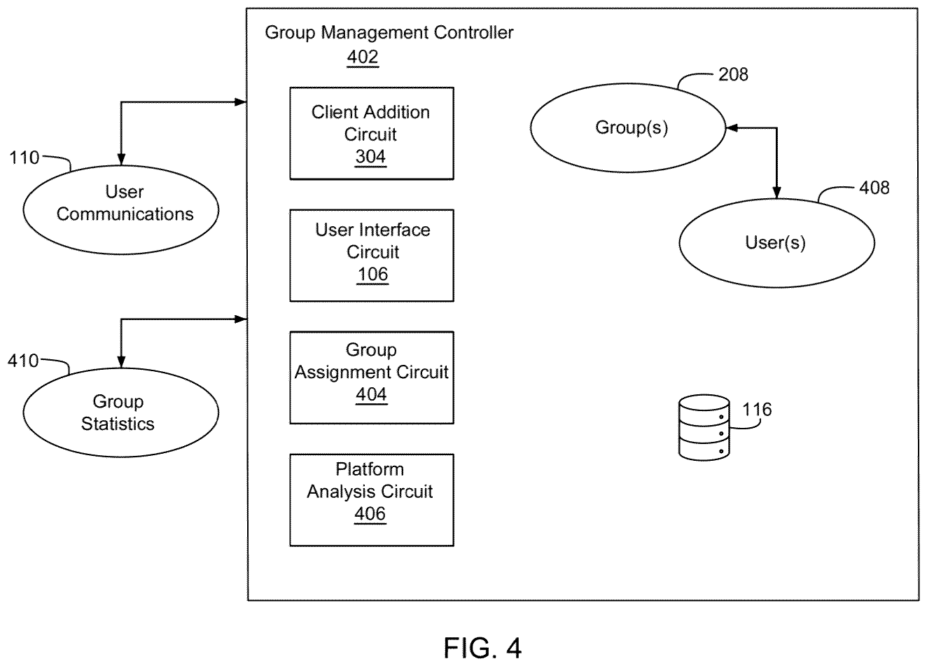

Referencing FIG. 4, an example group management controller 402 is schematically depicted. The example group management controller 402 may be utilized with the platform 102, and/or included as a part of the platform 102. The example controller 402 includes a client addition circuit 304 that receives a group addition request (e.g., as a user communication), which may relate to an existing group 208 or a new group 208 created to include one or more user(s) 408. In certain embodiments, a group 208 may be created without users, for example to set up a group 208, statistical analysis 410 for the group 208, communication and notification criteria for the group 208, etc., as a template group 208 (e.g., for use by the same user, by a group of users, and/or accessible to users across the platform and/or a user class on the platform), and/or as a preliminary group 208 that will be associated with added users to the group 208 at a later time.

The utilization of a group 208 as an organizing concept may be utilized for any reason, for example to manage enrollments of a group of users that are related in some manner (e.g., belonging to a same tranche 204, same organization, utilizing a same agent or agency, utilizing a same carrier, utilizing a same underwriter, related to a same IMO, and/or having a related client attribute and/or a related attribute of any one or more of the foregoing). The client addition circuit 304 is described in relation to putting clients in a group 208 for convenience of the present description, but a group may be organized around clients or any other user type, for example a group of agents, a group of agencies, a group of carriers, etc. In certain embodiments, a group 208 may be related to a platform-specific concept, such as a group of users having authority to change the permissions of other users of the platform 102. The utilization of groups 208 allows for coordinated operations in any dimension, for example for operating an enrollment process for the group, tracking success or performance metrics for the group, providing relevant notifications for the group, providing visibility to the group to certain users of the platform 102, or the like.

The example controller 402 includes a group assignment circuit 404 that adds one or more users to a group 208 in response to the group addition request. The group addition may be automatic for certain situations, for example where a sufficiently authorized user creates the group 208 and/or adds users to the group 208. In certain embodiments, the group addition may be permissions based—for example sending a request for the group creation and/or group addition to another user, where the addition is made in response to acceptance of the group addition request by the another user. In certain embodiments, the group 208 is utilized to control a common aspect of the group 208, for example to control the setting of permissions for the group 208, tracking platform statistics 410 for the group 208, to control interface parameters for the group 208, to control a common workflow for the group 208 (e.g., an enrollment, follow-up, analysis, and/or servicing workflow), and/or to control common parameters for the group 208, such as document storage, retention, interface display, preferences, and/or communication parameters. In certain embodiments, a user may be a part of more than one, or many, groups 208—for example a user may be a part of an agent group 208 and a supervisory group 208. In another example, a user may be a part of a general client group 208, and a part of a group of users having a certain asset or financial product as a part of a plan, having a certain time horizon for a plan, or the like.

In certain embodiments, aspects of the group 208 applicable to the user are applied permissively, for example where the user may have options to adjust menus, interfaces, communications preferences, notification preferences, appearance in statistics related to the group, inclusion as a member of the group, or the like, such that the user can change the normal aspects applied to the group, omit aspects, and/or add aspects. In certain embodiments, aspects of the group 208 applicable to the user are applied without permission, for example where the user does not have visibility to the applied aspects and/or cannot change the applied aspects. In certain embodiments, a group 208 may have aspects that are applied permissively, and other aspects that are applied non-permissively. In certain embodiments, a user setting up the group 208 may select which aspects are permissive and which aspects are non-permissive. In certain embodiments, the permissive nature of aspects of the group 208 may be dependent upon the permissions of the user setting up the group 208, the permissions of users that are members of the group 208, configuration of group creation and/or modification capabilities by an administrator of the platform, settings applied by a user having authority over the user setting up the group 208, or the like. In certain embodiments, some group characteristics may be affected by, or defined by, regulatory requirements (e.g., to manage personally identifiable information of users of the platform, health information of users of the platform, according to local privacy laws, accounting principles such as GAAP requirements, disclosure requirements, etc.), policy requirements (e.g., requirements set by carriers, agencies, IMOs, underwriters, the platform administrator, etc.), or the like.

In certain embodiments, a tranche 204 may be implemented using a group 208, for example implementing a tranche 204 by creating a group 208 representing the members of the tranche. In certain embodiments, the tranche 204 and a group 208 are entirely separate concepts on the platform 102, with the implementation of the tranche 204 being performed separately from the group implementation. In certain embodiments, a tranche 204 and a group 208 may be related concepts, but may not be fully identical—for example where a tranche 204 is created and a related group 208 is created, a user may be moved from one tranche 204 to another tranche 204, where the related group 208 may be updated with the change in the tranches, or the related group 208 may remain unchanged (e.g., to facilitate separate statistics from the tranche 204, for example as set forth in relation to FIG. 2 and the related description). Without limitation to any other aspect of the present disclosure, any aspect described in relation to a tranche 204, for example including permissions management, addition or removal of members, common enrollment tracking, common communication and/or notification control, determinations to move users between groups, and/or notifications in response to user movement and/or imminent user movement, are separately applicable, mutatis mutandis, to groups as set forth herein.

With further reference to FIG. 4, an example group management controller 402 is configured to implement a group enrollment. Implementation of a group enrollment may be performed for any reason, including at least: enrolling a related group 208 (e.g., employees of a specific company) in a coordinated enrollment operation; enrolling a group of users having some shared attribute in a coordinated enrollment operation (e.g., a group of users having a similar target date, similar wealth plan (e.g., annuity, insurance, investment, loan or financial instrument, and/or risk profile), similar demographic characteristic, a common agent, a common carrier, etc.), or a combination of one or more of these. The group enrollment provides numerous benefits, such as: convenience tracking and execution of the enrollment process; convenient tracking of enrollment compliance (e.g., for an HR representative tracking a group of employees); determination of statistics for the group to ensure protection of clients, to enhance machine learning, AI, and/or iterative improvement operations (e.g., by providing an outcome corpus for training, relevant statistical base, or the like); and/or convenient management of the platform 102 to provide coordinated notifications or other features for a group of clients that are in the workflow at a similar time (and, accordingly, are operating in a similar macro-economic environment, similar regulatory environment, and/or that have a coordinated understanding and likely utilization of technology mix such as messaging formats, platform application versions, payment applications, etc.). Accordingly, it can be seen that the utilization of a group enrollment process provides benefits to multiple users of the platform, including at least clients, agents, agencies, carriers, underwriters, banks, IMOs, and/or platform administrators.

The operations of the group management controller 402 for the group enrollment may utilize any aspects of group management as set forth throughout the present disclosure, with a few aspects described following for clarity of the description. An example controller 402 allows for common notifications, timing of communications and/or availability of documentation, and common interface provisions for members of the group enrollment. These common aspects may be controlled, permissively or non-permissively, by a user creator of the group 208, and may be subject to permissions of that user, regulatory requirements, policy requirements, adjustments by other users (e.g., supervisors or administrators), or the like. In certain embodiments, users of group enrollment may be moved between groups 208 according to any description herein related to movement between groups 208 and/or between tranches 204. The user members of the group enrollment may be included in a tranche together, and/or may be separated between one or more tranches, including being included within one or more tranches having users that are not a part of the group enrollment user member group. In certain embodiments, statistics related to the user members of the group 204 may be tracked separately, in addition to or as an alternative to other statistical descriptions related to the user members (e.g., a specific user may contribute to statistics for the group enrollment group, for another group that the user is a member of such as “users retiring between 2040-2044, and further for a tranche 204 that the user member is positioned within). In certain embodiments, the inclusion of a user member in the group enrollment group may be optional (e.g., the user can opt out of the group 208, but remain on the platform) or non-optional (e.g., the user cannot opt out of the group 208, and/or cannot opt out of the group 208 while remaining on the platform—at least for that particular enrollment instance, although the user may potentially utilize the platform separately, such as through an agent, an invitation, or the like).

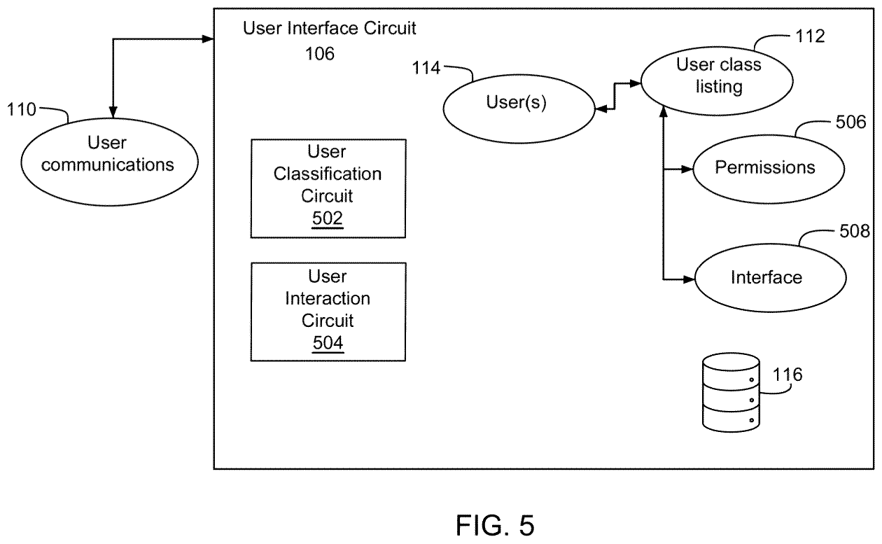

Referencing FIG. 5, an example user interface circuit 106 is schematically depicted. The example user interface circuit 106 may be utilized with, in whole or part, a platform 102 such as depicted in FIG. 1, and/or with any other systems, components, controllers, or the like as set forth in the present disclosure. In certain embodiments, the user interface circuit 106, in whole or part, may interact with, be provided in communication with, and/or be included in a system with, any other systems, components, controllers, or the like as set forth in the present disclosure. The example user interface circuit 106 includes a user classification circuit 502 that determines a user class for an accessing user 114 of the platform 102. The accessing user 114 may be a user presently accessing the platform 102, for example through a web portal, a mobile application, and/or a proprietary application on a computing device, and/or the accessing user may be a prospective user, such as the user classification circuit 502 determining a user class for a client user 114 that has been invited to the platform 102, where the determined user class may be stored in a profile, account, or other relational data for the prospective user, to be utilized at a later time when the prospective user actively accesses the platform 102.

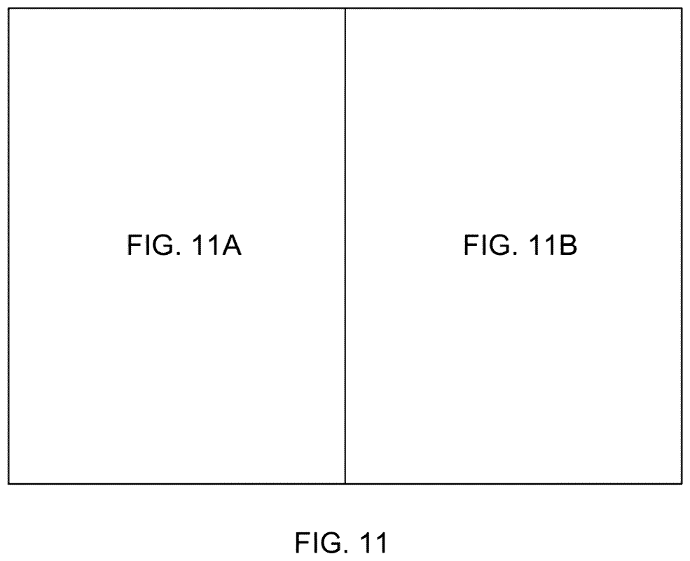

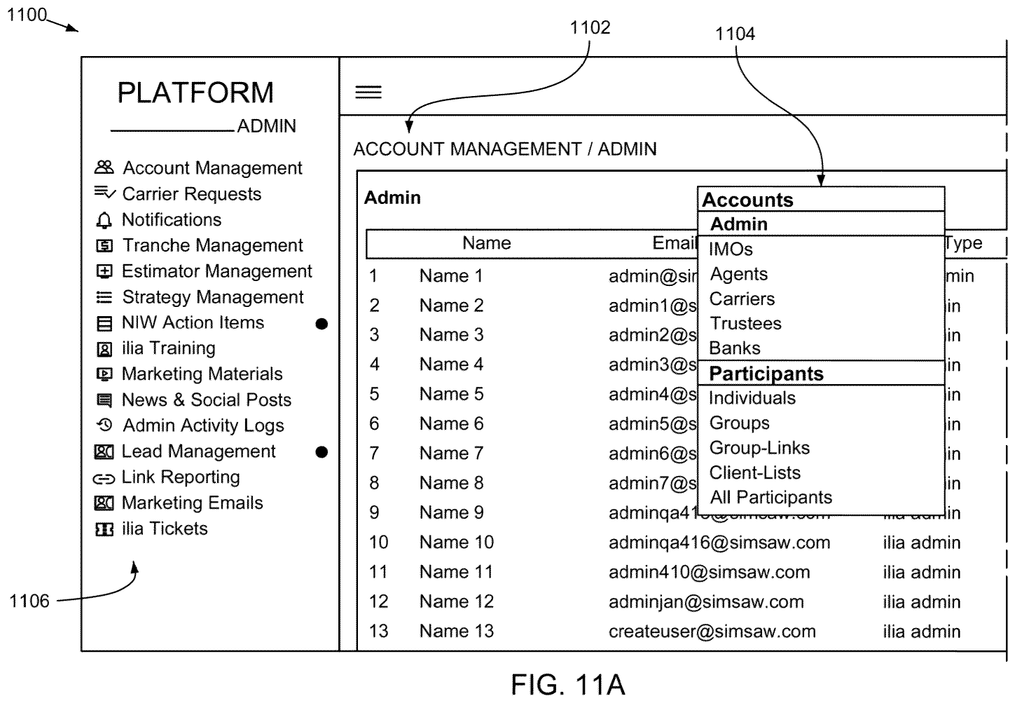

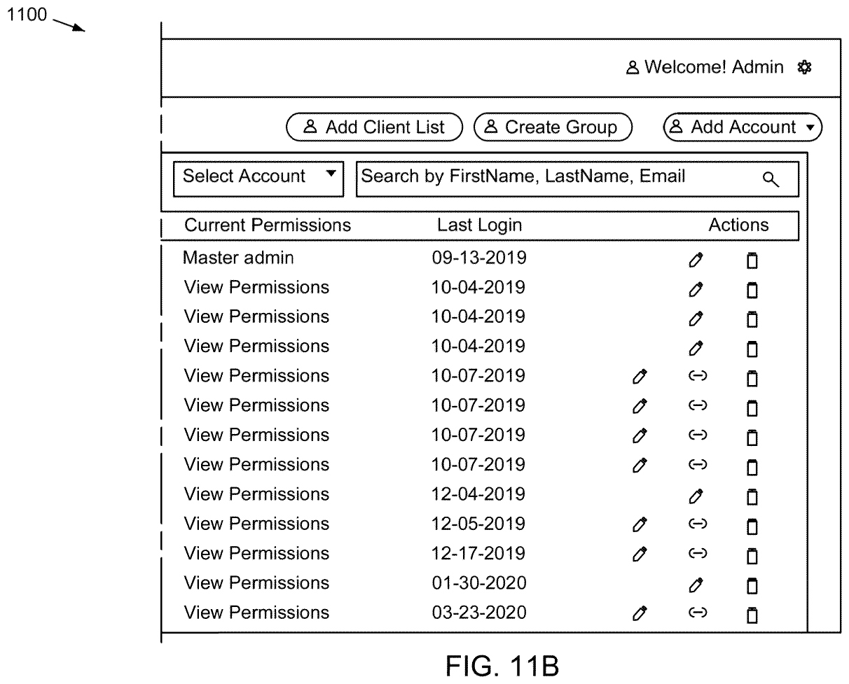

The example user interface circuit 106 further includes a user interaction circuit 504 that implements a selected user interface based on the user class. The example user interaction circuit 504 may additionally adjust the user interface for the user based on user preferences, or any other adjustments as set forth throughout the present disclosure. Adjustments to the user interface may result in a user interface for the user class that has been adjusted in some manner, or an adjustment to the user interface for a user class may result in a separate user class (e.g., a sub-class) that uses the adjusted user interface. The terminology of the user interface and user class adjustments is not limiting, and will depend to an extent upon selections of terminology, the organization of stored user class and user interface data, or the like. An example user interaction circuit 504 may implement a configured user interface based on the user class by any method, including at least: utilizing the user interface associated with the user class, and optionally modified by the user or any other authorized user on the platform; utilizing the user interface associated with the user class, where the user class utilizes a modified user interface relative to a broader user class (e.g., a client class may be the broader class, and a “client retiring after 2030” class may be the specific user class, based on modifications to the client class), and optionally modified by the user or any other authorized user on the platform 102; utilizing a user interface associated with more than one user class associated with the user, for example with a hierarchy between the classes (e.g., a client class and a “client having an annuity” class, with arbitration between the classes where interface elements have a conflict on some interface elements); combinations of any of these; and/or any of these combined with one or more default user interface elements (e.g., a user class interface definition may adjust certain elements of the default user interface, whether the user class interface definition defines all elements of the interface, or just a portion of the interface elements). Example and non-limiting user interface elements include one or more of: organization of selection tabs, navigation buttons, menus, and the like on the page; organization of pages—e.g., a home page, a main portal page, analysis page(s), illustration page(s), training page(s), etc.); font selections; language selections; activity buttons (e.g., actions to add clients, create groups, create or edit scenarios, check status of enrollments, check items due and/or update actions on items due, etc.); management features (e.g., adjust permissions for the user and/or other users; change contact information for the user or other users; add users of certain types, such as agents, agencies, carriers, underwriters, banks, IMOs, administrators, clients, etc., to the platform; access stored information such as historical performance, documentation, group lists, client lists, agent lists, etc.; and/or linking elements to drill down on information displayed (e.g., interacting with a displayed number or value to check the source, interacting with a graph to see the underlying data and/or to adjust viewing elements such as labels, scales, plot types, etc.). In certain embodiments, any type of user interaction may be present and/or accessible, for example access to training materials, news articles, relevant social media posts, marketing materials, communications, messages, help resources, group management, workflow management, or the like. The described examples are non-limiting, and the available user interface elements in a particular embodiment will depend upon the user class and/or user role, and/or the purpose of the platform. Any element related to a process workflow associated with the platform 102, data stored on the platform 102, external data accessible to the platform 102, and/or users on the platform may be included in a user interface. Without limitation to any other aspect of the present disclosure, example user interfaces are depicted in FIGS. 11-73B, 75-78B, and 83-88B, to illustrate certain aspects of the present disclosure. In certain embodiments, user interface elements include any one or more of: screens, menus, links, and/or varying content of these according to the user class, preferences, permissions, and/or as adjusted by another user having sufficient permissions; analytics available on the platform; functions available for the platform; reports available on the platform; notifications; documents and/or document tracking; enrollment stage tracking; and/or pending activity or next activity tracking.

In certain embodiments, the user interface circuit 106 implements the user interface 508 in response to permissions associated with the user class for the user, and/or in response to permissions associated with the specific user. In certain embodiments, permissions 506 may prevent or allow features to be viewed, to be accessed (e.g., the user may see that a feature exists but cannot access the feature), and/or requested (e.g., an unavailable feature may be displayed, where the user can request access to the feature, which may be permitted or denied, such as by another user, by a subscription, for a limited time period, etc.). In certain embodiments, the permissions level of another user may affect the permissions and user interface of the first user—for example where a first agent has authority to turn on certain features and/or interface elements for clients, and a second agent does not have authority to turn on those features and/or interface elements for clients.

In certain embodiments, the user interface circuit 106 implements the user interface 508 in response to a request from the user that applies a selected user class to the interface 508. For example, an agent user may be able to select a client user class to test or view a user interface 508 on the platform as a client user would see the interface—for example to allow for improvements to the user interface, to help the agent assist the client, and/or to monitor the experience on the platform for the client. In certain embodiments, the selectable interfaces for a particular user are adjusted according to the permissions of the user—for example an administrator for the platform may be able to select any user interface available on the platform for troubleshooting, debugging, and/or help purposes.

In certain embodiments, a user interface 508 may exist separately from the user class, for example a training interface, a marketing interface, or the like. In certain embodiments, the separate interface may be further adjusted for the particular user, for example where a marketing interface includes product information, process workflow information, or the like, that is modified according to the user class, user location, indicated user preferences, or the like. In certain embodiments, one or more of the separate interfaces may be unavailable to some users (e.g., an agent training interface may not be available to clients). In certain embodiments, some interfaces may be provided based on the circumstances (e.g., the user interfaces for a client may be changed after enrollment is completed), according to certain time frames (e.g., certain interfaces may be displayed or available at selected times, such as five (5) years after enrollment, ten (10) years before retirement, a selected interface for certain life events such as a marriage, divorce, birth, or death related to the user, etc.). The example user interfaces 508 based on the user class, separate user interfaces, and various adjustments to the user interfaces are non-limiting example to illustrate certain features of the present disclosure. In certain embodiments, a separate interface may be associated with a user class, for example where the user class changes over the course of the workflow on the platform (e.g., where a client user class may include “initial client user class,” “enrolled client user class,” “long-term client user class,” “client in tranche 6 user class,” etc.), and/or for an embodiment where more than one user class can be associated with a user (e.g., a user may have a “client user class” tag and also have a “near retirement user class” tag). Where more than one user class can be associated with a particular user, the classes associated with the user may change according to the status of the process workflow associated with the user, according to events related to the user, according to adjustments made by another user having sufficient permissions, or the like.

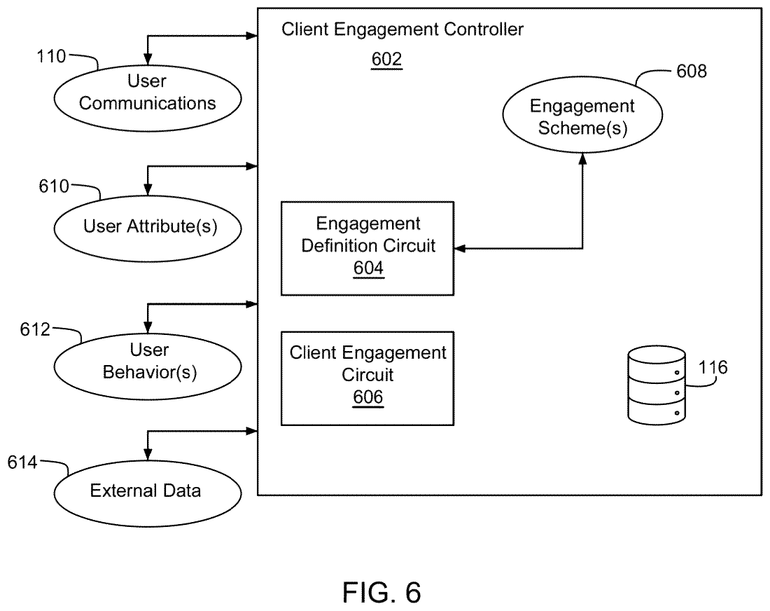

Referencing FIG. 6, an example client engagement controller 602 is schematically depicted. The example client engagement controller 602 may be utilized with, in whole or part, a platform 102 such as depicted in FIG. 1, and/or with any other systems, components, controllers, or the like as set forth in the present disclosure. In certain embodiments, the client engagement controller 602, in whole or part, may interact with, be provided in communication with, and/or be included in a system with, any other systems, components, controllers, or the like as set forth in the present disclosure.

The example client engagement controller 602 includes an engagement definition circuit 604 that identifies a user and/or a user attribute 610, where information about the identified user is utilized to configure operations of a client engagement, for example using a selected engagement scheme 608 and/or an adjusted engagement scheme 608. The example controller 602 further includes a client engagement circuit 606 that interprets an engagement scheme 608 based on the identified user and/or user attribute 610. For example, the user identification and/or attribute may include a user class, user profession, user demographic value, or any other parameter that may be related to the relevant workflow for the platform 102 to usefully configure the engagement of the user interface with the user. In certain embodiments, the user class, profession, age, time of day that the user typically interacts with the platform, materials that the user may have already accessed (e.g., which can be determined based on user prior history, the inviting agent or agency for the user, etc.), the user's goals (e.g., important dates such as retirement date, investment horizon, etc.), the user's risk profile or category, or the like may be utilized to improve information presented on the user interface to be relevant to the user, to utilize metrics (e.g., rate of return, fees, investment types, etc.) that are relevant and/or important to the user, or the like. In certain embodiments, the engagement scheme 608 is utilized to configure marketing materials, demonstration materials, initial presentation materials, training materials, examples used in illustrations, or the like, which can increase the utility of the platform 102 for the user (e.g., increase confidence that the user's goals are understood and/or will be achieved), increase the completion rate for enrollments, increase the retention of the user, and make various communications between the user and other users (e.g., an agent, carrier, underwriter, medical examiner, etc.) more efficient. In certain embodiments, a workflow related to the platform 102, such as an enrollment workflow, may be adjusted based on the engagement scheme—for example eliminating unnecessary steps, adjusting communication types to the user, configuring menus and/or document locations for ease of access and/or understanding by the user, or the like. In certain embodiments, workflow steps may be re-ordered, combined, and/or divided based on the engagement scheme 608—for example options to offer automatic linking to external sites for documentation may be omitted for a user that is likely to utilize paper copies for that documentation (e.g., saving unnecessary navigation of those steps, and/or reducing confusion for the user), certain underwriting activities may be eliminated and/or pre-scheduled, and/or certain product offerings may be added or removed from the user interface based upon the engagement scheme. In certain embodiments, marketing examples may utilize different terminology based on the engagement scheme 608 (e.g., adjusting terminology to add or remove jargon or specific terms, improving communication efficiency and understanding), use relevant examples for the user (e.g., dollar values, time frames, geographic locations, etc. that are likely to be familiar to the user), and/or configure materials according to the user location (e.g., putting in specific disclaimers, required disclosure or notifications, etc., based on the relevant regulatory environment for the user, rather than having to put in a generalized version of these that tries to cover all users).

In certain embodiments, the engagement scheme 608 may be one of a selected number of engagement schemes, for example with pre-built templates that are selected based upon specific user attributes 610 (e.g., an attorney template utilized for clients that have an attorney profession, selecting a template based on whether the client has children and/or based on the number and age of the children, selecting a template based upon indicated preferences, goals, or risk tolerance of the client, etc.). The example of FIG. 6 is described in the context of a client user to present a concrete illustration, but an engagement scheme 608 may be utilized with any user or user type, for example an agent user, carrier user, underwriter user, etc. In certain embodiments, without limitation to any other aspect of the present disclosure, engagement schemes 608 may be utilized to improve operations and/or communications for any one or more of the following: marketing materials; initial presentation materials; training materials; enrollment implementation (e.g., presentation of enrollment operations on the user interface, communication operations, and/or workflow operations); analysis implementations (e.g., data or statistics on the platform relevant to the user, depiction of example performance, depiction of actual performance, depiction of estimated future performance, depiction of sensitivity parameters, selection of models and/or modeling parameters, etc.).

In certain embodiments, the client engagement circuit 606 selects and/or adjusts an engagement scheme 608 based upon known or estimated attributes 610 of the target user, and may further select or adjust the engagement scheme 608 based upon other information that is known or becomes known about the user through available public information (e.g., a social media profile of the user, a news article referencing the user, etc.), through interactions of the user with the platform (e.g., configuring illustrations based on user interactions with the platform, adjusting training materials based on user interactions with the platform, adjusting illustration materials based on user interactions with an initial presentation, marketing materials, and/or interactions with a help section or FAQ, etc.).

In certain embodiments, the engagement schemes 608 available, adjustments to the engagement scheme(s) 608, the selection of the engagement scheme(s) 608, and/or the relationship of these to various inputs such as client attributes 610, external data 614 such as news information and/or publicly available information, and/or interactions of the client with the platform 102, may be iteratively improved over time through the operations of a machine learning, AI, and/or other iterative improvement component, improving the overall performance of the platform 102 over time to ensure that various users get the information most helpful to them, and presented in a way that ensures that users have higher confidence that the platform 102 is serving their needs, while reducing overhead for users having to search for information, have repeated communications, ask questions that may not be necessary, and the like. In certain embodiments, an engagement scheme 608 may encompass any aspect of the platform 102 that is accessible to the user and as set forth throughout the present disclosure, for example and without limitation including at least: menu selections available and the arrangement thereof; the presence, content, and/or arrangement of interface tabs; font and/or other formatting selections; communication types, content, frequency, timing, or the like; pre-configured information for fields or selections, including the configuration of default values (e.g., time frames for illustrations, revenue goals, investment goals, model assumptions, etc.); training materials available, the content of these, and/or the arrangement of these; marketing materials available, the content of these, and/or the arrangement of these; and/or enrollment or other process parameters, including the arrangement, number, ordering, and/or distribution of process steps.

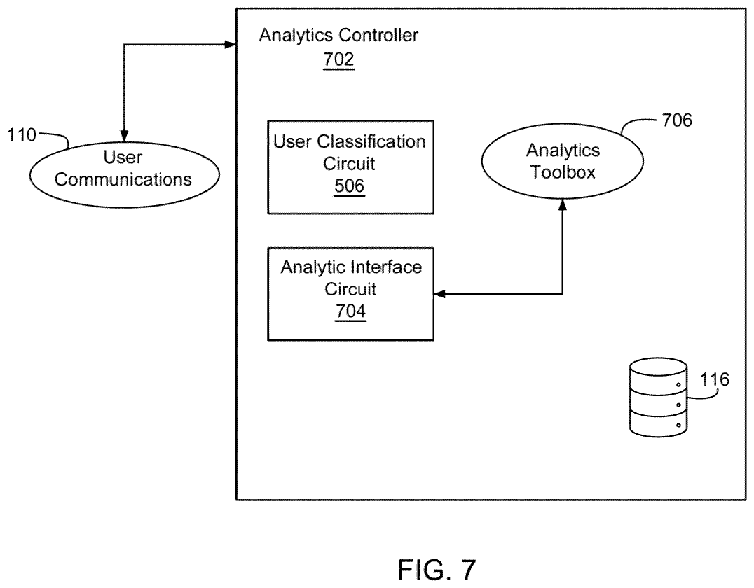

Referencing FIG. 7, an example analytics controller 702 is schematically depicted. The example analytics controller 702 may be utilized with, in whole or part, a platform such as depicted in FIG. 1, and/or with any other systems, components, controllers, or the like as set forth in the present disclosure. In certain embodiments, the analytics controller 702, in whole or part, may interact with, be provided in communication with, and/or be included in a system with, any other systems, components, controllers, or the like as set forth in the present disclosure.

The example analytics controller 702 includes a user classification circuit 506 configured to identify a user, for example according to the user class, an attribute of the user, and/or according to a specific identity of the user. In certain embodiments, the identification of the user class is sufficient, for example an agent user, carrier user, underwriter user, or the like. In certain embodiments, one or more aspects of the analytics controller 702 utilize more specific information about the user, for example a fiscal year or quarter associated with the user, specific goals or desired information for the user, or the like. In certain embodiments, one or more aspects of the analytics controller 702 utilize attributes of the user such as a user title, user role, indicated preferences by the user, or the like, as a part of the identity of the user.

The example analytics controller 702 includes an analytics interface circuit 704 that interprets an analytics toolbox 706 for the user, for example including modeled parameters, reports, data visualizations, tables, or the like, for the user, based on the identified user and/or attributes within the user identity. In certain embodiments, the analytics interface circuit may be a part of a user interface circuit 106, and/or may interact with the user interface circuit 106. An example operation of the analytics interface circuit 704 implements a user interface in response to the user identity and the analytics toolbox 706, for example providing menus, analytics tabs, or the like, with analytical tools from the analytics toolbox 706. Additionally or alternatively, the analytics interface circuit 704 may arrange, re-order, and/or pre-configure the analytics tools on the interface, for example listing tools in an order of priority for the user, in an order in which the analytics are likely to be accessed by the user, and/or hiding or moving unnecessary tools to an unobtrusive location. In certain embodiments, the analytics interface circuit 704 adjusts the tools, for example linking tools that are likely to be utilized, for example providing a bucketed graph of performance by quarter for a report, and linking the data details so the user can select one of the buckets and pull up a report of the underlying data. In certain embodiments, the analytics interface circuit 704 adjusts display elements, for example using smaller or larger buckets (or bars), adjusting colors, adjusting display units (e.g., selection of displayed currency values), adjusting interface elements (e.g., providing buttons for data links, and/or removing buttons and providing hyperlinks on text values, etc.).

The operations of the analytics interface circuit 704 may be performed based on pre-determined operations for a particular user attribute (e.g., defined by an administrator, a subject matter expert, or the like), based upon previous behavior of the user (e.g., previous interactions with analytics tools, reports, etc.), based upon indicated preferences from the user, and/or based upon iterative improvement operations of a machine learning and/or AI component using a corpus of data from the user and/or other users having the same or similar attributes in some dimension.

Example and non-limiting analytics tools include one or more of: reporting tools (e.g., summary information, tabulated information, etc.); a census report (e.g., agent counts, client counts, carrier counts, etc.); a value report (e.g., for a client, agent, group, tranche, etc.); a growth report (e.g., growth of value, number of enrollments, number of clients, etc.); progression statistics (e.g., time-at-stage for each step of an enrollment process, performance progression over time such as conformance to plan of growth, enrollment, or the like); completion statistics (e.g., time and/or closure rate for various steps of a process, and/or for completion of the enrollment process); forecasting tools (e.g., estimated or projected versions of any one or more of the foregoing, and/or including historical matching of prior forecasting to actual results); and/or comparisons of any one or more of the foregoing to a prior implemented plan. In certain embodiments, any one or more of the foregoing may be filtered, sorted, aggregated, summarized, averaged, correlated, or the like, against any criteria available within the purview and/or permissions of the user, for example based on client attributes, agent attributes, carrier attributes, or the like, and/or based upon any other criteria such as time-of-day for activity, completion time for a particular step, presentation, availability, and/or actual access to certain materials (e.g., marketing materials, training materials, etc.) by a client and/or agent. The examples are non-limiting illustrations of certain capabilities of the example analytics interface circuit 704.

An example analytics tool includes an anomaly detection tool, for example determining whether specific steps of a workflow (e.g., an enrollment workflow) exhibit unusual delays, and/or whether specific users are associated with delays or other off-nominal events. Determination of anomalies may be based upon expected thresholds (e.g., a number of days, a number of users, etc.), deviations from an average value (e.g., a threshold amount above or below the average, and/or a statistical distance from the average), according to frequency component analysis (e.g., detecting anomalies that occur with a regularity that is not apparent from the base data, but shows a strong amplitude at certain frequencies that is apparent, for example, from a Fourier analysis of the data), and/or based on outlier data (e.g., evaluating a highest or lowest performing data point, or similar data points, under the assumption that they are not “normal” events). In certain embodiments, for example using a machine learning or AI component, anomaly detection may be performed against any parameter available to the platform, including for example external data 614 (e.g., a weather event, periodic event outside the platform such as an election cycle, trending of certain topics on social media, etc.), allowing for configuration of the platform, marketing materials, training materials, or the like to detect and respond to anomaly causing events that may not be readily apparent to a user of the platform 102. Example users identified by, and assisted by, the analytics controller 702 may include any user of the platform 102, with analytics made available to the user that area appropriate for the user, and within the scope of permissions available to the user. Example users include a client user, an agent user, a carrier user, an underwriter user, a trustee user, a bank user, an IMO user, and/or an administrator user. For example, a client user may be able to access analytics tools related to their account, portfolio, and situation. An agent user may be able to access analytics tools related to their clients and/or some analytics associated with a related entity such as a carrier that the agent is authorized to work with. In certain embodiments, some users may be able to access any analytical tools, for example an administrator of the platform, although in certain embodiments, some information may be hidden from even such users, for example related to PII, medical information, and/or according to data privacy regulations.

In certain embodiments, the analytics interface circuit 704 provides an action link in response to a detected anomaly, and/or related to any analytics value that is known, indicated, or determined to be important. For example, a bucketed response time data visualization may automatically highlight a link to the underlying data for the bucket having the anomalous value. In certain embodiments, the action link may include further information about the anomalous and/or important data that is not as readily available for other data—for example an agent having an anomalously high delay time for enrollments may be highlighted on a report, with other information such as the schedule of the agent, client attribute data about the agent relative to client attribute data averages for a group of agents, information about the agent such as a note that the agent had a vacation scheduled during the anomalous period, or the like.

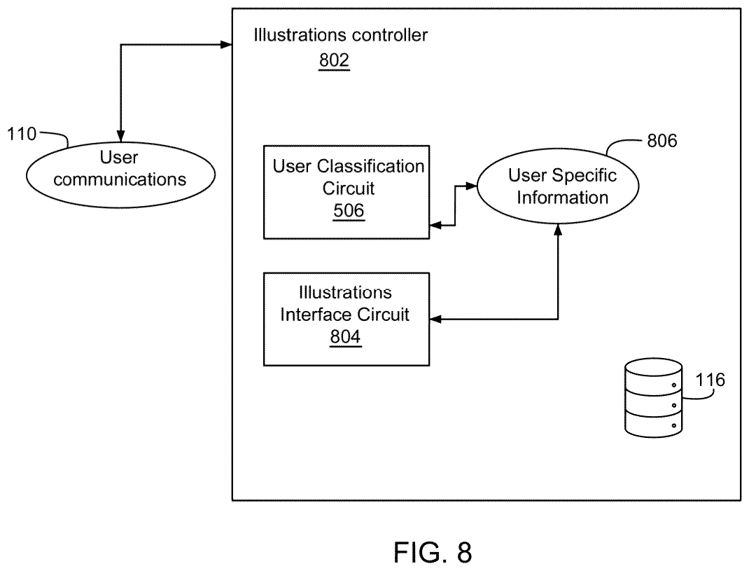

Referencing FIG. 8, an example illustrations controller 802 is schematically depicted. The example illustrations controller 802 may be utilized with, in whole or part, a platform 102 such as depicted in FIG. 1, and/or with any other systems, components, controllers, or the like as set forth in the present disclosure. In certain embodiments, the illustrations controller 802, in whole or part, may interact with, be provided in communication with, and/or be included in a system with, any other systems, components, controllers, or the like as set forth in the present disclosure.

The example illustrations controller 802 includes a user classification circuit 506 that identifies the user, including for example the user class, user role, or other user attribute relevant to the operations of the illustrations controller 802. In certain embodiments, the user classification circuit 506 identifies the user specifically, for example to access user preferences or other attributes relevant to the illustration operations herein. In certain embodiments, the user classification circuit 506 accesses user specific information, such as asset holdings, product holdings, past performance, enrollment status, or the like.

The example illustrations controller 802 includes an illustrations interface circuit 804 that implements a user interface in response to the user identification and/or user specific information, and provides an illustration for the user to the user interface. In certain embodiments, the illustrations interface circuit 804 may be a part of a user interface circuit 106, and/or may interact with the user interface circuit 106. An illustration, as utilized herein, provides for a performance prediction of a plan over a period of time, and/or at a specified time (e.g., a future date), including one or more of: values of holdings, cash value parameters, cost and/or premium parameters, or the like. In certain embodiments, the illustration includes certain assumptions (e.g., rates of return, inflation, performance of certain products, currency exchange rates, tax rates and/or tax effects on aspects of the plan, etc.) and/or modeling values, which may be shown to the user or hidden from the user. In certain embodiments, some assumptions and/or modeling values may be visible to other users (e.g., an agent or an underwriter), but may not be visible to other users (e.g., a client), and/or may be selectively available, for example upon request, interaction with the illustration user interface, or the like. In certain embodiments, one or more assumptions and/or modeling values may be adjustable by one or more users (e.g., the client user, an underwriter, etc.), while other assumptions and/or modeling values may be unavailable, and/or only available to users having relevant permissions.

In certain embodiments, the illustration may include stress testing aspects, for example determined based upon a range of values of modeling parameters and/or assumptions, and/or based upon limit values of modeling parameters and/or assumptions (e.g., providing parameters that overall provide a low or unfavorable outcome within a statistically relevant range). In certain embodiments, the illustration may include sensitivity aspects, for example testing individual parameters and/or combinations of parameters to determine how sensitive the outcomes of the plan are to variations in those parameters or groups of parameters are likely to be. In certain embodiments, stress testing may be based on certain continuous parameters (e.g., inflation rates, tax rates, rates of return, etc.) and/or discontinuous parameters (e.g., step changes in tax law, bankruptcy events of relevant entities, weather or disruption events that may change holdings and/or property values relevant to the plan, social events that may change aspects of the plan or model, etc.). In certain embodiments, the stress testing and/or sensitivity may be performed in a Monte Carlo type of analysis, for example varying a set of parameters according to a statistical distribution, but may additionally or alternatively the stress testing and/or sensitivity determination may be performed using other techniques, for example testing selected cases at selected statistical distances from the average or expected values. Additionally or alternatively, stress testing and/or sensitivity testing may be performed for selected parameters at selected values to test specific potential negative scenarios. The described techniques are for illustration, and any stress testing or sensitivity determination techniques understood in the art are contemplated herein.

The example illustrations controller 802 may additionally or alternatively include a sensitivity description, for example reporting certain parameters within the model or plan as sensitive (or insensitive) parameters, and/or may further include a quantitative description of the sensitivity (e.g., ranges where the parameter substantially affects or does not affect the plan outcome, a quantitative description of the sensitivity value and/or a valid range for the sensitivity, such as a ΔP/ΔO value, where P is the parameter and O is the appropriate outcome, or the like). In certain embodiments, the type and/or resolution of sensitivity information provided may be dependent upon the user, user type, user role, user permissions, or the like. In certain embodiments, the illustrations controller 802 provides a reporting of forecast results for a selected range of selected sensitivity parameters, a description of certain stress parameters that have been tested, the results of the stress testing, and/or a confirmation that a stress test is passed, failed, or a parameter of concern.

An example illustrations controller provides a number of forecast results for the illustration, for example based on a number of parameter values or assumptions, based on an uncertainty range for the forecast, or the like. For example, an illustration may be provided with uncertainty bands, high and/or low likelihood outcomes (e.g., 10/90 outcomes, 25/75 outcomes, etc.), and/or may include one-sided uncertainty only (e.g., a highest or lowest statistically reasonable outcome). In certain embodiments, the illustration may include time sequenced data, for example a monthly forecast, yearly forecast, or the like.

The example illustrations controller 802 is capable to perform automated illustrations based upon the cross-section of information about the client user and other relevant information available on the platform, as described throughout the present disclosure. Accordingly, embodiments herein are capable to provide responsive and high resolution illustrations that require input and consideration from experts in previously known systems. Additionally or alternatively, the process management, notification, and scheduled permissions provided in embodiments of the present disclosure provide a planning ecosystem on the platform where an automated illustration is more likely to be correct, where notifications can be provided to various users if information to complete the illustration is missing, or if illustration results appear to give anomalous indications. Additionally, an illustration can be provided to a user rapidly, and with the key information highlighted, readily available, and/or configured for review by an expert (e.g., using an engagement scheme configured for expert review of illustrations), financial analyst, or the like. Accordingly, automated illustrations can be provided by the illustrations controller in embodiments of the present disclosure, within acceptable commercial risk and process efficiency tolerances, enabling the utilization of automated illustrations that are not available in previously known systems. Further, the embodiments herein allow for a number of illustrations, sensitivity scenarios, and/or stress testing scenarios to be completed rapidly, allowing for greater confidence that reasonable scenarios have been tested. By contrast, previously known systems require significant manual input by experts, greatly increasing the time and cost to prepare illustrations, to stress test plans, and reducing the number of scenarios that can be tested, degrading the confidence that a sufficient number of scenarios have been tested. Accordingly, process outcomes (e.g., a financial plan for the client user) are degraded in previously known systems—for example due to conservative design in the plan (e.g., to account for the limited stress testing that can be performed), and/or with greater acceptance of risk, and accordingly a higher likelihood that the plan goals will not ultimately be achieved. Embodiments of the present disclosure allow for the preparation of hundreds, or even thousands, of illustrations to be performed within just a few minutes, a process that in previously known systems is highly manual, and with communication delays and expert capacity issues typically adds hours, days, or even weeks to each plan for a client user. The delays for illustrations in previously known systems have further negative consequences beyond those stated previously, for example reducing enrollment success rates, reducing the number of client users that can get the benefits of enrolling in and executing a plan, and moving the illustration further back in the planning process. The movement of the illustration further back in the planning process increases the likelihood that negative externalities will result in the selection of a sub-optimal plan for the client user (e.g., a client user may be more likely to implement a marginal plan due to sunk cost into the wealth management process, and an expert, agent, client, or other user in the system is also likely to accept a minimally acceptable plan, rather than adjusting to a more favorable plan, due to the costs and delays involved with updating the illustration).

In certain embodiments, the illustrations interface circuit 804 is configured to include historical performance, combined with previous predictions, in an overlay on the illustration and/or an updated illustration. Accordingly, a client user can determine whether the previous predictions have been achieved, whether deviations of the previous predictions align with sensitivities, stress testing determinations, and/or parameter outcomes versus assumptions. Further, the client user, and/or another user such as an agent user, expert, and/or financial analyst, can readily determine whether adjustments to the plan are warranted, and what adjustments should be made. The information and process ecosystem of the platform additionally makes related communications and decisions more efficient to implement, and ensures that the users involved have correct, high resolution information available for plan forensics and adjustments.

Again referencing FIG. 1, an example enrollment management circuit 108 is configured to interact with the illustrations interface circuit 804 to facilitate rapid enrollment and enhanced illustration generation. For example, the enrollment management circuit 108 may pre-populate enrollment information based on interactions with the client user. In previously known systems, enrollment information, including information utilized for providing an illustration, is collected in a dedicated operation that is performed separately from the initial engagement information. Embodiments of the present disclosure pre-populate information utilized throughout the process based on any available interactions with the client user, and/or further based on external data 614 (e.g., pre-populated as preliminary data). In certain embodiments, the operations are performed as a dedicated pre-population of data, but may additionally or alternatively be utilized as a part of implementing an engagement scheme 608 for the client user. These operations allow for numerous improvements, including a more rapid transition through the enrollment data entry, deeper improvements such as configuration of menus and other aspects of the user interface based upon data that is already available (e.g., providing for greater improvement than just reducing repetitive data entry, and providing further levers for a machine learning and/or AI component to enhance the operations of the platform), and facilitating not only an even more rapid illustration process, but also allow for operation and utilization of an illustration earlier in the enrollment process (and/or ongoing review or servicing process), driving beneficial information into the decision making process even earlier, and further leveraging numerous benefits set forth throughout the present disclosure. Additionally, if the early illustration is utilized for the plan, then the operations to pre-populate information for the enrollment and/or operations to utilize the engagement scheme 608 to improve the client user experience may be utilized right away, providing for even further enhancements of the platform relative to previously known systems.

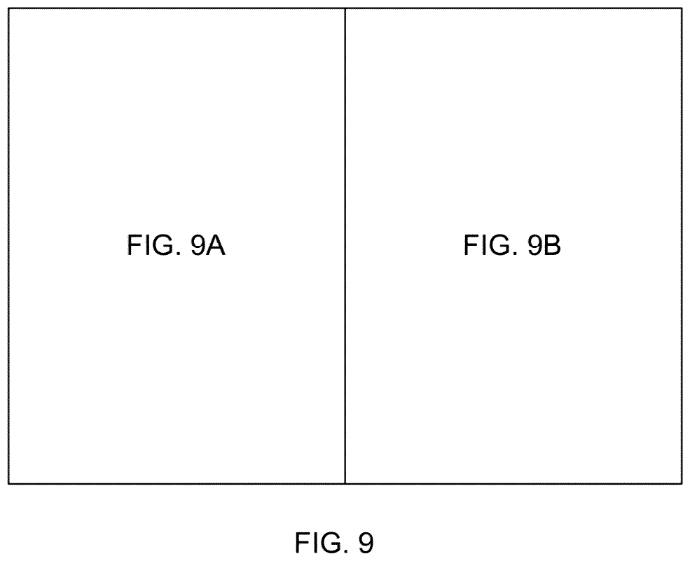

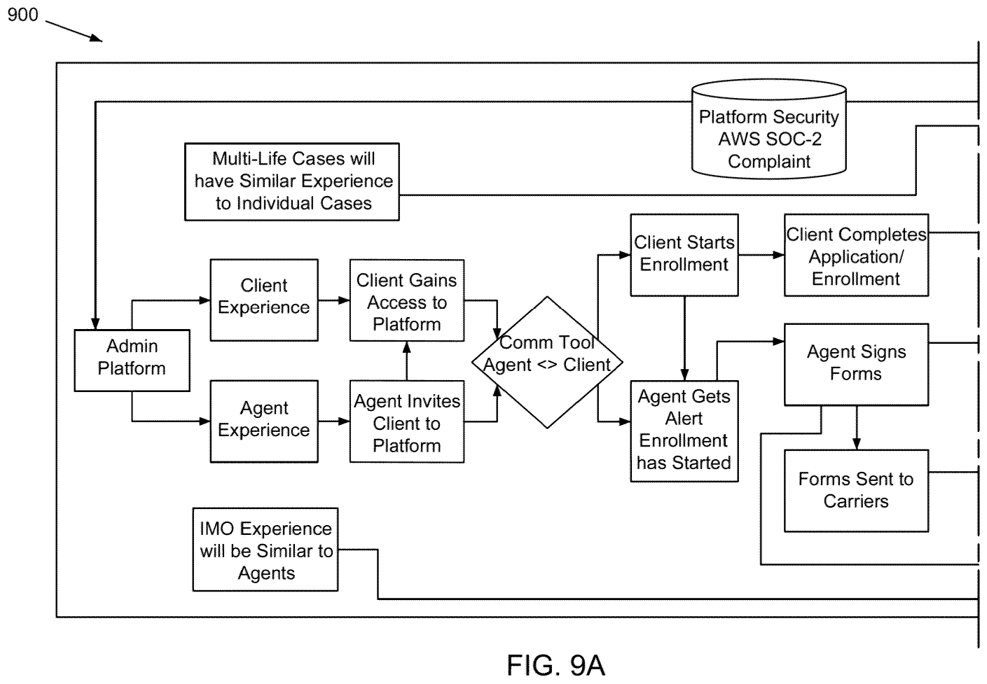

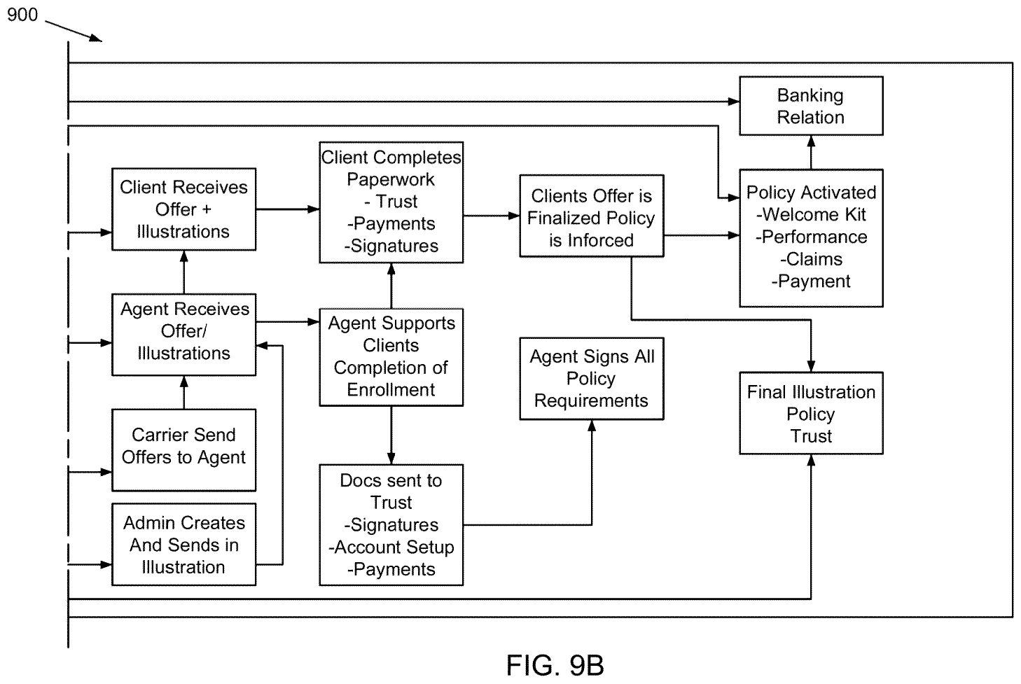

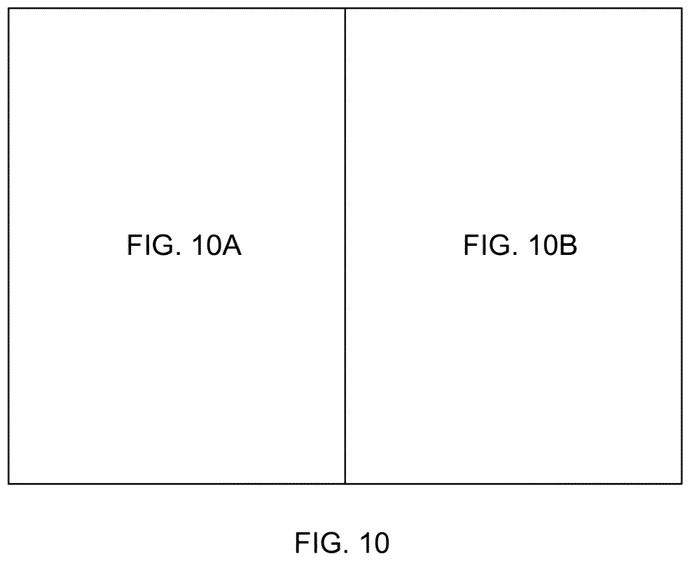

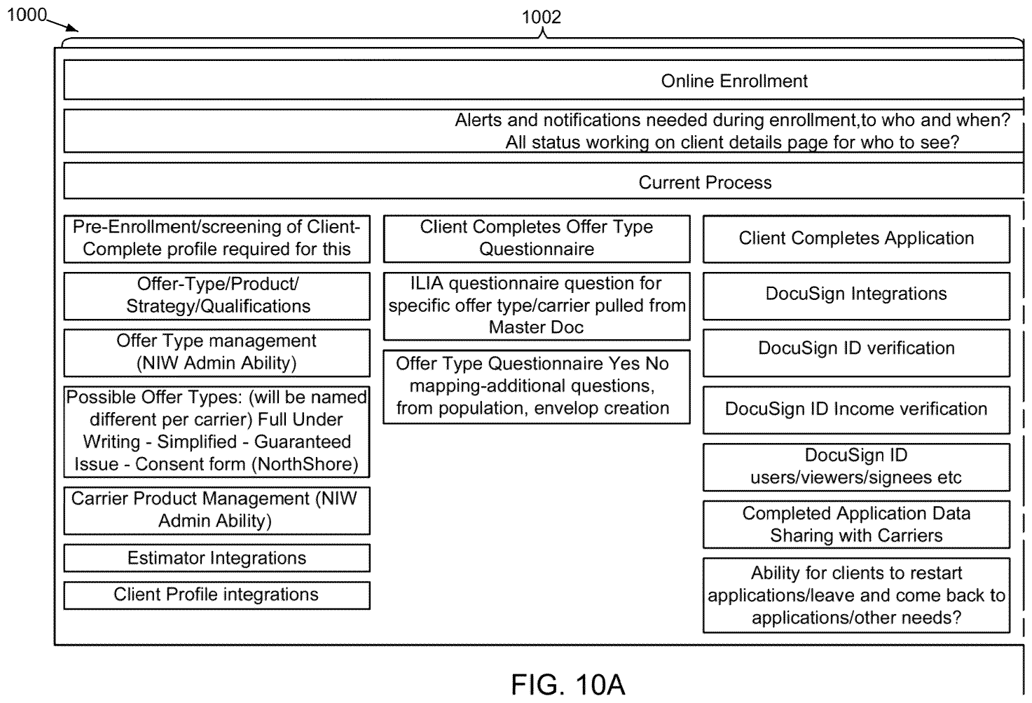

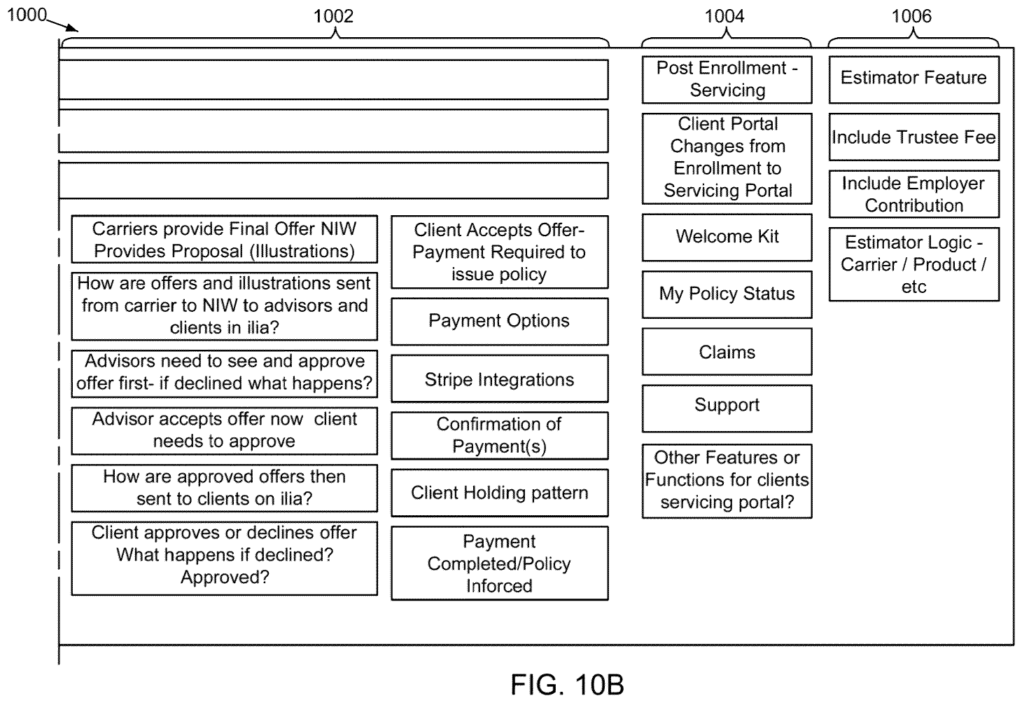

Referencing FIGS. 9-10B, an example process that may be managed on a platform 102 according to the present disclosure is schematically depicted. The example process is an enrollment process for a wealth management product, for example an integrated wealth planning product with investments, life insurance, and other aspects to manage wealth creation, distribution, tax consequences, and the like. As set forth throughout the present disclosure, any type of process may be managed by a platform 102 herein, and particularly a process having a number of streams of a workflow, interactions between multiple entities that may not be well connected, or even related, outside of the platform 102, with a long-term management aspect to the process, and significant documentation, follow-up actions, or the like that may come over a long period of time following the main process, or as a part of the main process. Additionally or alternatively, a process that is applicable to a platform 102 herein may include a process that is subject to changes that may occur unpredictably (e.g., life events such as marriage, divorce, birth of children, change of occupation, etc.), after a significant delay period, changes that require access to documentation that may have been created years before the change, and/or changes where the primary “owner” of the process (e.g., an agent, an attorney affiliated with the primary beneficiary, and/or the primary beneficiary of the process such as a client user) may change over the course of managing the process, and/or may not be available at the relevant time where the process is engaged (e.g., upon the death of a primary beneficiary). The platform 102, and other embodiments and aspects of the present disclosure, creates a process control that facilitates efficient interactions between separate entities, provides ready access to information for each entity to perform their actions relevant to the process, to provide or request information from other entities, and/or to monitor the process for compliance, performance, results tracking, modification, acquisition of documents, updating information or documents, or the like.

Throughout the interface examples of FIGS. 11-73B, 75-78B, and 83-88B, all data depicted is an illustrative example, and the actual data within particular fields is not important to the concepts and capabilities of the example platform that is being depicted. In certain views, some of the data depicted is obfuscated where the actual data values are not needed to understand the example. The specific example sometimes states “ILIA”, which is just an example name for a platform, and may be used interchangeably with “platform” for purposes of the examples. The specific example sometimes states “NIW”, which may be used interchangeable with “platform administrator” for purposes of the examples.

The example of FIG. 9, which is divided into FIGS. 9A and 9B for clarity of the depiction, depicts an example enrollment process 900, for example enrolling a client user on the platform, and completing an enrollment process for a client user to a wealth planning product. The example process of FIG. 9 includes multiple parallel workflows with a number of entities participating, where the platform utilizes the process map, such as in FIG. 9, to coordinate communications, determine status values of the process, determine which interfaces to provide to which users (including the content of those interfaces), provide and store documentation, and the like. The example process of FIG. 9 facilitates completion of a complex process, such as an enrollment process, and has been demonstrated based on simulation and experimental use to cut enrollment times by roughly a factor of ten (10), to enhance successful completion rates of the process (e.g., higher successful enrollment rates), and to improve the user experience in terms of reducing the number of menus and interactions that need to be navigated, the confidence of each user in determining the process status and confirming successful completion of the process, and improving interactions for receiving, managing, and answering questions that arise. Further, the example process of FIG. 9 improves notifications for various users, simplifies completion of activities for each user, and accordingly manages hand-offs between entities in the process, monitoring of entities to reduce delay periods in the process, and improves predictions of process outcomes for all participants, such as forecasting of process completion, process outcome, and/or aggregating information for multiple processes (e.g., process parameters for all members of a group, a tranche, all processes related to a particular entity such as an agent, carrier, IMO, etc.).

The example process of FIG. 9 includes a top-level secured platform execution operation (Platform security—at the top) that interacts with the entire process, ensuring communications are secured, encrypted as applicable, and enforces logins, authentication, permissions for users, and the like. In the example of FIG. 9, the process is initiated by a platform administrator, which sets up the client, agent, carrier, and/or other entities that are relevant to the process. In certain embodiments, the process may be initiated by any authorized user, such as by an agent inviting a client to the platform, or as otherwise set forth in the present disclosure, or as otherwise relevant for a process implemented on a platform of the present disclosure. The example process includes a client work stream, progressing from the client experience (e.g., initial presentations, marketing materials, introductory materials and/or communications, etc.), across the top line through approvals, payments, a product offering, and the like until the product is in force. The example process includes an agent work stream, progressing from the agent experience (e.g., initial presentations or the like depending upon the agent's experience with the platform, but that can further include confirmation of client information, invitation settings, or the like) to supporting documentation for the client until the product is in force. The example process includes appropriate collaboration points, for example a communication tool between the client and agent at a point in the process where client goals are being defined, and the agent assists in ensuring that the appropriate products are being requested in the plan for the enrollment process. The example process may optionally include additional or alternative work streams, for example a user may control the interface for a number of clients (e.g., a group enrollment, a company-wide enrollment, etc.), depicted as a “multi-life case” in the figure, which may have similar aspects to the client work stream, and/or may be adjusted according to the needs of the particular process. In certain embodiments, a process for a user controlling a number of clients may include additional interactions between that user and individual clients of the group. In another example, certain entities, such as a carrier, underwriter, or the like, may have interactions with the process at the appropriate points, including potentially interactions between those additional entities and the agent, the client, or another user. In the example of FIG. 9, a carrier user receives the plan forms from the agent (forms sent to carriers), and returns the product offering to the agent (e.g., after underwriting, confirming information, etc.). A given plan may have multiple products, with communications to a number of carriers or other entities, as applicable. In certain embodiments, the plan may include other products, such as loans, financing, annuities, long-term health coverage, or the like, with all appropriate parties brought in to the process at the appropriate time. For other processes, such as a manufacturing process, appropriate entities may include committees or other that review the process (e.g., a compliance committee, safety committee, facility committee, etc.) and may have inputs such as approvals for documentation, changes, etc. The work streams, process initiation, process completion, which entities are engaged at which point in the process, etc., may be configured according to the particular process, and the platform and aspects of the present disclosure may be configured accordingly to support such processes.

In certain embodiments, an IMO may be involved, and may engage the process in a similar manner to an agent, and/or the IMO may utilize an agent for certain aspects of the process, and directly perform other aspects of the process. At the bottom, the example process includes an operation “ADMIN illustration”, which may be a process outcome prediction that is provided by any entity related to the platform. In the example of FIG. 9, the illustration operation is performed by a platform administrator, but may be performed by any other entity having sufficient information and permissions. The example of FIG. 9 allows for an early illustration relative to previously known wealth planning systems, and further allows for rapid customization, response to unexpected events (e.g., a carrier approval is not received, and/or has changed parameters relative to the requested product), allowing for rapid determination of the appropriateness of a plan for the client user, comparison of multiple plan features relative to the expected outcome of the plan, and ensuring that assumptions, robustness (e.g., to sensitive parameters and/or stress tested aspects), communication materials, and the like are correct, compliant, and/or in a format that is helpful to the process customer (e.g., the client user).

The example process of FIG. 9 includes capturing of documentation (e.g., Docs sent to Trust), facilitates execution of documentation, ensures that monitoring entities can access the documentation, and stores the documentation for ready access by relevant users (e.g., the client user, a designated beneficiary, a fiduciary for the client user, etc.), including access that may occur years after the primary enrollment process is completed. The example process concludes with the activation of the policy (or other plan elements), a final updated illustration, or the like. In certain embodiments, the process of FIG. 9 is an example initiating process, but is a part of, or is followed by, later process elements such as a servicing, monitoring, and/or updating process—for example to service, monitor, and/or update the wealth planning process, or any other process supported by the platform.

Referencing FIG. 10, an example enrollment process is depicted schematically, with operation lanes progressing from left to right, with earlier activities depicted at the left, and later activities depicted at the right. The example of FIG. 10 is divided into FIGS. 10A and 10B for clarity of the depiction. The process portion 1002 sets forth an example enrollment process, the process portion 1004 sets forth a post-enrollment servicing process, and the process portion 1006 sets forth an estimator process. The entities that are engaged for each activity may vary with the specific implementation. Where the example of FIG. 9 depicts lanes organized by the entity (e.g., client, agent, IMO, etc.), the example of FIG. 10 depicts operations organized by dependency, for example one or more operations to the left are performed before one or more operations to the right. The specific flow of activity, the dependency of each activity on another activity, etc. will be understood by the process designer, and can be varied and supported by a platform accordingly. The example of FIG. 10 depicts pre-enrollment activity, followed by information gathering activity, followed by application activity (e.g., for a wealth planning product), followed by offer completion activity, followed by offer acceptance activity (e.g., enrollment). In the example of FIG. 10, post-completion activity, which may be considered as a follow-on monitoring activity, or as a continuous part of a main process, is also completed by the platform. Example post-completion activity includes operations to monitor the plan, to provide easy access to information for the client or interested entities, to provide updates, periodic review, status information, or the like, including reporting activity—whether for compliance, to update an interested entity, or the like. The example process of FIG. 10 is capable to provide updated illustrations, as set forth throughout the present disclosure, to any entity having appropriate authorization, including illustrations for predicted outcomes of the process based on the most recent information and performance, illustrations of performance versus plan, and/or performance of other related processes—for example enrollment performance on the platform, carrier performance related to the platform, agent performance related to the platform, or the like.

Referencing Figs. FIGS. 11-73B, 75-78B, and 83-88B, non-limiting user interface examples implemented by the platform are schematically depicted. The examples are selected to demonstrate certain aspects of the platform, but are non-limiting. In certain embodiments, the selection of menus, tabs, and/or other information may be varied, including which information is presented and/or the layout of the information. In certain embodiments, the menus, tabs, action links, labels, and the like may be varied according to the user type (e.g., client, agent, carrier, IMO, bank, underwriter, administrator, etc.), the specific user (e.g., that user's permissions, preferences, and/or selections for the user made by another user such as an agent, supervisor, etc.), the role of the user, and the like. The information shown in a particular context—for example on a client interface, may be useful in other contexts, and/or may be shown in part (e.g., with certain information redacted, made anonymous, etc.) according to the information utilized by each user type or user role in the process supported by the platform, and/or including information that must be shown for compliance or regulatory purposes, information that cannot be shown, or the like.

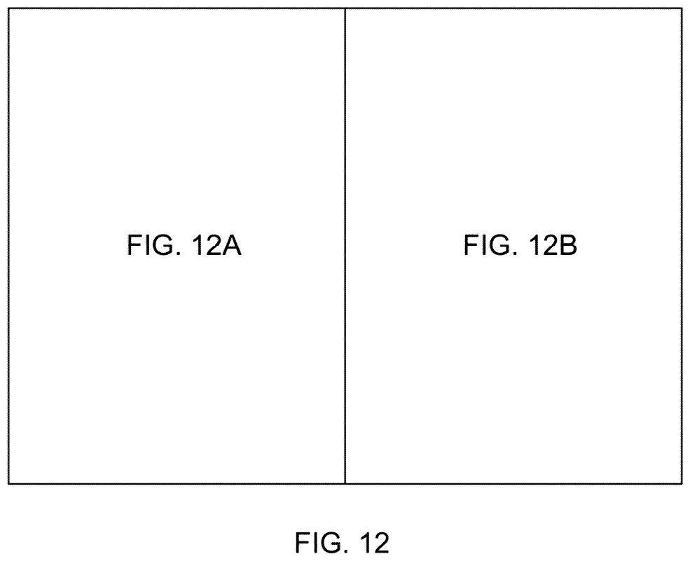

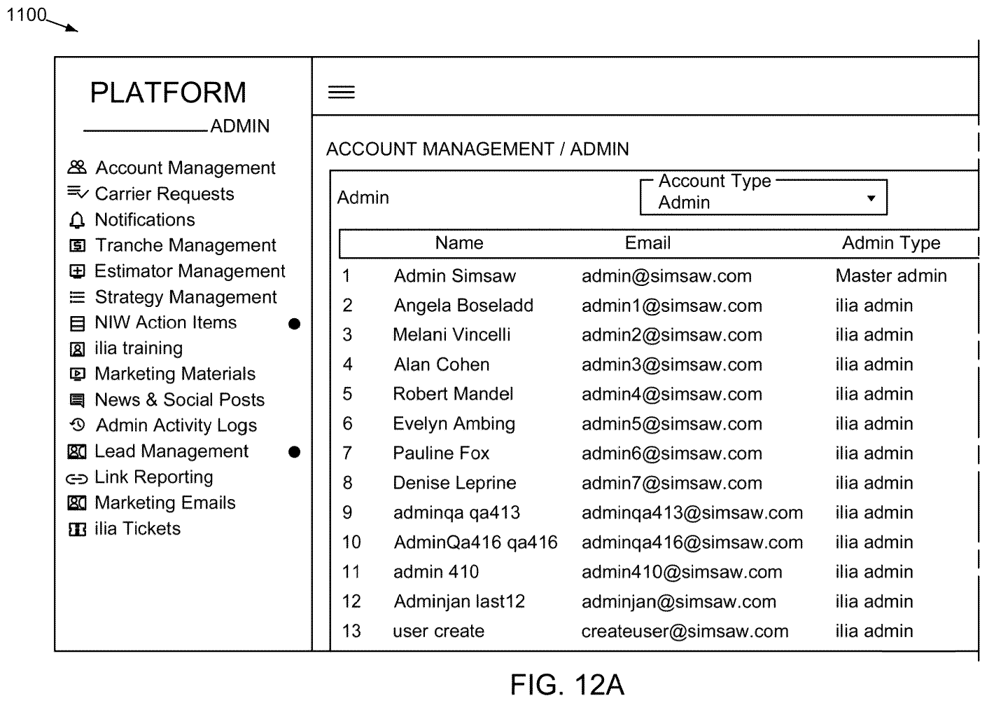

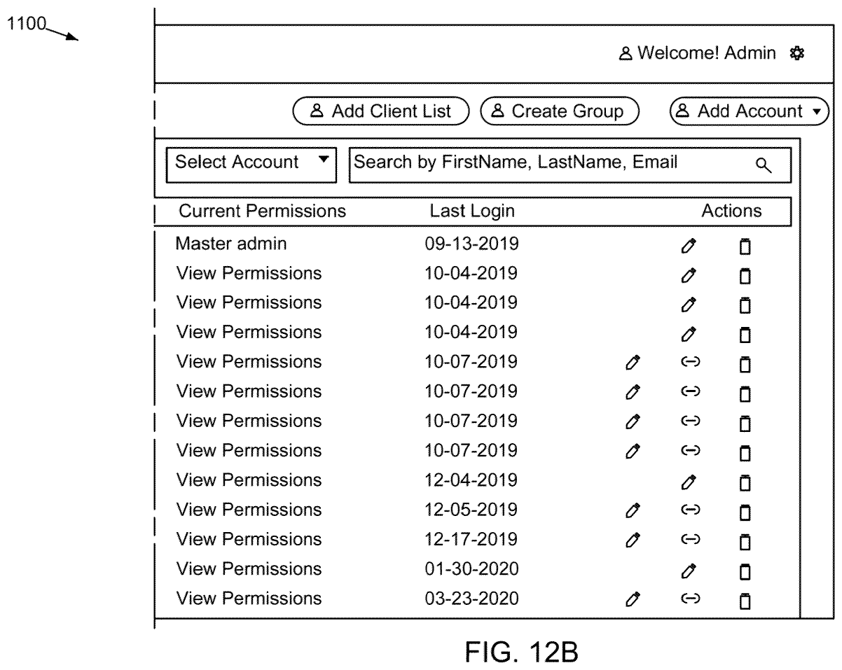

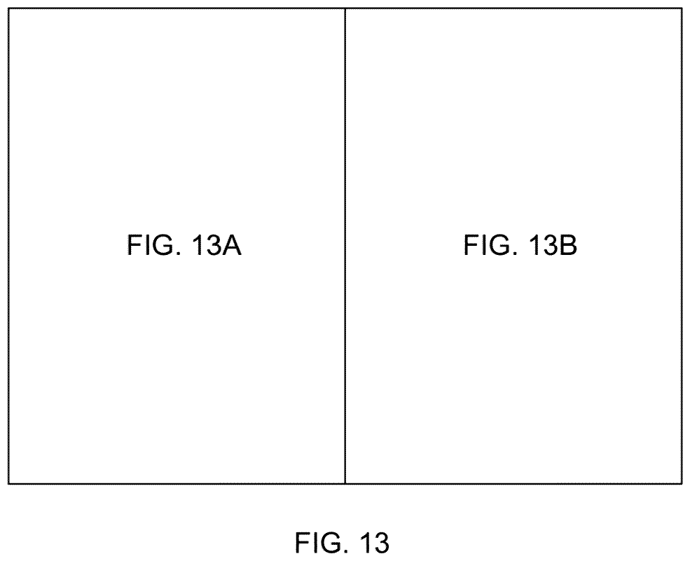

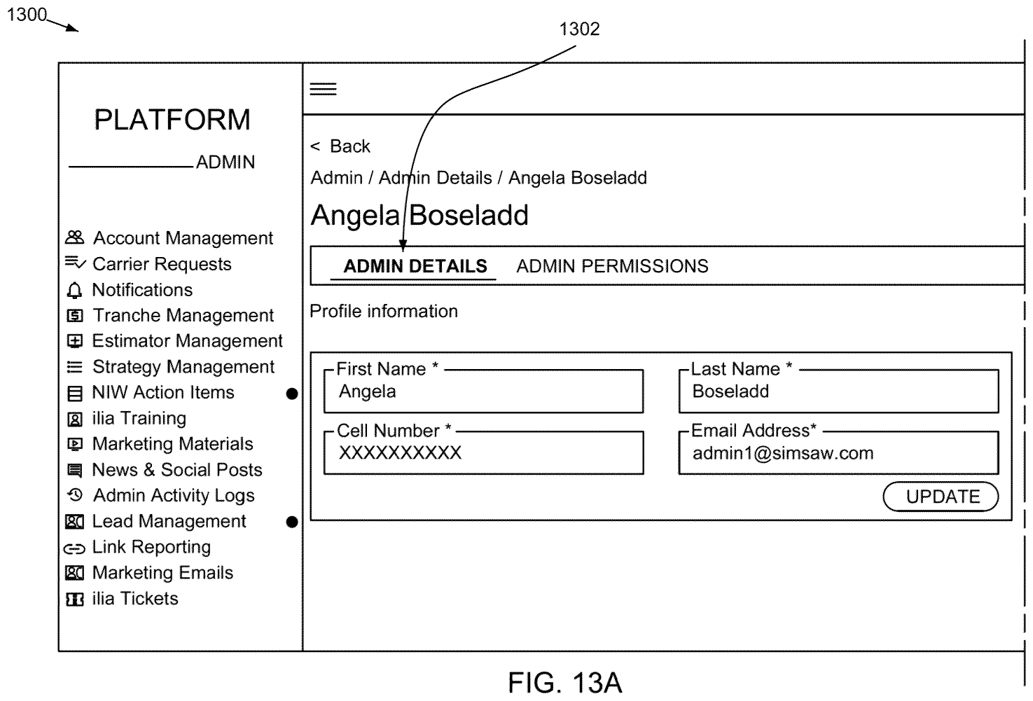

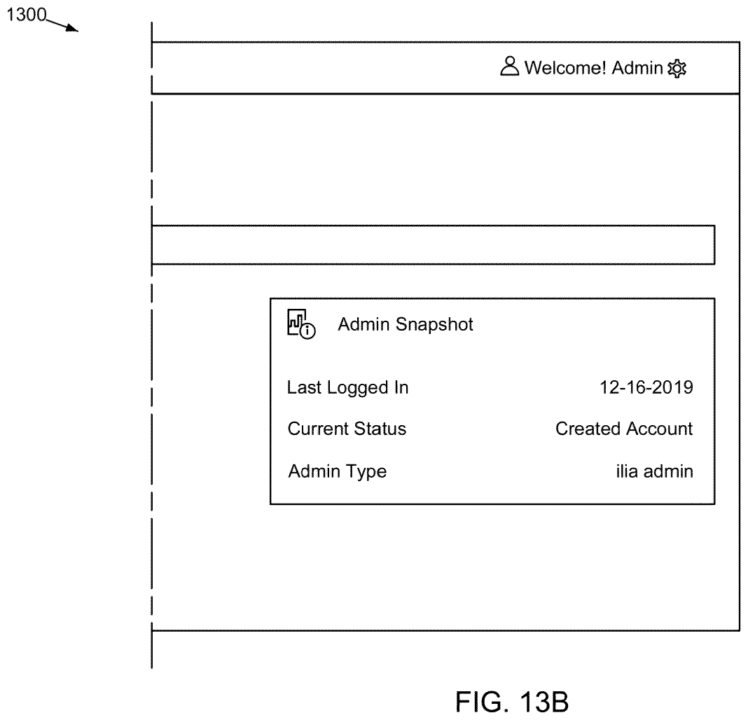

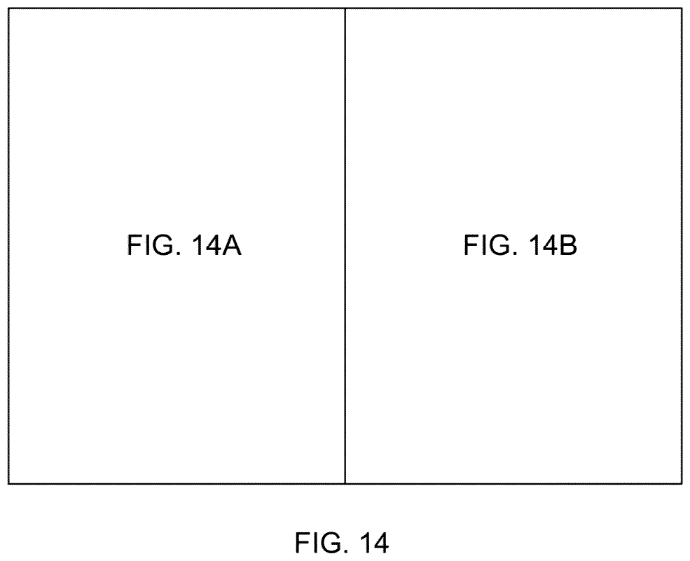

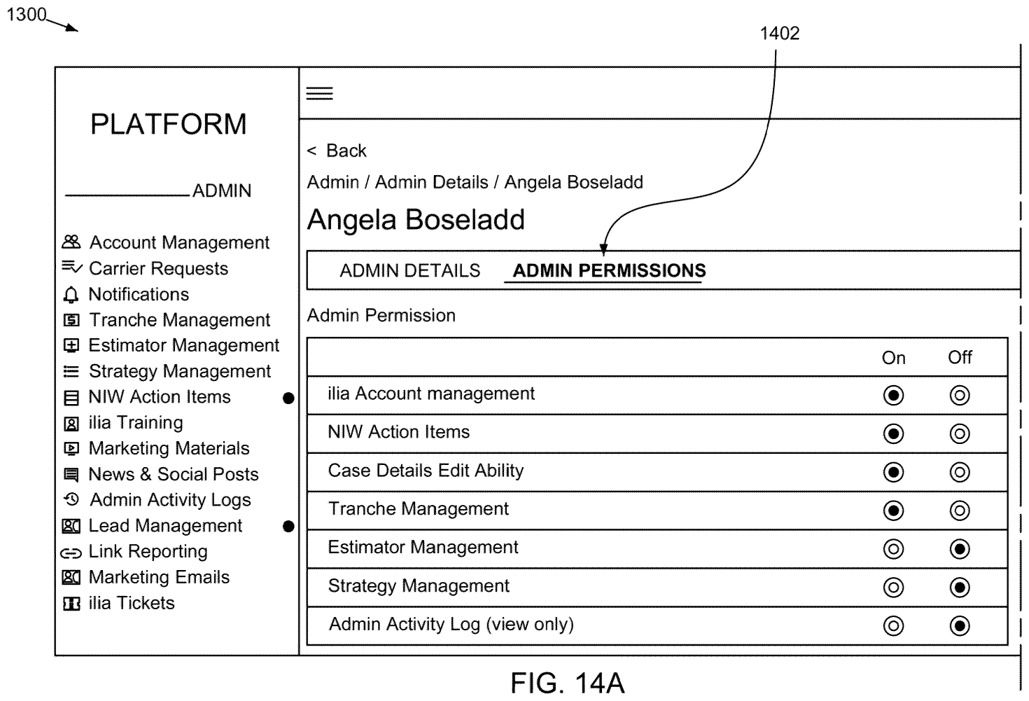

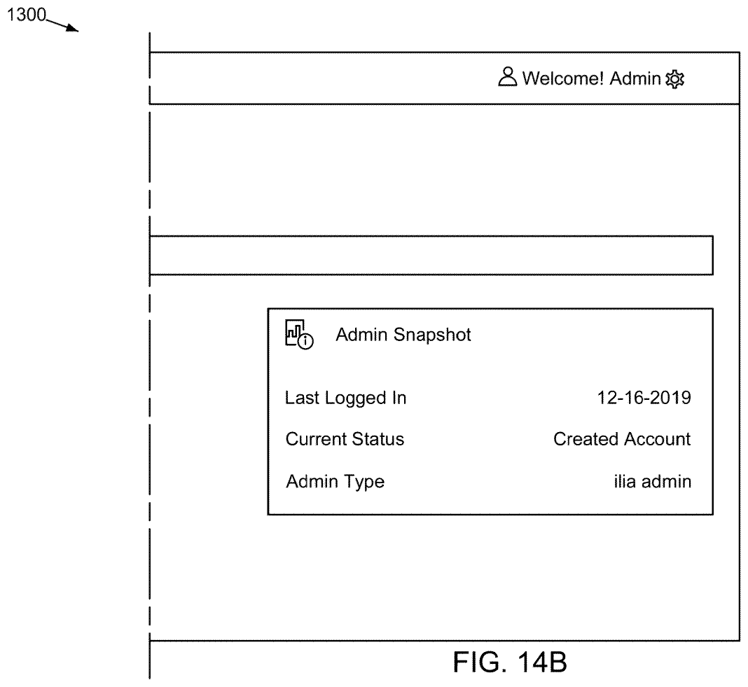

The example of FIG. 11 includes a general user interface 1100, for example an interface accessible to a platform administrator, with primary categories of information in a menu list at the left, a descriptive navigation header 1102, and a number of tabs for information categorization, action tabs (e.g., “add client list”, “create a group”, etc.) that are populated depending upon which menu is selected, and an information display area below. The example of FIG. 11 is divided into FIGS. 11A and 11B for clarity of the depiction. In the example of FIG. 11, an Account type filter 1104 is selected, with options for the user to select which types of accounts should be displayed. Throughout the present disclosure, information controls may be provided, including allowing for sorting, filtering, or the like, and/or with action controls for example to add or remove items from the list (which may include removal of the item from the platform, and/or just from display for the particular user or a selected scope by the user). The example of FIG. 12, divided into FIGS. 12A and 12B for clarity of the depiction, is consistent with the example of FIG. 11, where the user has selected “Admin” users for display. The example of FIG. 13, divided into FIGS. 13A and 13B for clarity of the depiction, is consistent with the example of FIG. 12, where an interface 1300 depicts a specific account (e.g., of an admin user) that is selected, and information accessible to the current user that selected the specific account is displayed, including ADMIN DETAILS 1302 for the account. In certain embodiments, if the selected account or entity has actions related to the process, the relevant activity may be displayed with a follow-up link or the like accessible to the current user. The example of FIG. 14 is consistent with the example of FIG. 13, with permissions associated with the selected account (or user) displayed. In the example of FIG. 14, divided into FIGS. 14A and 14B for clarity of the depiction, the current user can adjust the permissions 1402 available for the selected account/user, for example where the current user has sufficient authorization and/or permissions to both see the permissions of the selected user, and to adjust those permissions. In certain embodiments, a subset of the overall permissions available on the platform may be shown and/or adjustable, for example where the current user has permissions to view and/or modify some, but not all, of the permissions for the selected user. The permissions that are displayed, enabled, and/or adjustable may be depend upon the user type and/or role of the selected user.

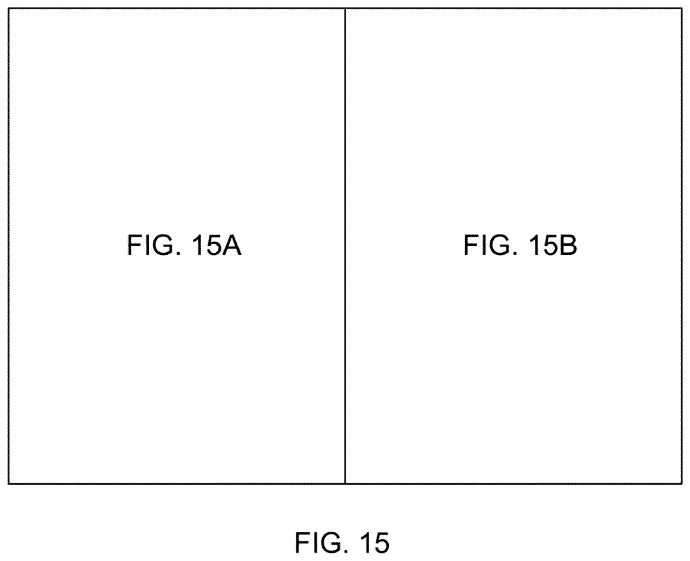

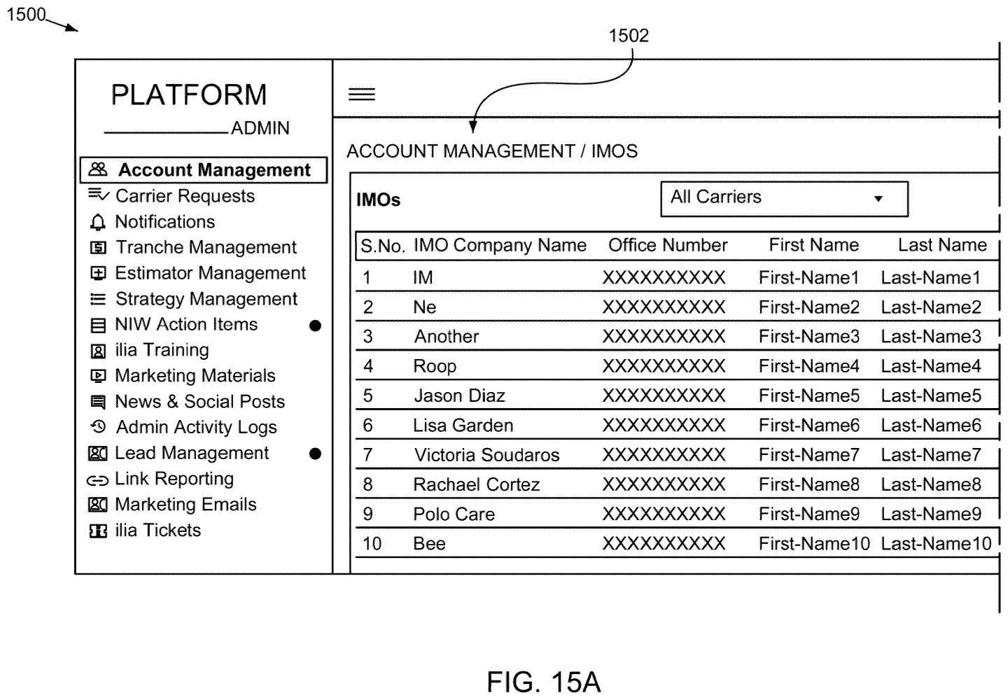

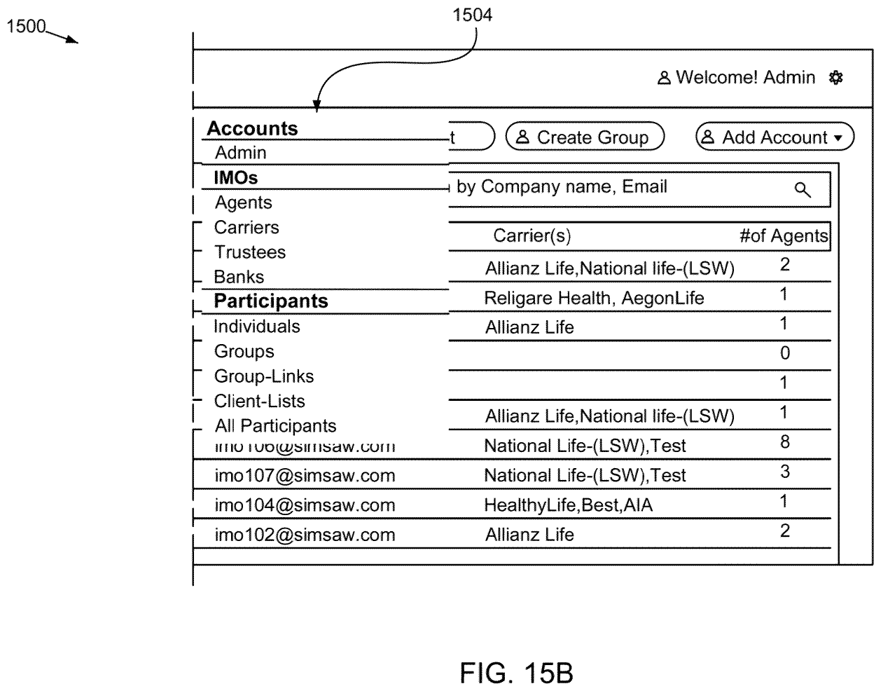

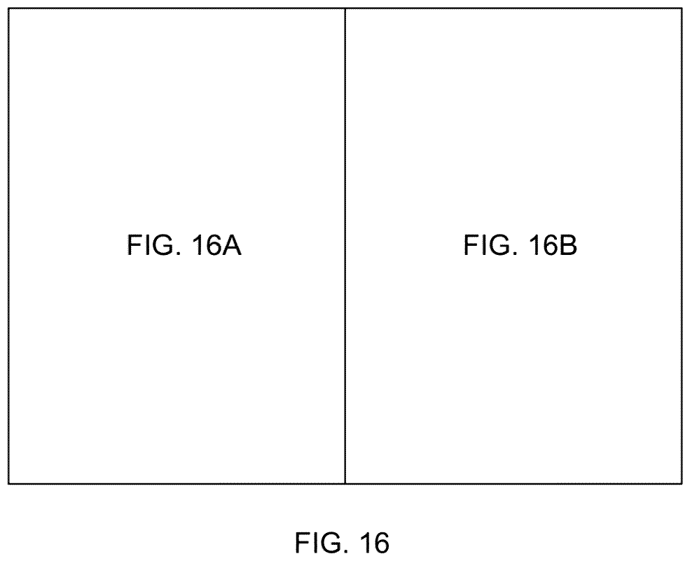

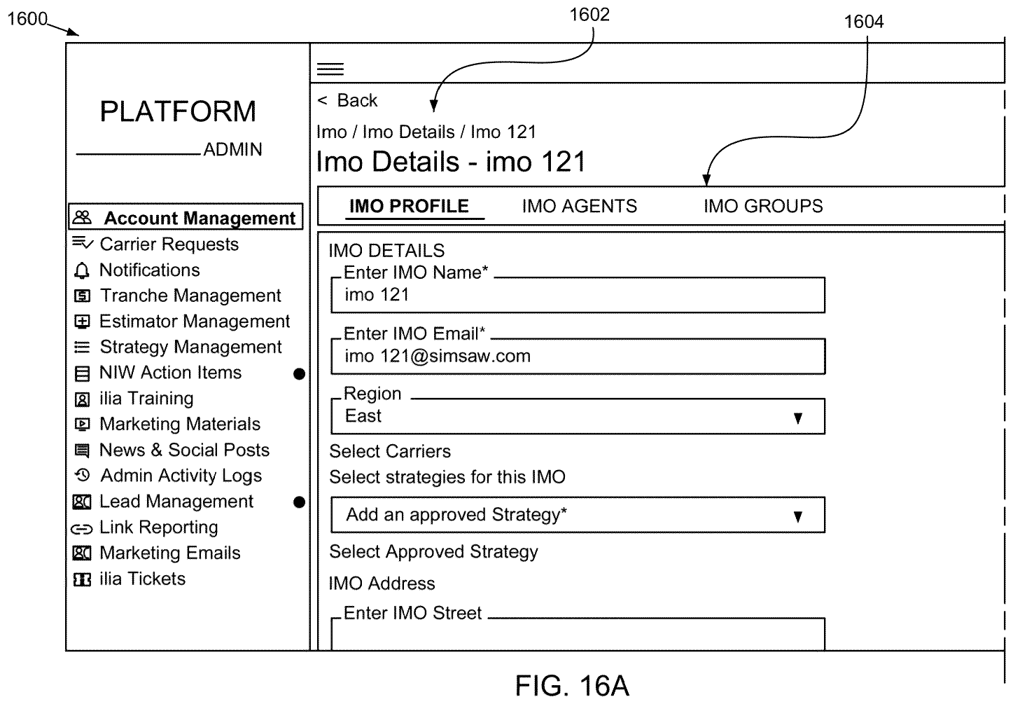

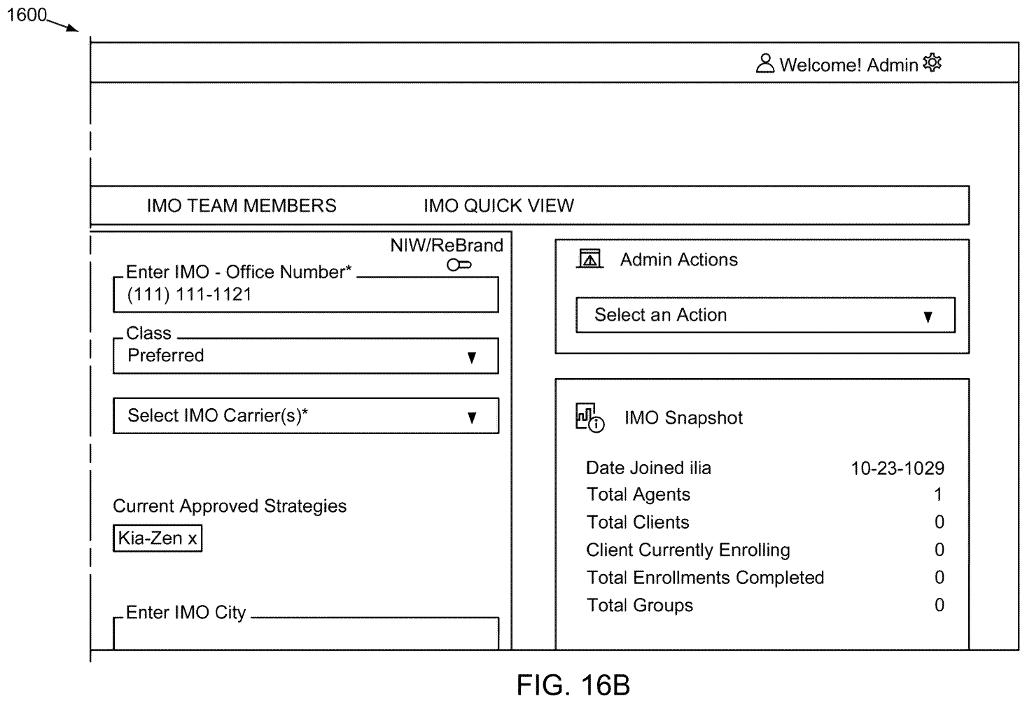

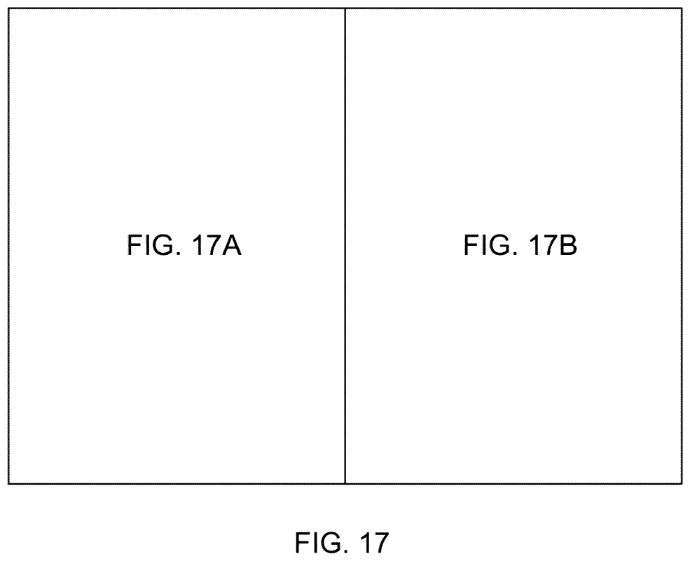

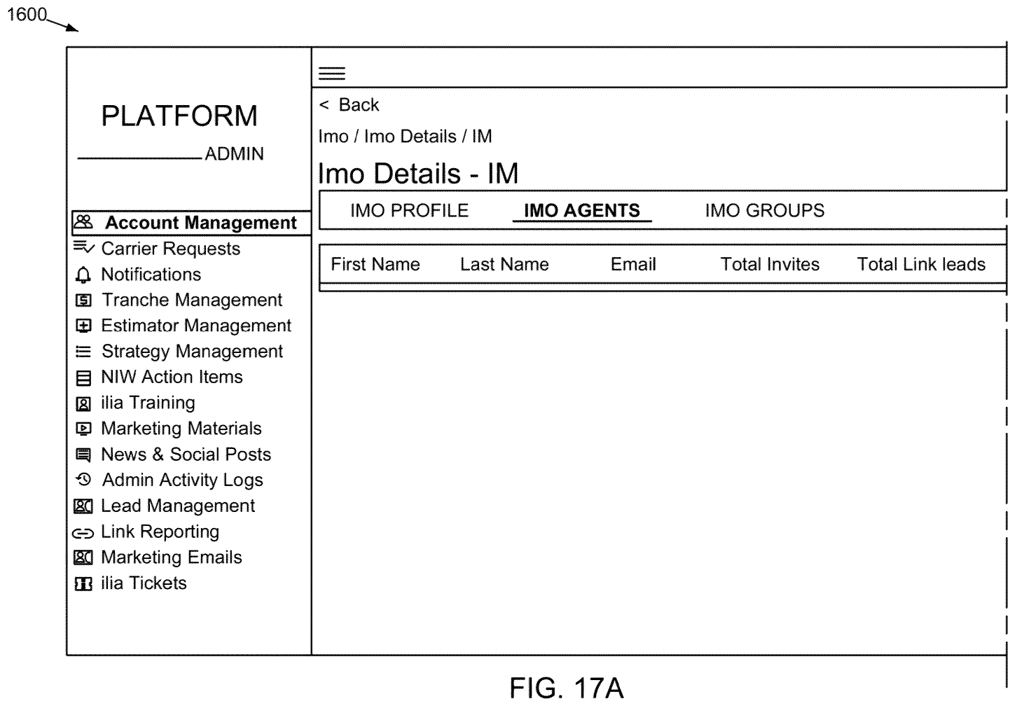

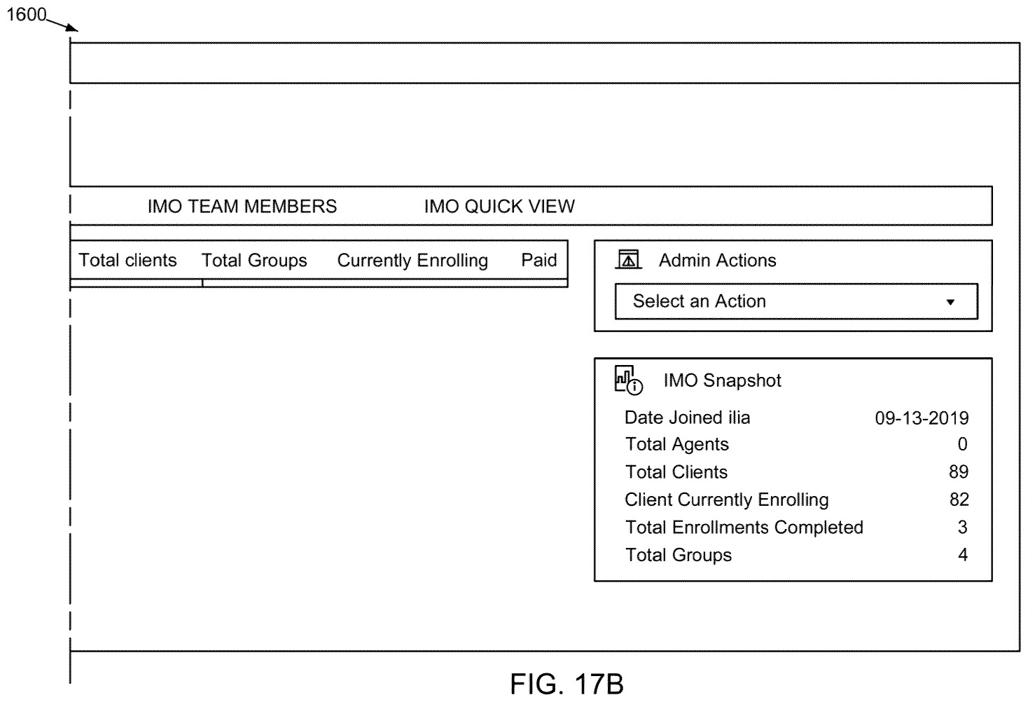

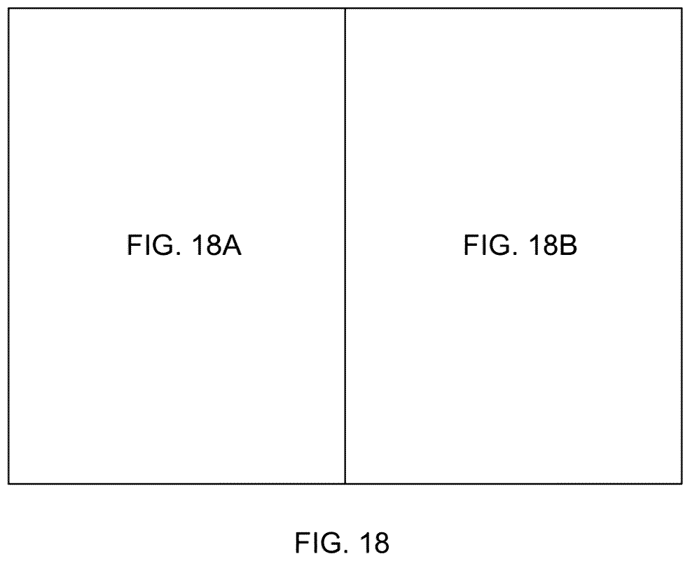

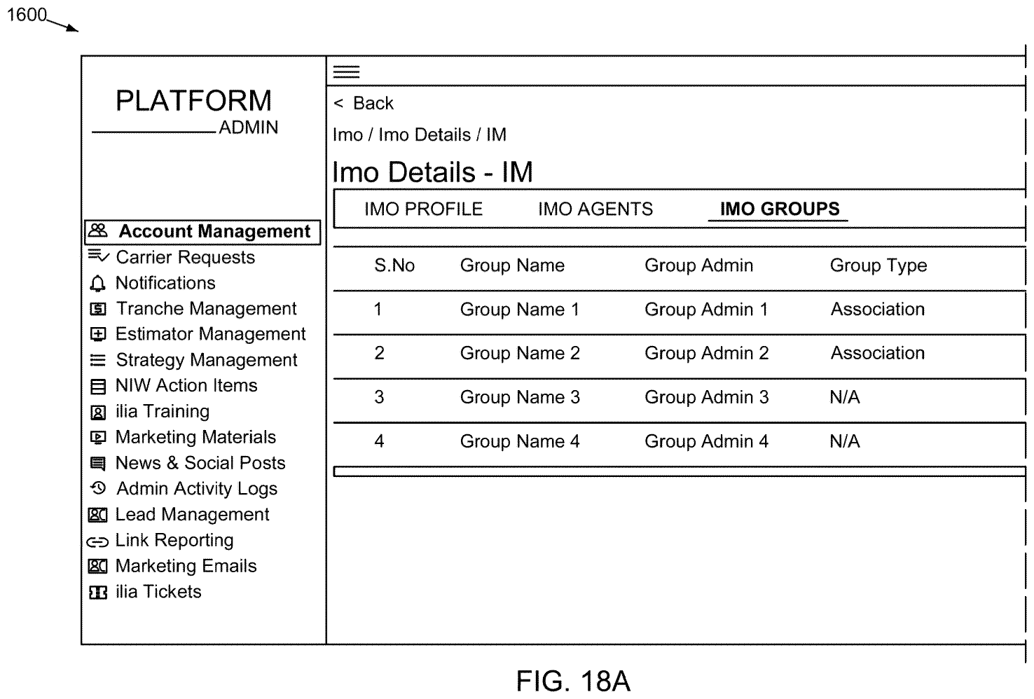

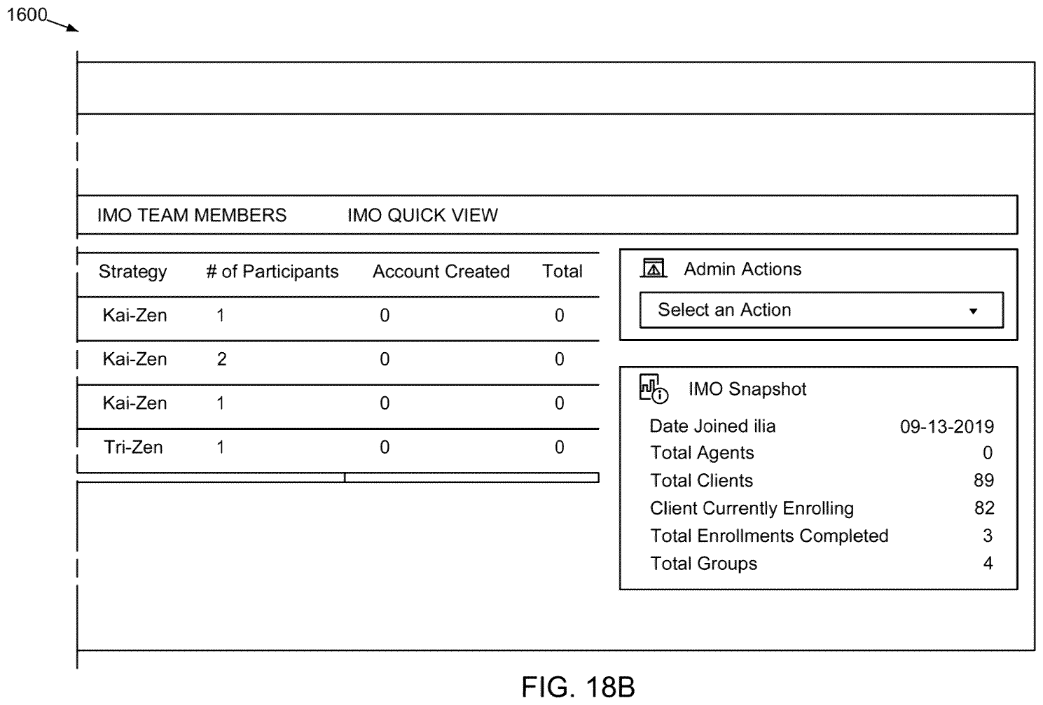

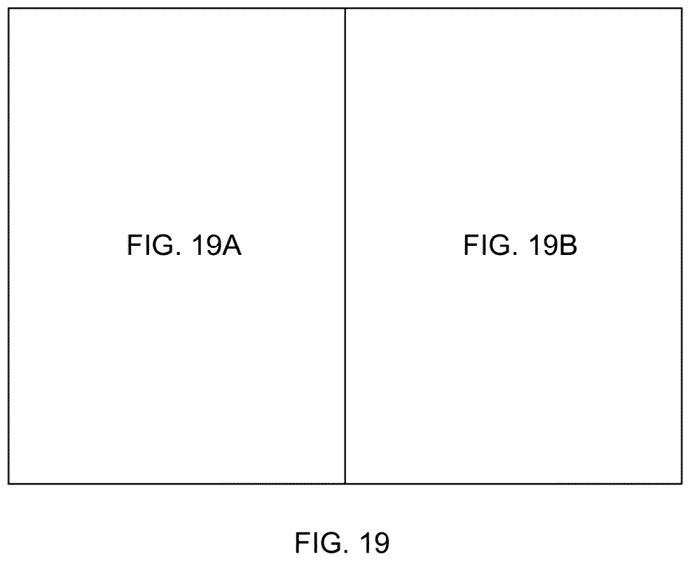

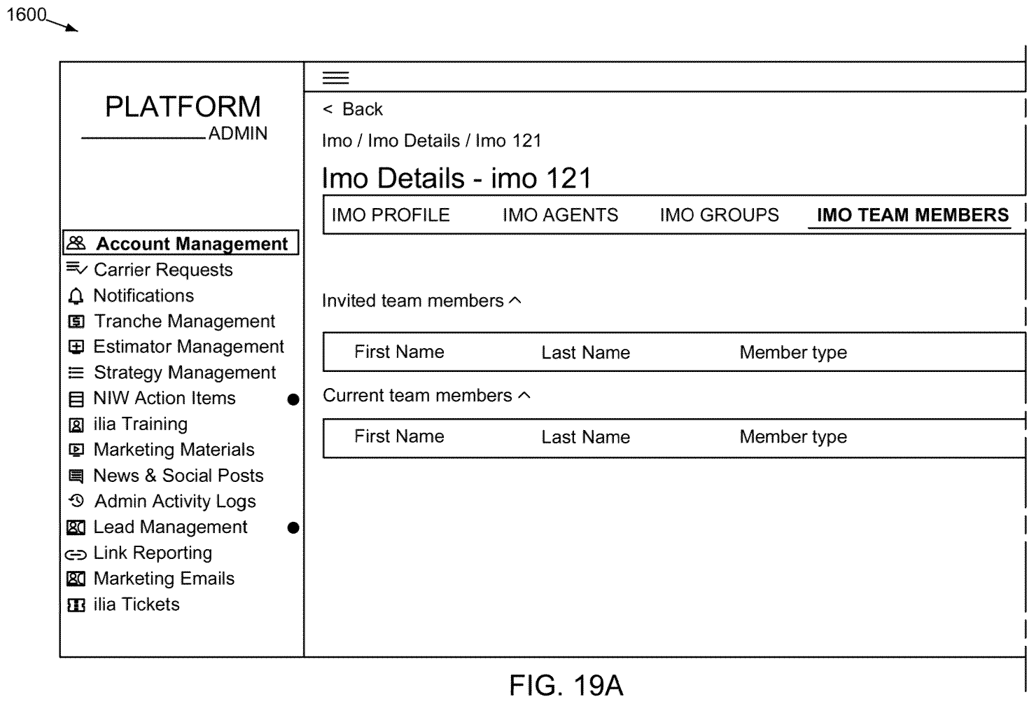

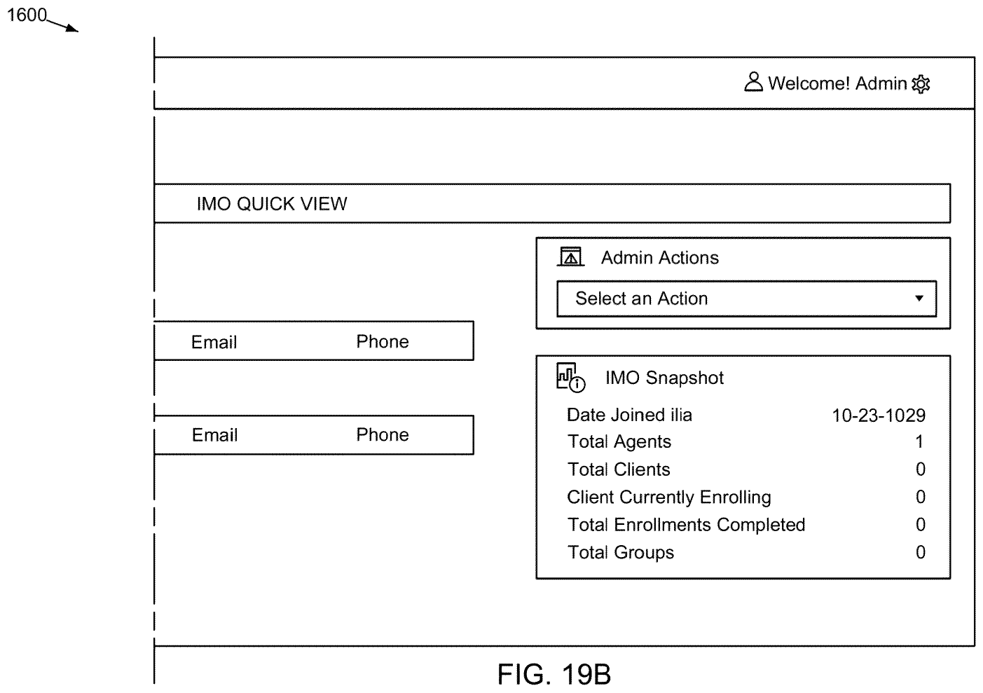

Referencing FIG. 15, an example user interface 1500 is depicted, divided into FIGS. 15A and 15B for clarity of the depiction, and consistent with the previous examples, with a listing 1504 of IMOs associated with the platform currently displayed, and a descriptive navigation header 1502. Referencing FIG. 16, an example interface 1600 is depicted, divided into FIGS. 16A and 16B for clarity of the depiction, and consistent with FIG. 15, with details 1604 available and provided on the user interface in response to a selection by the user of one of the IMOs from the list. In the example of FIG. 16, the selected details may be anything that is useful to the platform, the supported process, and/or the user operating the interface, such as contact information, preferences information (e.g., which strategies are to be utilized, are available, and/or are used as a default). The example of FIG. 16 allows for any entity on the platform to check the information for any other entity, limited to the permissions schedule, and provided in a manner where the key information can be arranged according to the requesting user. FIG. 16 includes a descriptive navigation header 1602. The example of FIG. 17 depicts example information available on the user interface 1600, divided into FIGS. 17A and 17B for clarity of the depiction, including for example summarized or aggregated information, for a particular entity type (e.g., an IMO in the example) and/or action links for activity related to the entity, to provide notifications or follow-up, or the like. The example of FIG. 18 is consistent with the example of FIG. 17, with example data populated in the information display of the user interface 1600, divided into FIGS. 18A and 18B for clarity of the depiction. The example of FIG. 19 depicts further details relative to the example of FIG. 18, for example which may be displayed if one of the IMOs from FIG. 18 is selected by the user. The user interface 1600 of FIG. 19 is divided into FIGS. 19A and 19B for clarity of the depiction.

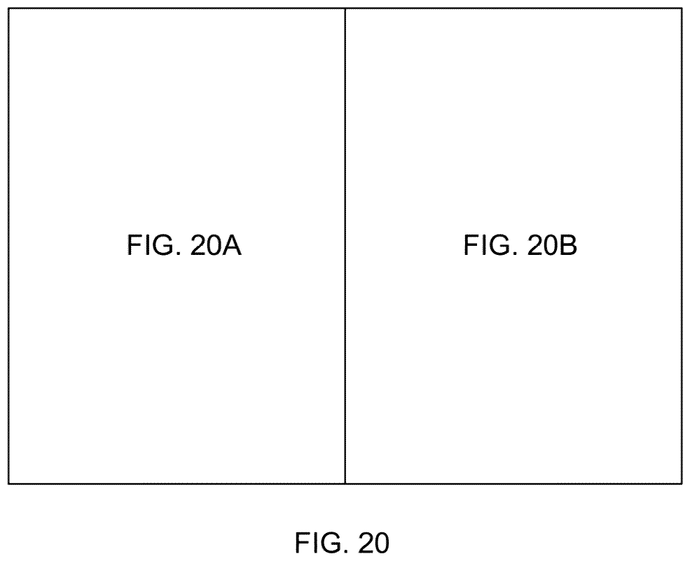

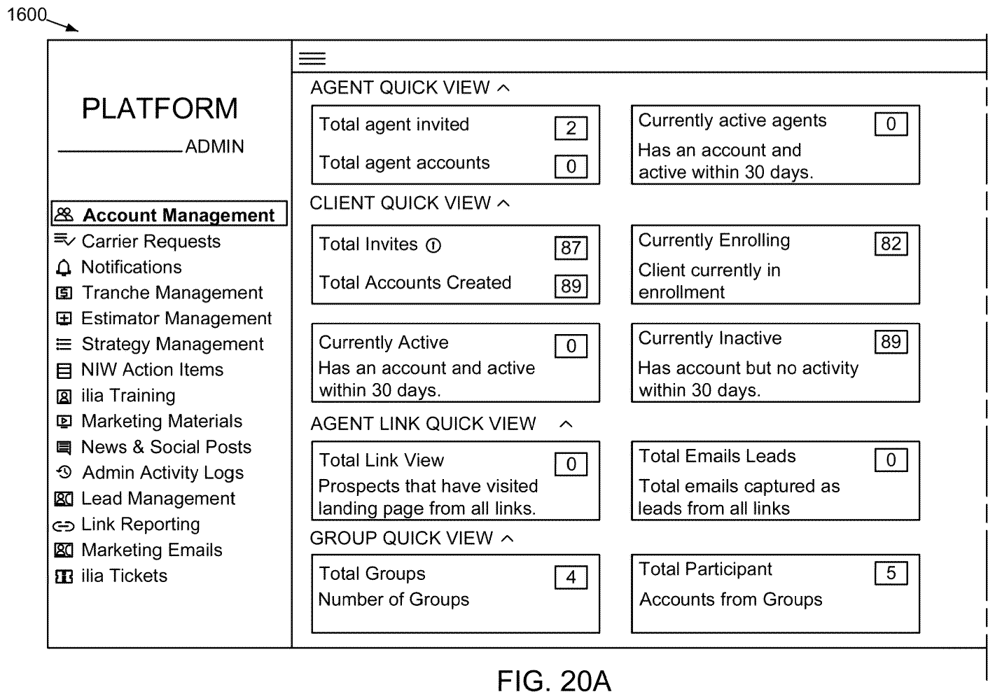

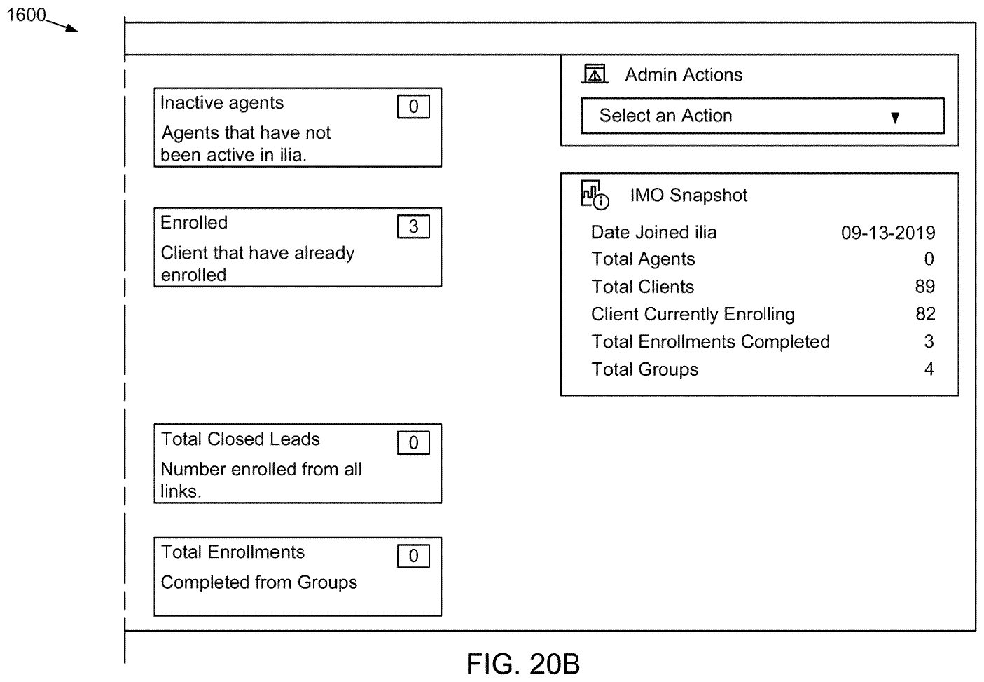

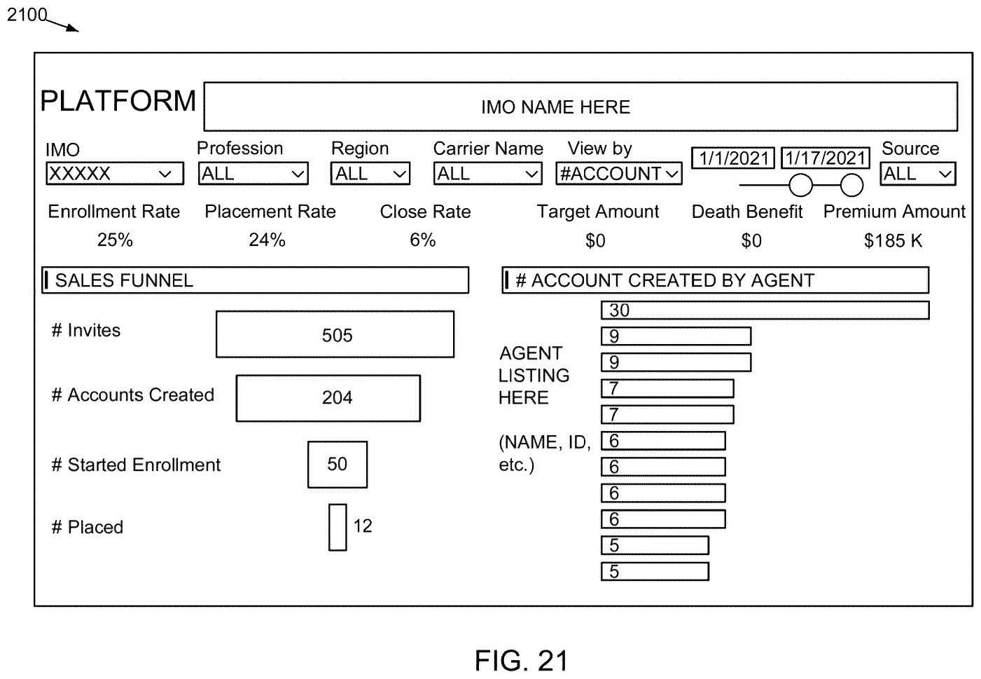

The example of FIG. 20 depicts an example dashboard for an IMO, using user interface 1600, divided into FIGS. 20A and 20B for clarity of the depiction. The dashboard may be prepared for any user, user group, user type, or the like, which may be available to a relevant user having sufficient permissions—for example an administrator related to the IMO, a supervisor or manager of the IMO, and/or a platform administrator. The information on the dashboard can be implemented by the platform, which has visibility to the entire process and the associated users, providing for a quick, configurable, and powerful tracking tool for processes on the platform, and overall performance and statistics for the IMO (or other relevant user type) on the platform. The dashboard, such as that depicted in FIG. 20, may be interactive, where the user can select information to get further details, including potentially down to the level of a single user, plan, date, or the like, and/or may filter by date ranges or the like. The example dashboard allows for the user to determine how many instances of the process are ongoing (e.g., how many clients being enrolled), the stage of these processes, where a process might be stuck or delayed, greatly facilitating process management and allowing the user to direct efforts where they are most likely to be helpful and to successfully move a process forward. Referencing FIG. 21, another example dashboard is depicted on a user interface 2100, with information for the user (an IMO, in the example) developed from the process activity and displayed for the user. The information and formatting of the information on a dashboard such as in FIG. 21 can be configured in any manner, where in the example the number of invites, accounts created, enrollees, and completed placements are the statistics of interest to the particular user associated with FIG. 21—for example an IMO tracking agent utilization, marketing cost effectiveness, or the like.

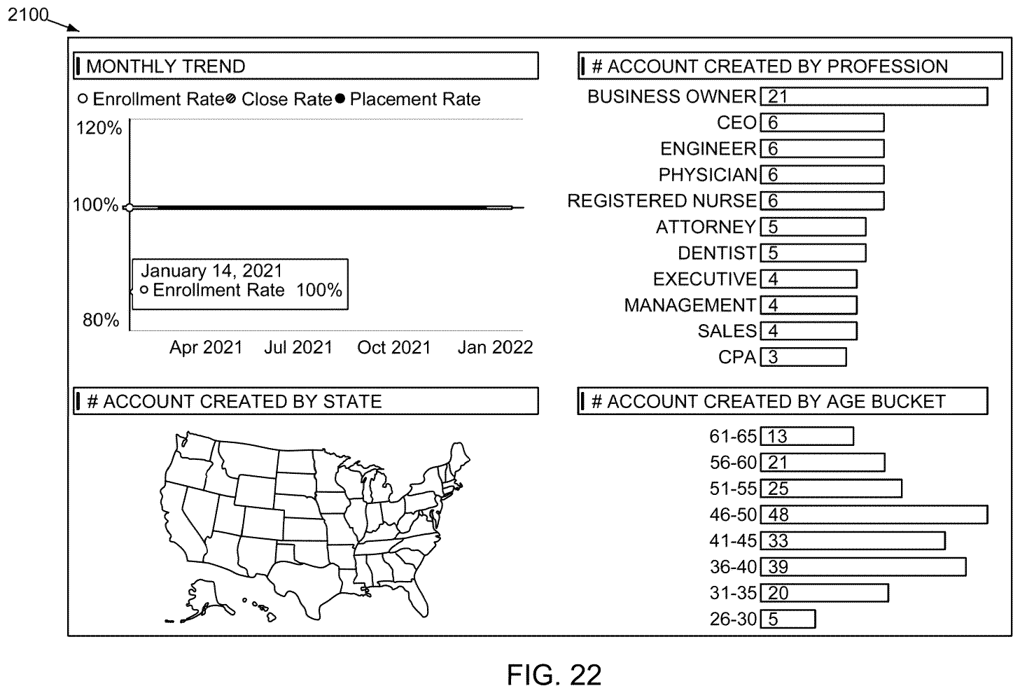

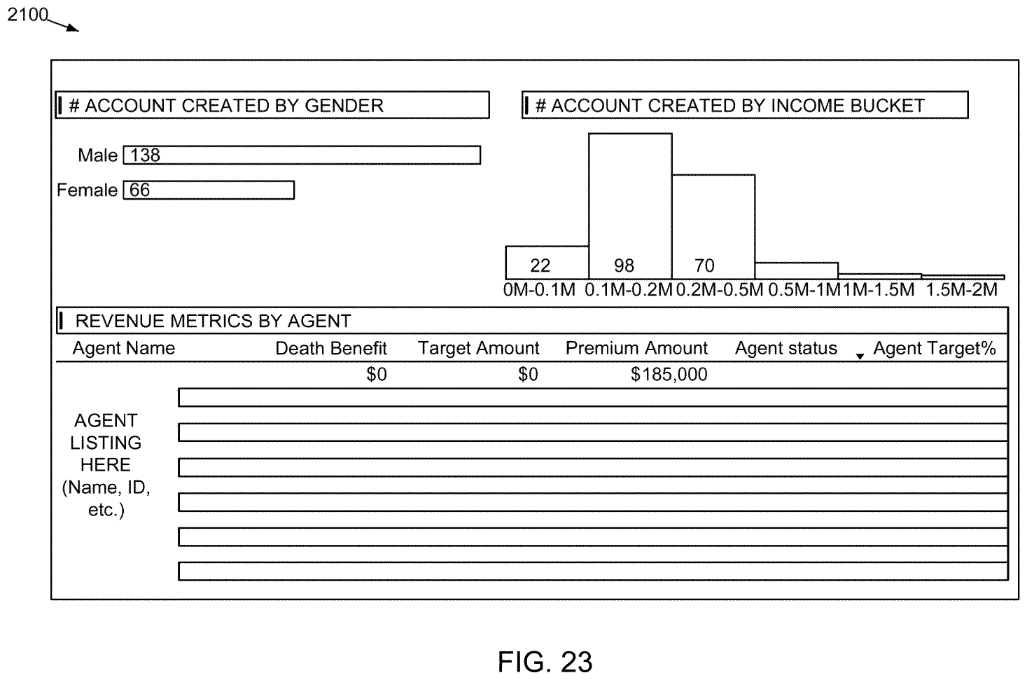

The example of FIG. 22 depicts a dashboard depicted on a user interface 2100, that may be of interest to a user wanting a platform-wide view, such as a platform administrator, depicting enrollments, placements, or other process outcomes of interest, and in the example the dashboard depicts accounts created by occupation, jurisdiction, and/or age brackets. In certain embodiments, information such as that depicted in FIG. 22 may be associated with an IMO, carrier, particular agent, or the like, and may not be platform-wide. Additionally or alternatively, the criteria selected (e.g., age, occupation, jurisdiction) may be determined according to what is of interest to the user associated with the dashboard, and/or the permissions available to that user. In certain embodiments, some information may be anonymized and/or aggregated, if acceptable according to applicable rules and regulations, for example to hide specific addresses, identifiable information such as health related information, age, etc. In certain embodiments, a user may have permission for a specific type of information (e.g., age brackets for enrollees), where anonymizing operations may be insufficient, and accordingly the information may not be displayed even if it is otherwise theoretically available (e.g., the information may be withheld until a sufficient number of users are in the system for sufficient anonymization). FIG. 23 is a continuing example from FIGS. 21-22, with summary information for a list of agents related to the dashboard is included at the bottom of the dashboard. In the example of FIGS. 21-23, the user can sort by any field, select visual elements to get further details, and/or print any view, depending upon the permissions of the user, the type of information displayed, or the like.

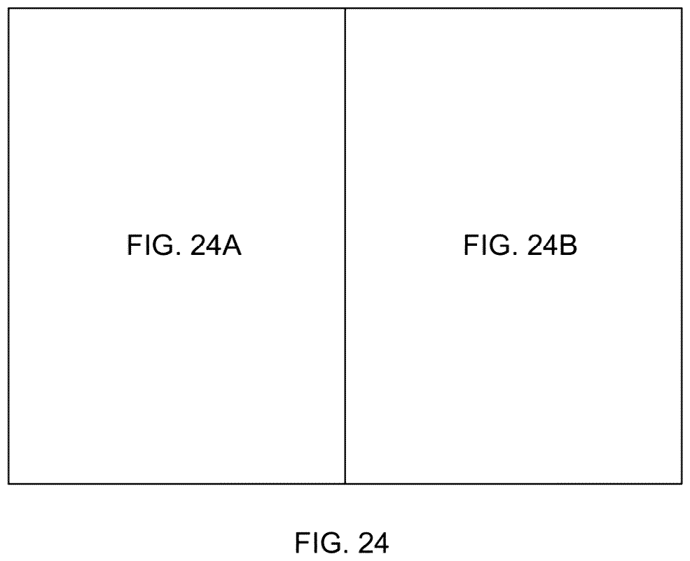

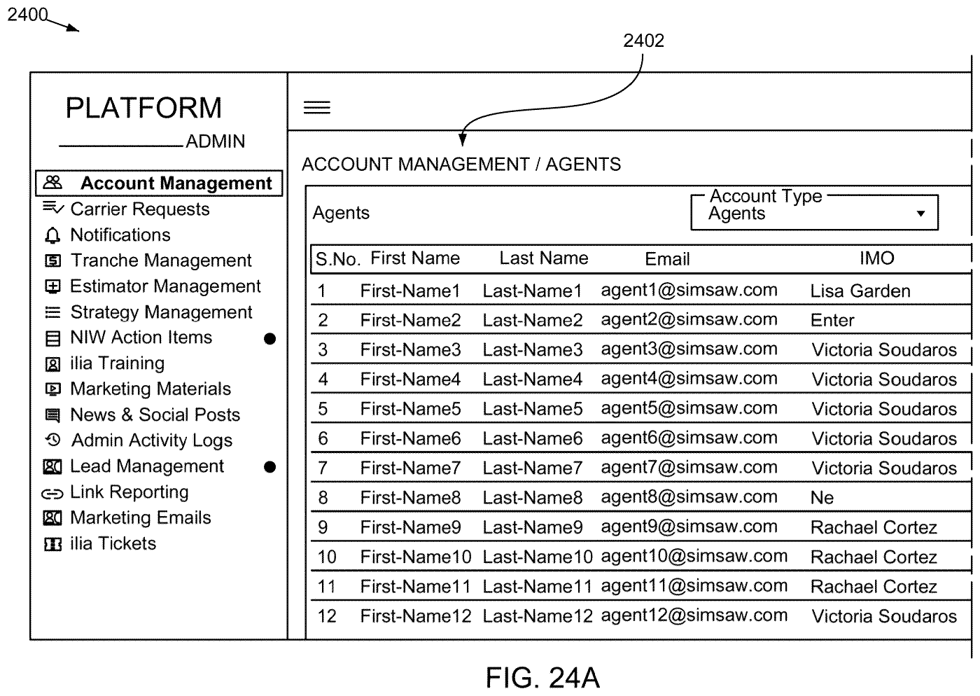

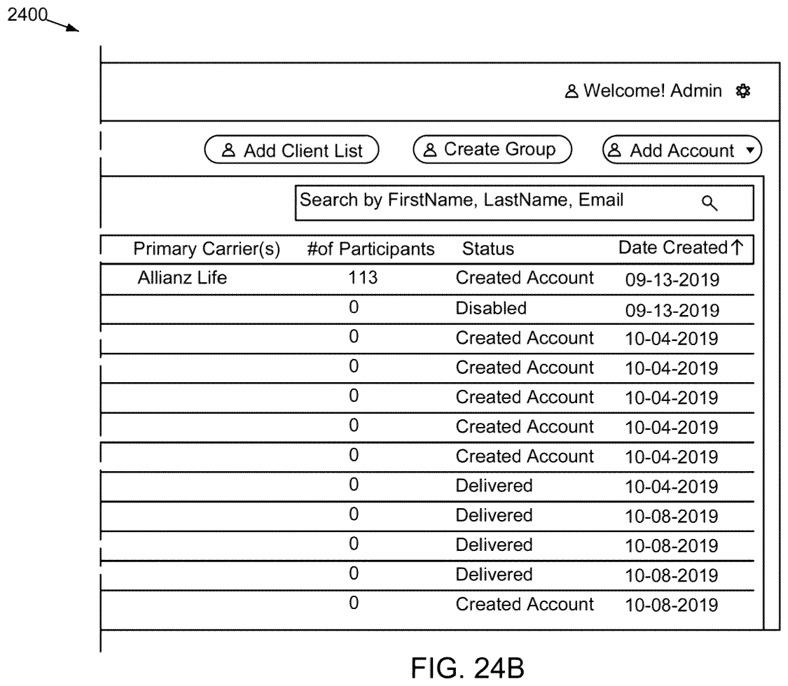

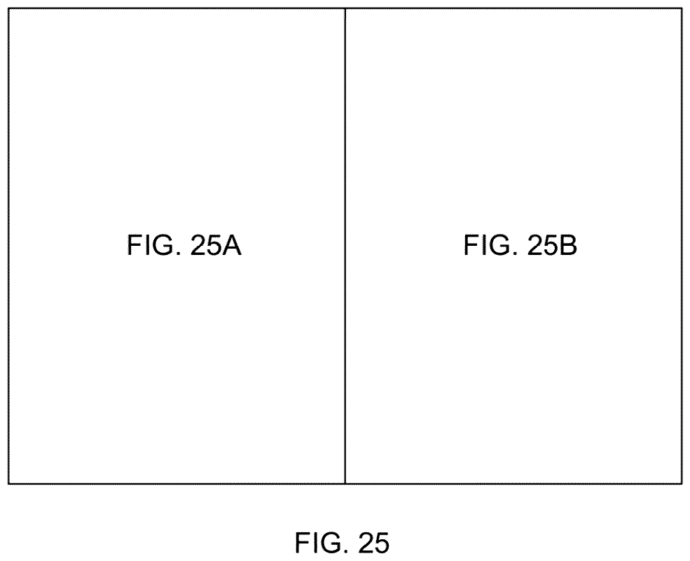

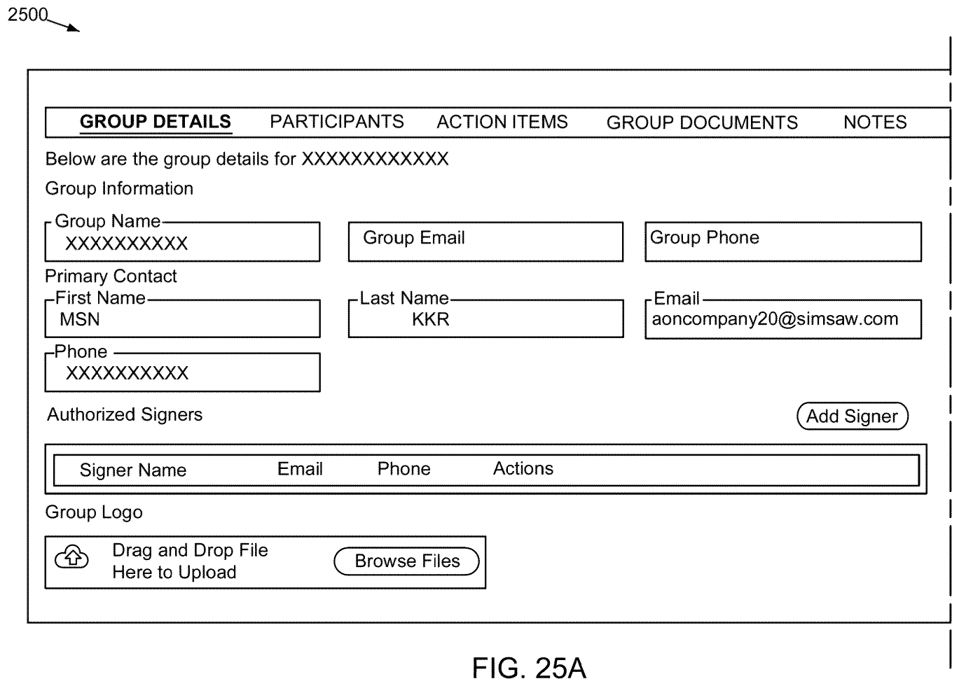

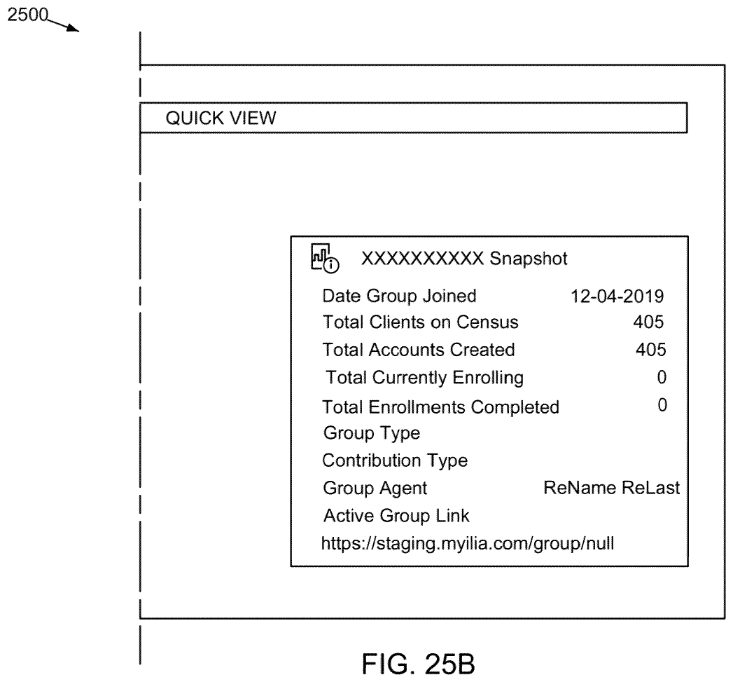

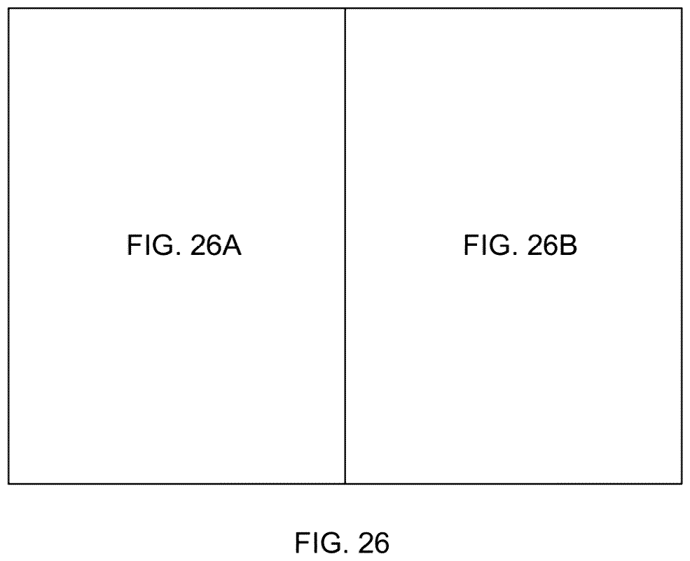

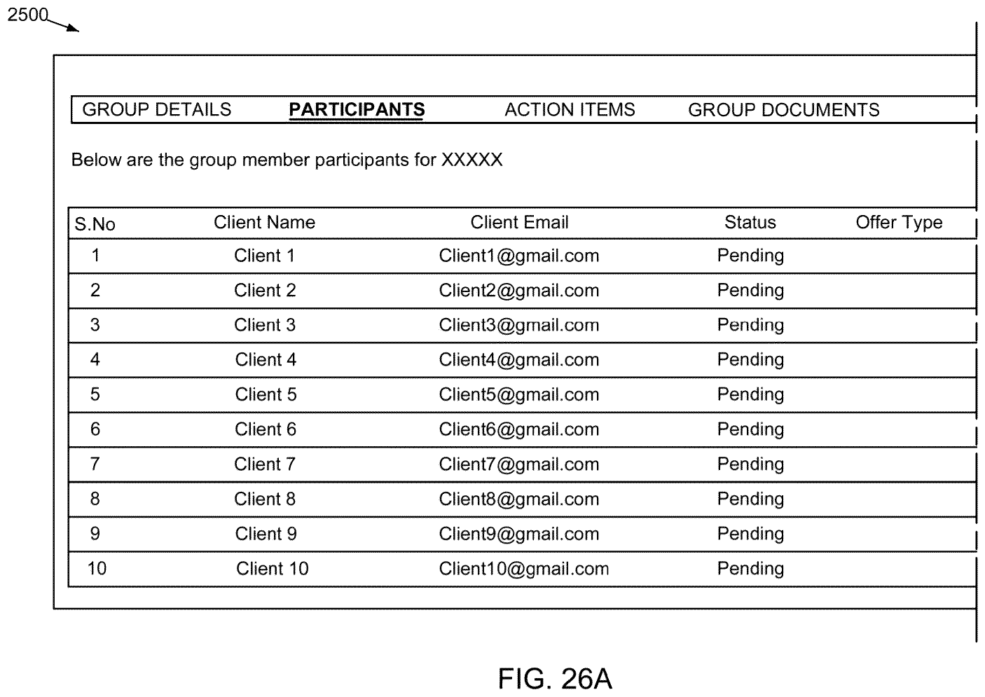

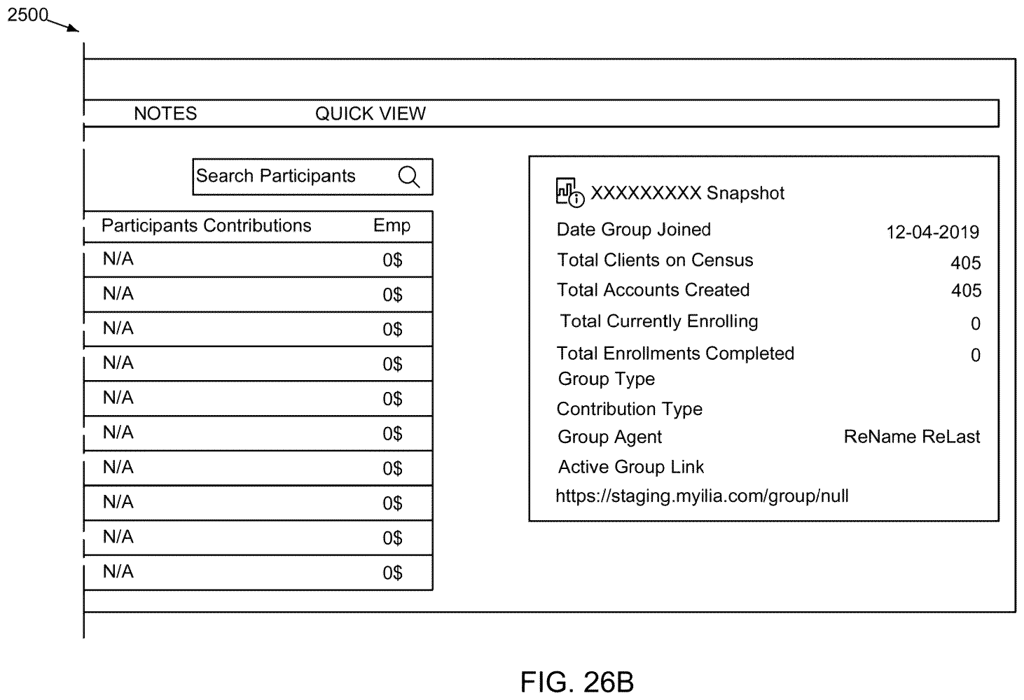

Referencing FIG. 24, an example user interface 2400, divided into FIGS. 24A and 24B, including an agent listing view is schematically depicted. The information displayed, fields depicted, and activity linked to the display are selectable according to the user as set forth throughout the present disclosure. The example of FIG. 24 includes a descriptive navigation header. Referencing FIG. 25, group details for an example group are schematically depicted on a user interface 2500, divided into FIGS. 25A and 25B for clarity of the depiction. In the example of FIG. 25, the user can assign a signer (e.g., an authorized party to sign for the group), notify group members, create or send a link to the group, change contact information, or the like. In certain embodiments, the group detail page such as in FIG. 25 can be accessed from a list of entities relevant to the group (e.g., a tranche, IMO, carrier, and/or any other defined group as set forth throughout the present disclosure). The information displayed on the group detail page, and actions available therefrom, depend upon the purpose of the group (e.g., guiding a group enrollment, tracking related users for statistics, creating a baseline group for comparison, etc.), the interactions of the group with the process(es) on the platform, the permissions of the user operating the interface, etc. FIG. 26 provides an example of participant details depicted on the interface 2500, divided into FIGS. 26A and 26B for clarity of the depiction, for example of the group depicted in FIG. 25. The details available may vary, as in other group concepts throughout the present disclosure, on the purpose of the group, the interaction of the group with process(es) supported on the platform, the permissions of the displaying user, or the like.

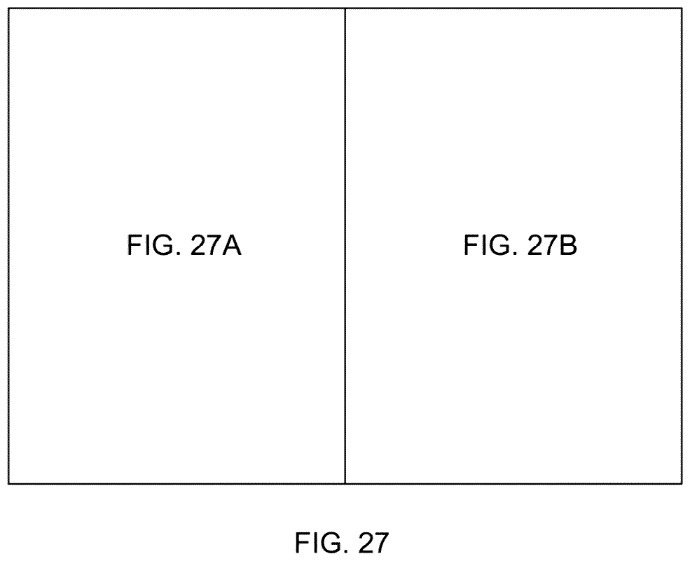

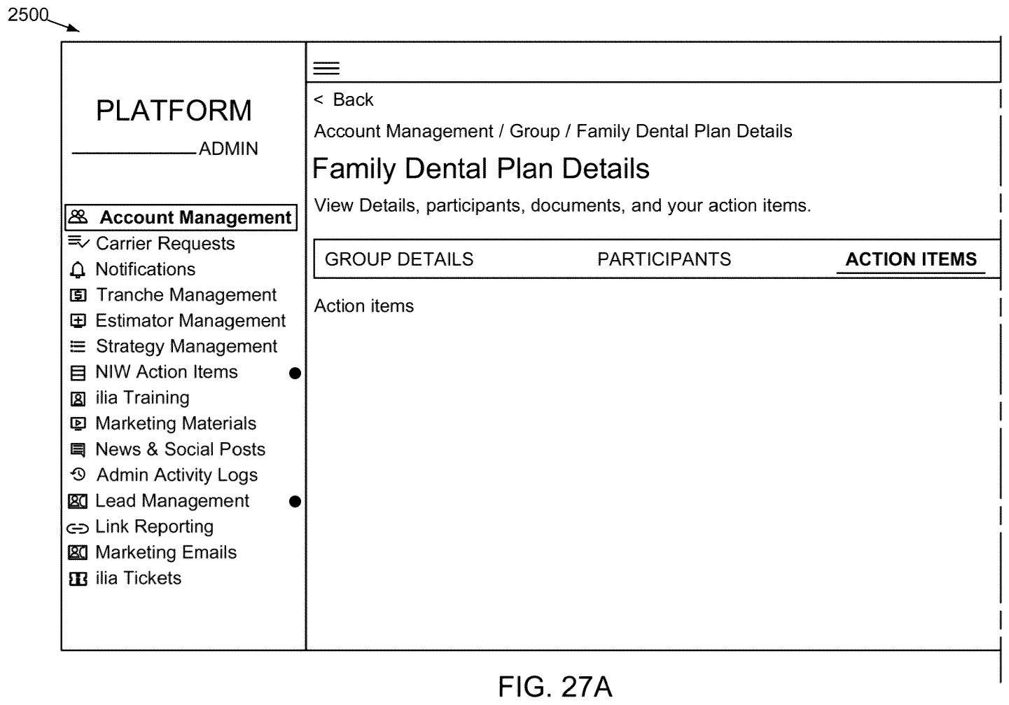

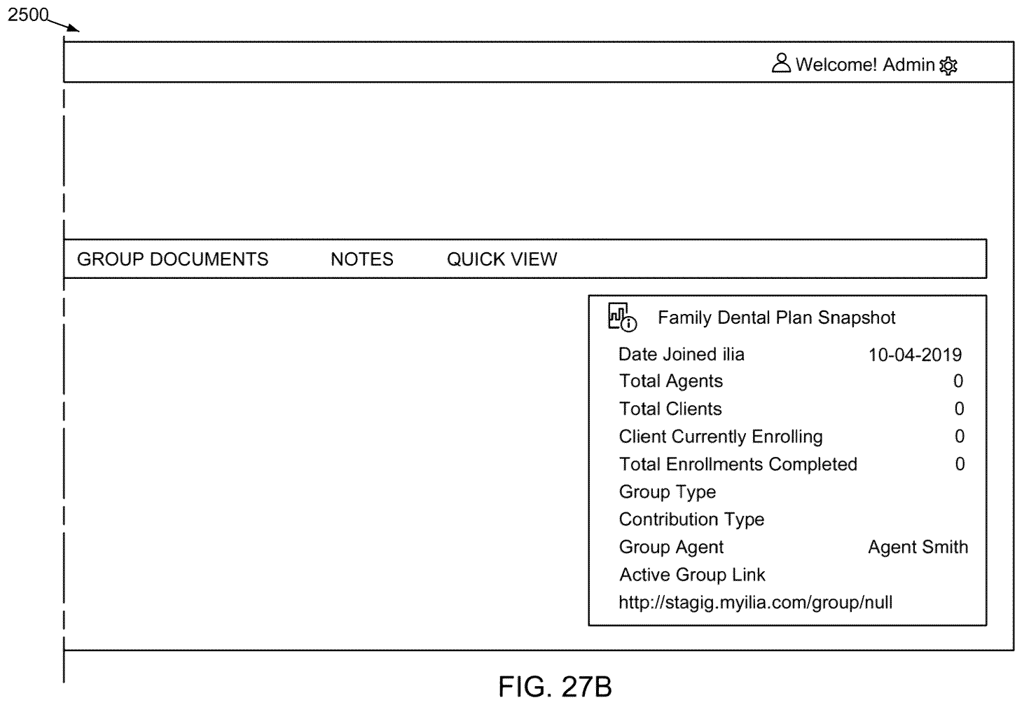

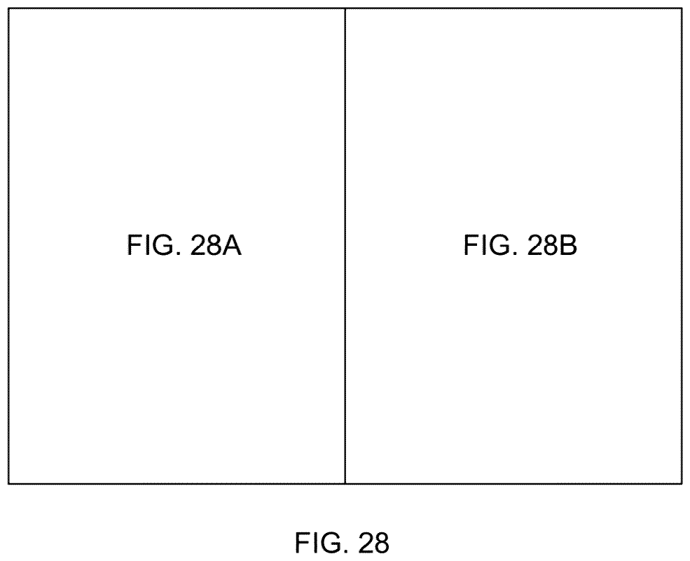

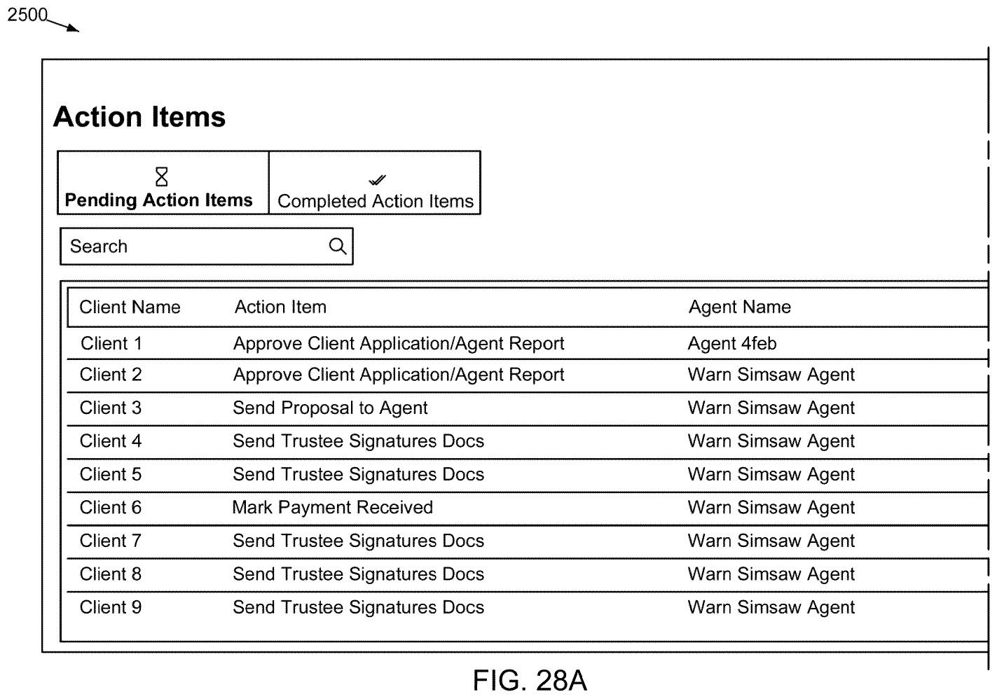

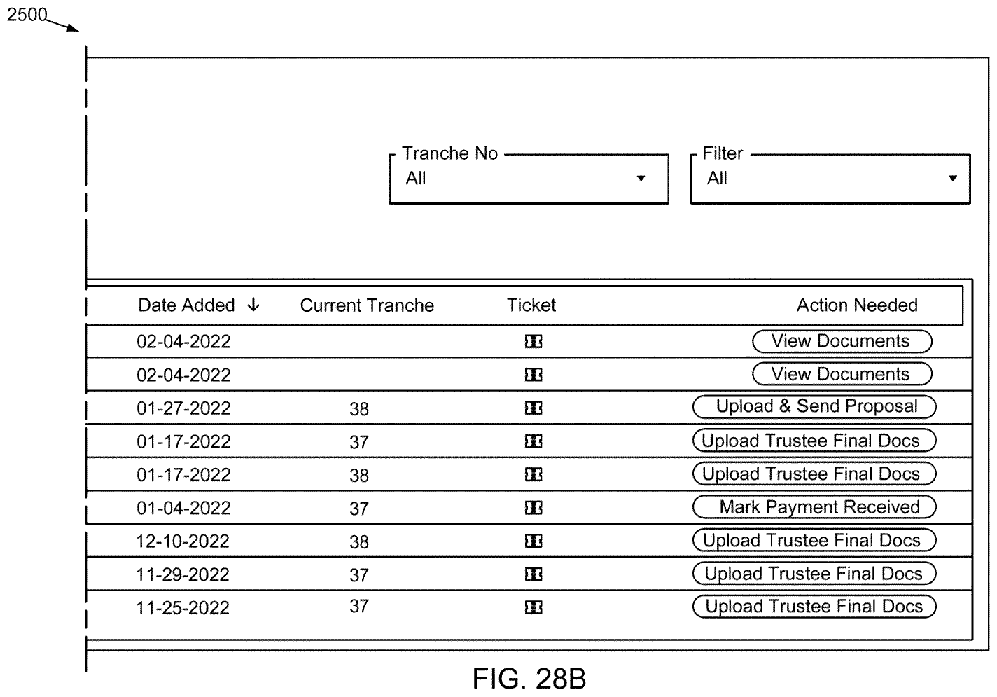

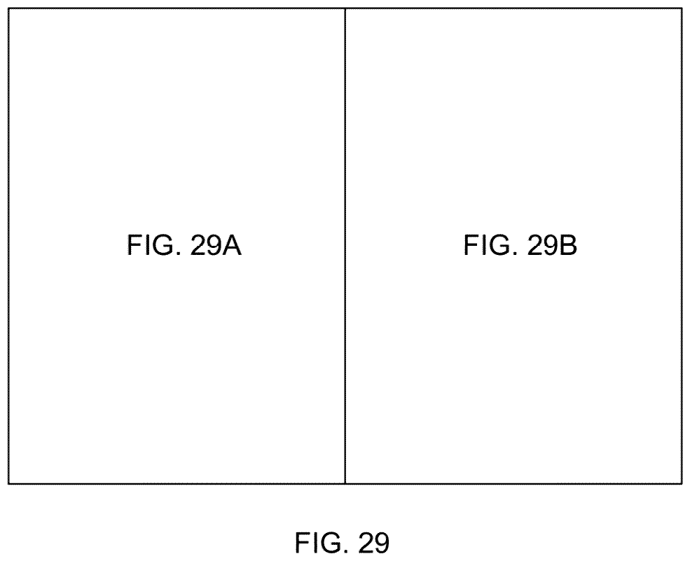

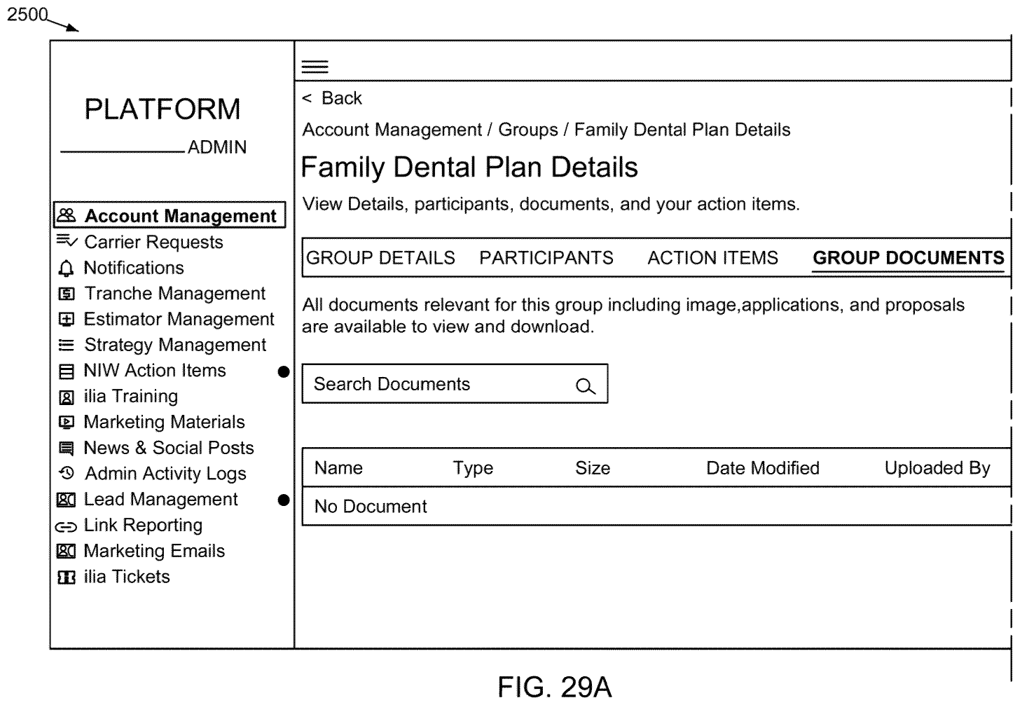

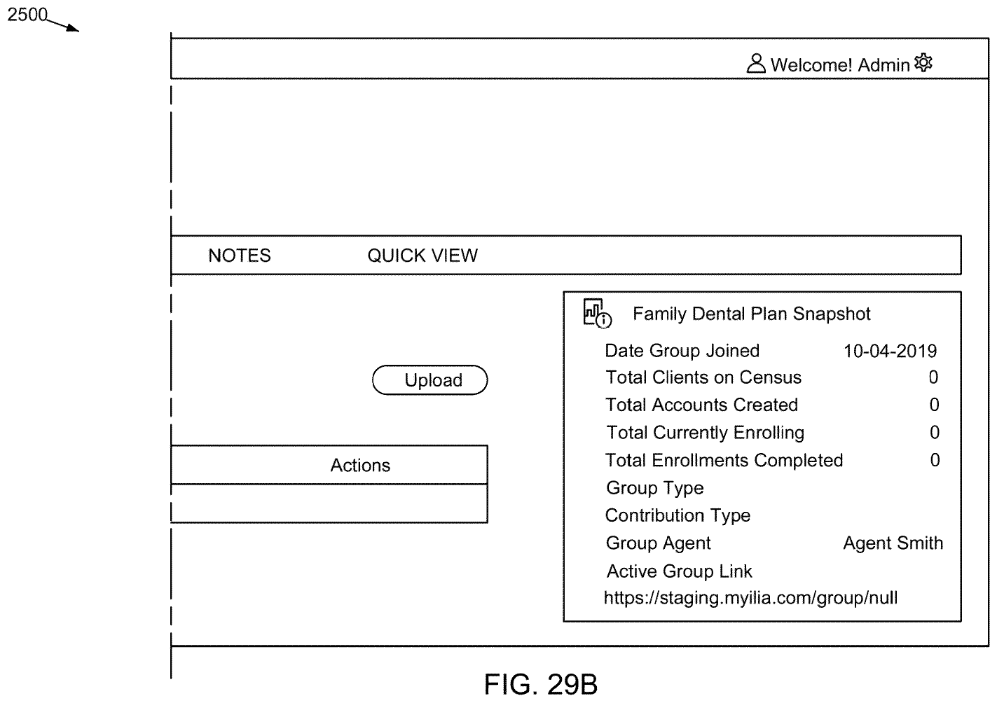

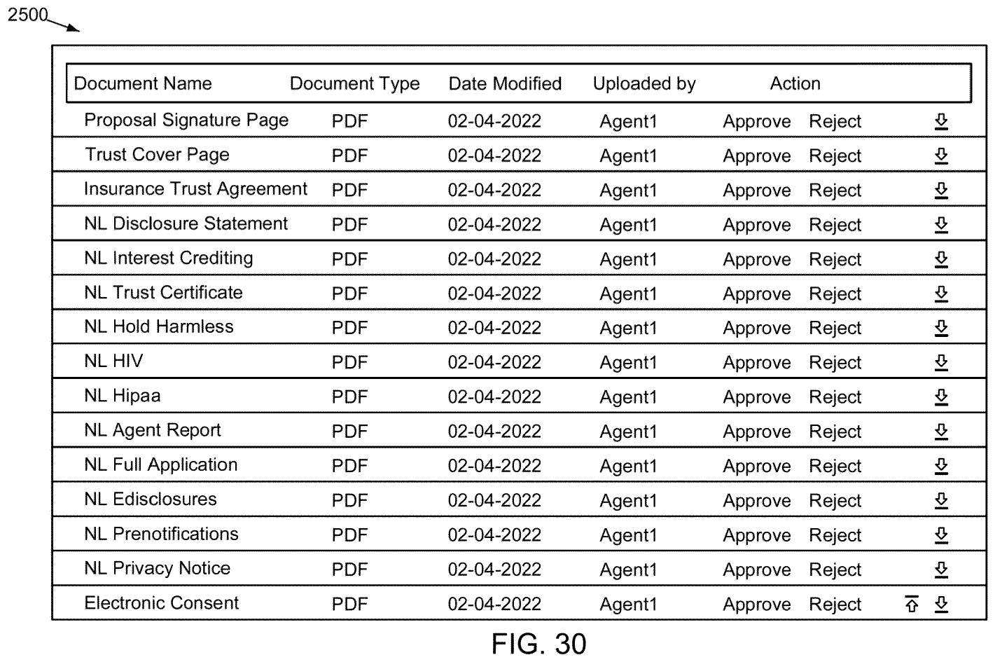

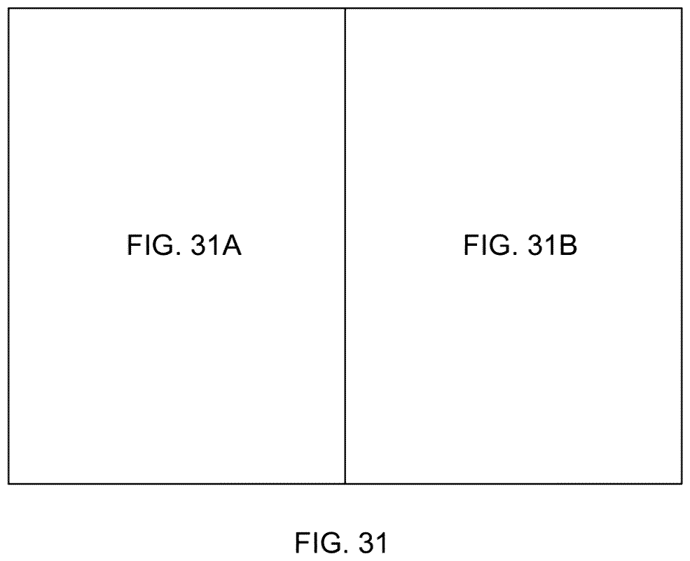

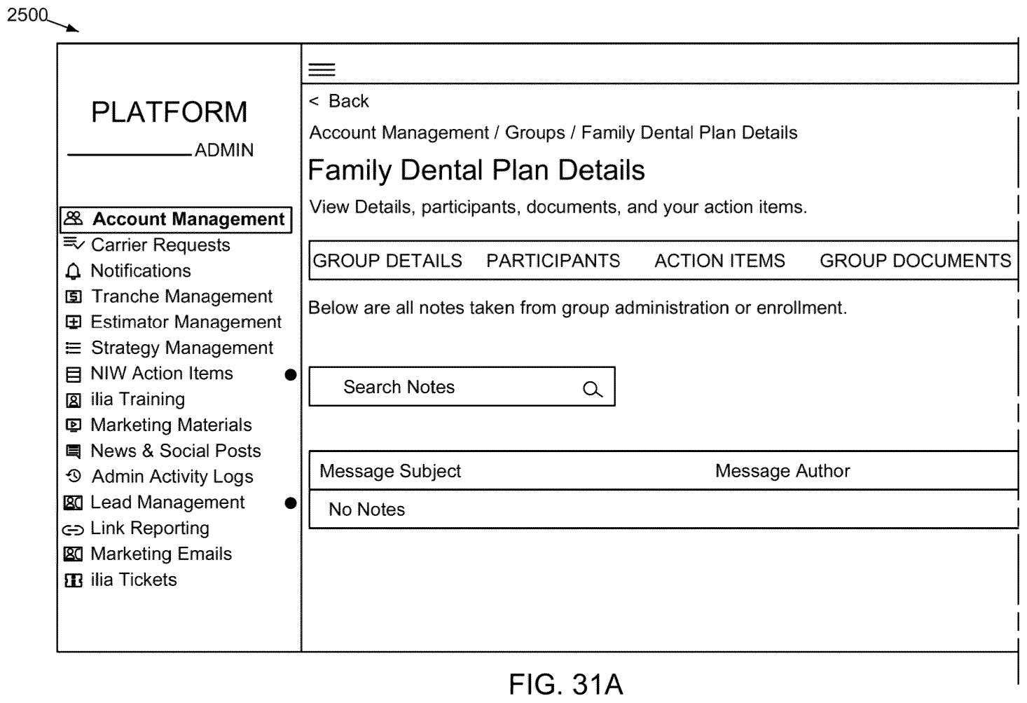

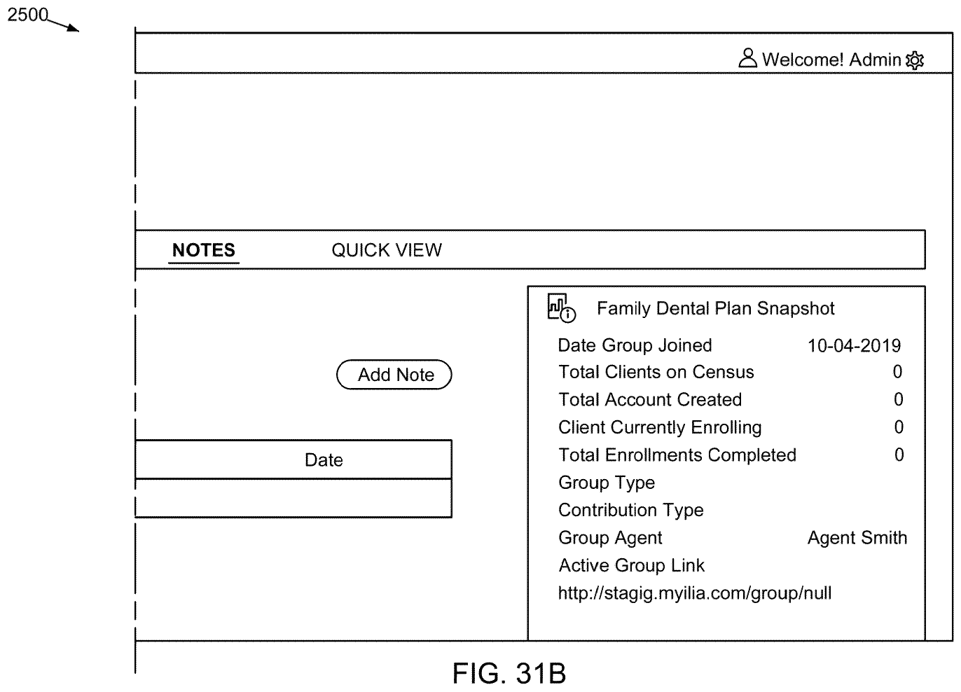

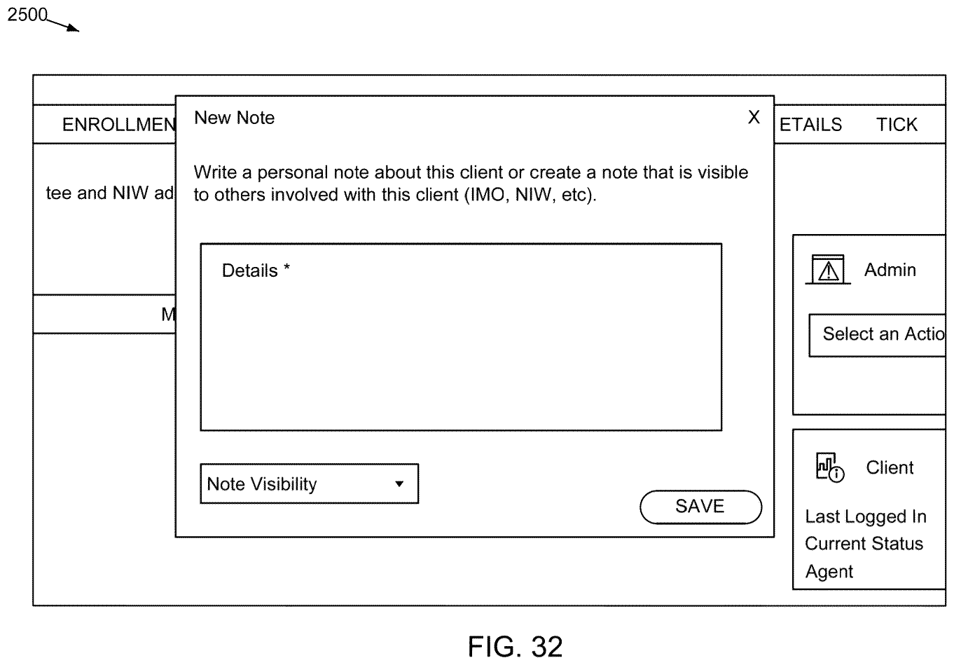

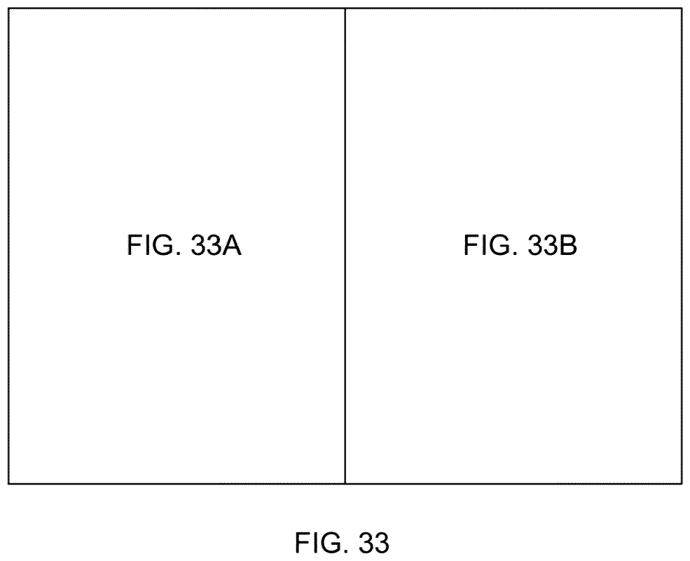

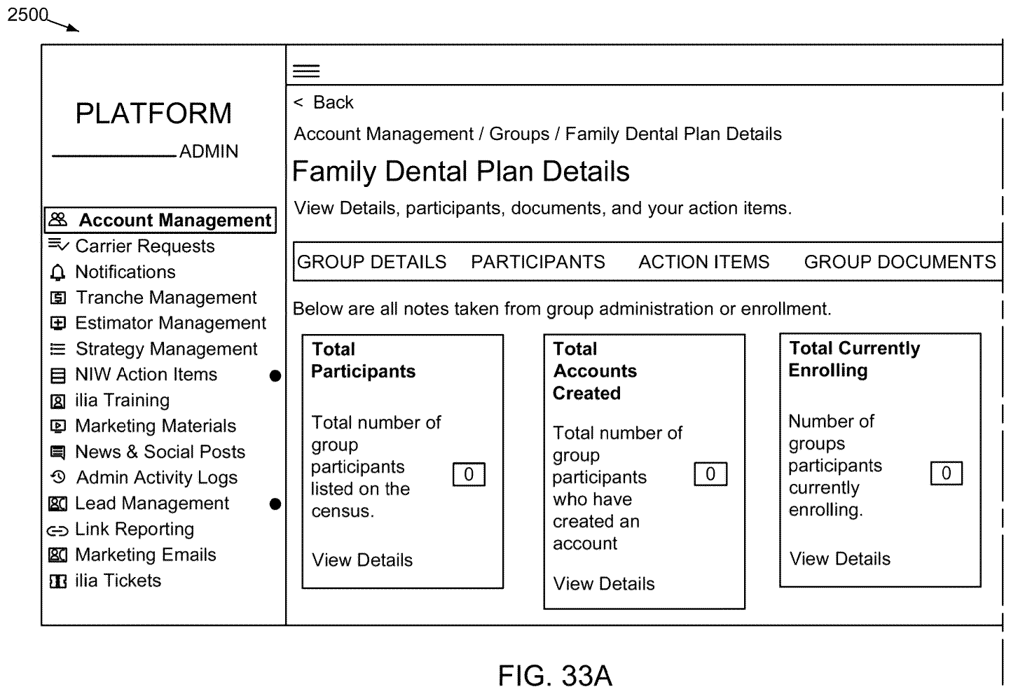

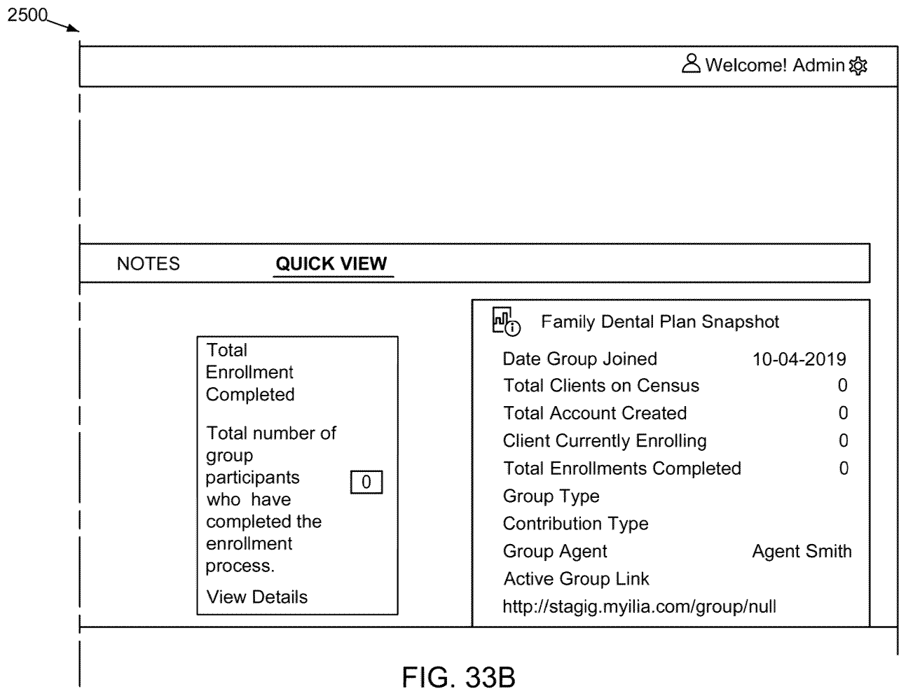

Referencing FIGS. 27-32 an example group display (“Family dental plan” in the example) is schematically depicted on a user interface 2500, with FIG. 27 divided into FIGS. 27A and 27B, FIG. 28 divided into FIGS. 28A and 28B, FIG. 29 divided into FIGS. 29A and 29B, and FIG. 31 divided into FIGS. 31A and 31B, which may be accessed through a census, a listing of groups, or the like. The example of FIGS. 27-28 supports an automated workflow, for example providing an action item list of actions that are pending and/or completed relative to the group. In the example, FIG. 28 may be displayed in the information portion on FIG. 27 (e.g., below “Action Items”), and/or may be displayed in response to a user action (e.g., clicking on “Action Items”). In the example, the user can readily determine the status of activity for each primary user (e.g., client user), or for any other user type if applicable, including whether documentation is completed, application information is complete, whether the user has a help ticket or request pending, where the process may be stuck if it is not ready, and the like. The information from a display such as in FIGS. 27-28 can be utilized to monitor the process, to drive process completion (e.g., utilizing the links and notifications provided on the display), and/or to generate dashboard information for various users on the platform. The example of FIGS. 27-28 is non-limiting, and similar features can be implemented for any group, process steps, or the like. The example of FIG. 29 depicts a documents search field, for example allowing a search for documents related to the group and/or an individual member of the group, allowing for quick confirmation that appropriate documentation is present and completed. The documents field may be utilized with any interface throughout the present disclosure, and is not limited to the group or group member context. The example of FIG. 30 depicts an example document list that may be displayed in the information portion of interface FIG. 29, and/or displayed as a result of selecting the documents tab of FIG. 29. The example of FIG. 31 depicts an optional notes field that may be utilized, related to any aspect of the group display, including selecting the visibility scope of the note, the content and timing of any notification responsive to the note, or the like. The utilization of a notes function may be made with any user interface element throughout the present disclosure, and can facilitate approval stream options for users, informal management of any unusual events related to the platform or a supported process, or the like. In certain embodiments, notes related to a user (e.g., mentioning the user, tagged for the user—which may be user-specific or a user class, etc.) may be accessed on the user's platform interface, in an action items tab, in a notes tab, in a messaging tab, or the like. The example of FIG. 32 depicts a note completion field that may be displayed in the information section of FIG. 31, and/or that may be provided in response to a note selection on FIG. 31. Referencing FIG. 33, an example dashboard is depicted on a user interface 2500, divided into FIGS. 33A and 33B for clarity of the depiction, and related to the group display depicted in FIGS. 27-32, with information that may be of interest to a manager, supervisor, or administrator related to the process and/or platform, and/or which may be filtered for a particular user (e.g., displaying group information for member supported by a particular agent). The availability of information, the layout, and the display of the information may be configured according to the user's permissions, preferences, and the like.

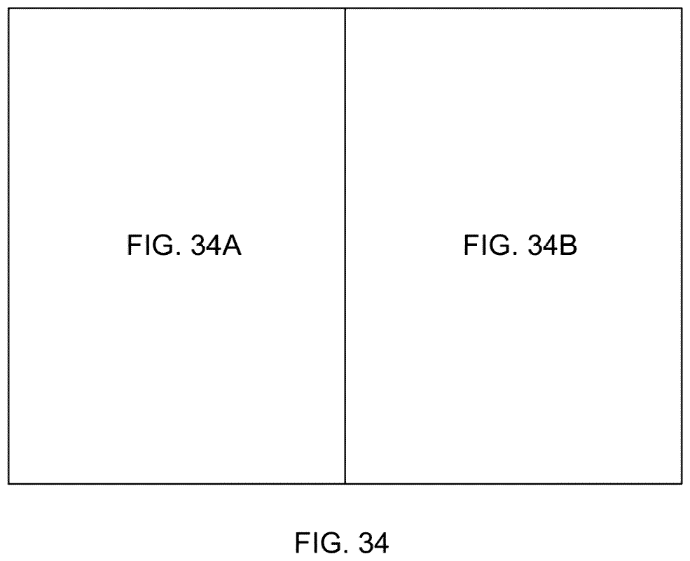

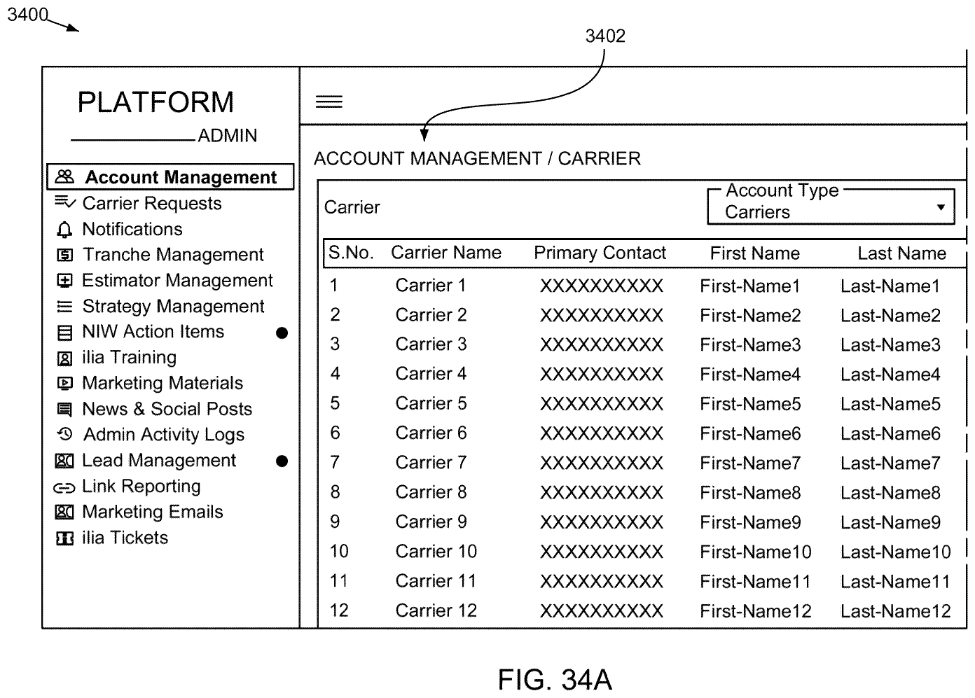

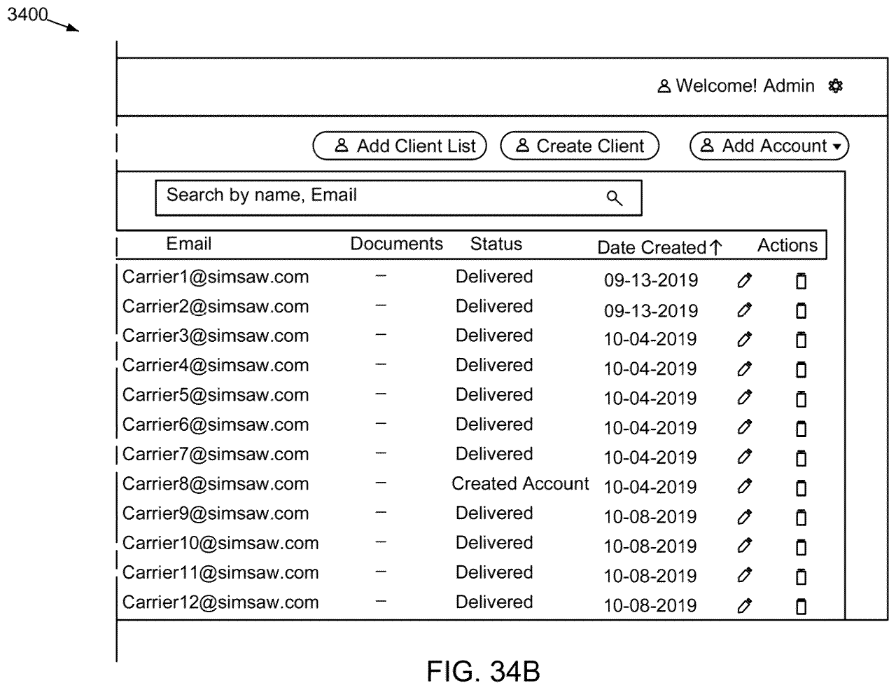

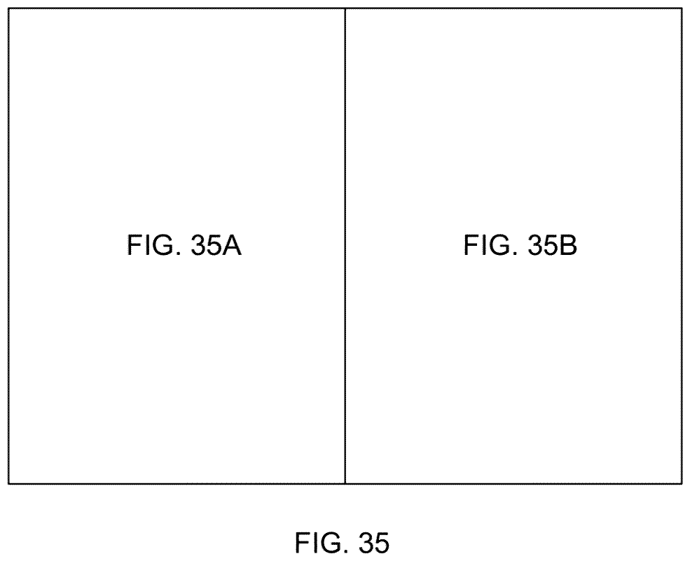

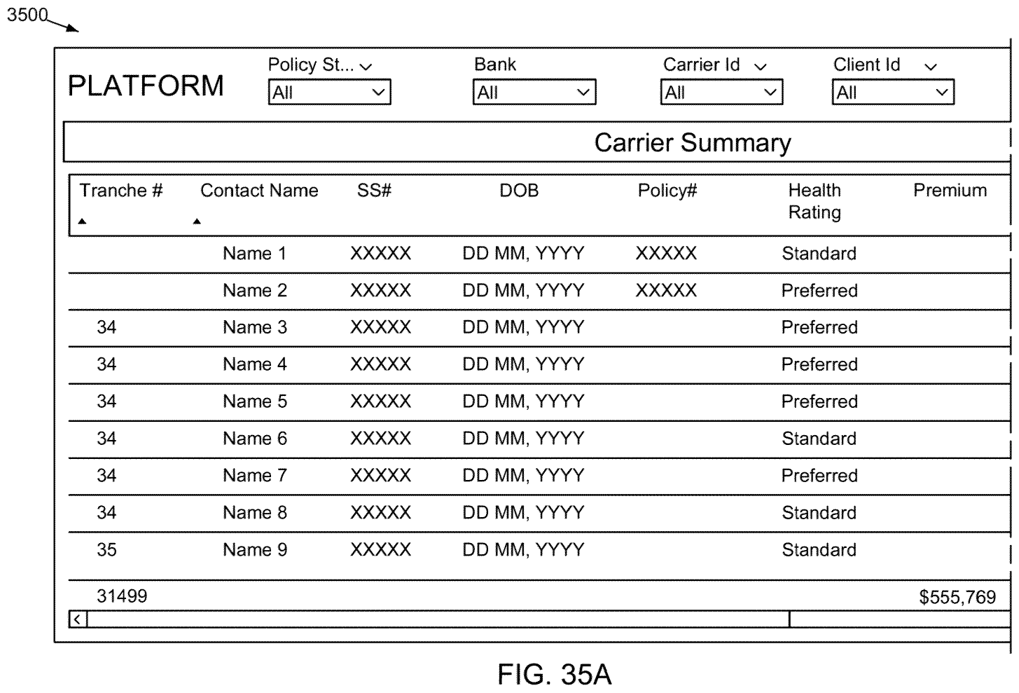

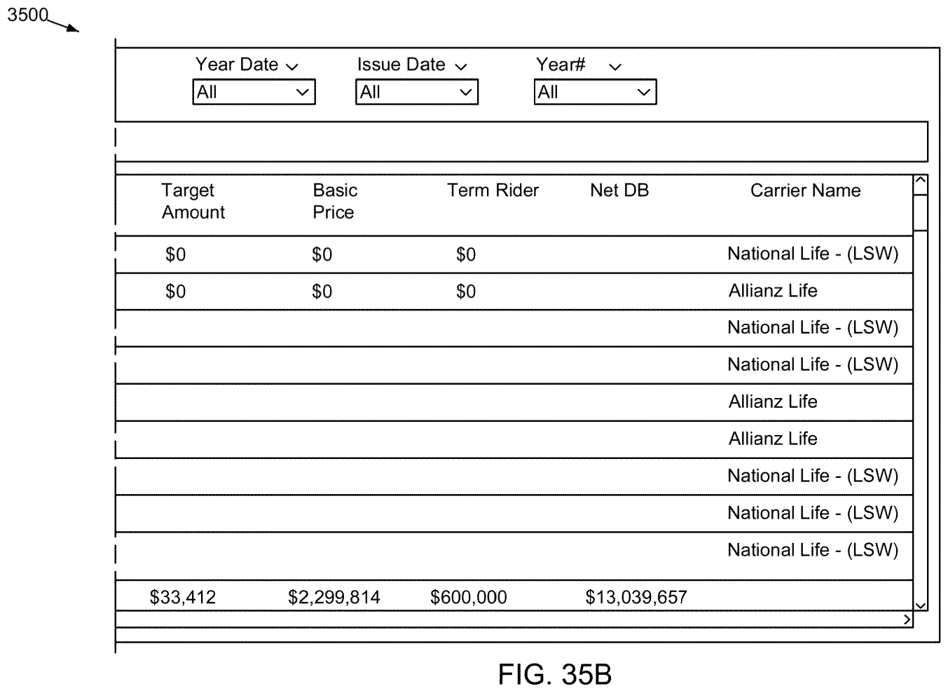

Referencing FIG. 34, an example carrier information interface is schematically depicted on a user interface 2400, divided into FIGS. 34A and 34B for clarity of the depiction. The example information may be pulled from a platform census, a search term, a filtering operation for carriers, or the like. The interface of FIG. 34 depicts carriers for purposes of illustration, but any user type, user class, entity type, or the like may be similarly displayed in certain embodiments. The example of FIG. 35 depicts information for a number of client users on a user interface 3500, divided into FIGS. 35A and 35B for clarity of the depiction, which may be client users associated with a carrier (e.g., selected on FIG. 34), or any other group of client users generated through any operations with the platform (e.g., a detail from a data visualization, a search term response, a filtering response, etc.). The information displayed is configurable according to the goals of the accessing user, their permissions, regulatory requirements, and the like, including according to any operations set forth in the present disclosure. The carrier information interface may be utilized similarly with any type of user, such as an IMO, agent, bank, trustee, underwriter, or the like, depending upon the user classes, associated entities, and the like that are present on the platform and/or related to supported processes by the platform. The information interfaces, such as depicted in FIG. 34-35, may be editable (e.g., to change the contact information, authorized persons, etc. associated with the user), and/or may include access to notes, activity links, or the like, associated with the entire group and/or individual listed members of the group.

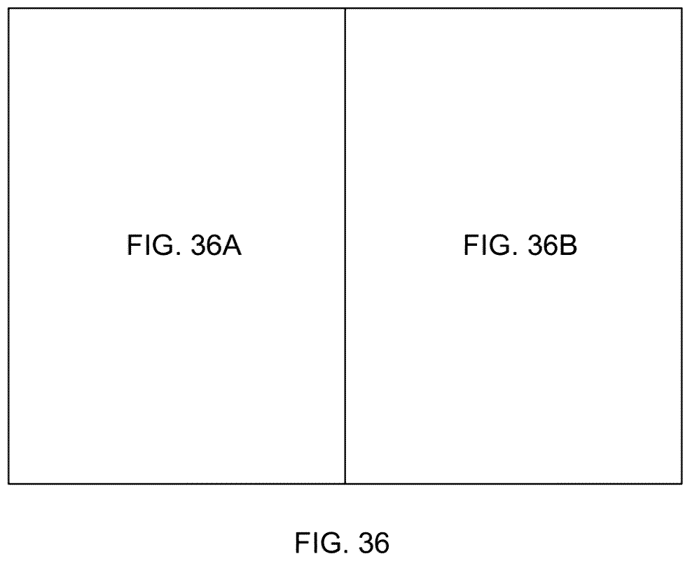

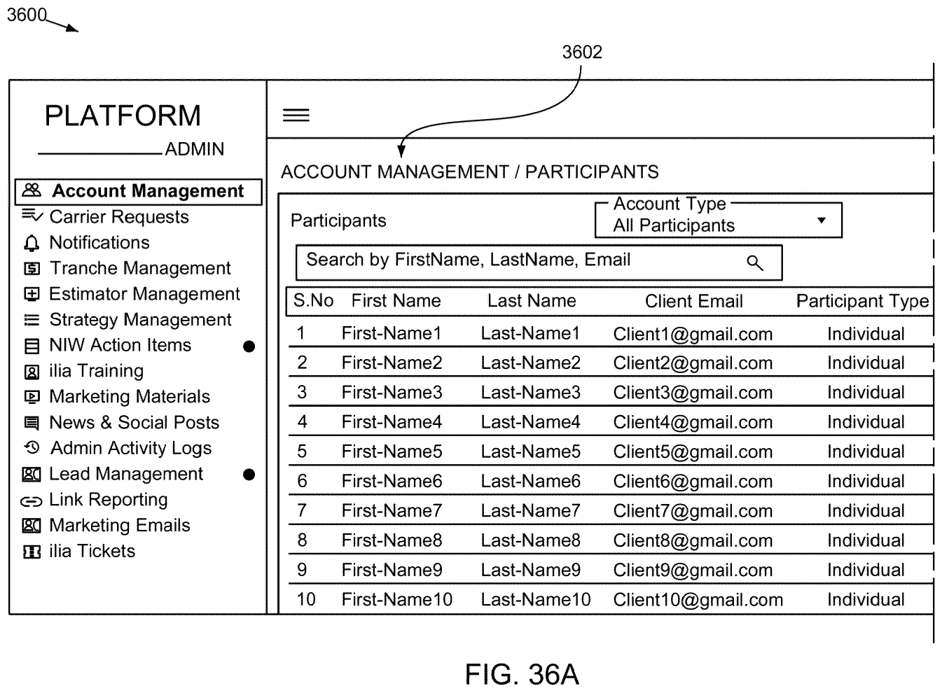

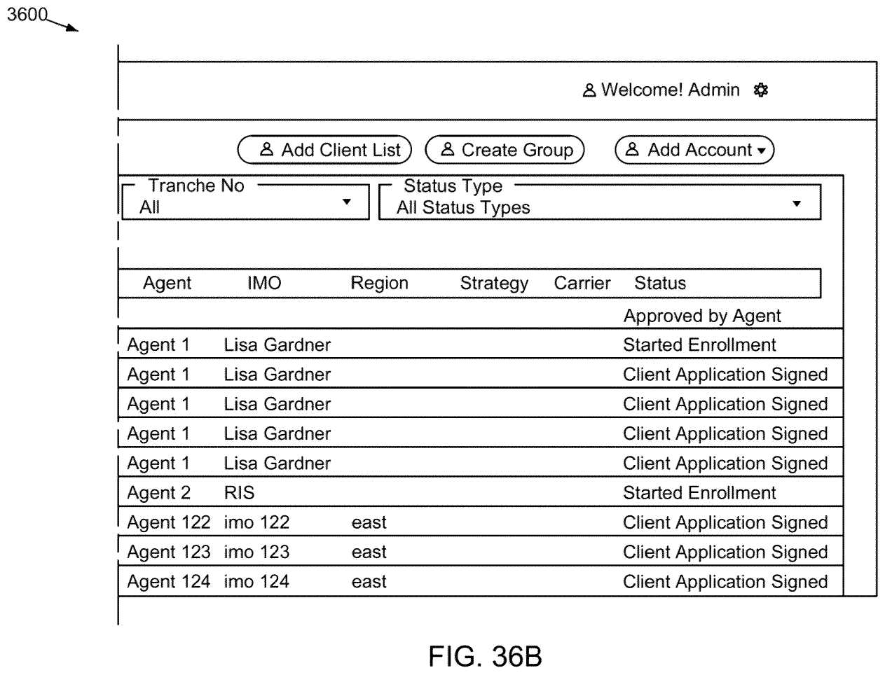

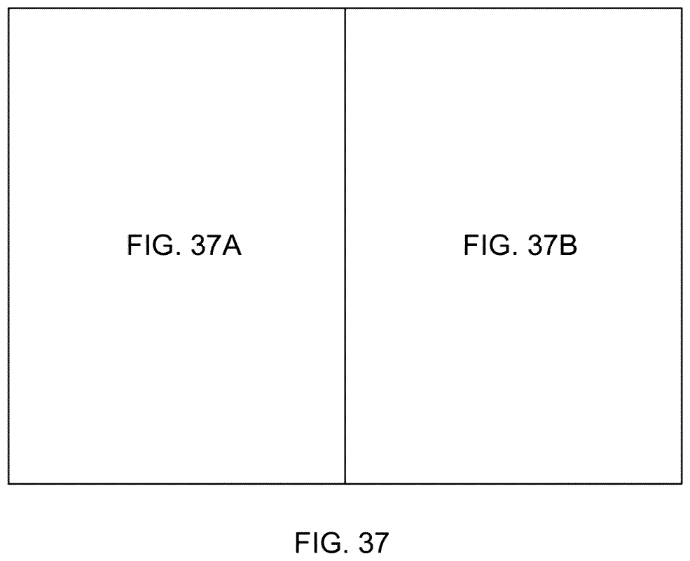

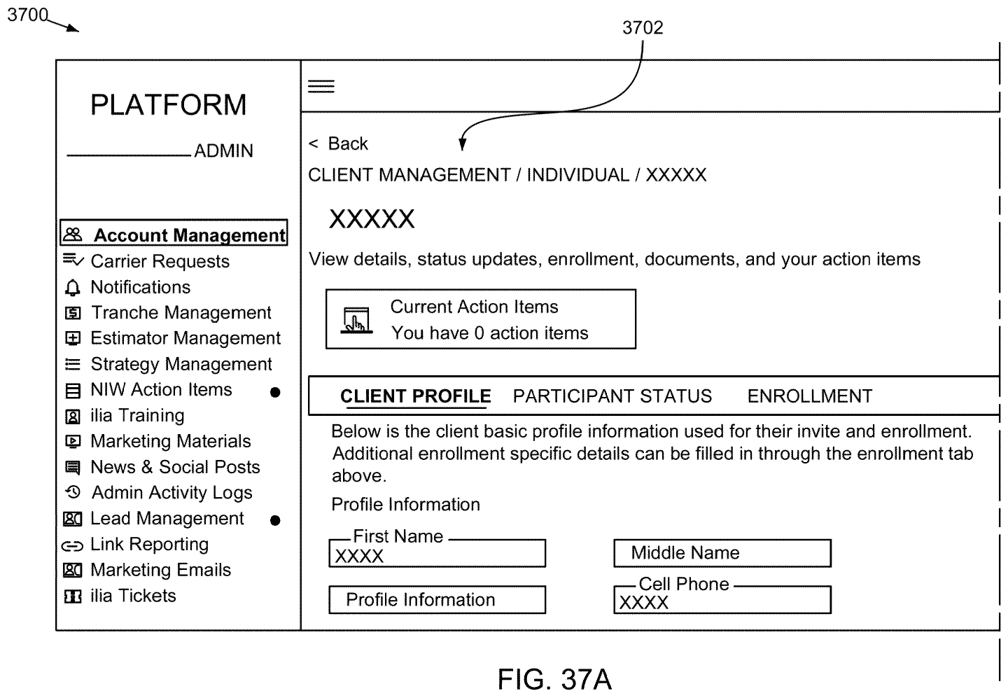

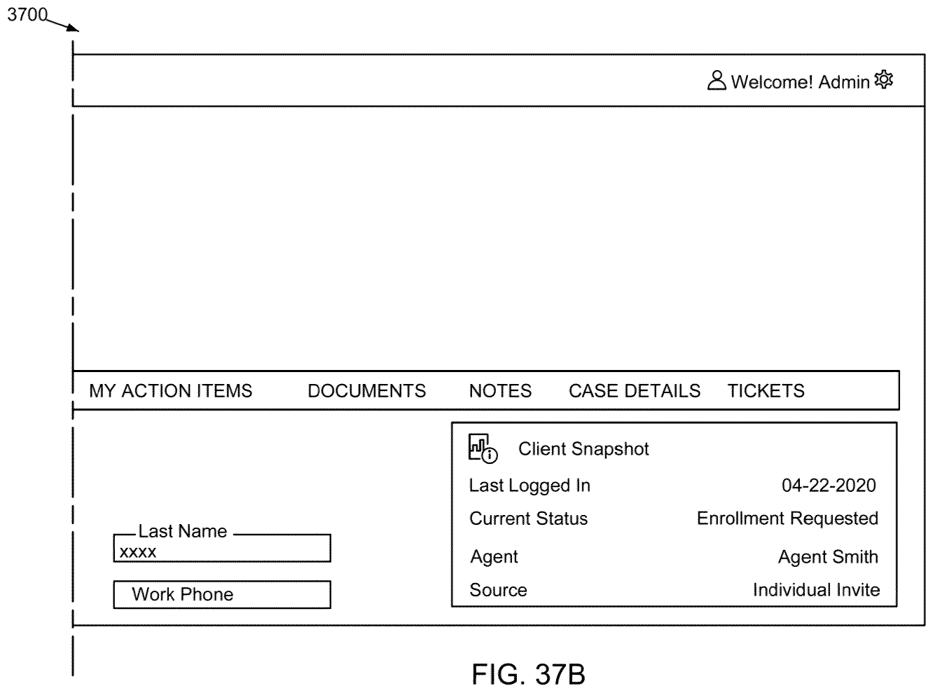

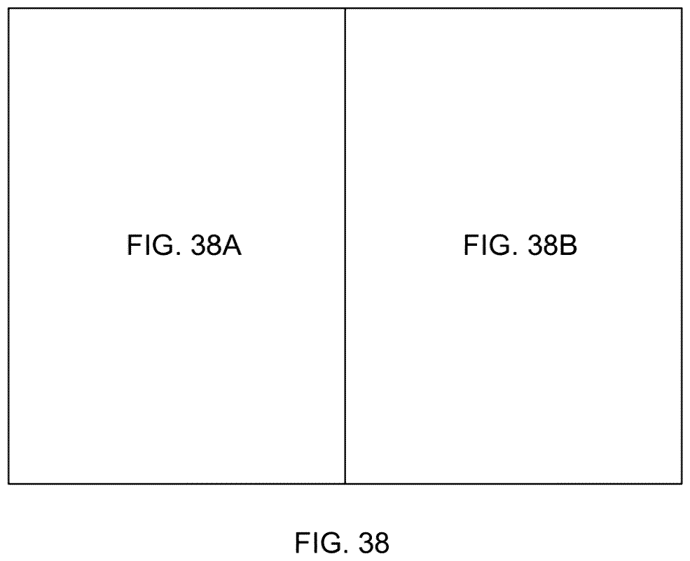

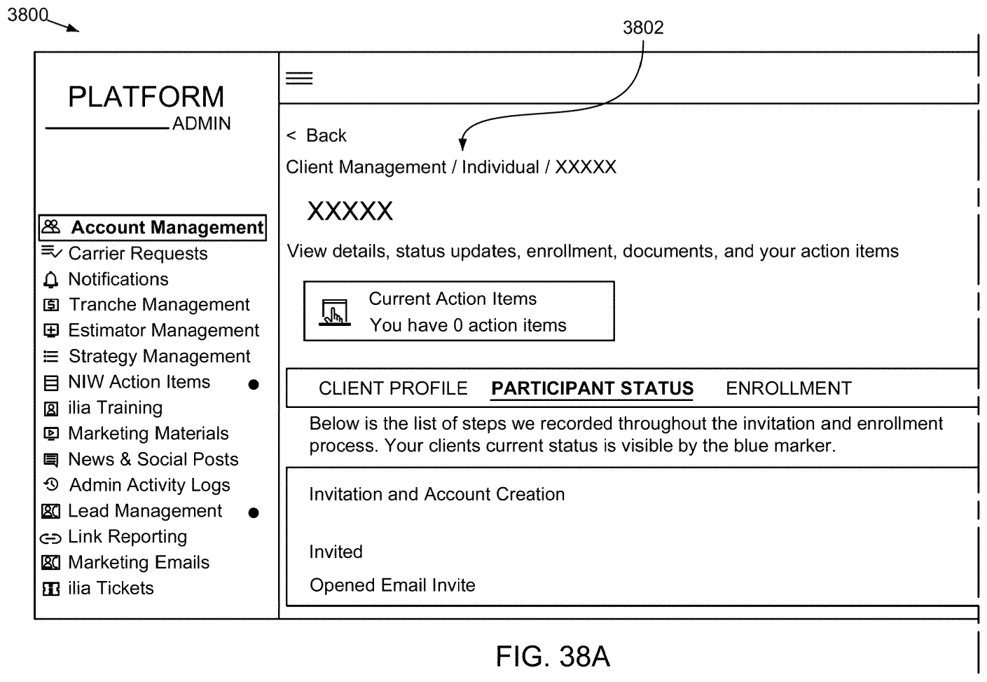

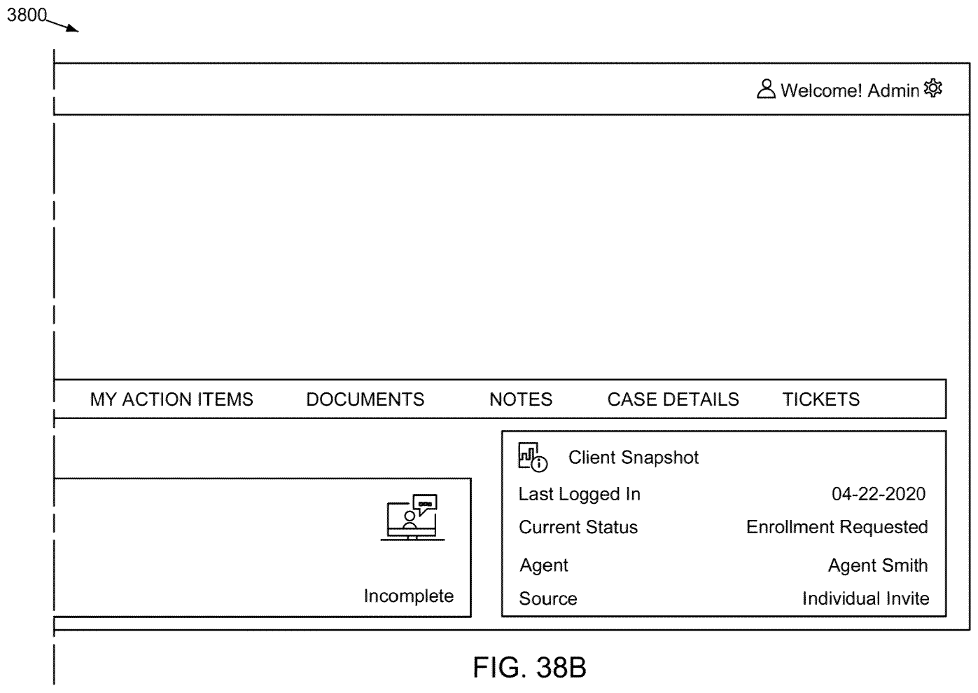

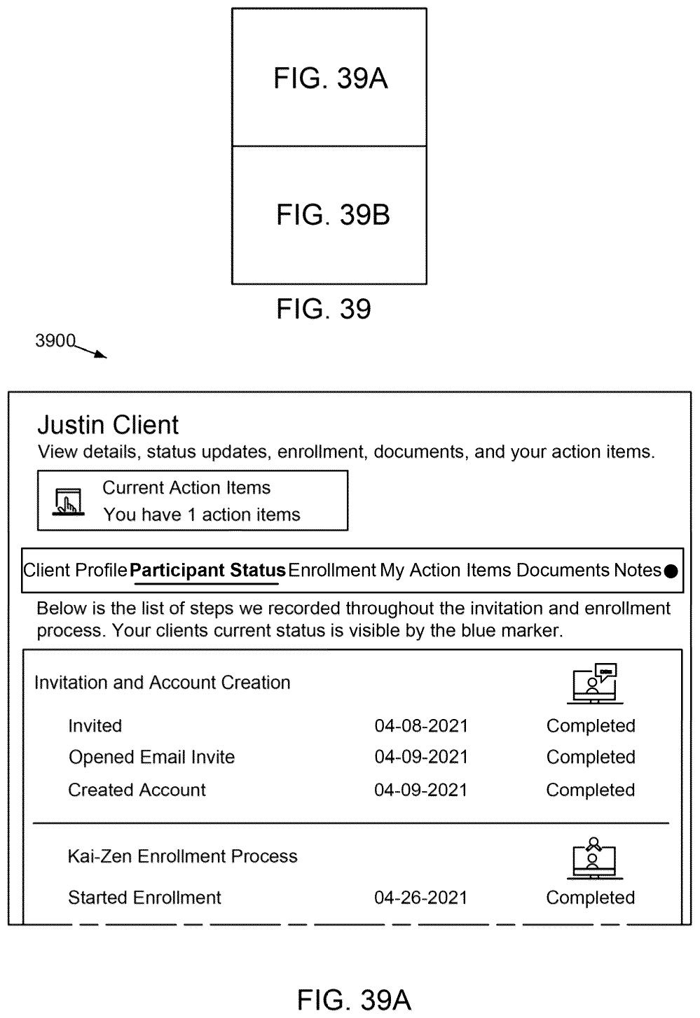

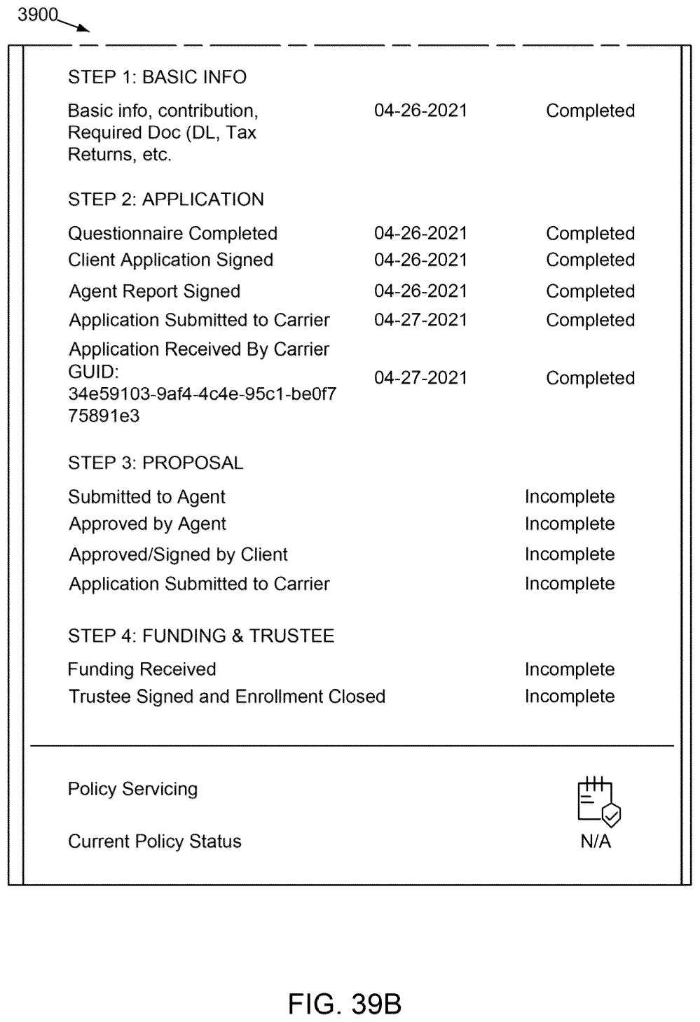

Referencing FIG. 36, an example client listing is depicted on a user interface 3600, divided into FIGS. 36A and 36B for clarity of the depiction, for example a group of clients associated with a carrier, an agent, an IMO, and/or a client listing generated by any manner as set forth herein (e.g., clients having specific products, occupation, income group, asset value group, tranche, etc.). The type of information depicted on the client group is configurable as set forth herein. FIG. 36 includes a descriptive navigation header 3602. Referencing FIG. 37, an example client detail is depicted on a user interface 3700, divided into FIGS. 37A and 37B for clarity of the depiction, for example accessible by selecting a particular client on interface FIG. 36. The example client details are editable and configurable, and may depend on the accessing user (including specific user ID, user type, user class, etc.), permissions, preferences, and/or the linking interface that pulled up the client information (e.g., client information accessed from a revenue summary tab may be distinct from client information accessed from an agent enrollment management tab). FIG. 37 includes a descriptive navigation header 3702. The example of FIG. 38 is a further client detail depicted on a user interface 3800, divided into FIGS. 38A and 38B for clarity of the depiction, with the “Participant Status” tab selected (compared to the “Client profile” tab selected in FIG. 37). FIG. 38 includes a descriptive navigation header 3802. The example of FIG. 39 depicts another view of a client detail on a user interface 3900, divided into FIGS. 39A and 39B for clarity of the depiction, with additional information related to specific process steps provided thereon.

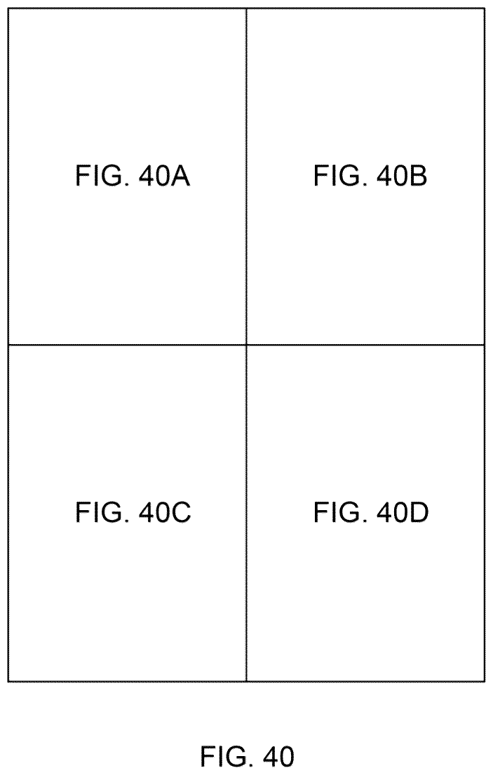

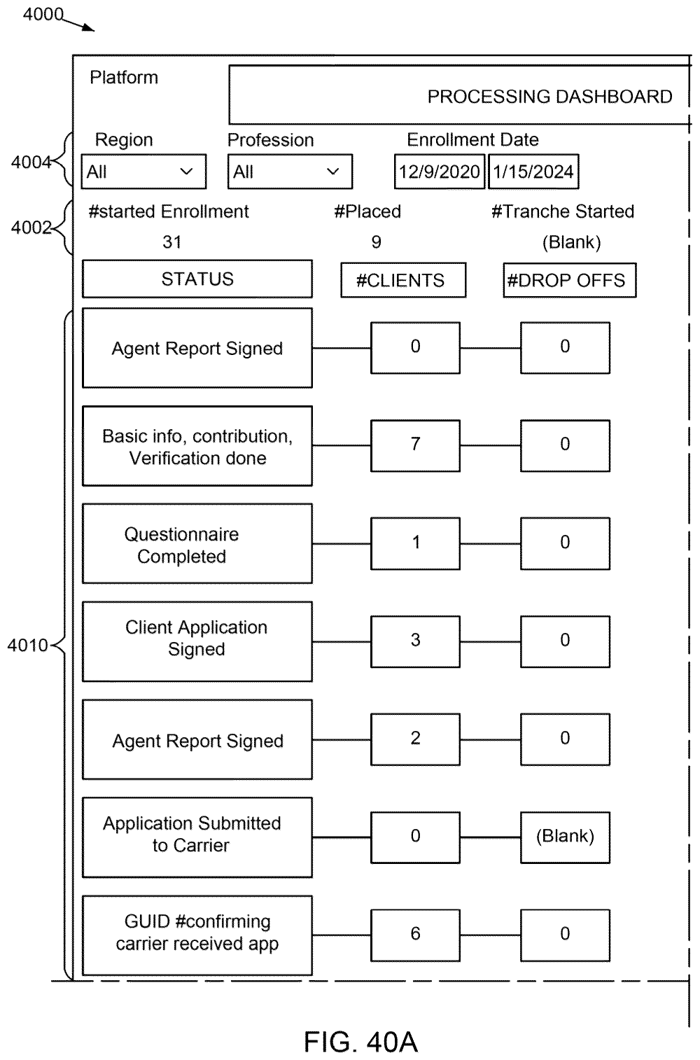

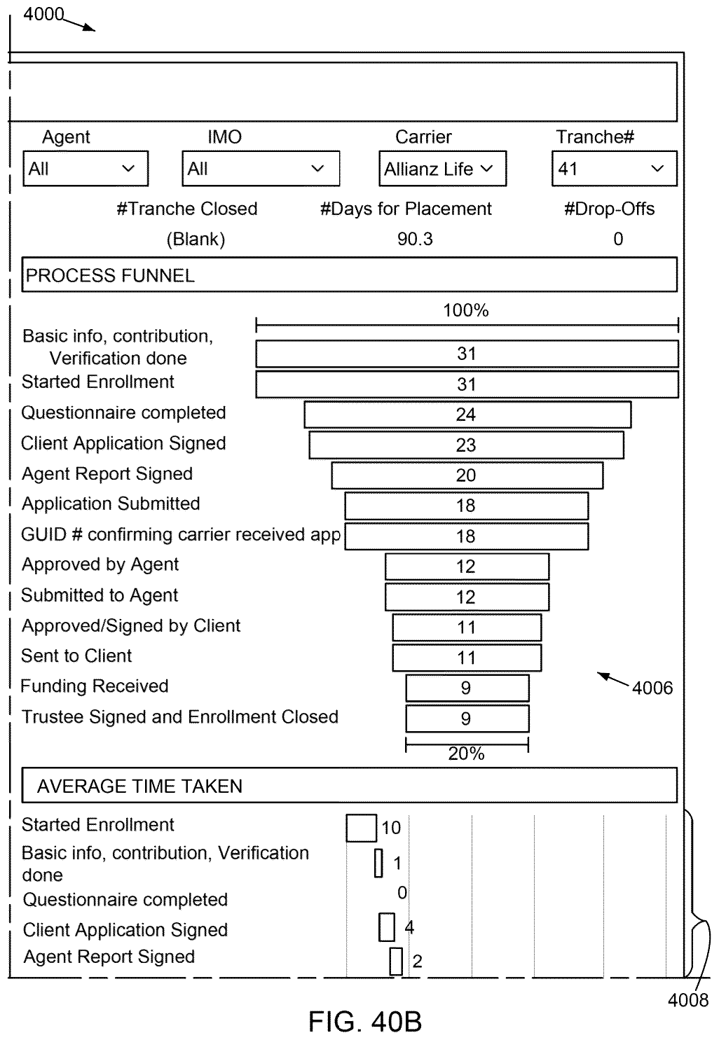

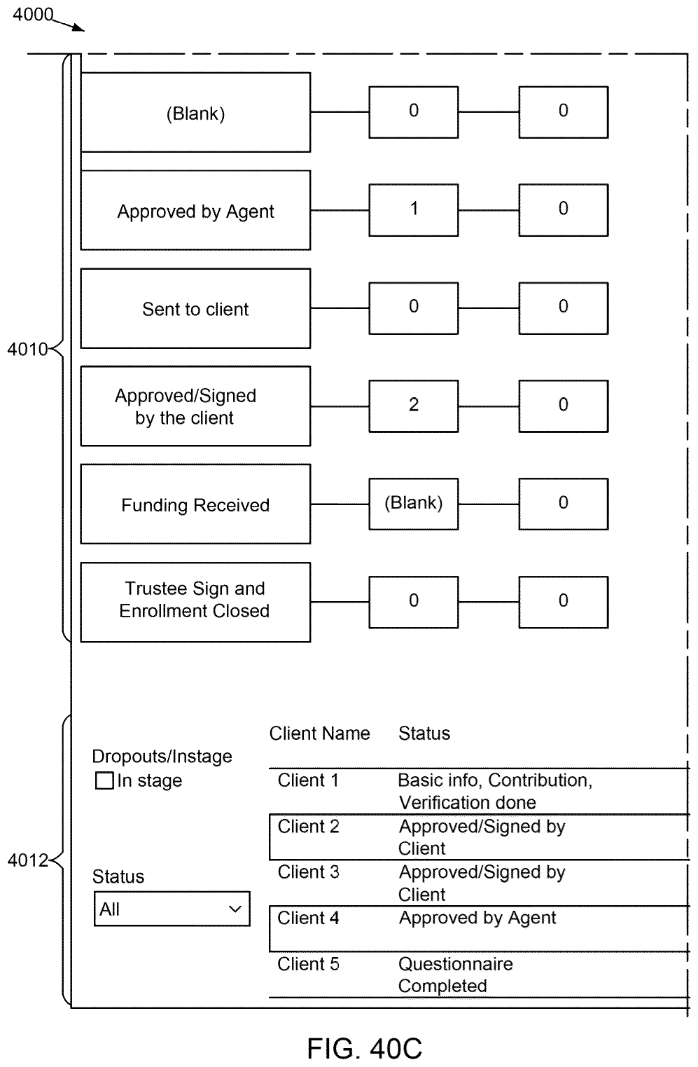

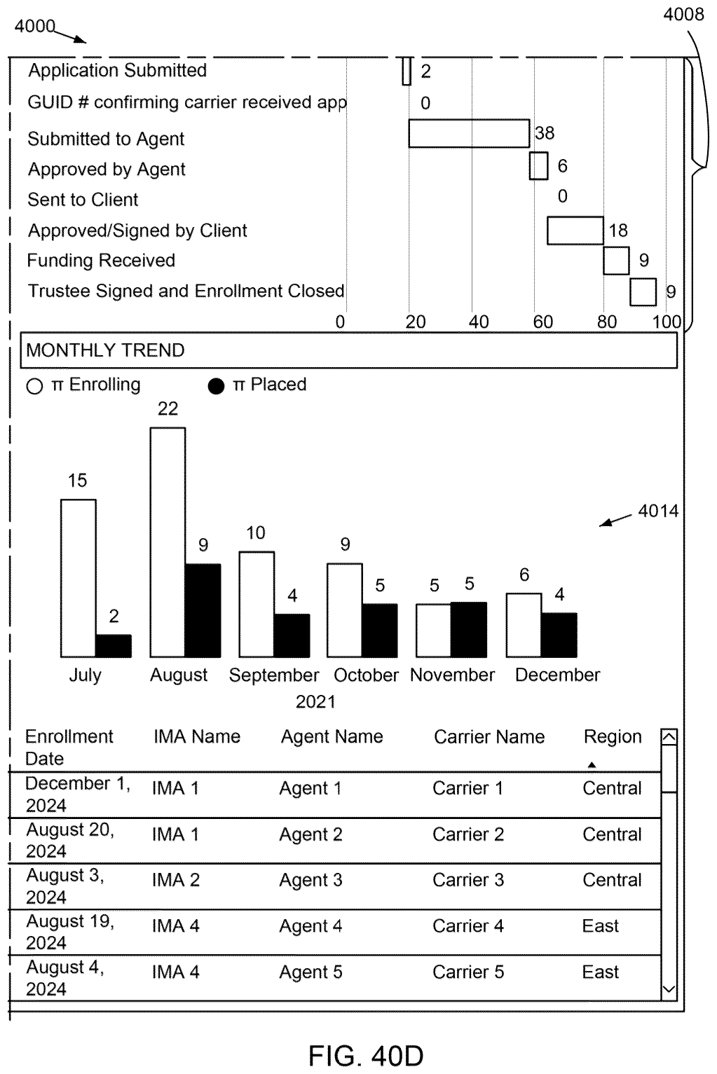

Referencing FIG. 40, an example process overview dashboard is depicted on a user interface 4000, divided into FIGS. 40A, 40B, 40C, and 40D for clarity of the depiction, providing process monitoring information that may be utilized by a carrier, IMO, agent, platform administrator, a group administrator, or the like. The example process overview depicts information for the group in the process, including which steps are completed, which ones are pending, whether group members have dropped out of the process, and the like. In certain embodiments, details around the process steps 4010 can be drilled down into, for example by clicking a process step showing steps where a client dropped out, pulling up details such as documentation and/or recent notifications related to process steps, or the like. In certain embodiments, the process overview dashboard can be filtered or searched (e.g., certain client criteria, attributes, or the like) using tools 4004. The content and interactivity of the process overview dashboard may be configurable, including according to permissions, user role, user type, user class, etc. The example interface 4000 depicts an overall participant progression summary 4002, specific status descriptions 4012, and a data visualizations 4006, 4008, 4014 for enrollment progression, which may include and/or be determined from tranche and/or group analytics and/or metrics.

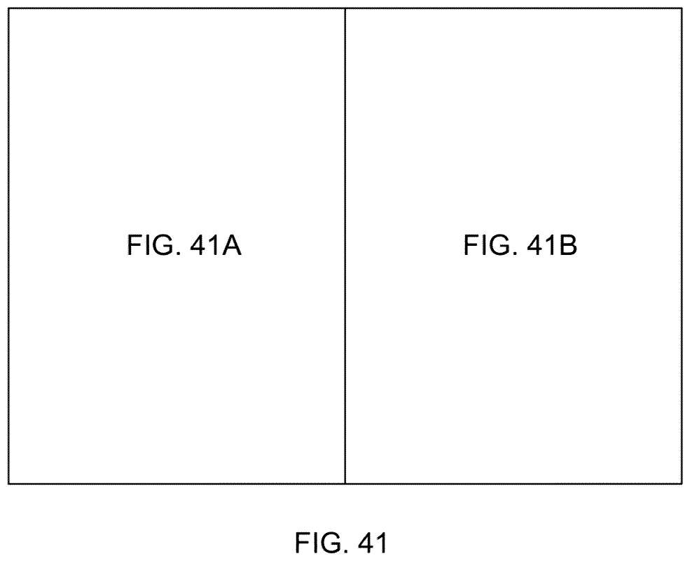

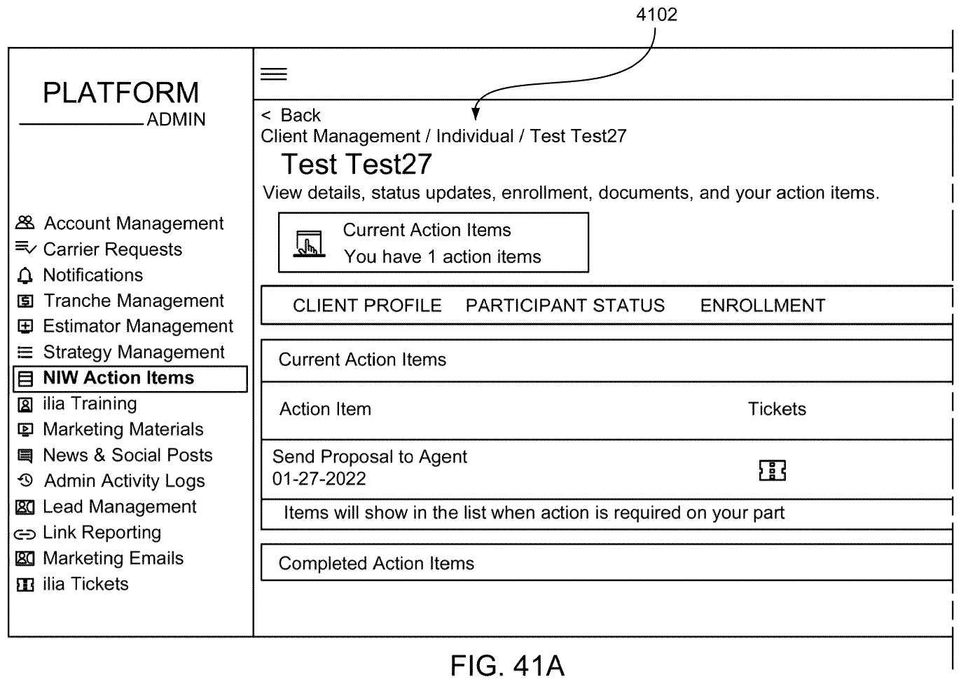

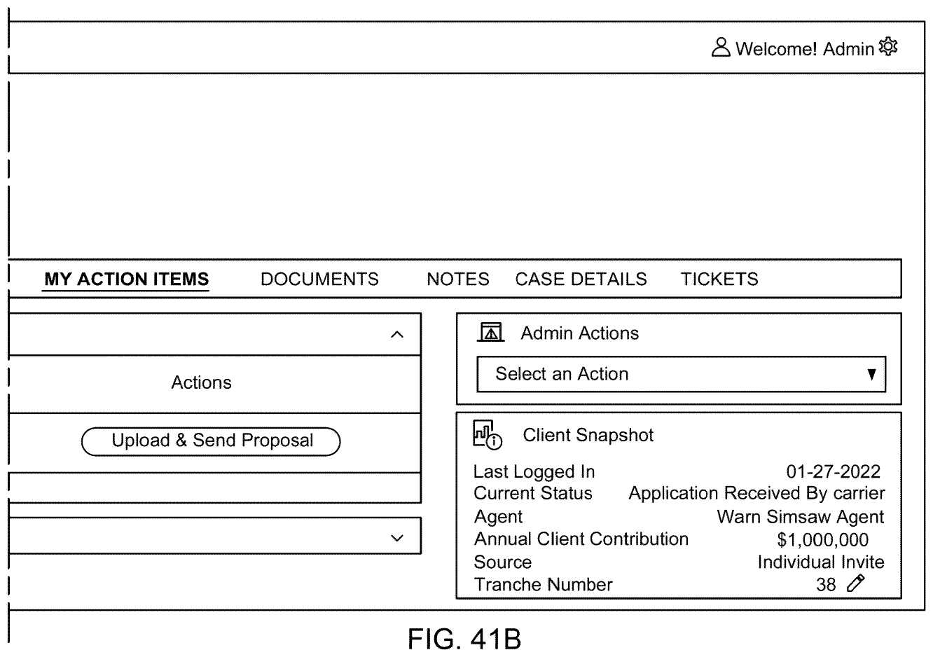

Referencing FIG. 41, an example action tab for a user is schematically depicted on a user interface, divided into FIGS. 41A and 41B for clarity of the depiction, which may be an action for an administrator, approver, or other entity related to the enrollment process for the specific client. For example, an administrator may check documentation for completeness, acceptable signature, etc., before forwarding the documentation on as a part of an application process or the like. The approver and/or administrator accessing the interface of FIG. 41 may be able to look at a global document overview for a selected group and/or for all clients relevant to that approver and/or administrator.

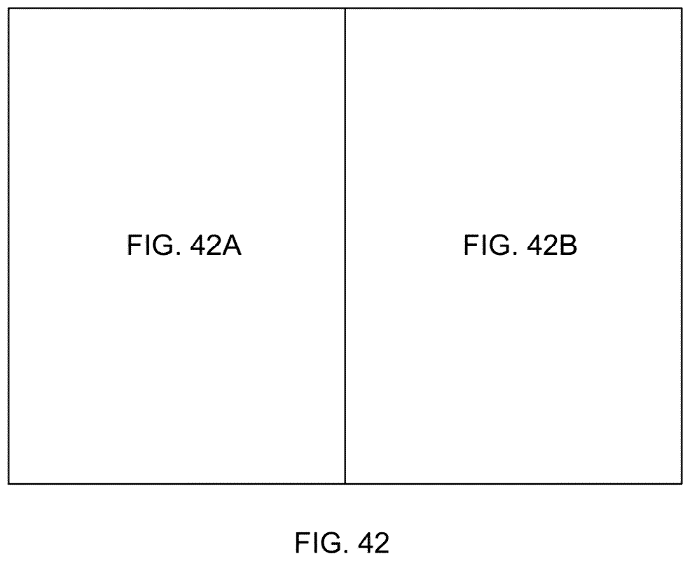

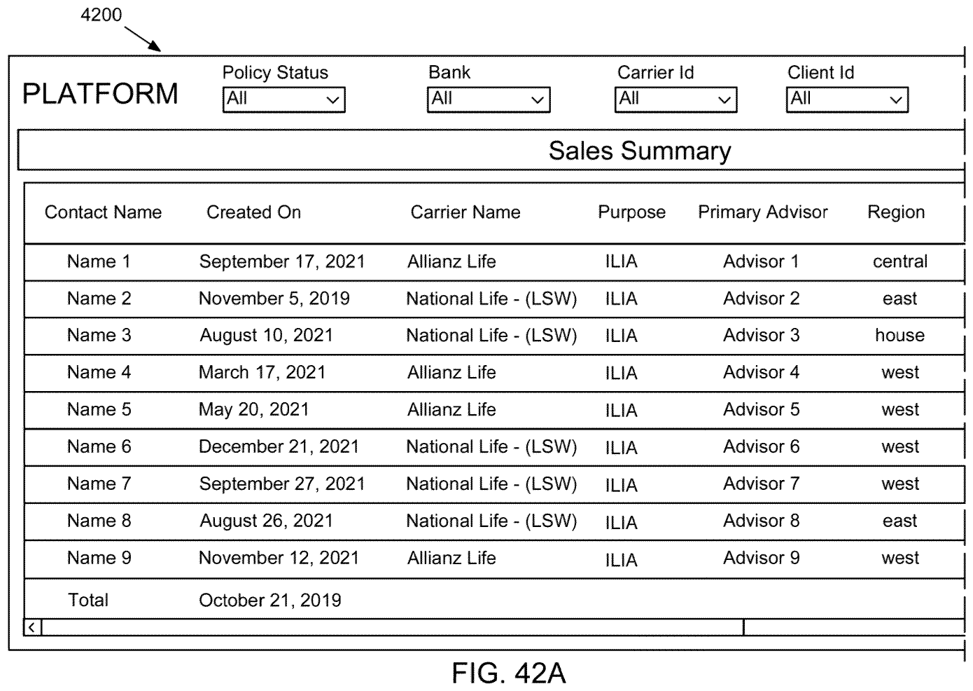

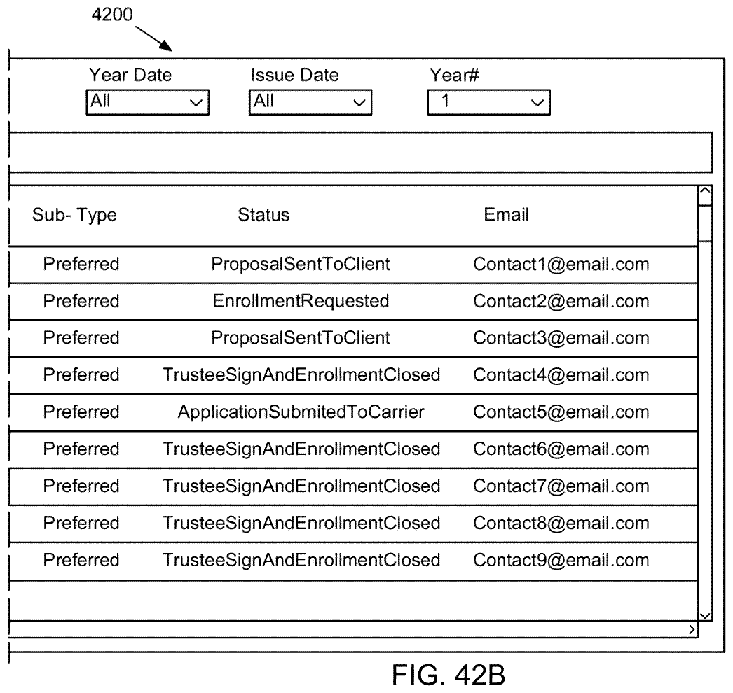

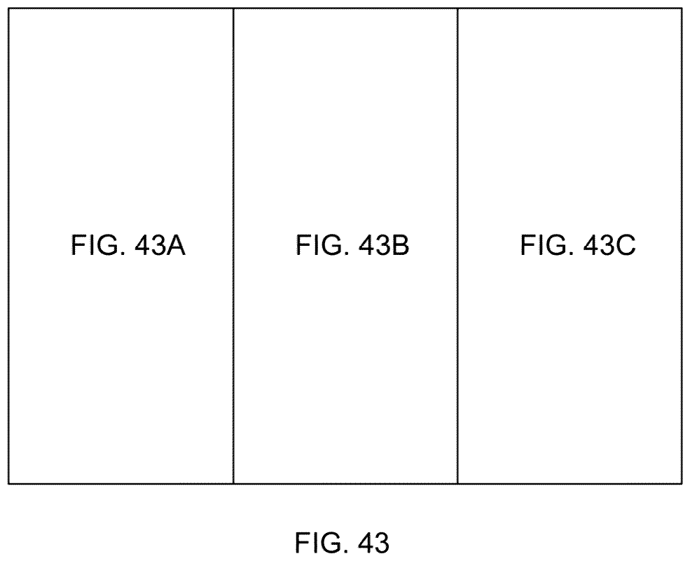

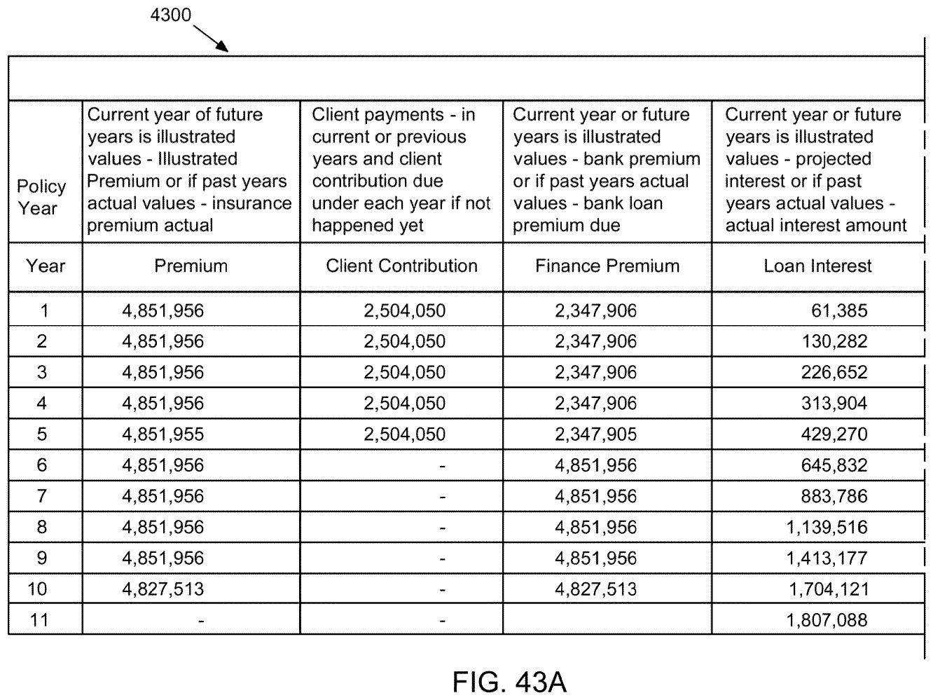

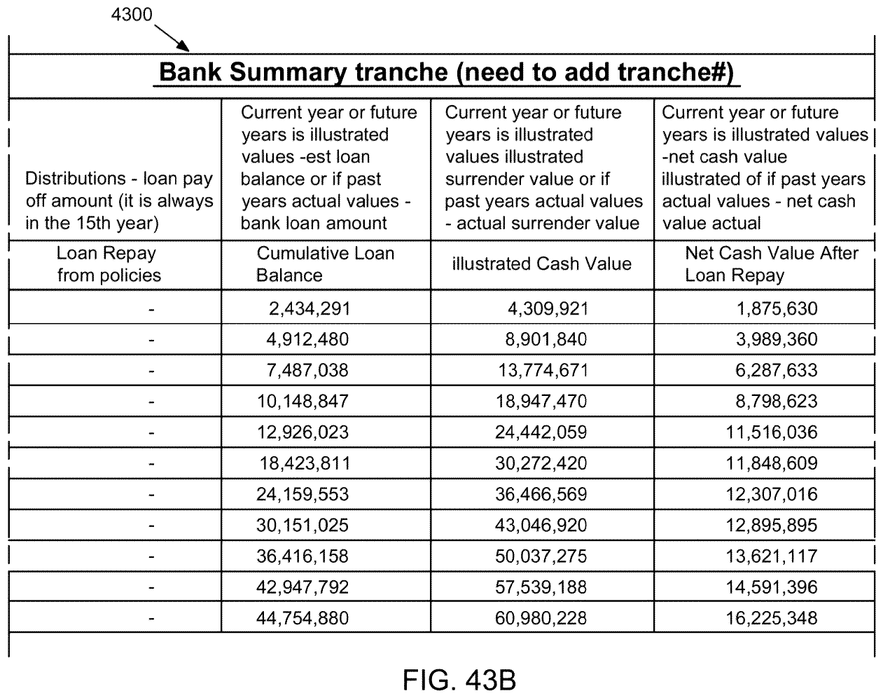

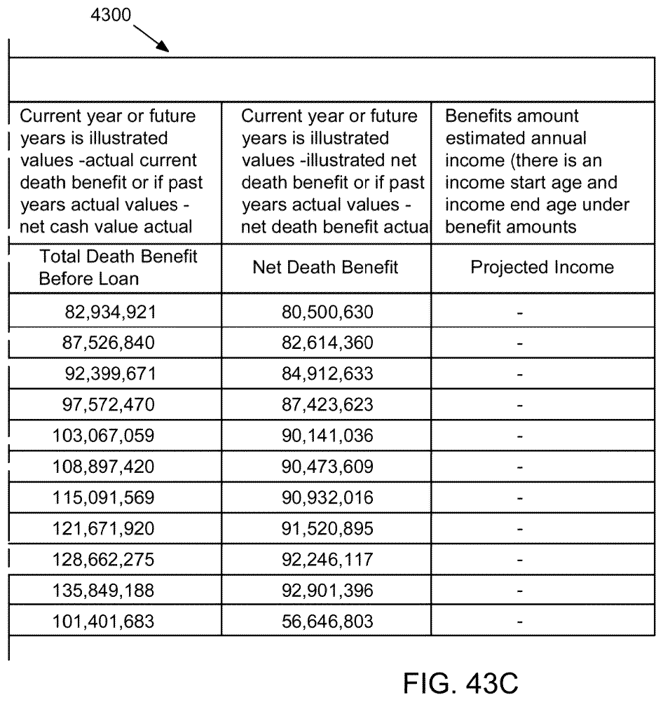

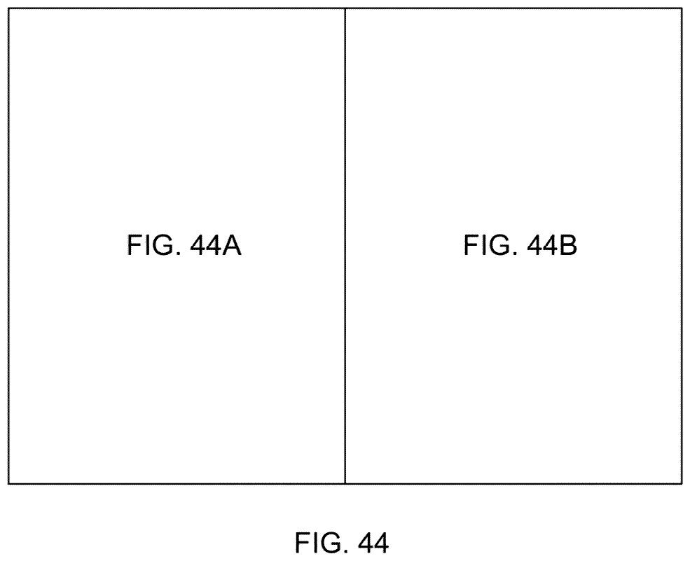

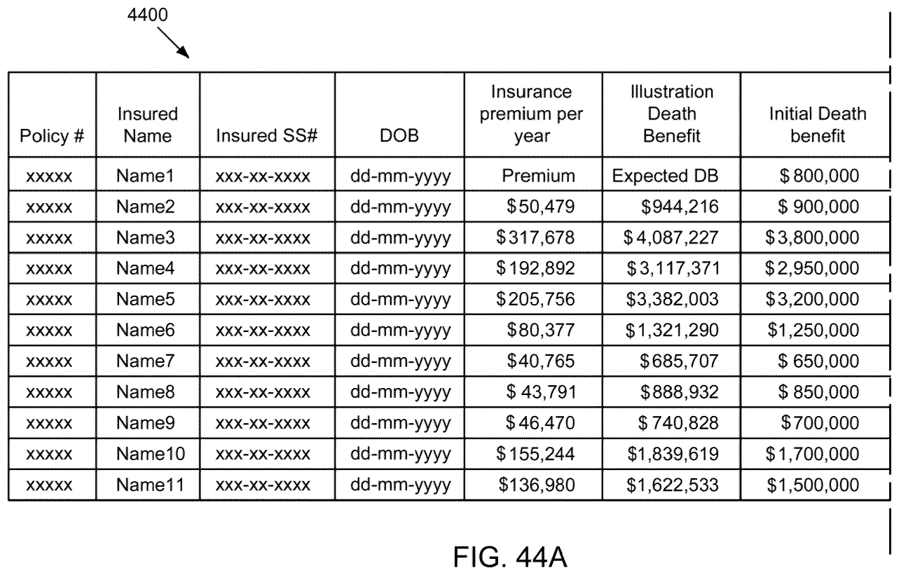

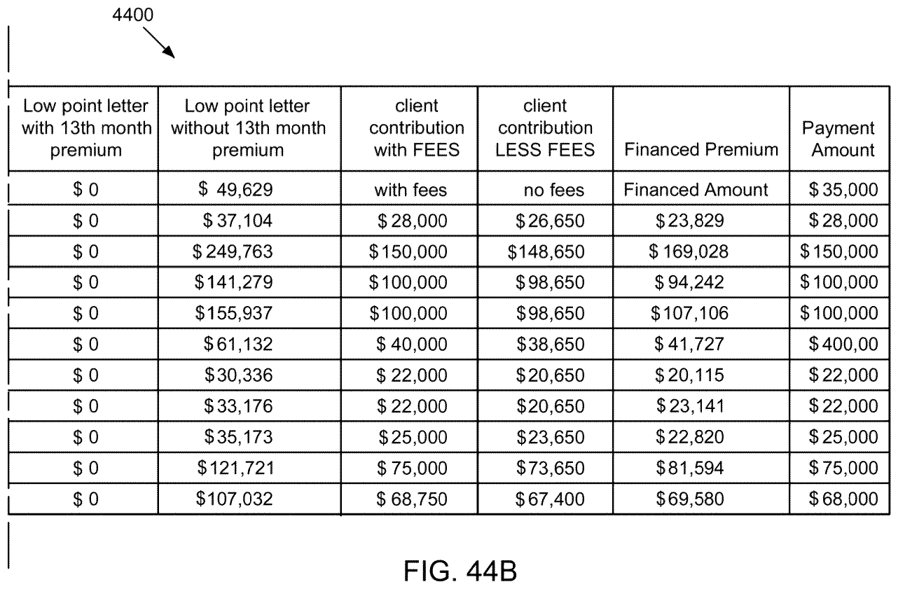

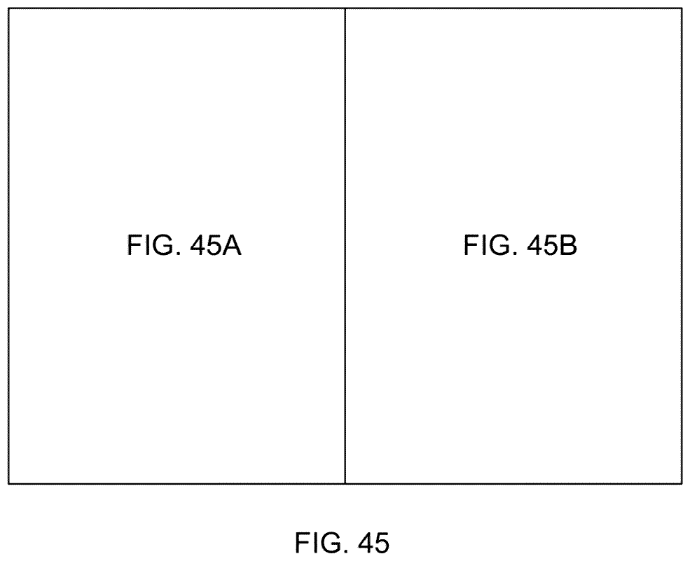

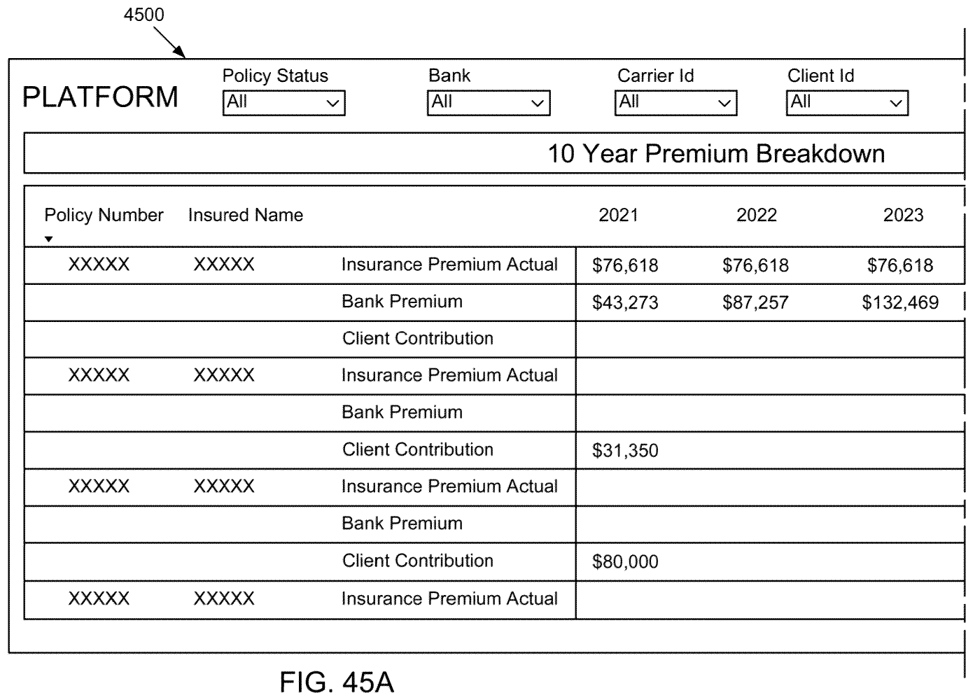

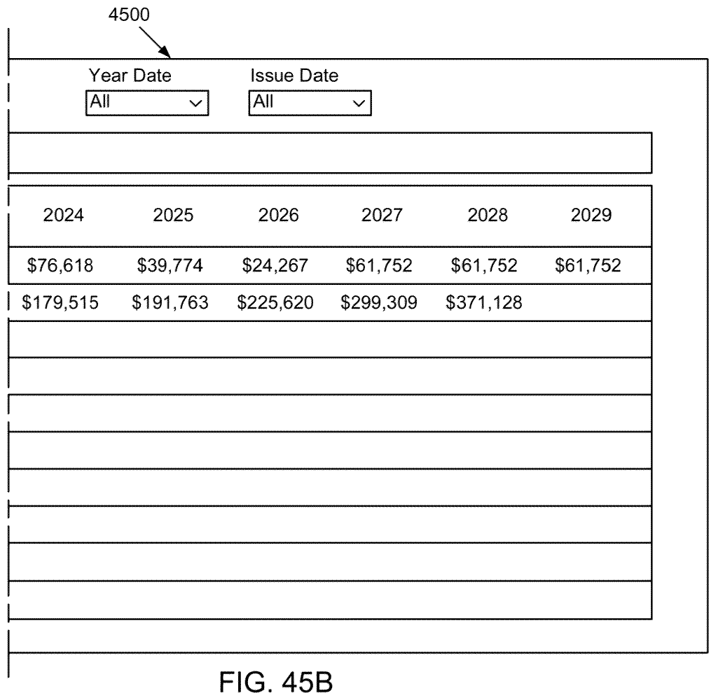

Referencing FIG. 42, an example sales summary is schematically depicted on a user interface 4200, divided into FIGS. 42A and 42B, which may be relevant to a carrier, IMO, agent, platform administrator, or the like. FIG. 41 includes a descriptive navigation header 4012. The example of FIG. 42 includes information about client enrollments, which may be utilized for forecasting, process monitoring, tracking performance of particular agents or products, resource planning, or the like. In certain embodiments, the interface of FIG. 42 may be utilized to track a particular unit of interactions with the process, for example a tranche. Referencing FIG. 43, financial tracking for a tranche is schematically depicted on a user interface 4300, divided into FIGS. 43A, 43B, and 43C, which may be relevant to a carrier, IMO, agent, platform administrator, or the like. The information depicted in interfaces such as FIGS. 42-43 is configurable, searchable, filterable, etc. as set forth throughout the present disclosure. Referencing FIGS. 44-45, an example brief financial overview for a group, such as a tranche, is schematically depicted on user interfaces 4400, 4500, with FIG. 44 divided into FIGS. 44A and 44B, and with FIG. 45 divided into FIGS. 45A and 45B, and which may be utilized and/or configured in a manner similar to that set forth with regard to FIGS. 42-43.

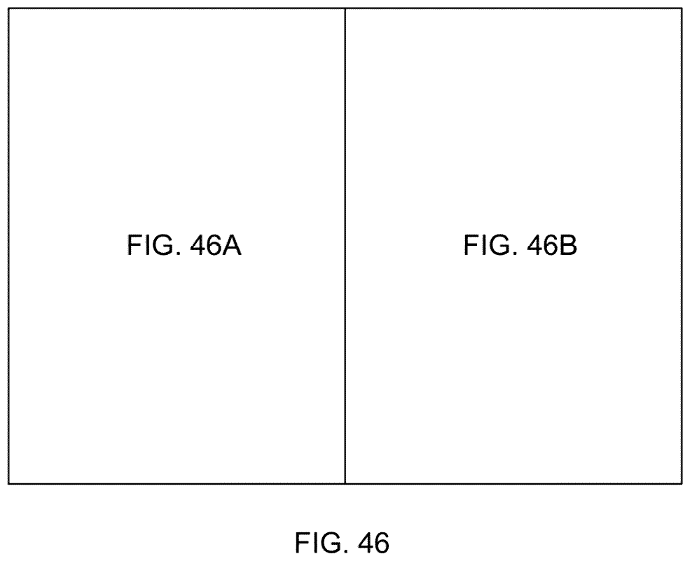

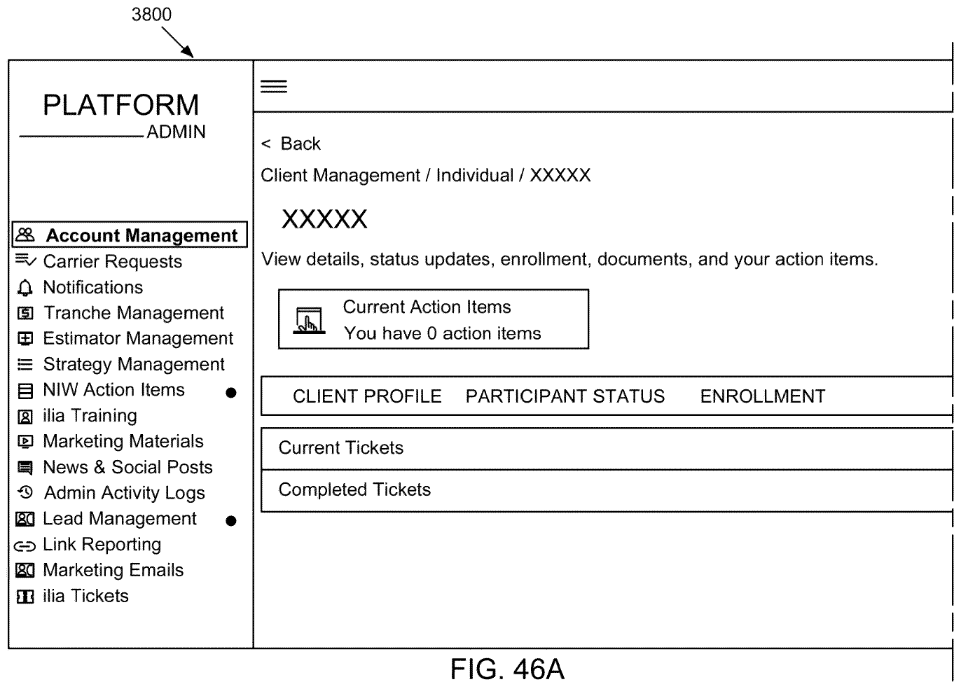

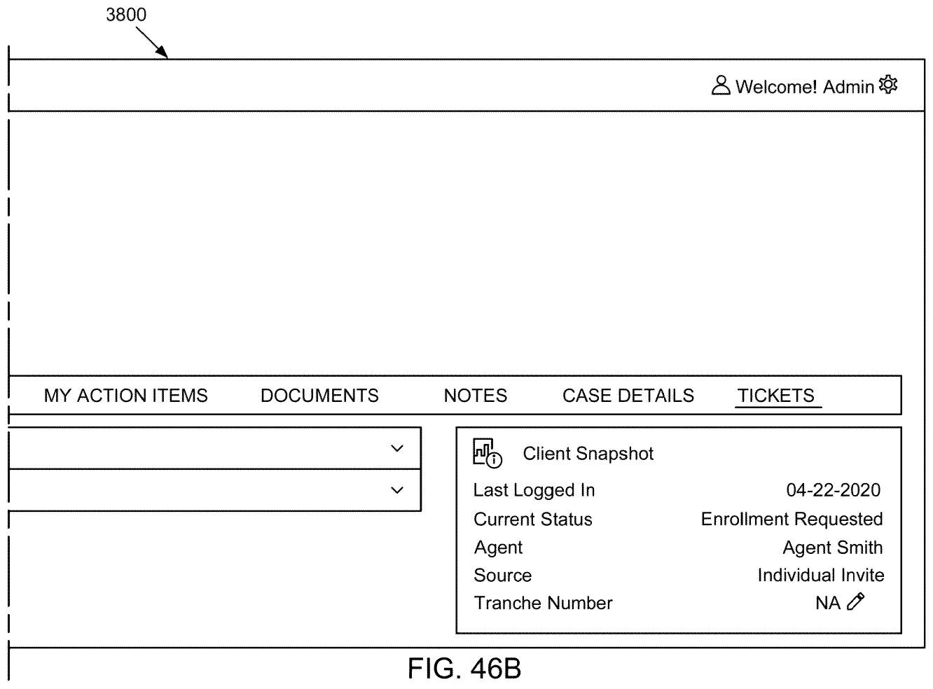

Referencing FIG. 46, an example help interface is schematically depicted on a user interface 3800, divided into FIGS. 46A and 46B, which may be populated according to the user accessing the interface, and which allows for users to readily access help related to the platform or the process. The example of FIG. 46 includes an interface to open and/or track a help ticket, to get status information on help tickets, and/or to receive feedback from the administrator or other person acting on the help ticket.

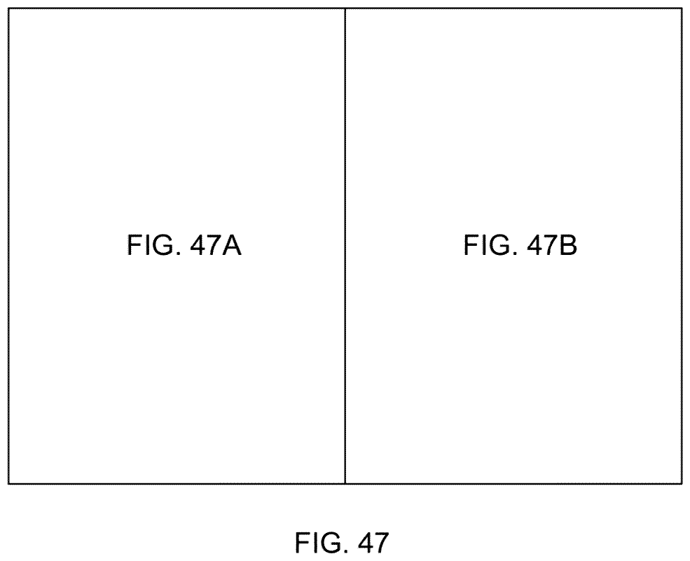

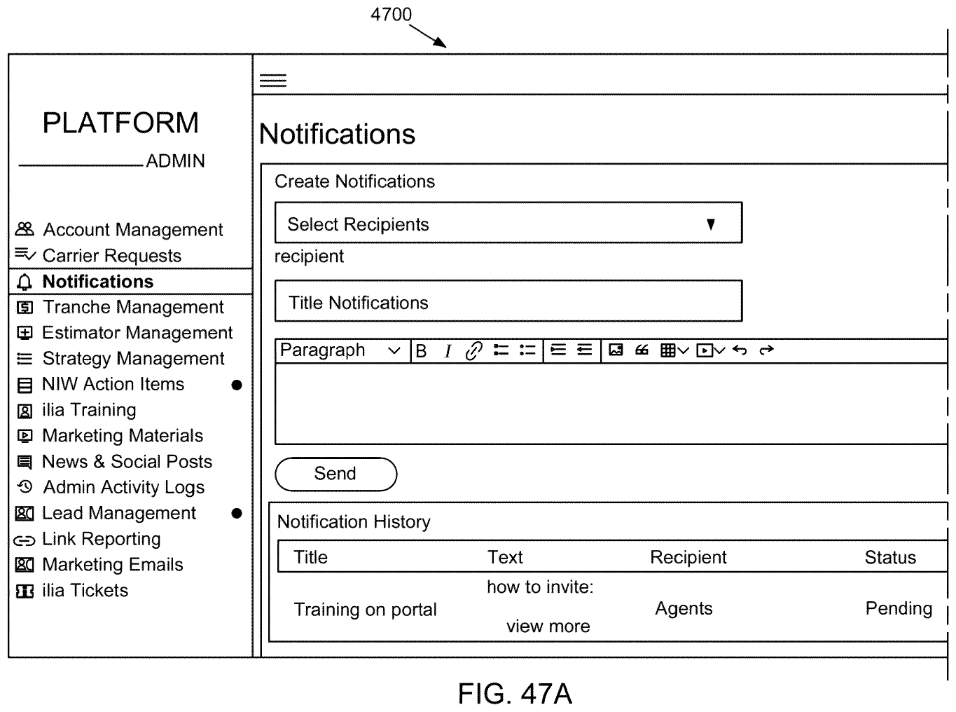

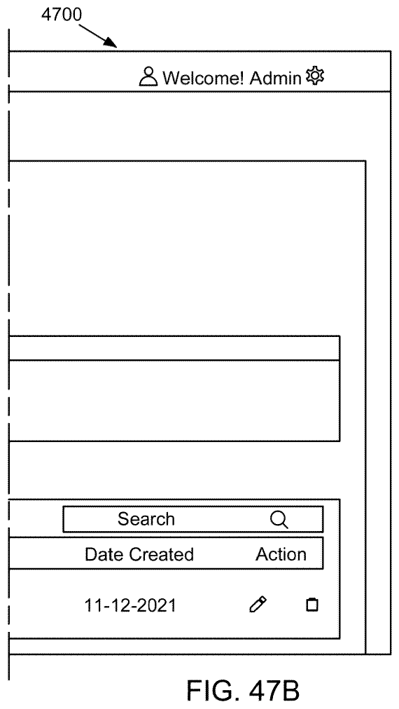

Referencing FIG. 47, an example notifications interface is schematically depicted on a user interface 4700, which may be divided into FIGS. 47A and 47B. The example notifications interface allows the user to configure notifications (within their permissions), and provides a unified location to review and respond to notifications from the platform, from process management aspects of the platform, and/or from other users within the platform ecosystem. Notifications may additionally or alternatively be sent to any location within the platform ecosystem, and/or according to selected preferences by the user—for example via text, e-mail, voice mail, phone call, physical document delivery, and/or a shared file access location.

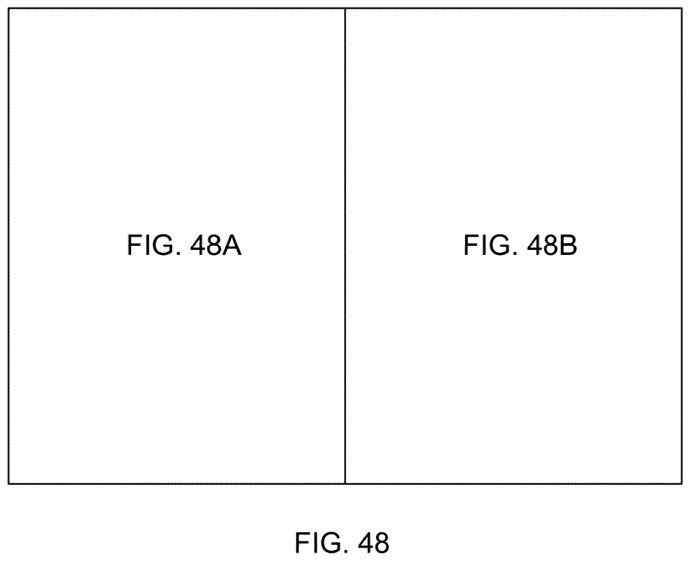

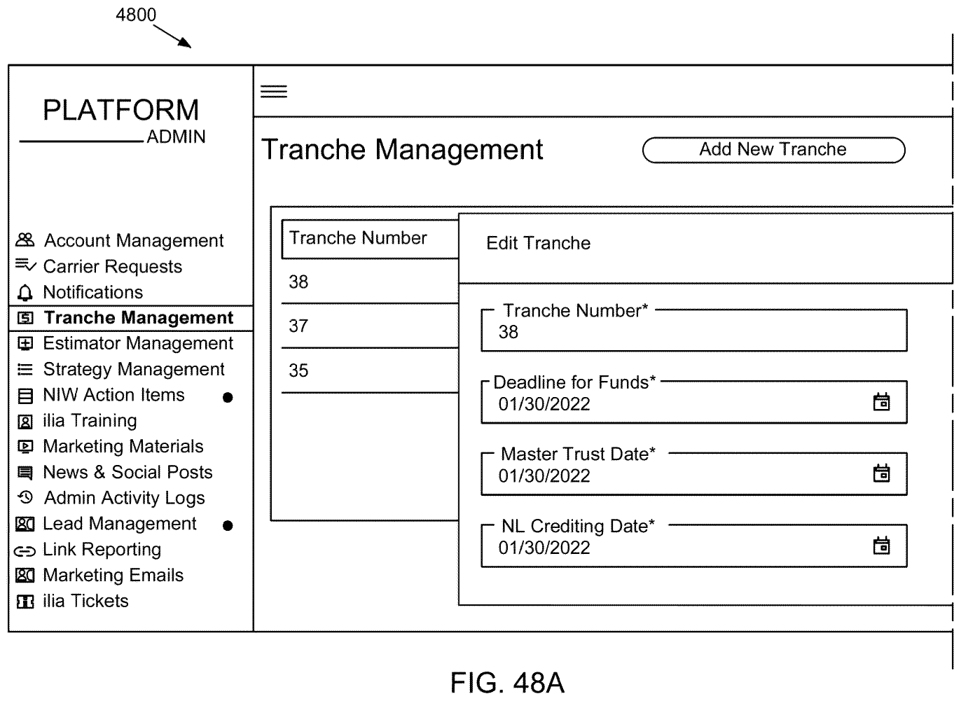

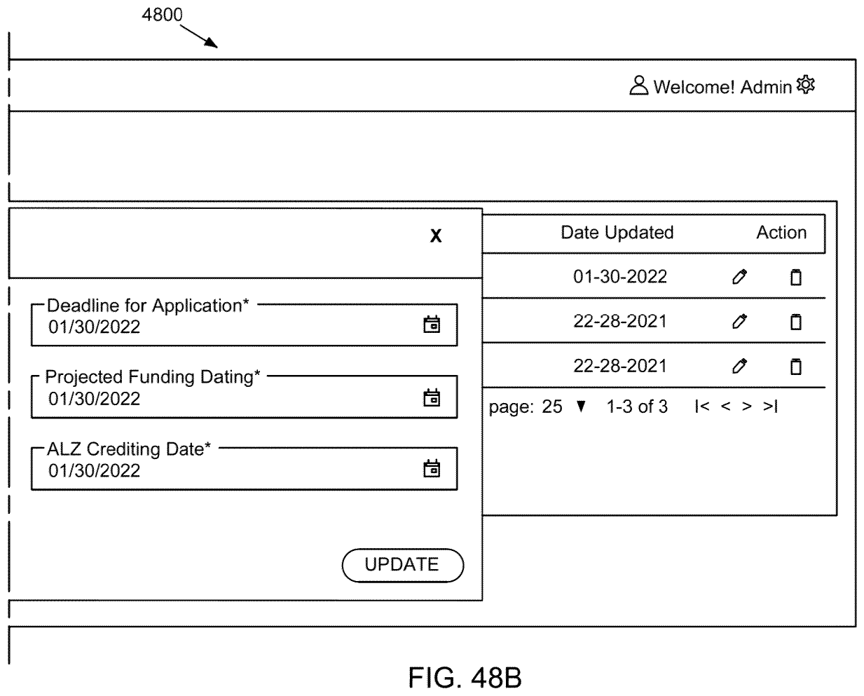

Referencing FIG. 48, an example tranche management interface is schematically depicted on a user interface 4800, divided into FIGS. 48A and 48B. The example tranche management interface may be accessed by any relevant user, for example a platform administrator, a carrier, an agent, a group member that is administering a group enrollment, or the like. The example tranche management interface includes an interface to set up the group and relevant members, to assign deadlines (e.g., target deadlines for process step completion), and the like. In certain embodiments, the tranche management interface may set up criteria to be included in the tranche, criteria to be moved out of the tranche (e.g., X deadline missed by Y time frame), and/or permissions related to the tranche (e.g., whether group members can move, notifications for the tranche, which aspects of the tranche are visible to other users, etc.). The tranche interface can also be used to populate information about members of the tranche—for example populating documentation, applications, etc., based on information available about the group members at the time the tranche interface is accessed and/or executed.

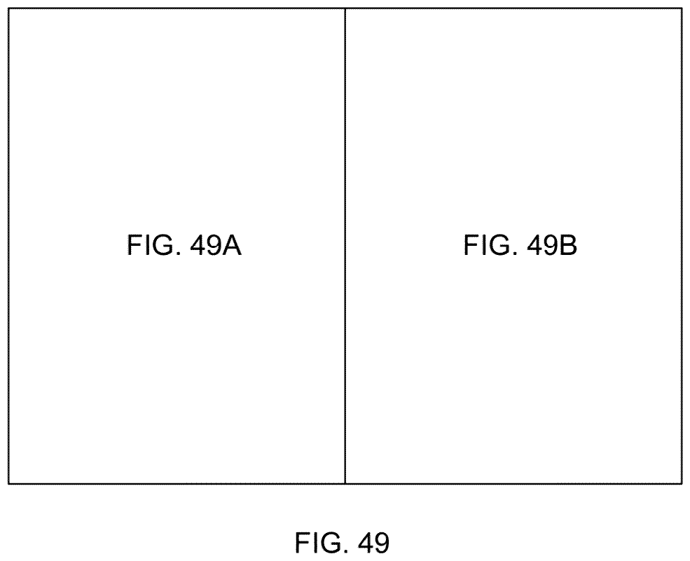

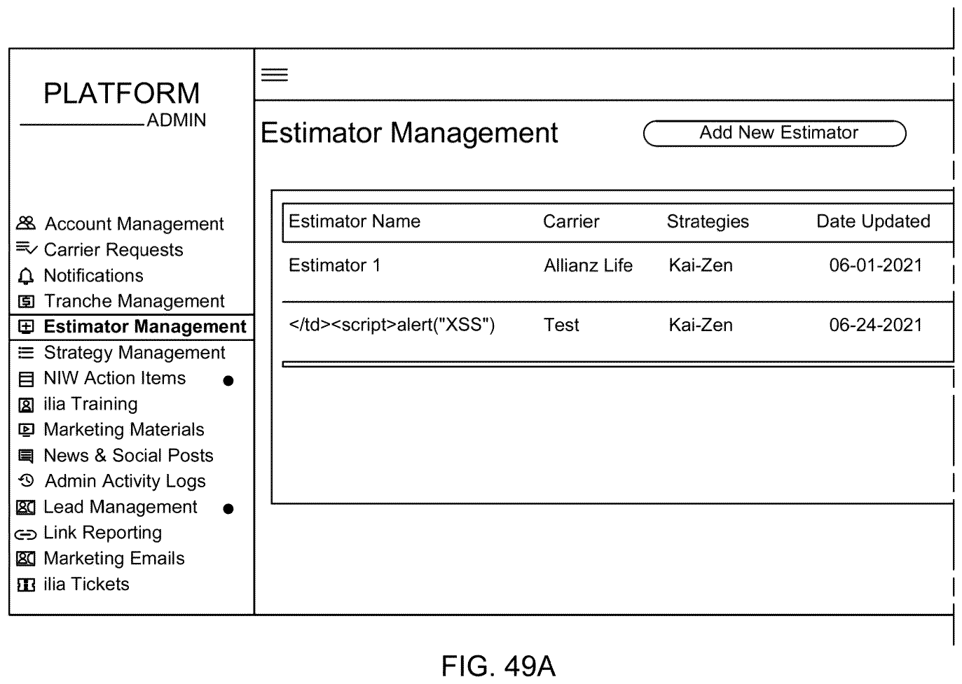

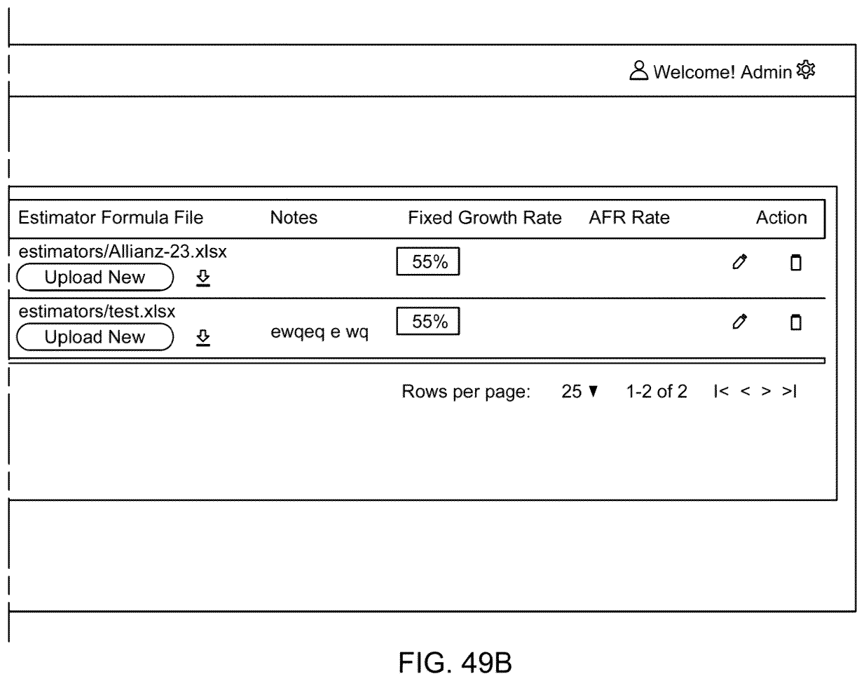

Referencing FIG. 49, an example estimation interface is schematically depicted on a user interface, divided into FIGS. 49A and 49B, allowing a user having appropriate permissions to set up estimation criteria such as assumptions to be utilized, carriers and/or product providers to use for the estimate, models to be utilized, modeling parameters to be utilized, relevant time frames, or the like. The estimation interface includes aspects available on other interfaces, such as a notes field, etc. In certain embodiments, the estimation can be saved as a template and re-used in other contexts, related to a tranche or group, etc. The utilization of the estimate interface facilitates rapid illustrations and other process efficiency promotion as described herein. The estimates may be performed on an illustrative example—for example a generic client with an age, income, occupation, etc. that may be relevant to a particular client (e.g., for an early illustration utilized for training or marketing, and/or to determine whether a client is likely to be a good fit for a particular plan), and/or may be based on actual client information (e.g., information pulled with regard to a client in the platform ecosystem, and/or based on publicly available information for the client).

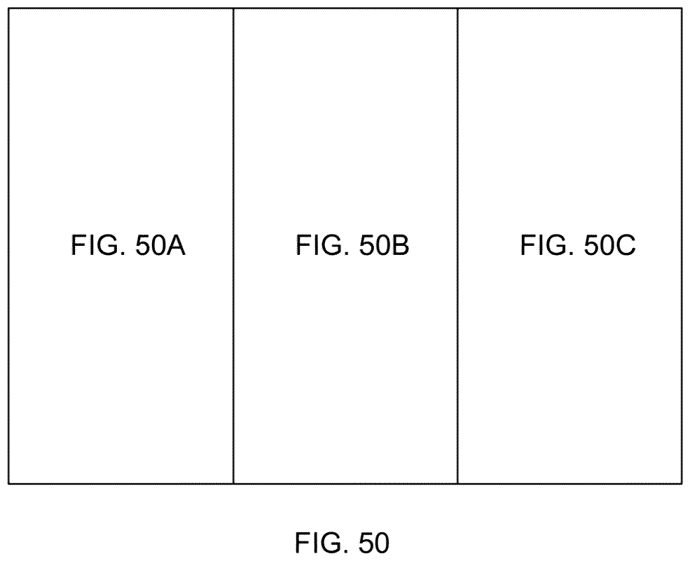

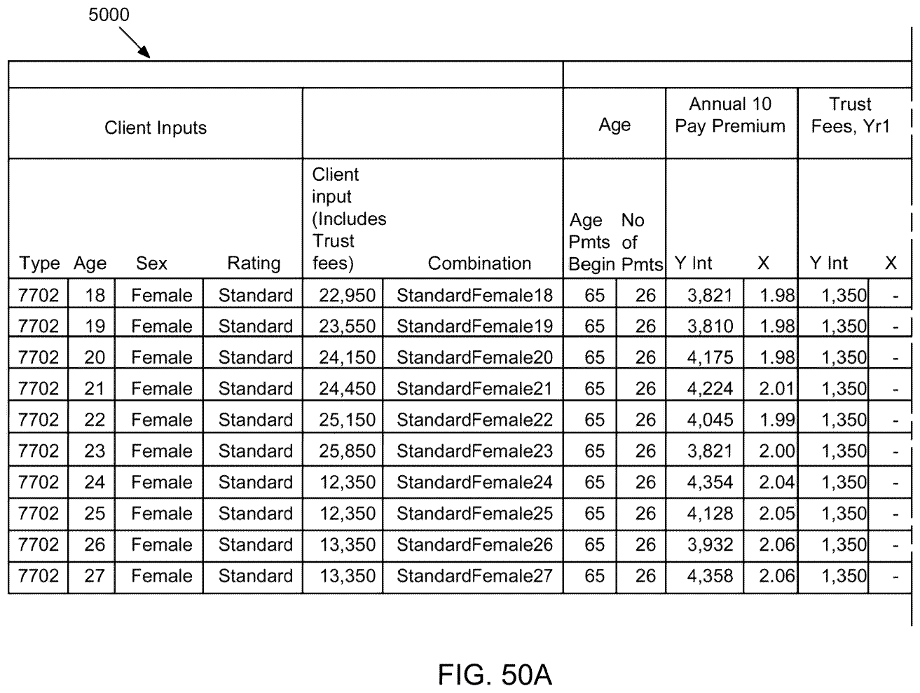

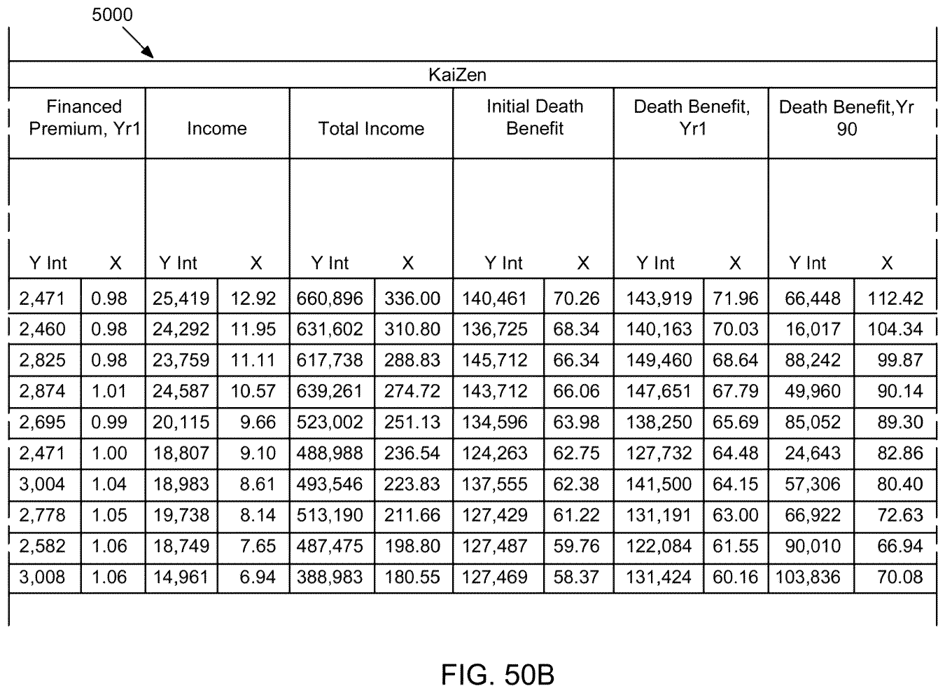

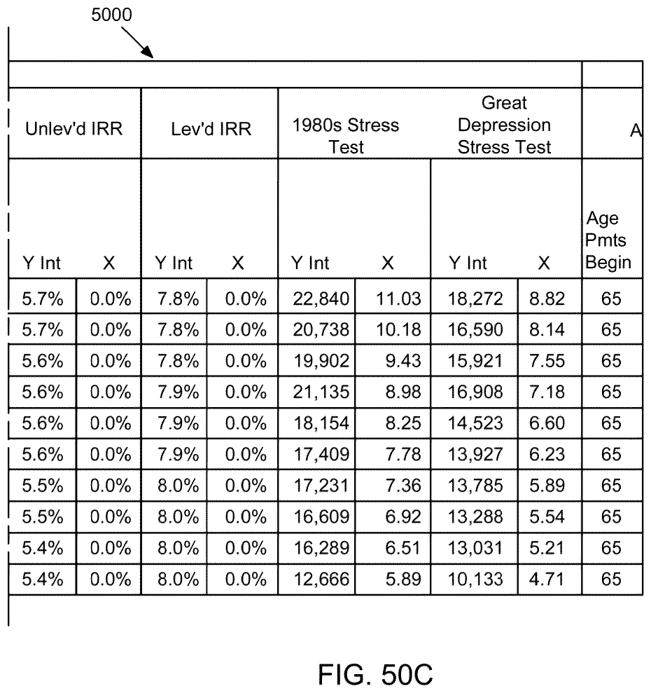

Referencing FIG. 50, an example illustration 5000 for a generic client is schematically depicted, divided into FIGS. 50A, 50B, and 50C, for example based on a nominal age, gender, income information, and the like, and which may be based on estimated products available (e.g., prior to actual application and acceptance). FIG. 50 depicts an example of some of the information that might be output from the estimator (e.g., see FIG. 49) with generic client information utilized for the estimate. In addition to building a template list of estimators (e.g., as in FIG. 49), in certain embodiments a template list of generic client considerations (e.g., age, gender, income, occupation, premium levels, net worth targets, broad health categories, target carriers, etc.) can be built, which even further accelerates the ability to provide relevant early illustrations, screen clients, improve client education, and screen from among available plan options, carriers, etc. The estimation templates and/or generic client templates, where present, may be updated periodically, after changes that may affect the resulting illustrations (e.g., tax law changes, inflation environment changes, carrier actuarial changes, product availability, etc.)

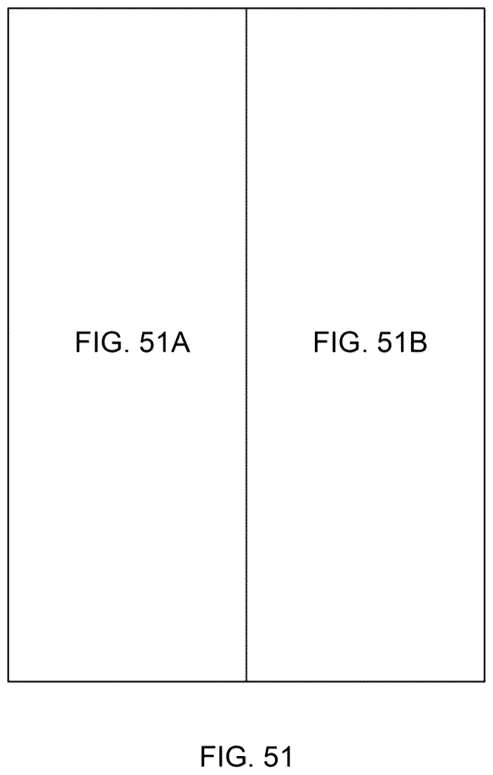

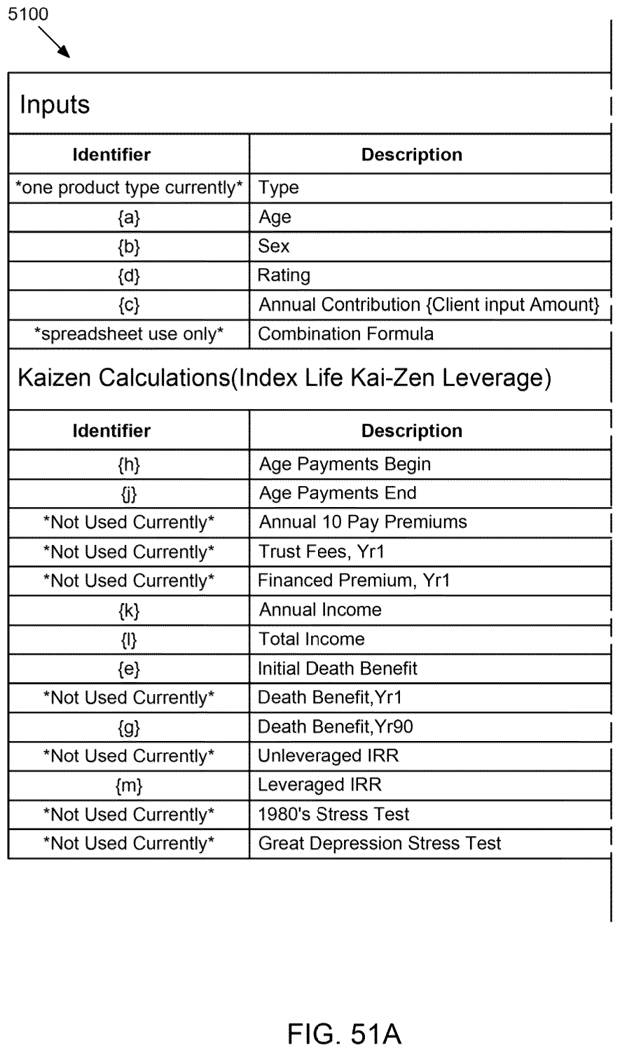

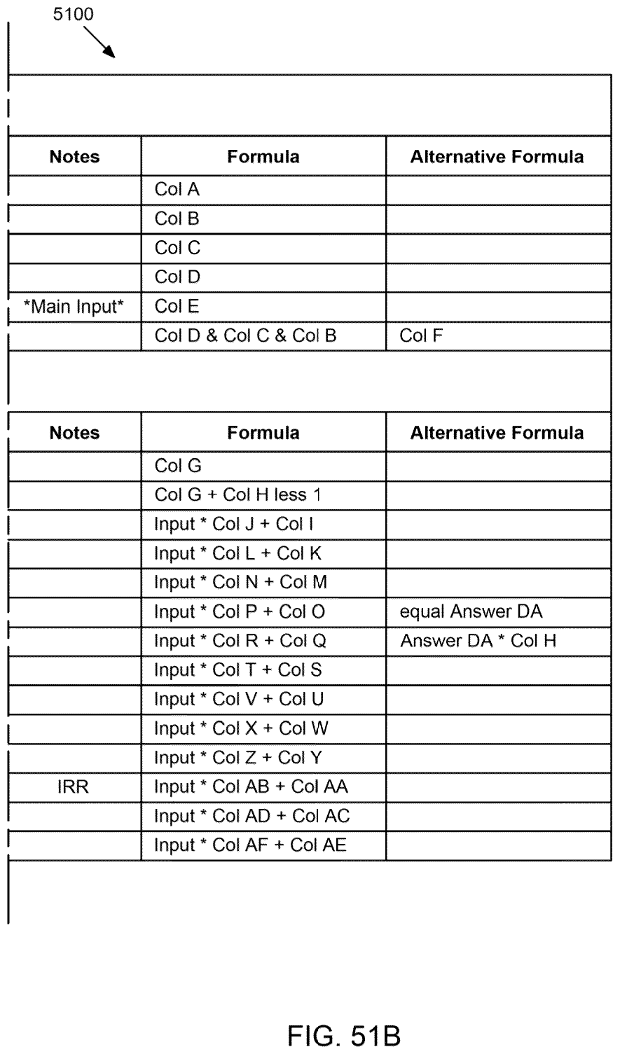

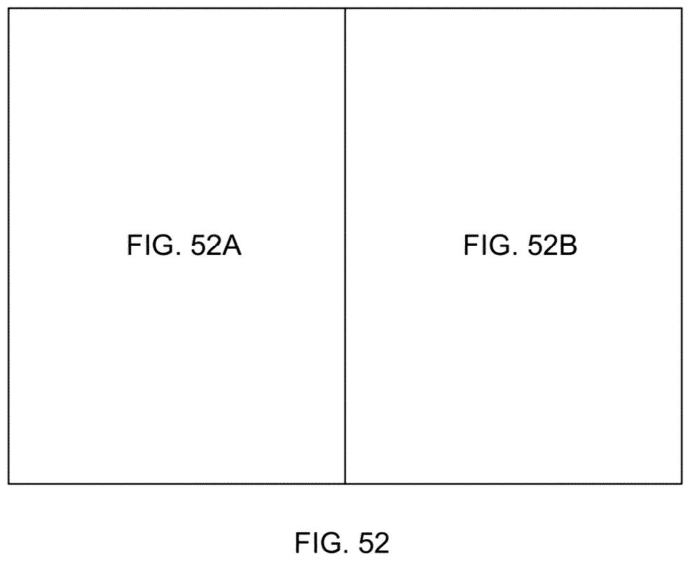

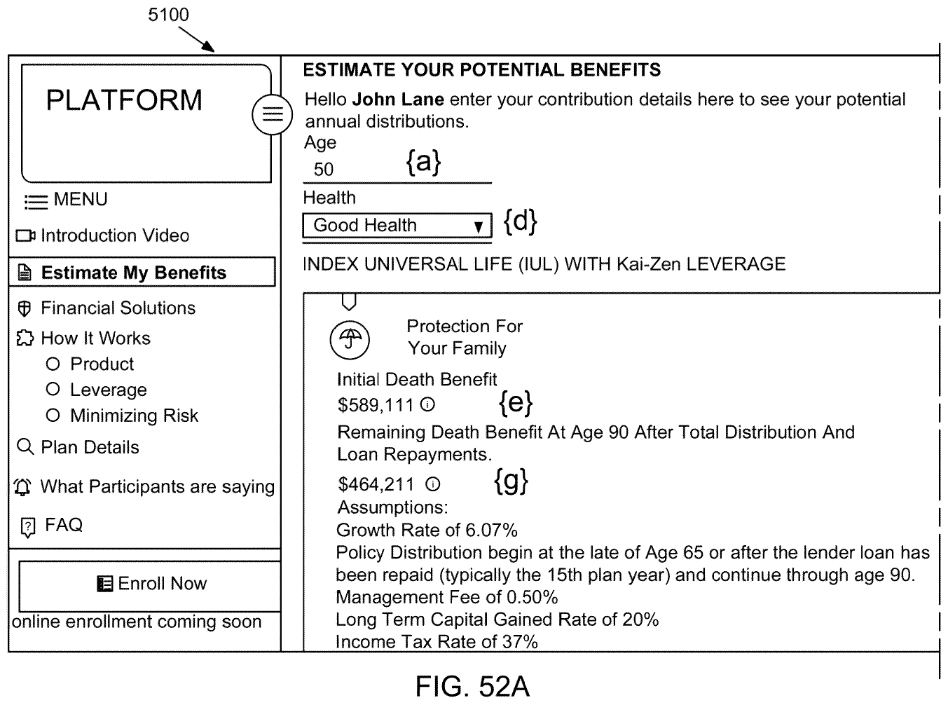

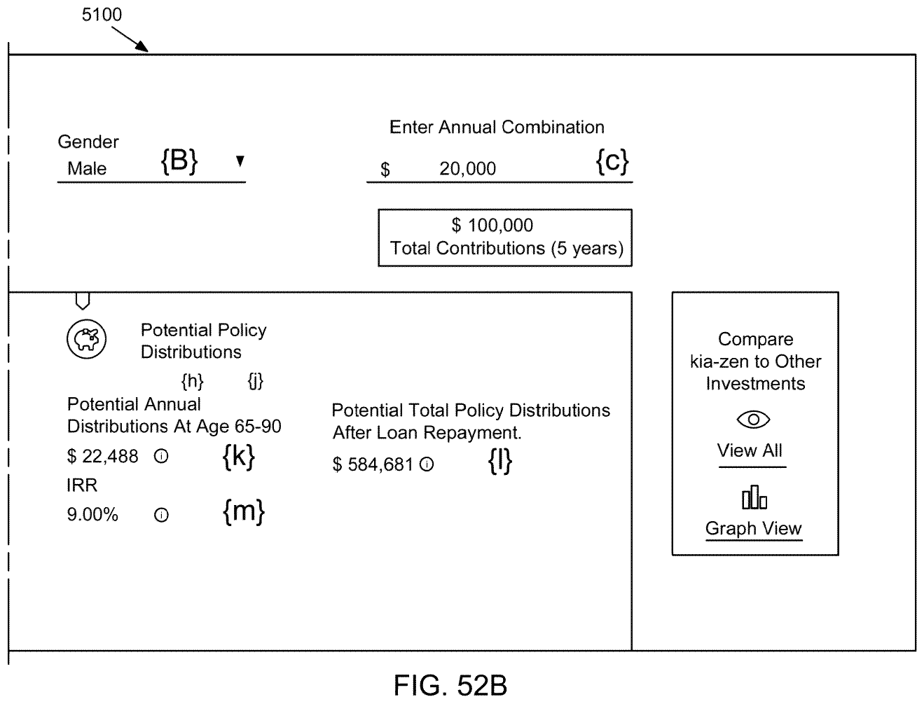

Referencing FIG. 51, an example illustration display 5100 is schematically depicted, divided into FIGS. 51A and 51B. The example information display includes a number of elements, some or all of which may be displayed depending upon the accessing user, permissions, preferences, or the like. In the upper right, a graphical depiction in included with high level information such as death benefits, distributions, contribution amounts, etc., that may be packaged in a manner to be most informative to a client or casual user, with more detailed information available in a drill down and/or provided to supporting users (e.g., an agent, financial analyst, or fiduciary for the client user). Certain detailed aspects of the illustration display 5100 may be available to some users, for example an agent user and/or a platform administrator user, and not available to other users, for example a client user. The depiction in FIG. 51 is a non-limiting illustration. The example of FIG. 52 depicts another embodiment of an illustration display 5100 showing details and/or assumptions, again where all or a portion of the illustration may be provided to the accessing user. The example of FIG. 52 is divided into FIGS. 52A and 52B for clarity of the depiction. Multiple illustrations may be utilized to depict the outcome of certain risk factors, to compare different plans, to compare different carriers, and/or to depict different scenarios (e.g., different retirement dates, contribution amounts or timing, etc.).

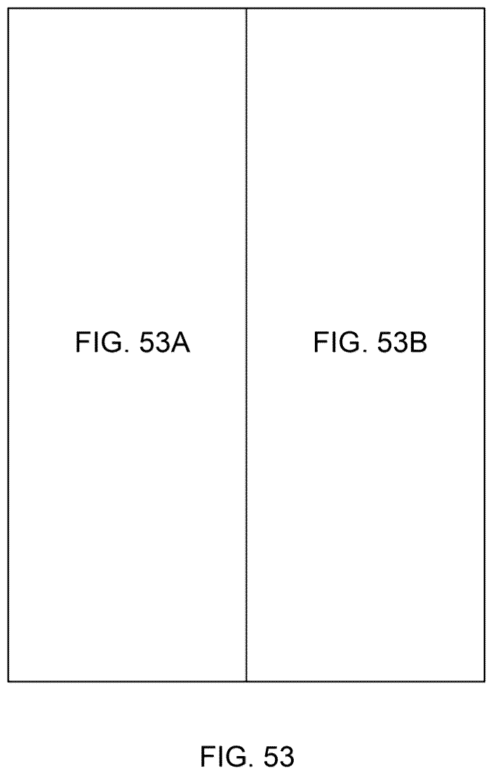

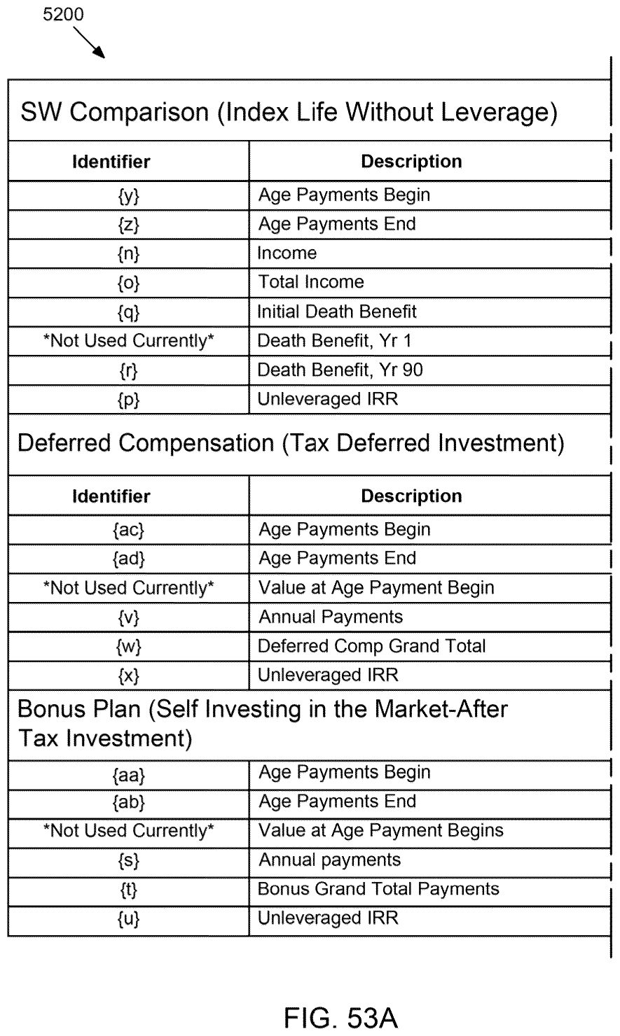

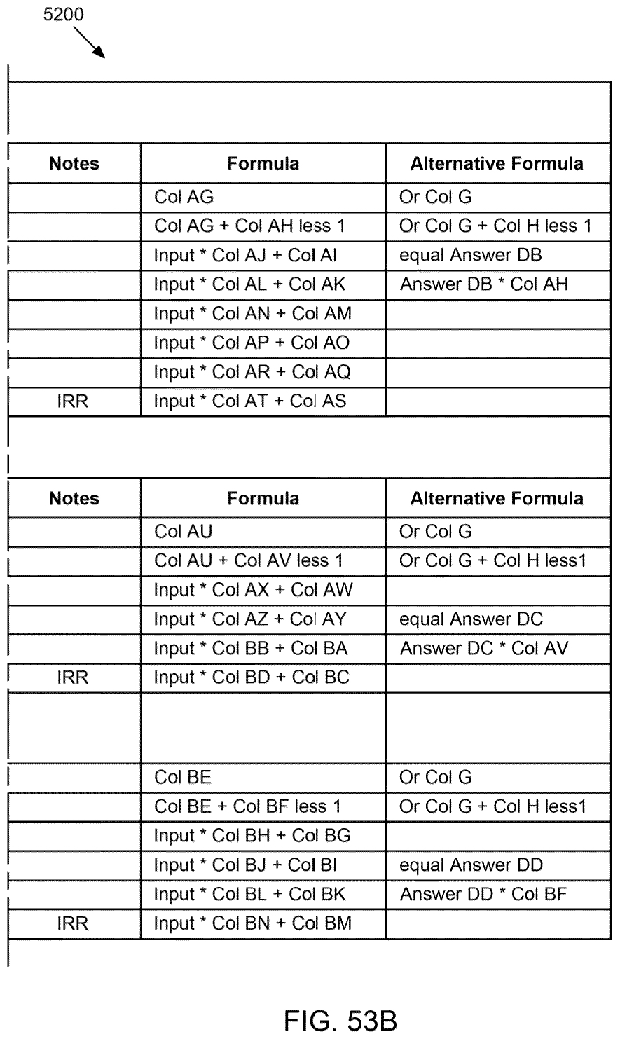

Referencing FIG. 53, an example depiction of certain elements for an estimator 5200 is schematically depicted, including example calculation details that may be presented to some users of the platform. FIG. 53 is divided into FIGS. 53A and 53B for clarity of the depiction. In certain embodiments, some or all of the estimator elements may be available to a user, with a subset of the estimator elements available to another user. For example, an expert financial analyst associated with the platform and/or a carrier may set certain parameters, and an agent may have the ability to set other parameters (e.g., start date, retirement date, contribution plan, etc.). In certain embodiments, a client user or other user may additionally be able to adjust certain parameters, for example income over time or other parameters that the user may have a likelihood to impact as a part of the planning process. The assumptions available in FIG. 53 are a non-limiting example, and may be the type of parameters available for a middle capability user, such as an agent or IMO representative. However, the specific accessibility to different assumption and/or modeling parameters is a design choice that will depend to an extent on the process content of the platform, the configuration of the platform, and the user classes available on the platform.

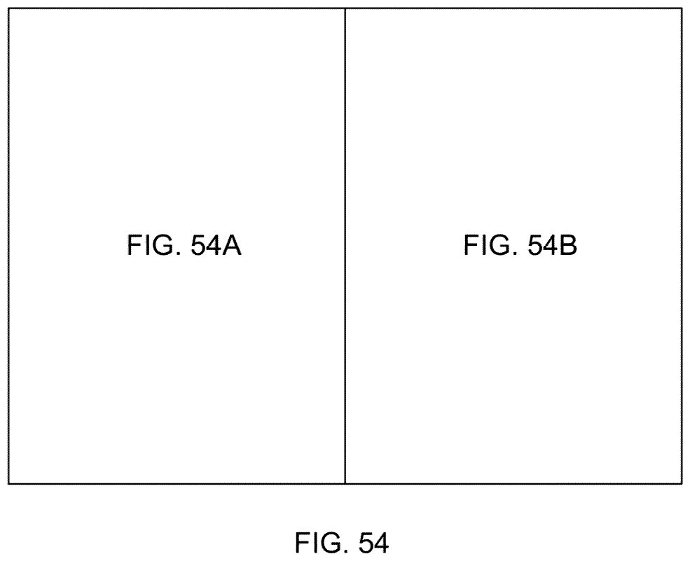

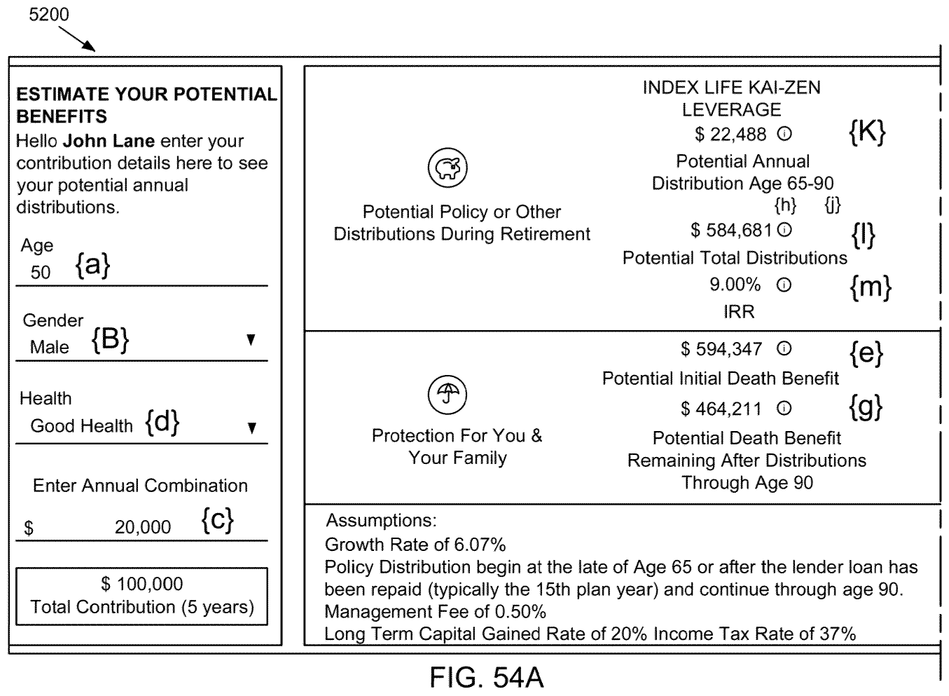

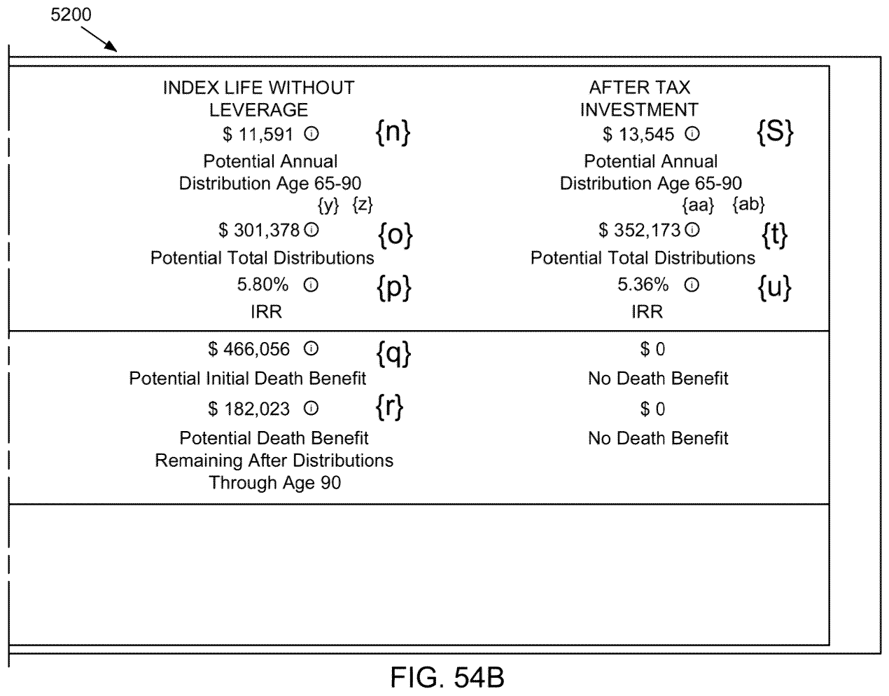

Referencing FIG. 54, an example depiction of certain elements for an estimator 5200 is schematically depicted, including example assumptions and/or financial goals that may be presented to some users of the platform. FIG. 54 is divided into FIGS. 54A and 54B for clarity of the depiction. In certain embodiments, some or all of the estimator elements may be available to a user, with a subset of the estimator elements available to another user. For example, an expert financial analyst associated with the platform and/or a carrier may set certain parameters, and an agent may have the ability to set other parameters (e.g., start date, retirement date, contribution plan, etc.). In certain embodiments, a client user or other user may additionally be able to adjust certain parameters, for example income over time or other parameters that the user may have a likelihood to impact as a part of the planning process. The assumptions available in FIG. 54 are a non-limiting example, and may be the type of parameters available for a middle capability user, such as an agent or IMO representative. However, the specific accessibility to different assumption and/or modeling parameters is a design choice that will depend to an extent on the process content of the platform, the configuration of the platform, and the user classes available on the platform.

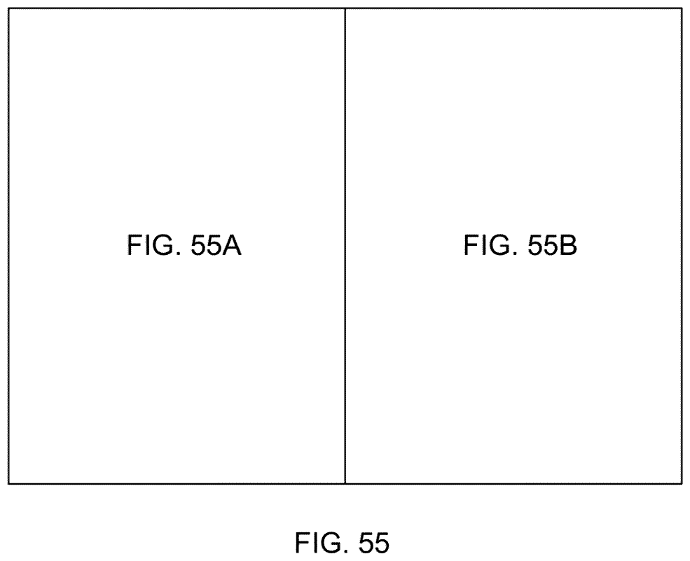

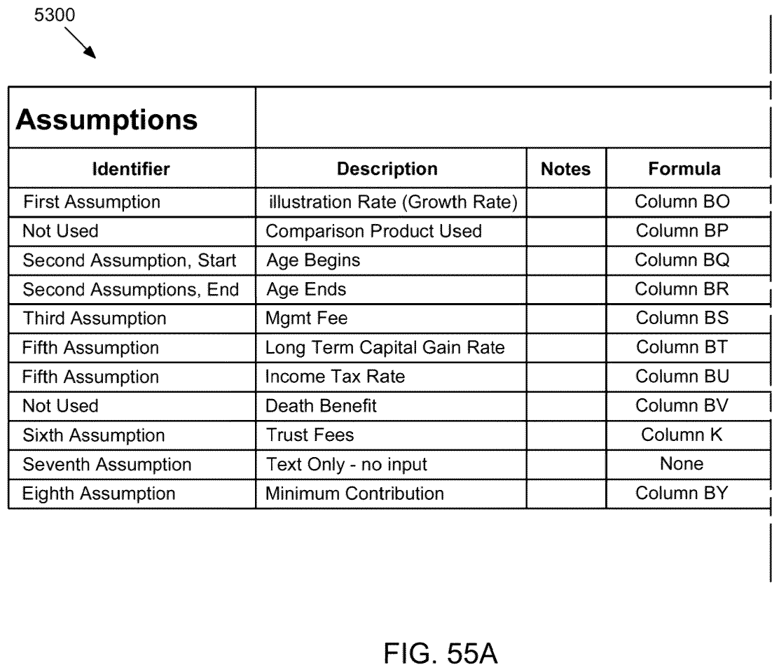

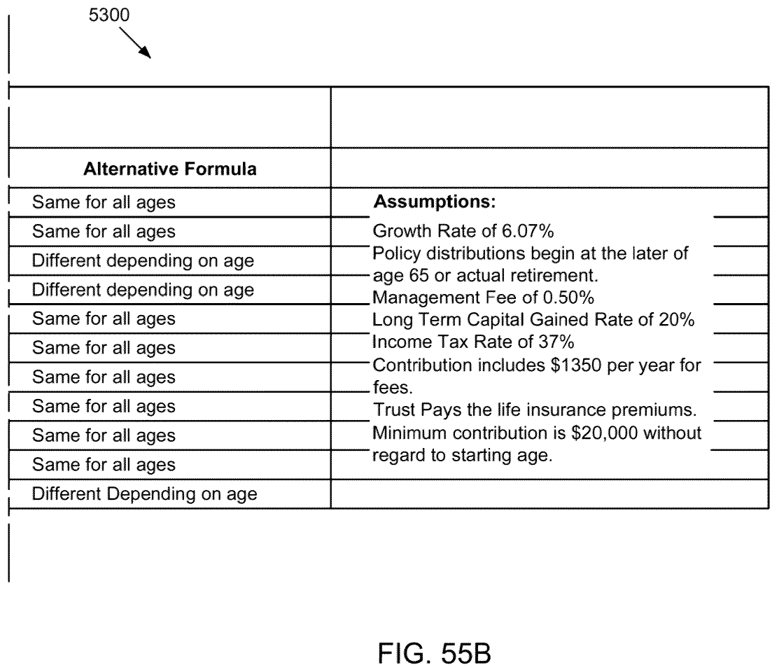

Referencing FIG. 55, an example estimator assumptions interface 5300 is schematically depicted, divided into FIGS. 55A and 55B. The example of FIG. 55 includes assumptions related to determination of illustrations and/or estimates. The assumptions available in FIG. 55 are a non-limiting example, and may be the type of parameters available for a middle capability user, such as an agent or IMO representative. However, the specific accessibility to different assumption and/or modeling parameters is a design choice that will depend to an extent on the process content of the platform, the configuration of the platform, and the user classes available on the platform.

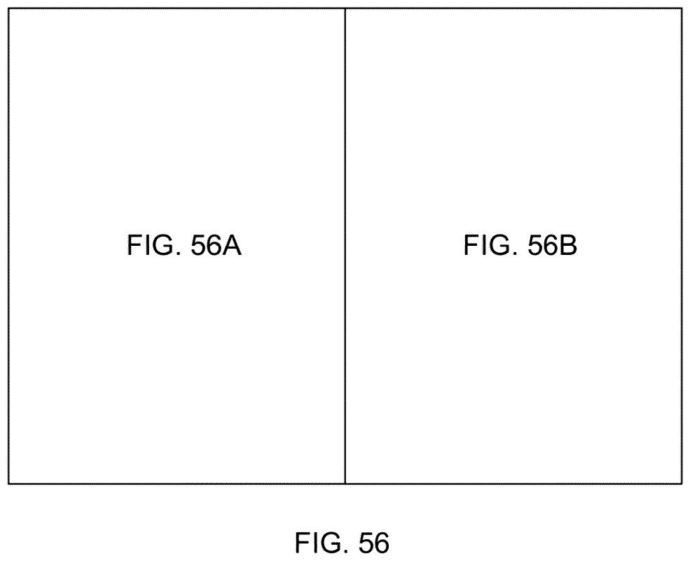

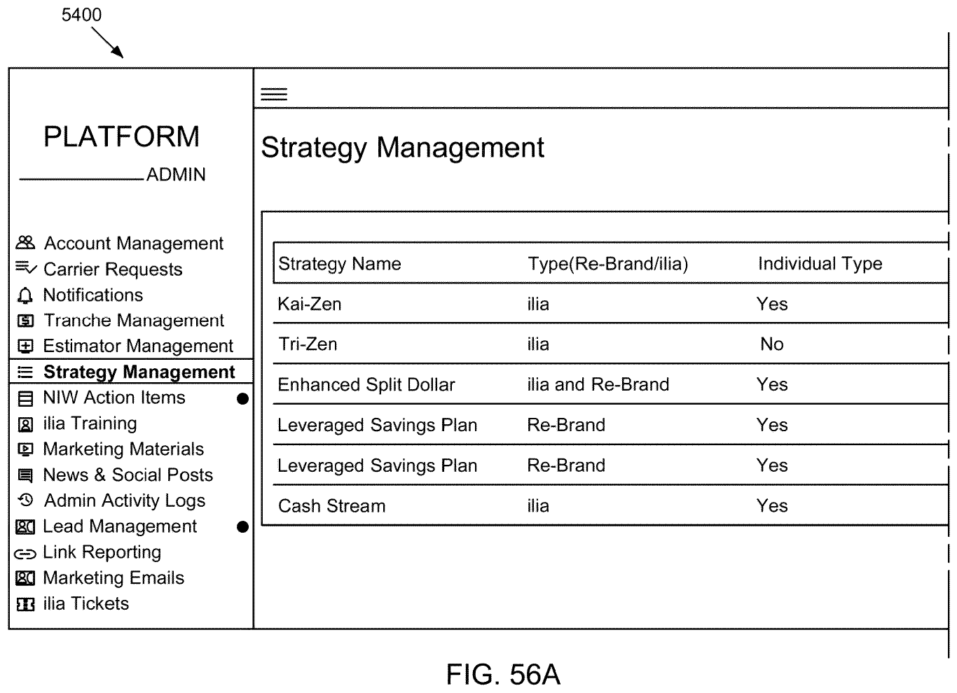

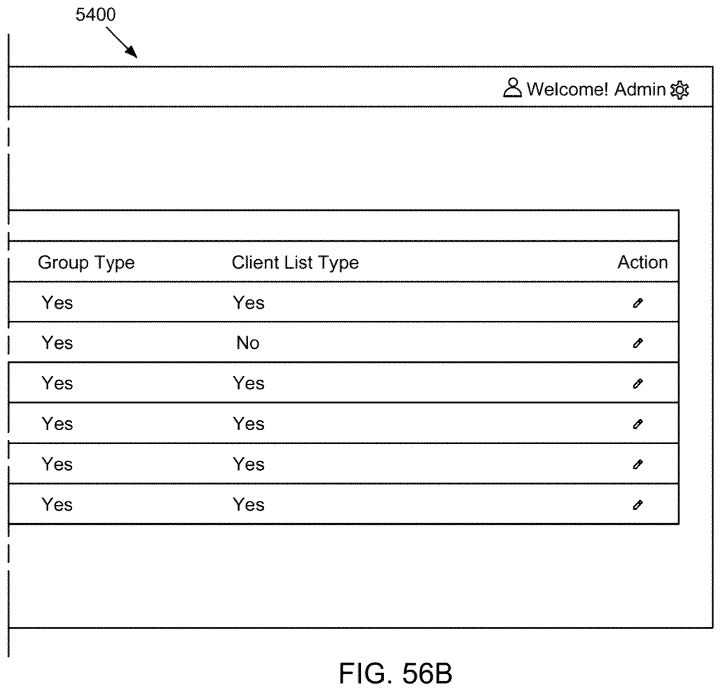

Referencing FIG. 56, an example strategy management user interface for an estimator 5400 is schematically depicted, divided into FIGS. 56A and 56B. The example strategy management user interface is configured for a sophisticated user, such as an expert financial analyst, platform administrator, underwriter, or the like. In the example, the strategy name, models utilized, type of analysis (e.g., individual and/or group), and the like are available. The example interface also allows aspects of the strategy to be selectively visible to other users—for example in reporting (e.g., with a strategy name provided on the illustration), and/or may allow other users to adjust one or more parameters of the strategy where appropriate for the user level and/or available in the platform permissions. The utilization of a strategy management component, as in FIG. 56, allows for more sophisticated and customized strategy development to be quickly implemented, reducing the time to perform process steps, allowing for re-creation of illustrations, monitoring of the process and/or illustration development, and the like.

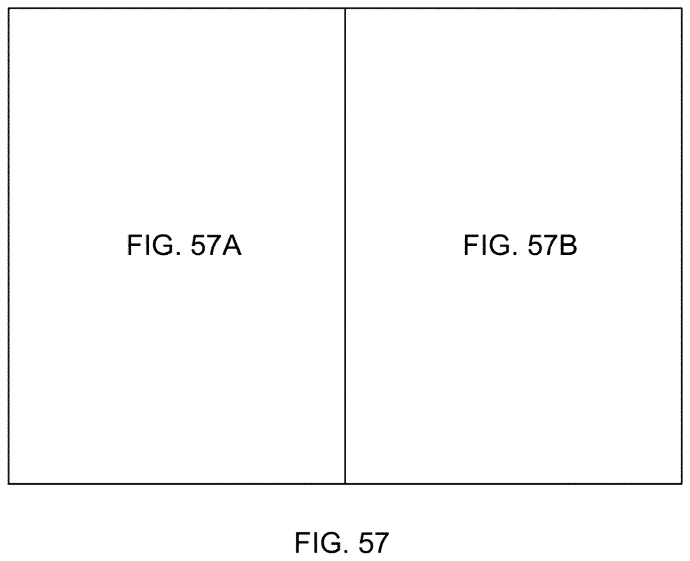

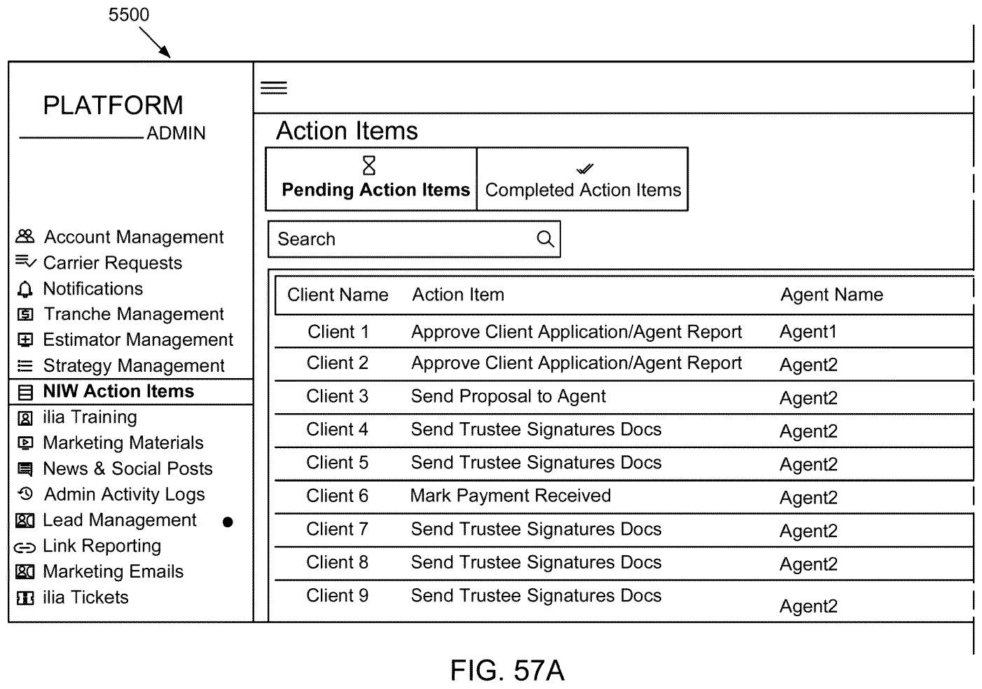

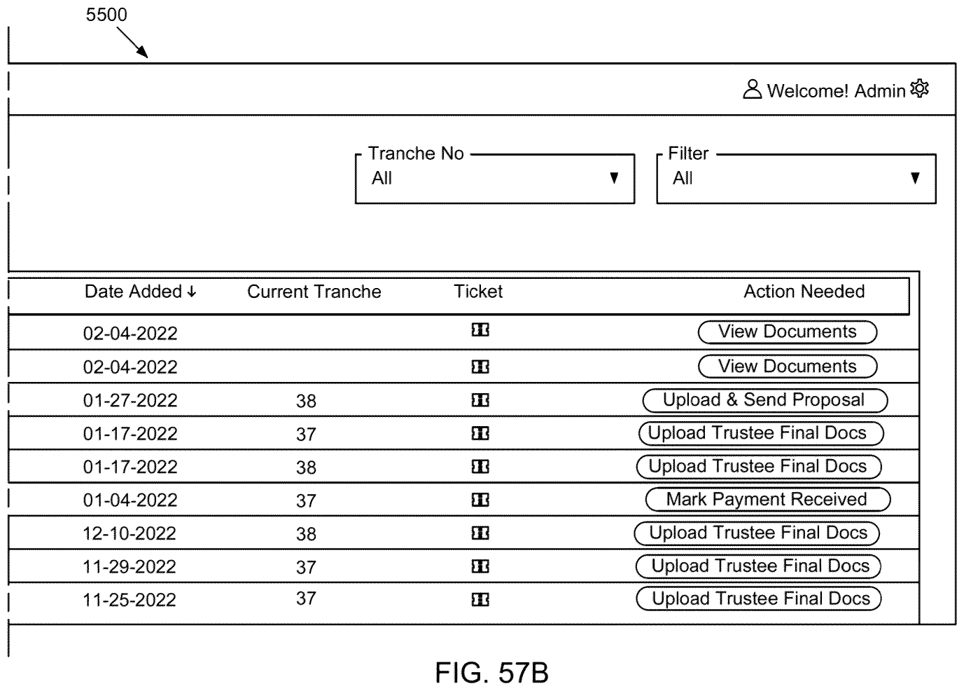

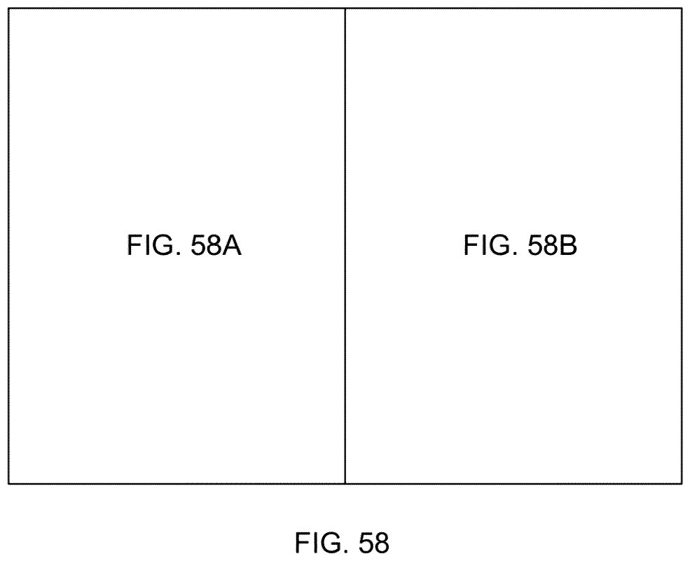

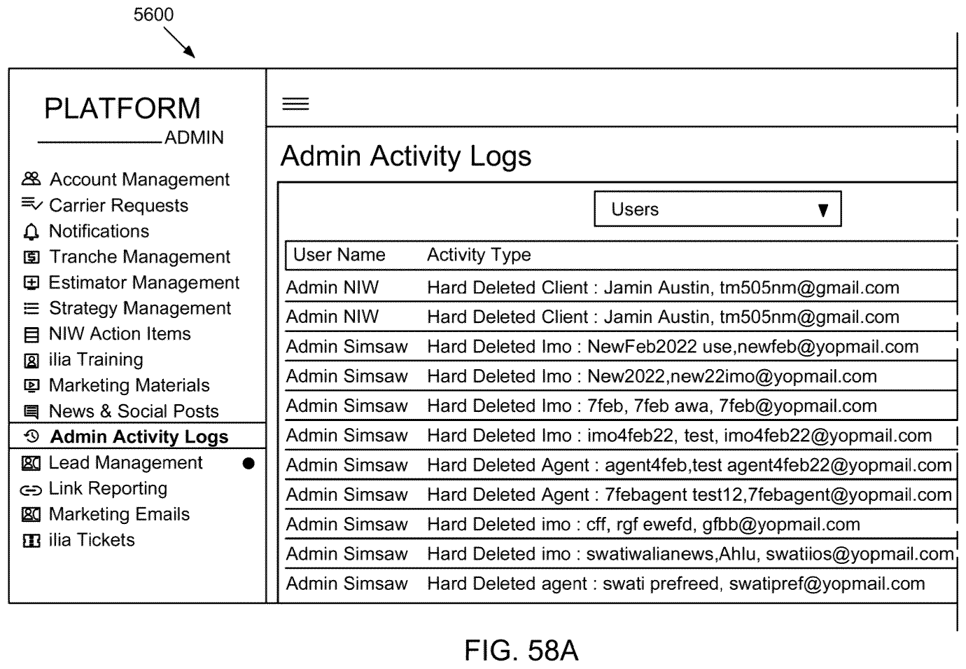

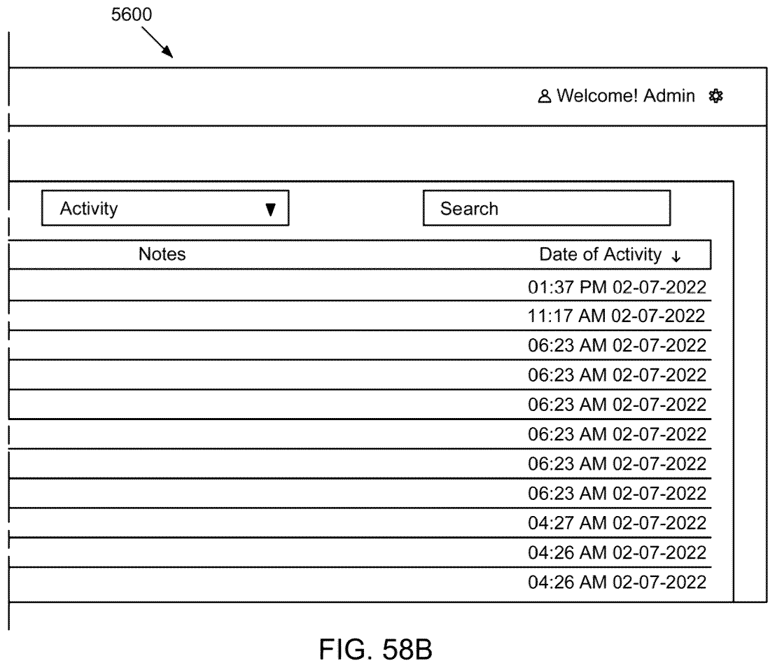

Referencing FIG. 57, an example activity tracking interface 5500 for an individual user is depicted, divided into FIGS. 57A and 57B, as described throughout the present disclosure. Referencing FIG. 58, an example admin activity log 5600 is schematically depicted, divided into FIGS. 58A and 58B. The example activity log may be utilized in any context, for example an agent activity log, group activity log, or the like. The activity log may be utilized to track completed actions, to debug the process (e.g., where certain corrective actions are repeating), or for any other reason related to the platform and/or the managed process(es).

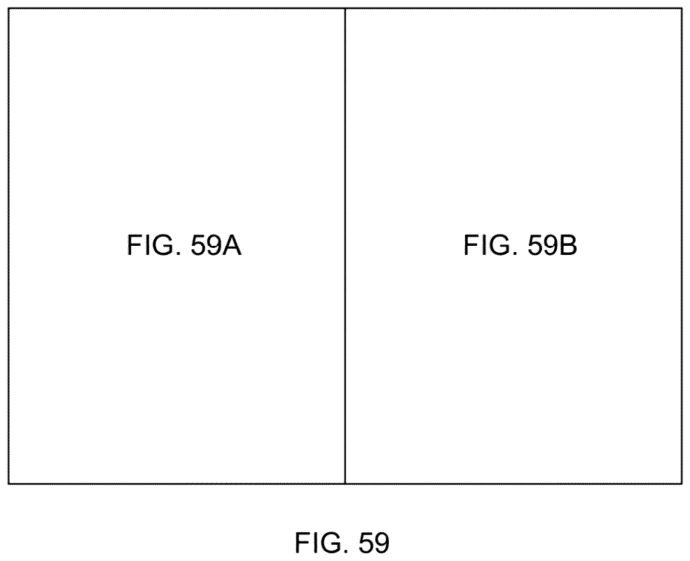

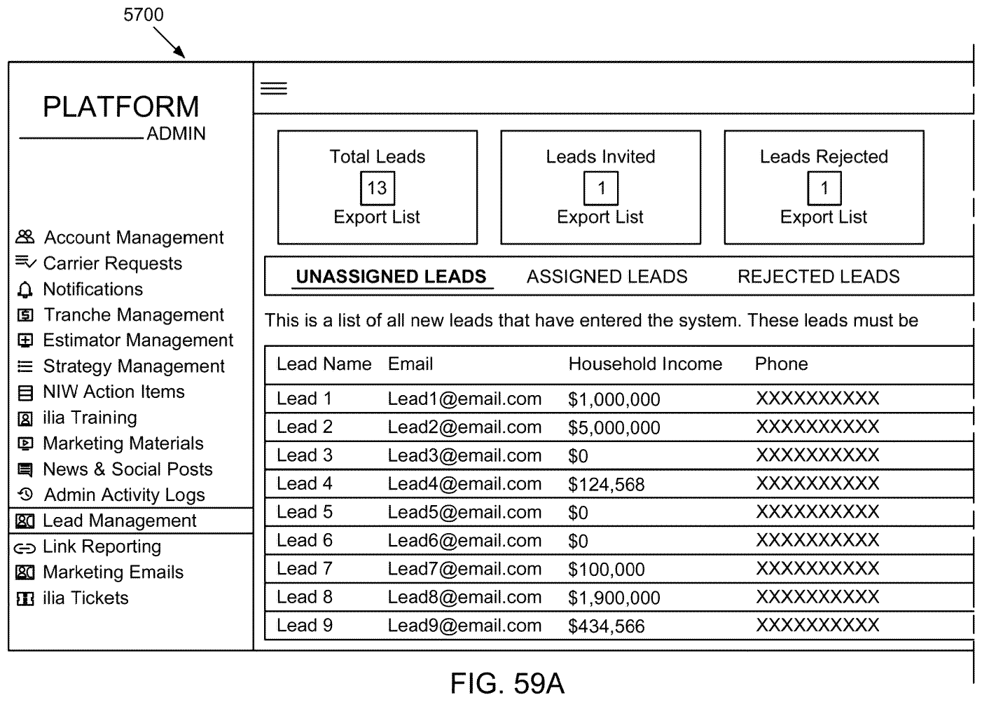

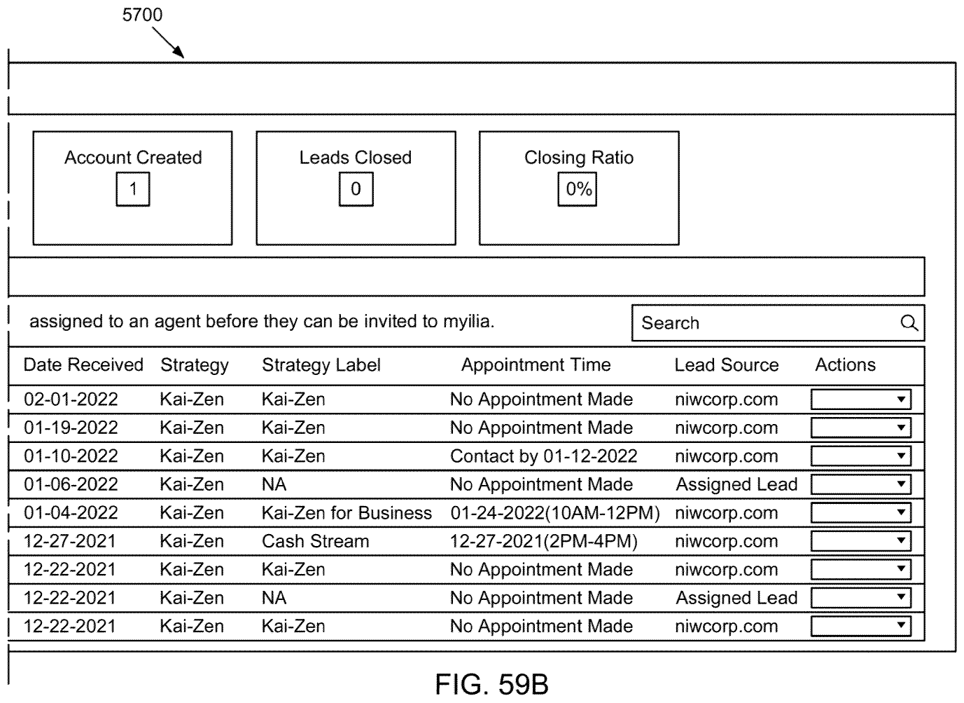

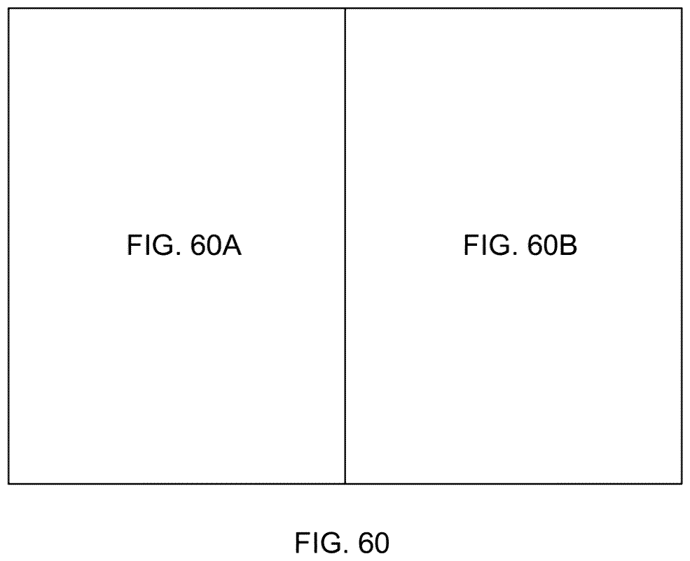

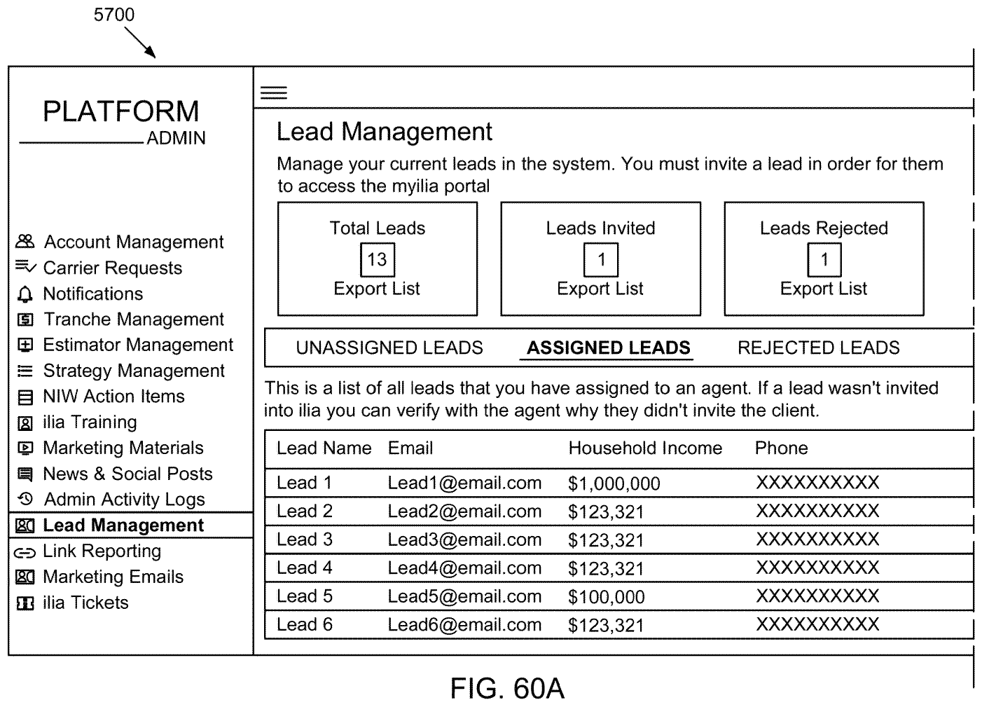

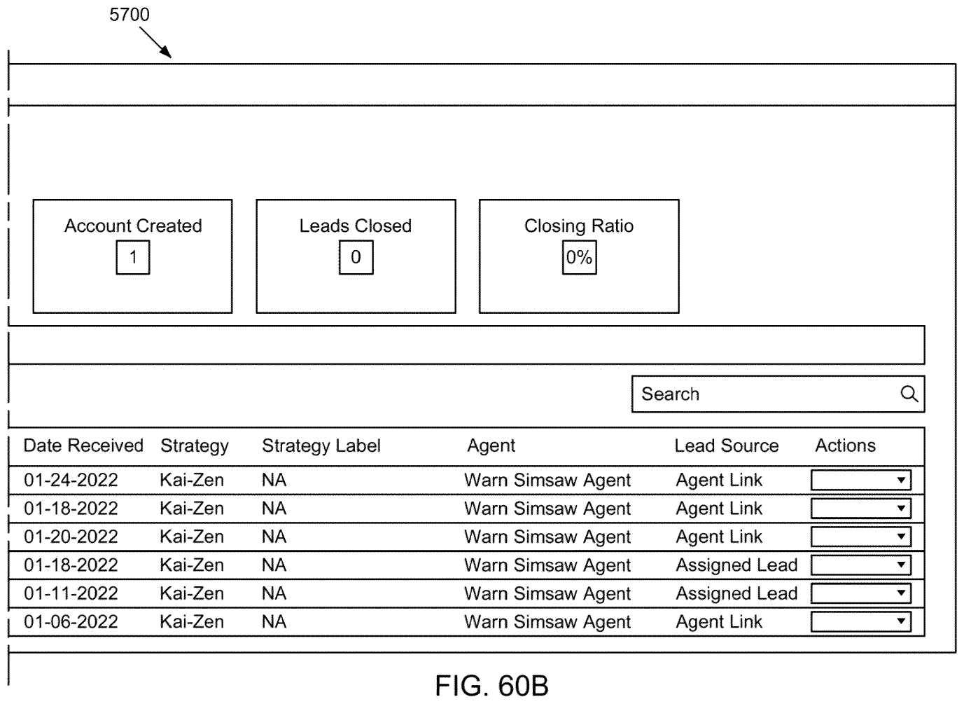

Referencing FIG. 59, an example interface 5700 for pre-enrollment contacts (e.g., “leads”) is schematically depicted, divided into FIGS. 59A and 59B. The example interface depicts persons that have not yet been assigned to an agent, carrier, IMO, or the like, and may be from any source relevant to the platform. In certain embodiments, the pre-enrollment contacts may be tracked by the platform, by a carrier (e.g., to be assigned to an agent), or any other lead generating entity in the platform. In certain embodiments, pre-enrollment contacts may be tracked from multiple sources, for example to prevent multiple contacts to a same person. Referencing FIG. 60, an example interface 5700 for pre-enrollment contacts is depicted—in the example of FIG. 59 the tab “Unassigned leads” is selected, where in the example of FIG. 60 the tab “Assigned leads” is selected. FIG. 60 is divided into FIGS. 60A and 60B. The examples of FIGS. 59-60 is non-limiting, and any other arrangement to track and assign pre-enrollment contacts, if relevant to the supported process, is contemplated herein.

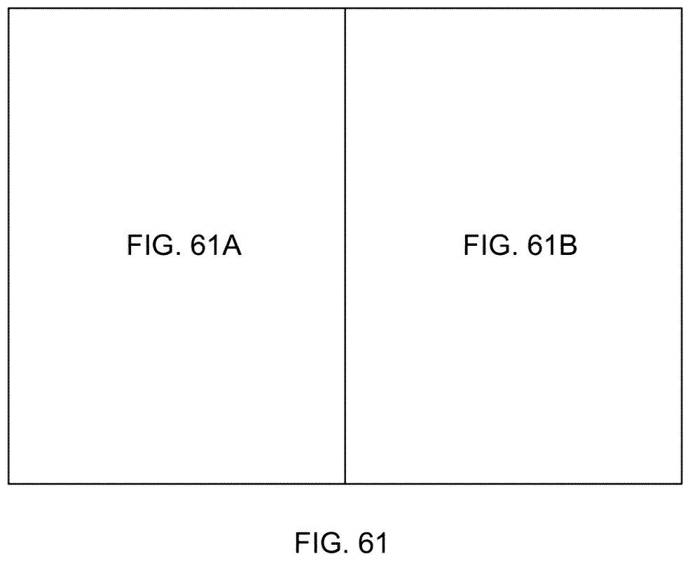

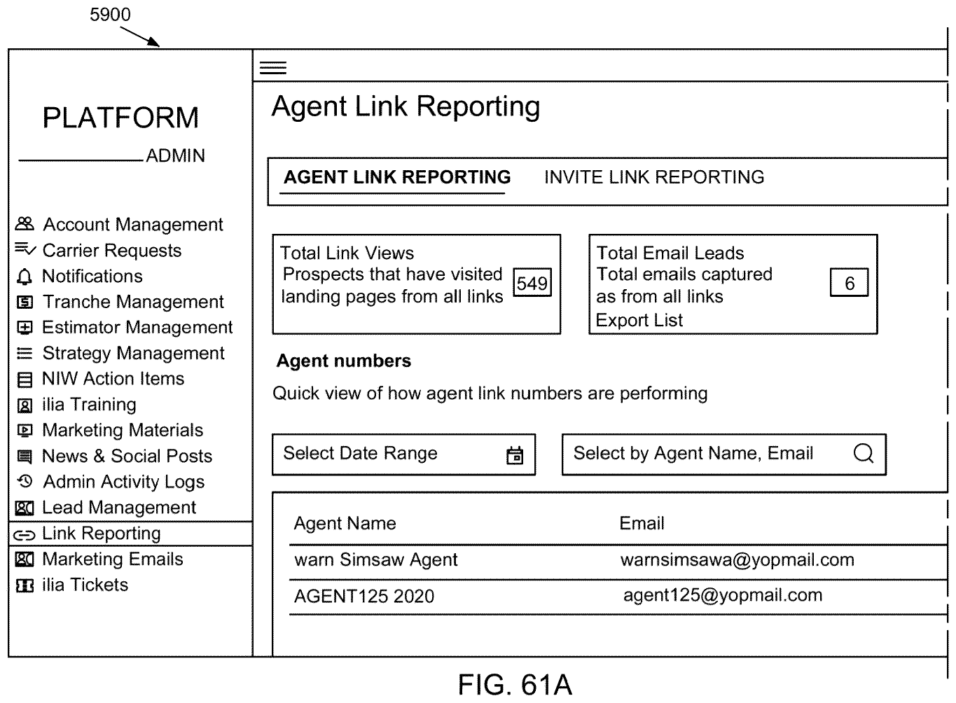

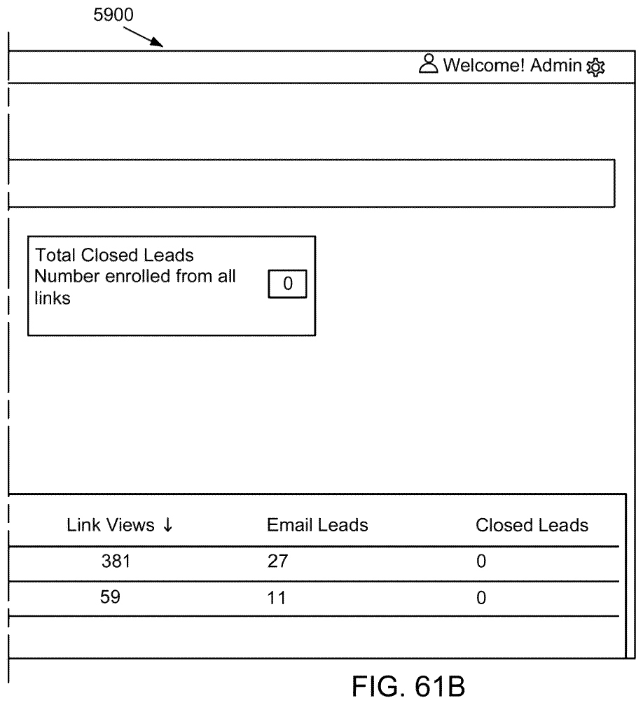

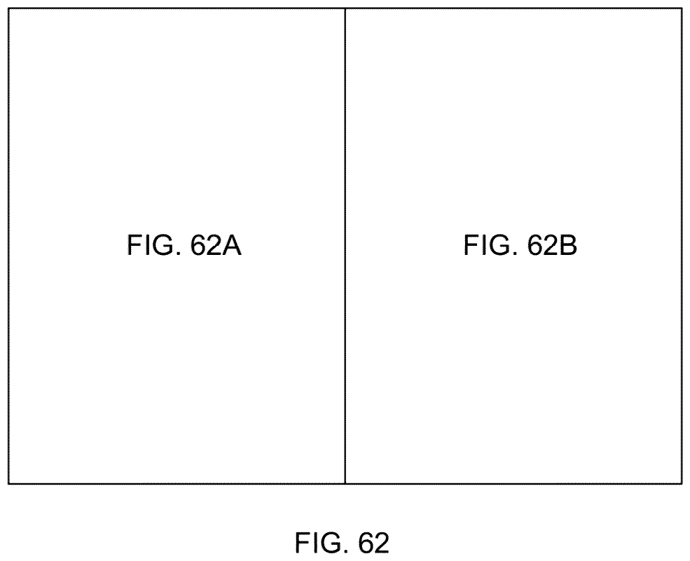

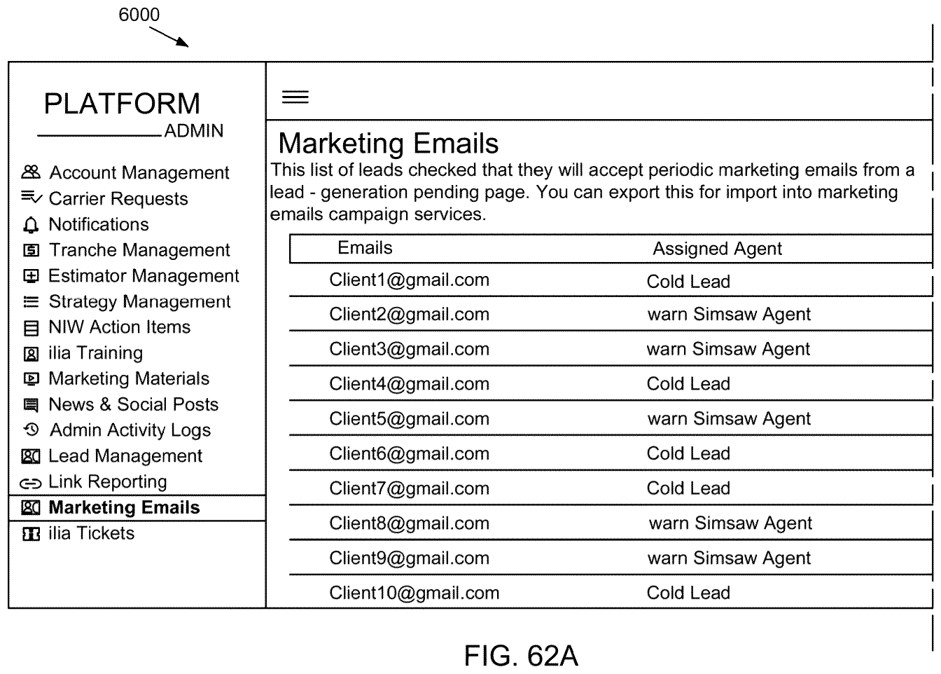

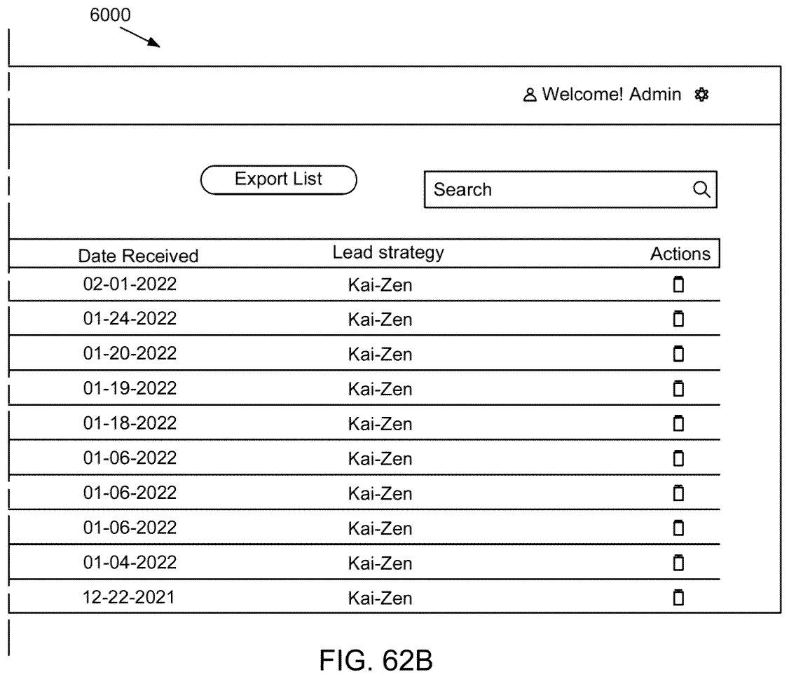

Referencing FIG. 61, an example agent link reporting interface 5900 is schematically depicted, divided into FIGS. 61A and 61B. The example interface tracks agent assignments for pre-enrollment contacts, and is an optional organizational tool for tracking contacts with agent assignments. Referencing FIG. 62, an example marketing email interface 6000 is schematically depicted, divided into FIGS. 62A and 62B, which may be utilized to track which leads have received initial materials describing available products or otherwise marketing products associated with the platform. The example of FIG. 62 is non-limiting, and similar interfaces may be implemented to track any type of pre-enrollment or pre-engagement communications, any type of one-time communication (e.g., a change to terms and conditions, acknowledgement, training communications, etc.), or the like.

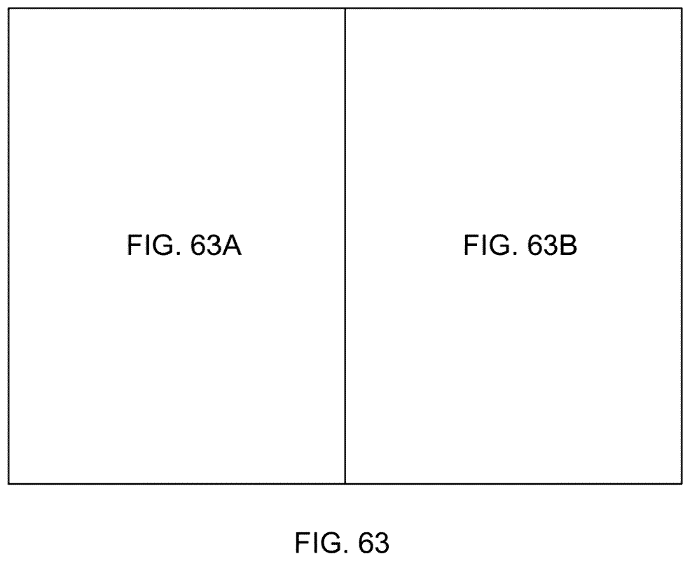

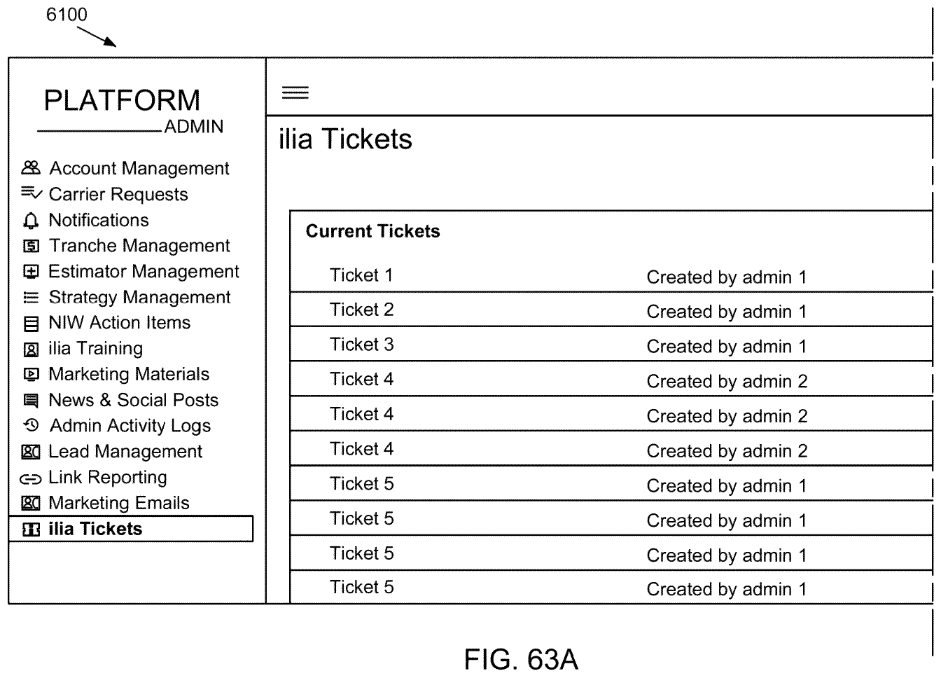

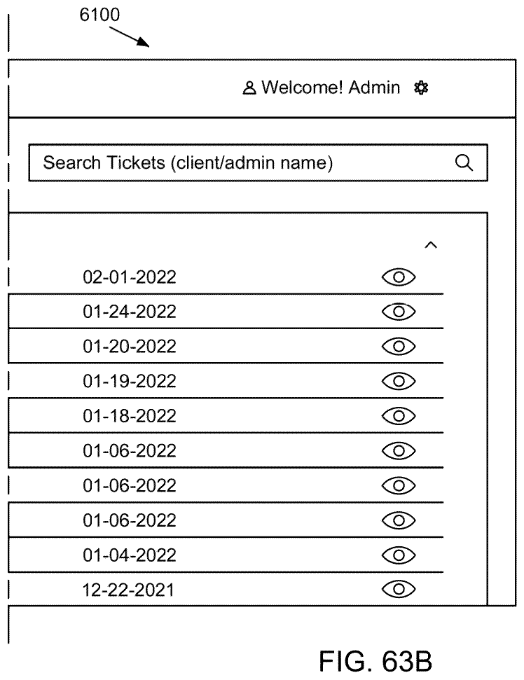

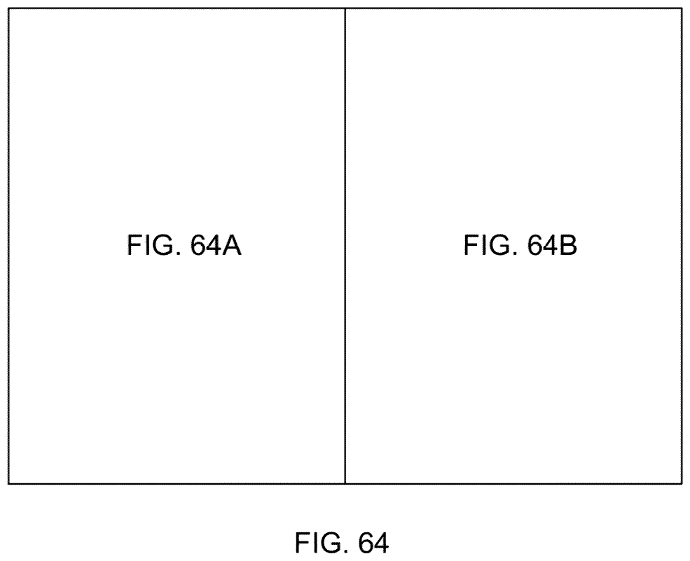

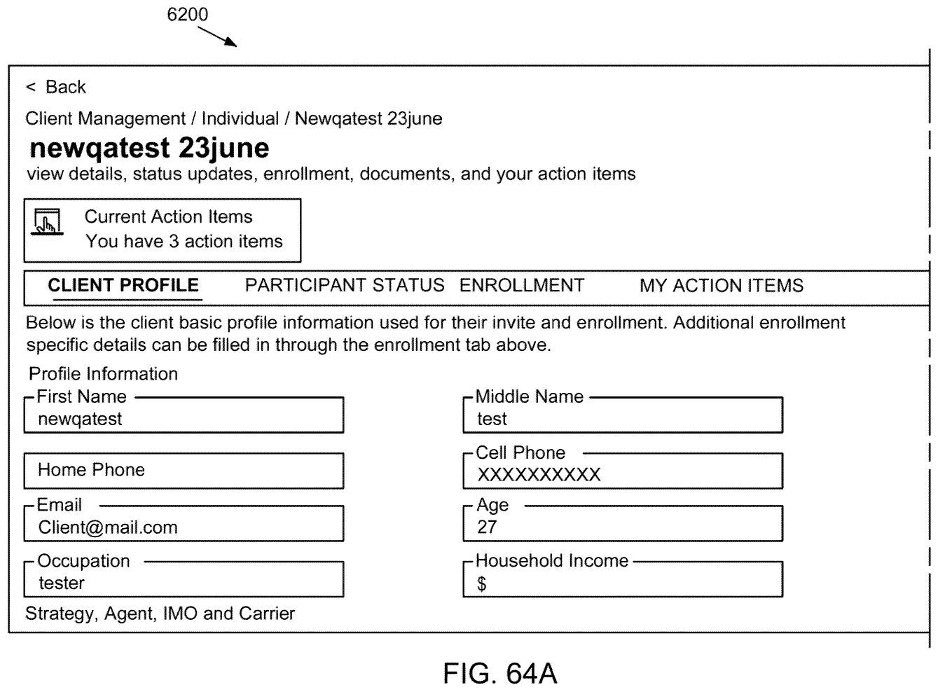

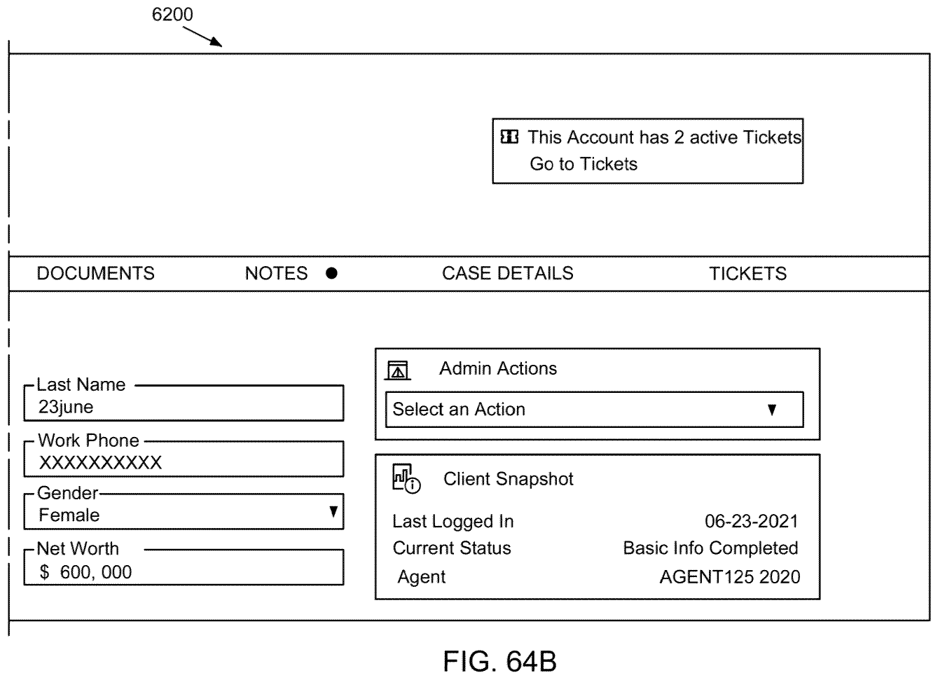

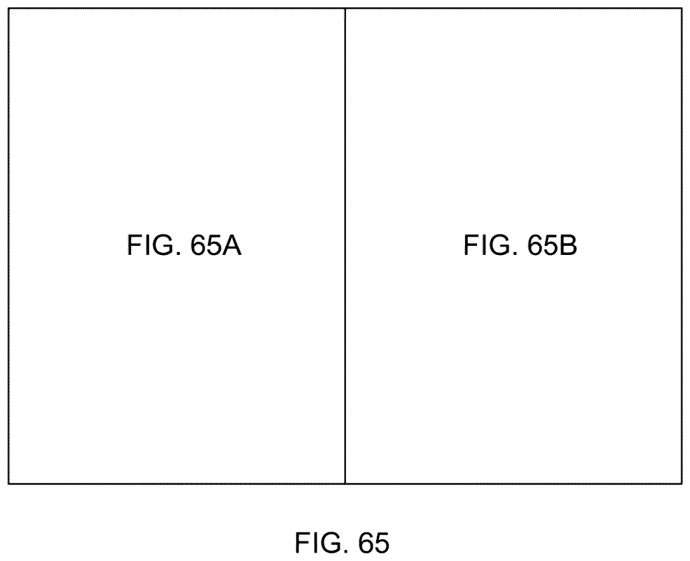

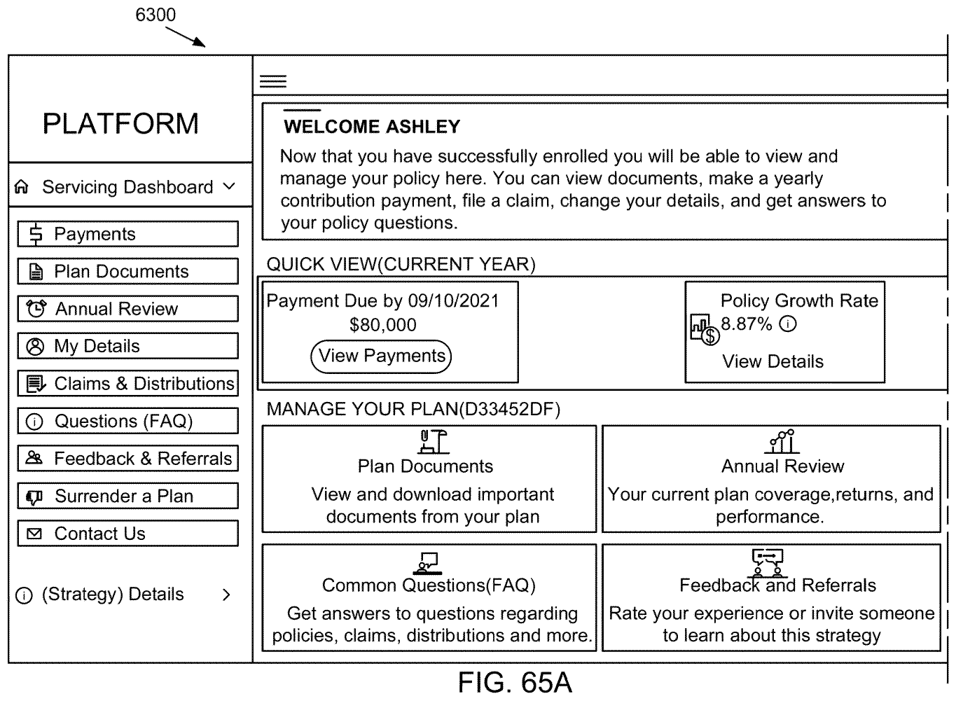

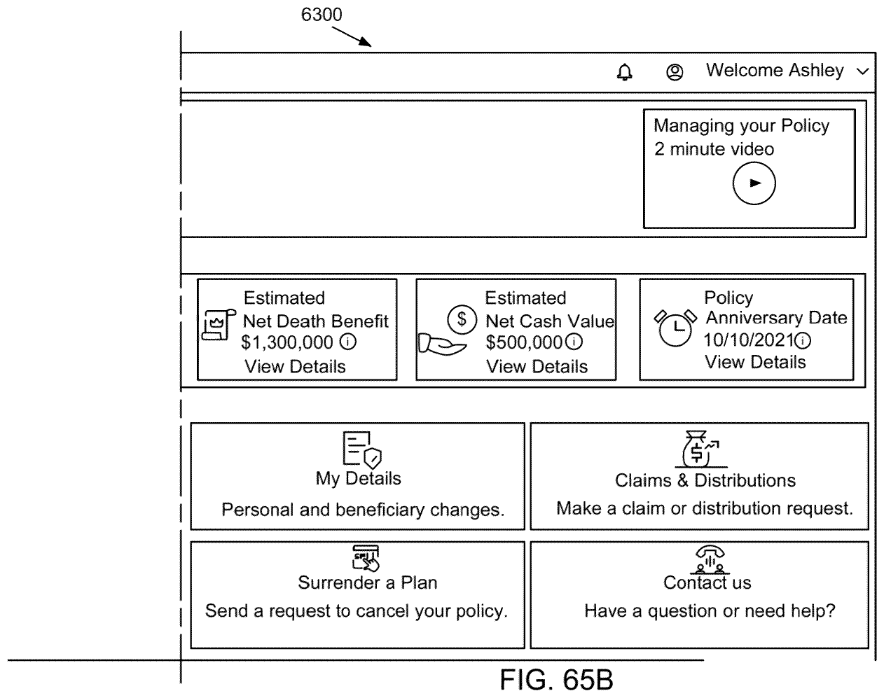

Referencing FIG. 63, an example ticket management interface 5900 is schematically depicted, divided into FIGS. 61A and 61B. Referencing FIGS. 64 and 65, an example enrollment landing pages 6200, 6300 for a client user, for example for a user of a platform supporting a wealth planning process, is schematically depicted, divided into FIGS. 64A and 64B and 65A and 65B, respectively. The example enrollment landing pages include various information helpful to the client user, including documentation, action items, notification, FAQs, training links, illustration links, and links to actions that may be applicable from time to time, such as changing beneficiaries, claims, distributions, etc. In certain embodiments, the enrollment landing page may be a service portal, and/or a client facing portion of a service portal for the client user.

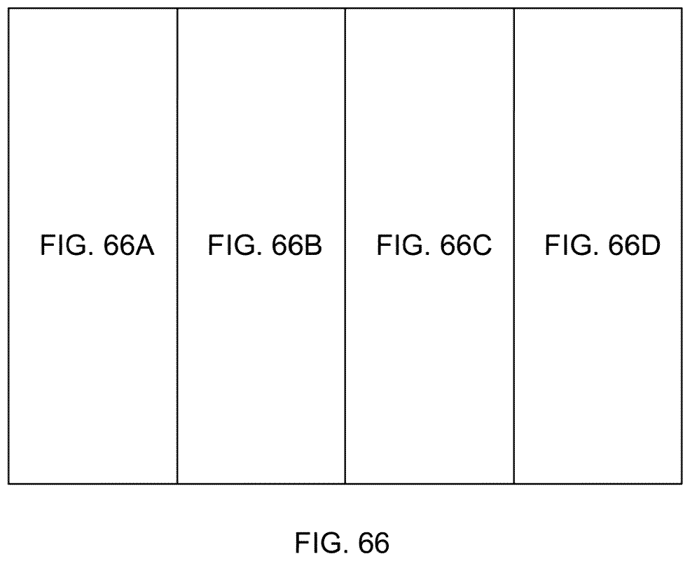

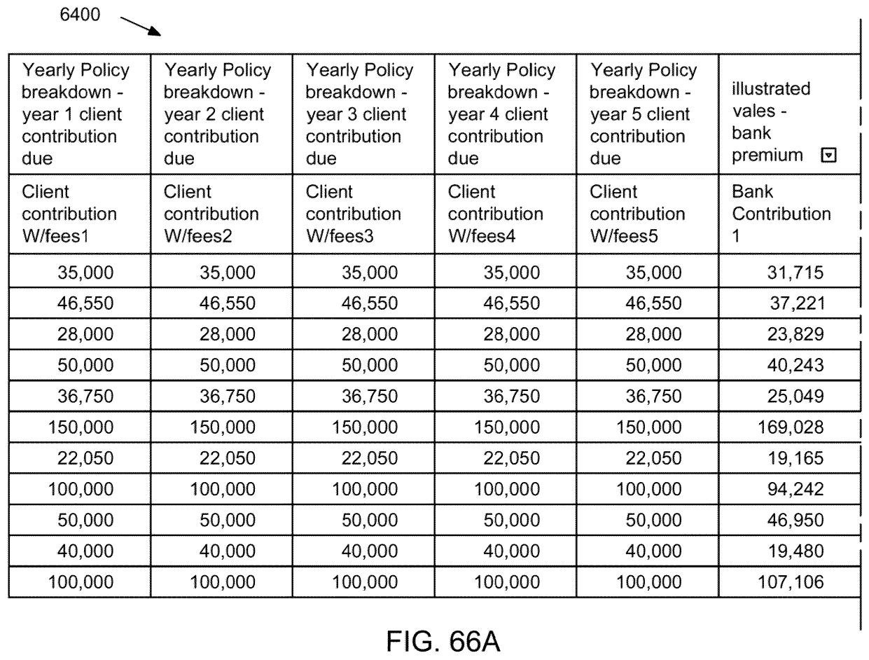

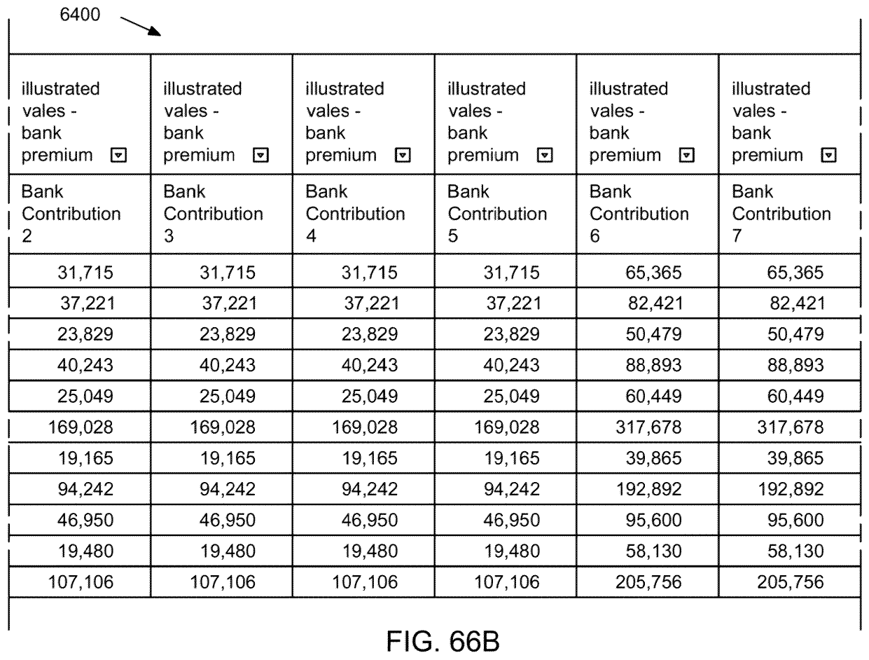

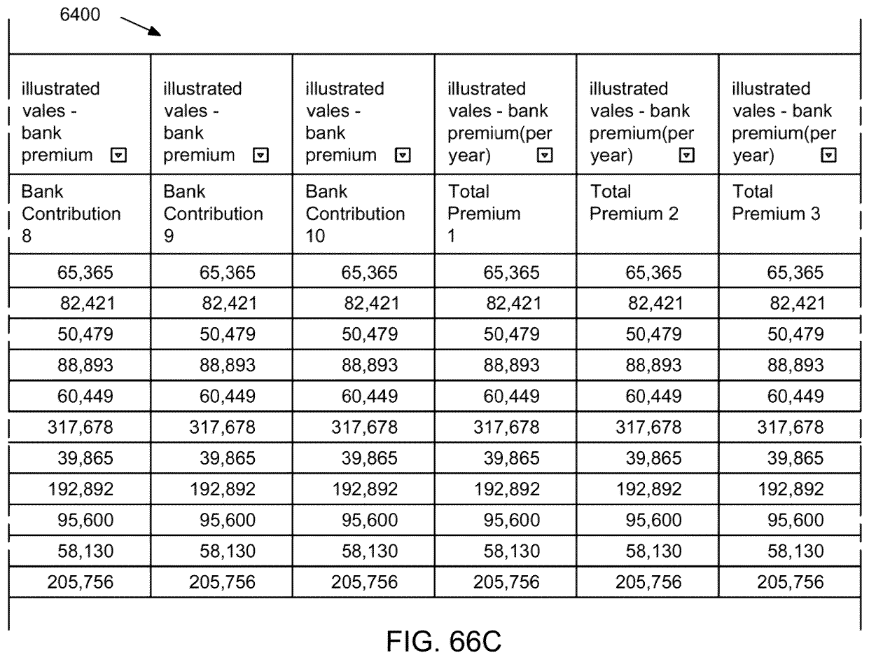

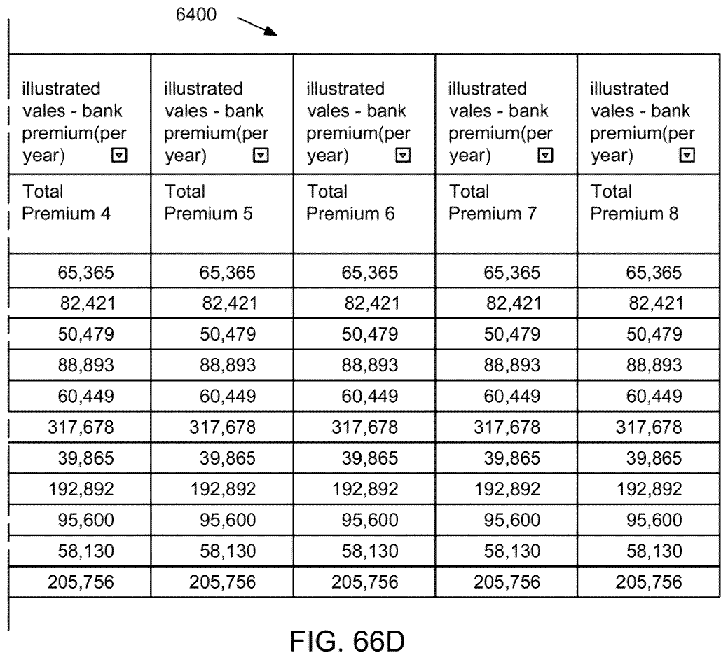

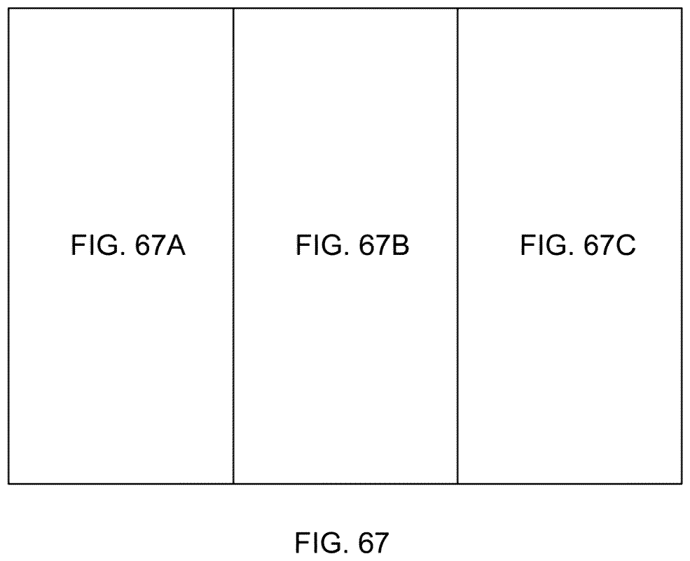

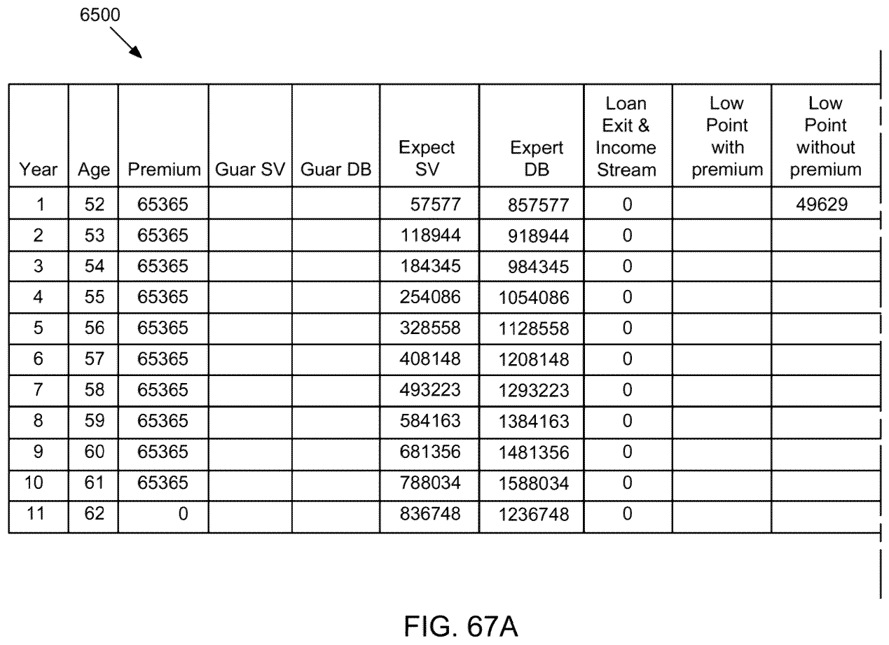

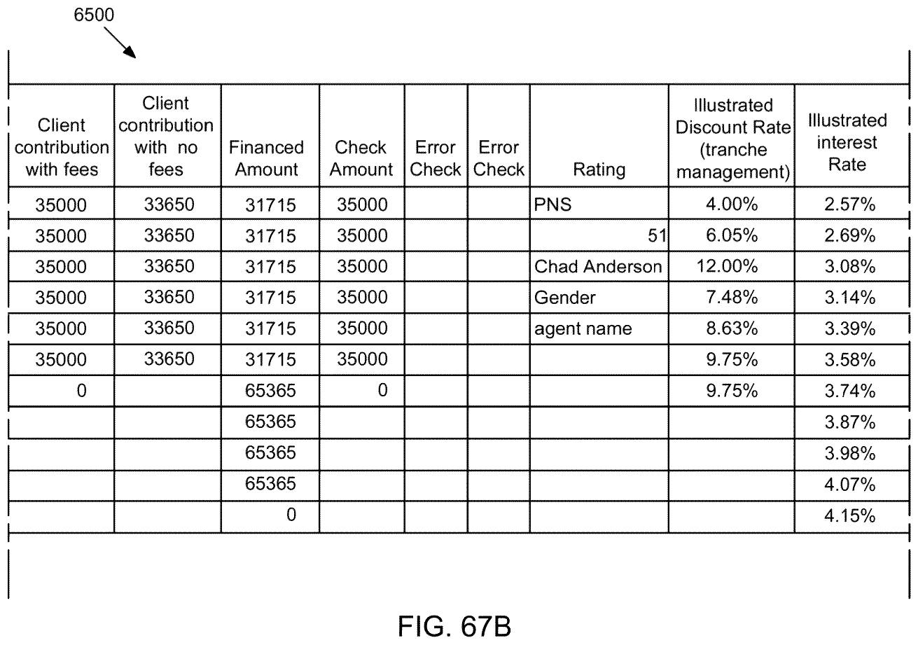

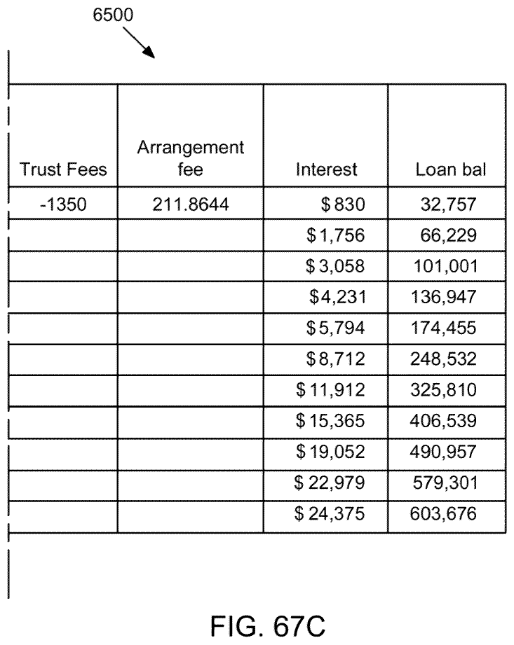

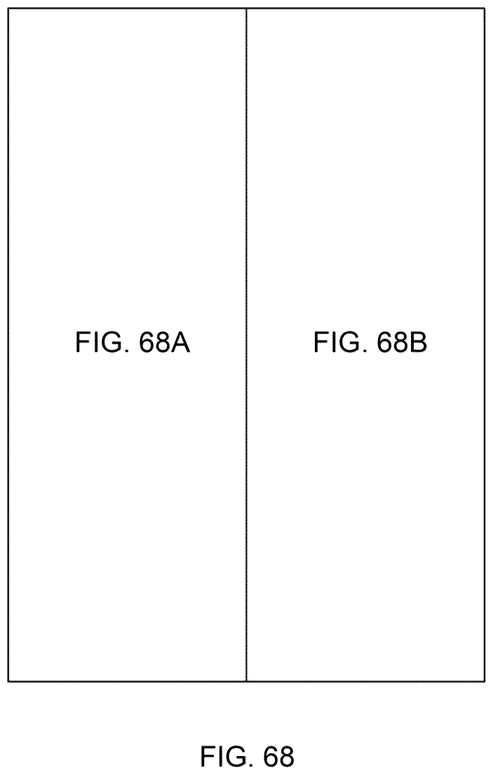

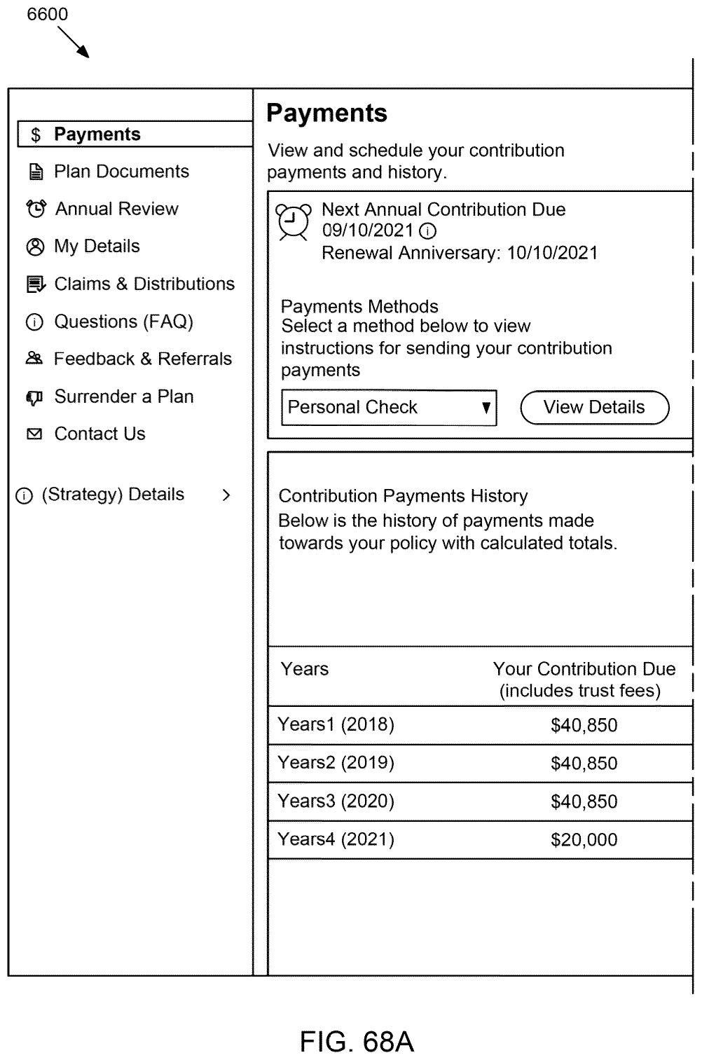

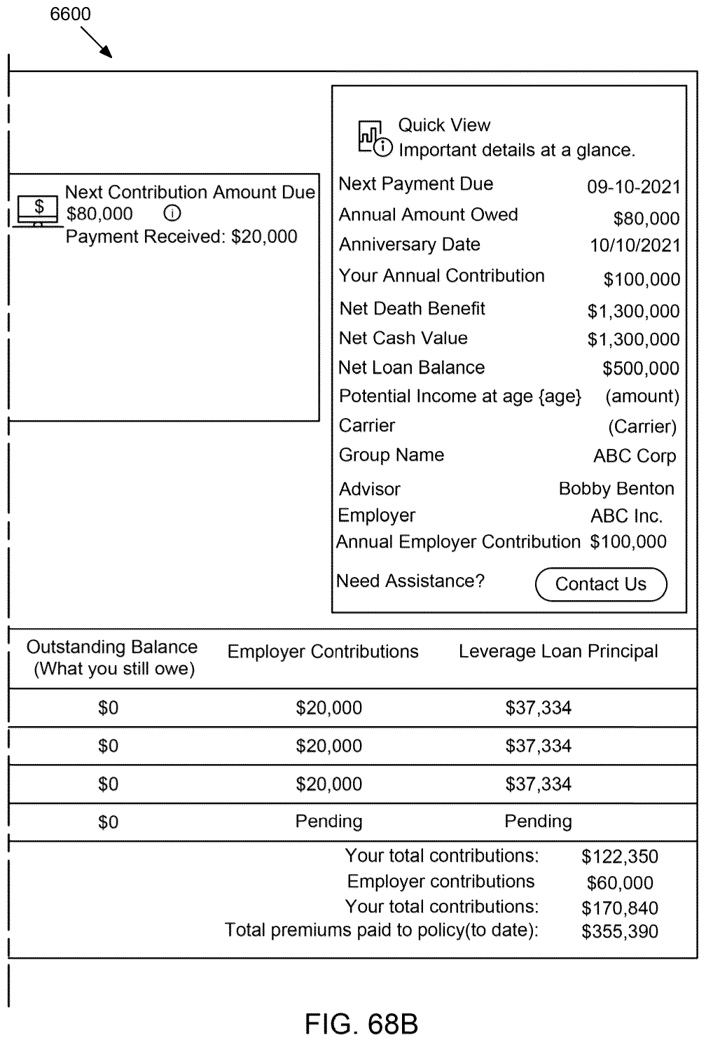

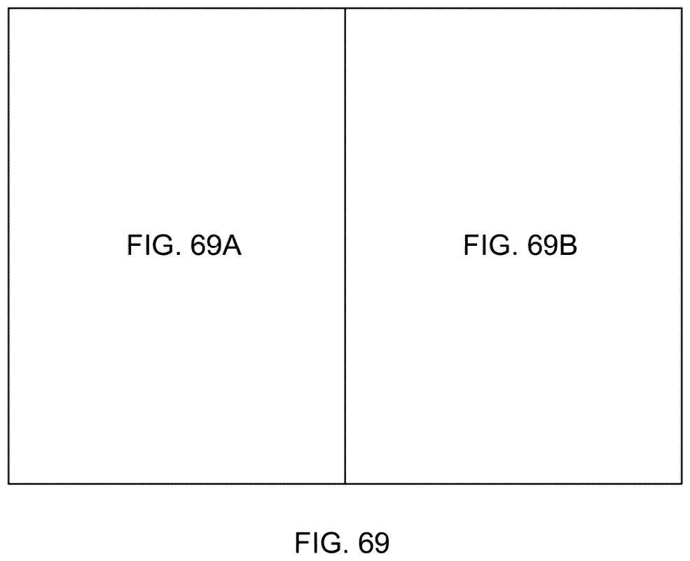

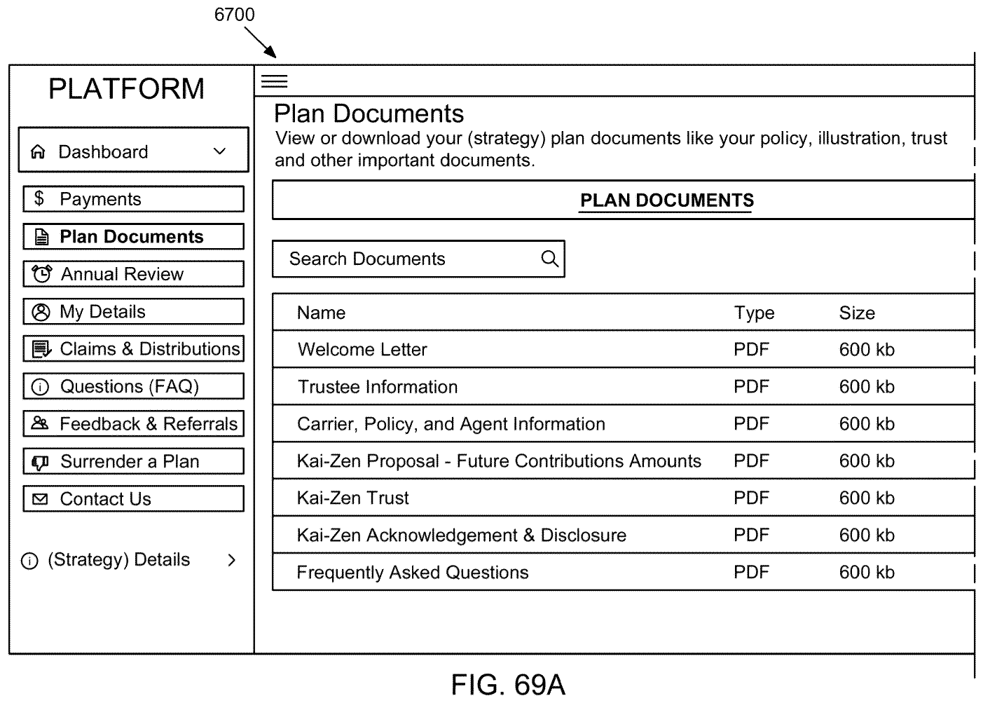

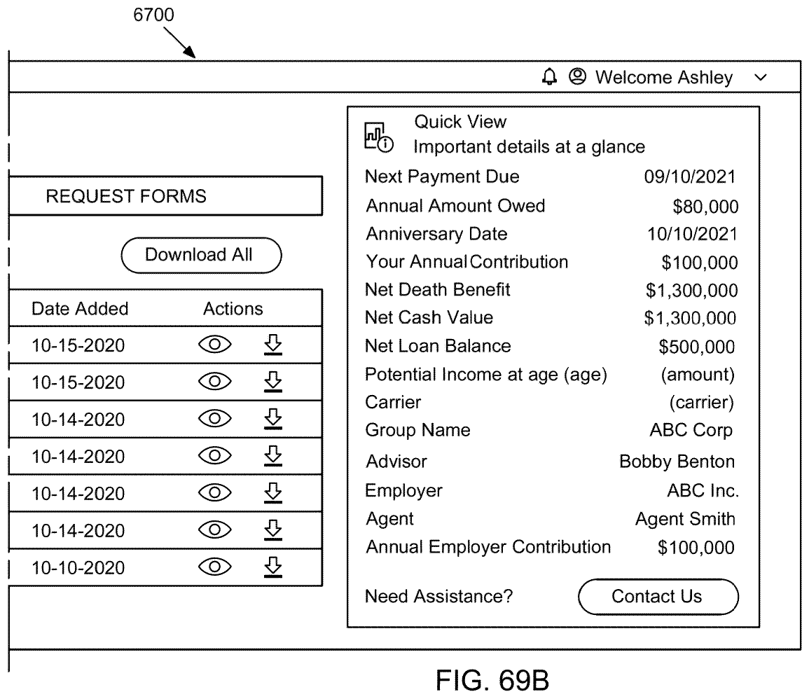

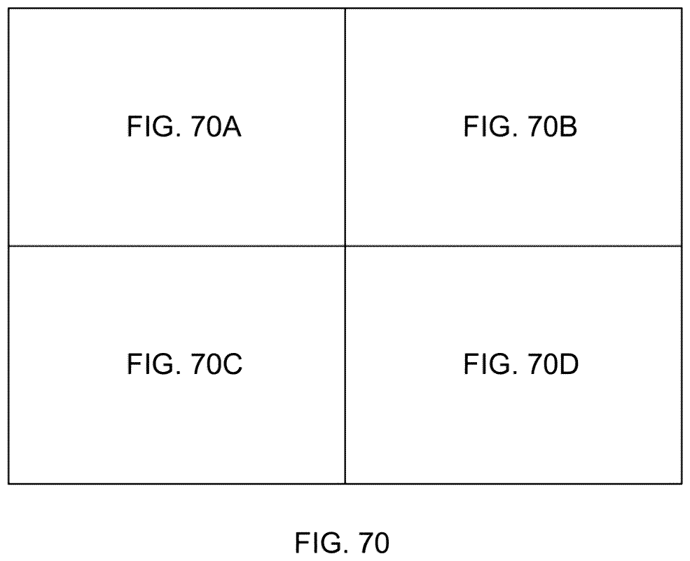

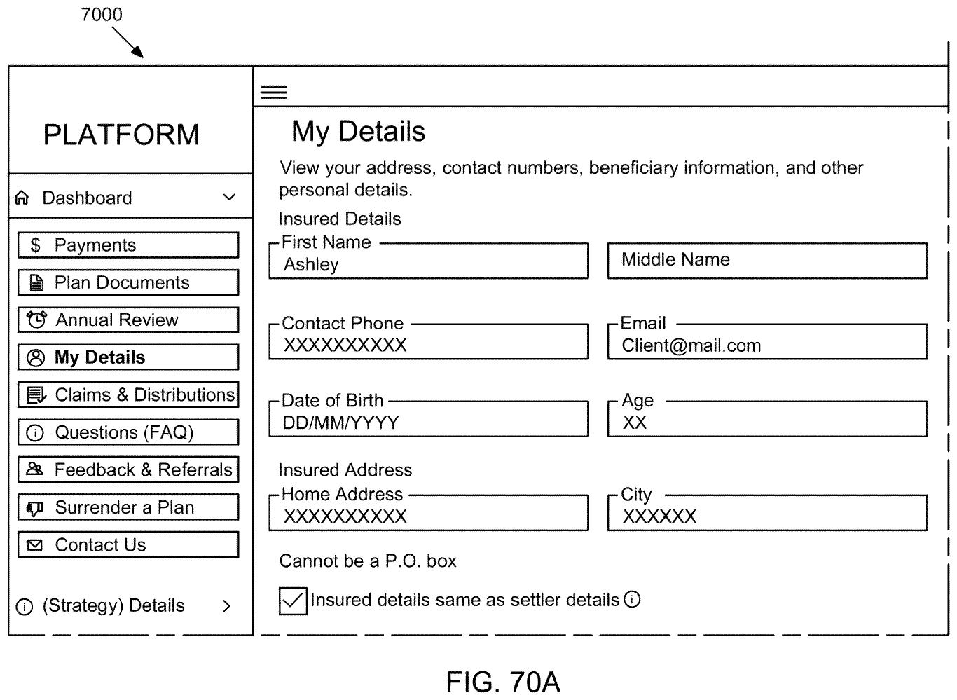

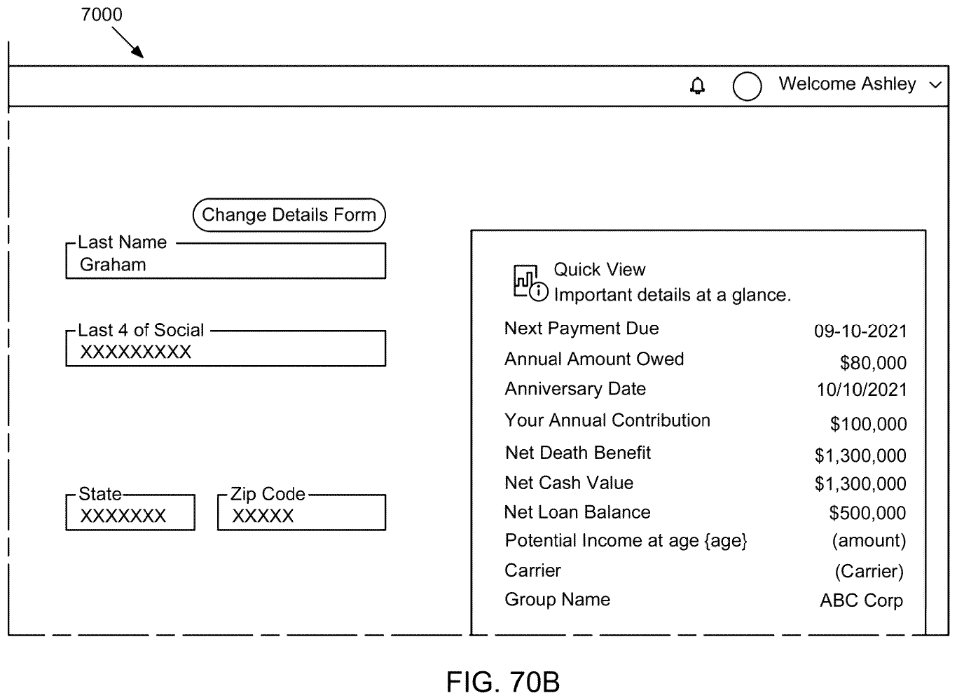

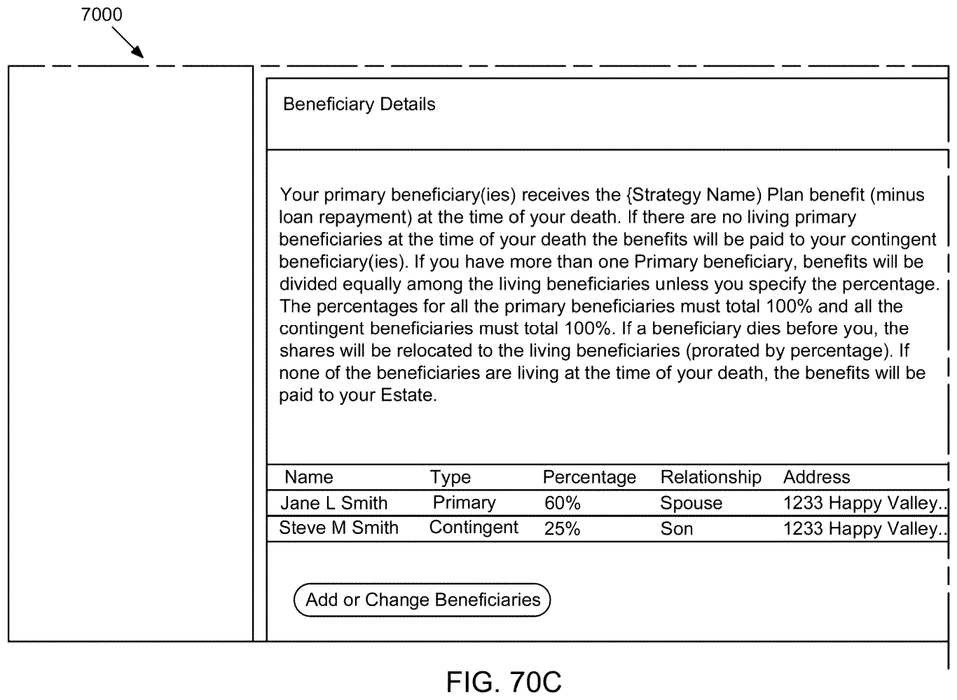

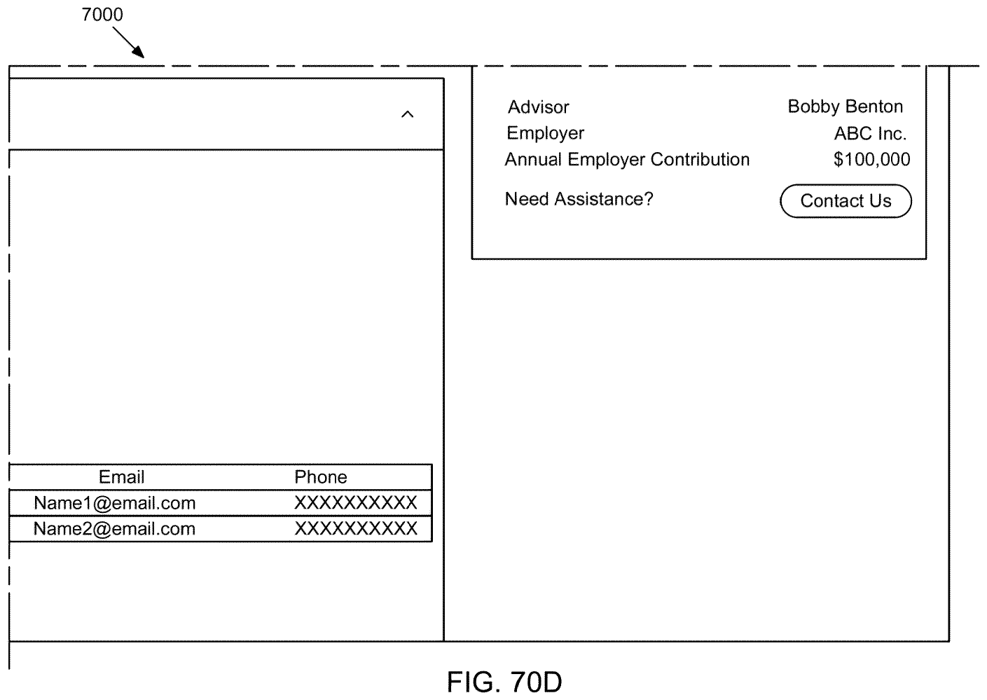

Referencing FIG. 66, another example illustration 6400 is depicted, divided into FIGS. 66A, 66B, 66C, 66D, for example accessible from the enrollment landing page and configured for the particular client. Referencing FIG. 67, another example illustration 6500 is depicted, divided into FIGS. 67A, 67B, 67C. Referencing FIG. 68, an example payment notification interface 6600 is depicted, divided into FIGS. 68A, 68B, and providing convenient information for client planning on payment dates, amounts, next payment to be made, and the like. Referencing FIG. 69, an example document summary page 6700 is depicted, divided into FIGS. 69A and 69B, allowing the client user, or another related user, to readily access, print, update, request changes to, etc., documentation on the platform, allowing the client user to access their documentation at any time in the life cycle of their plan. Referencing FIG. 70, an example client detail page 7000 is depicted, divided into FIGS. 70A, 70B, 70C, 70D, and allowing the client user to readily enter, confirm, and/or update client details that may be utilized to determine user class values, client descriptions, client attributes, or the like for a client user on the platform.

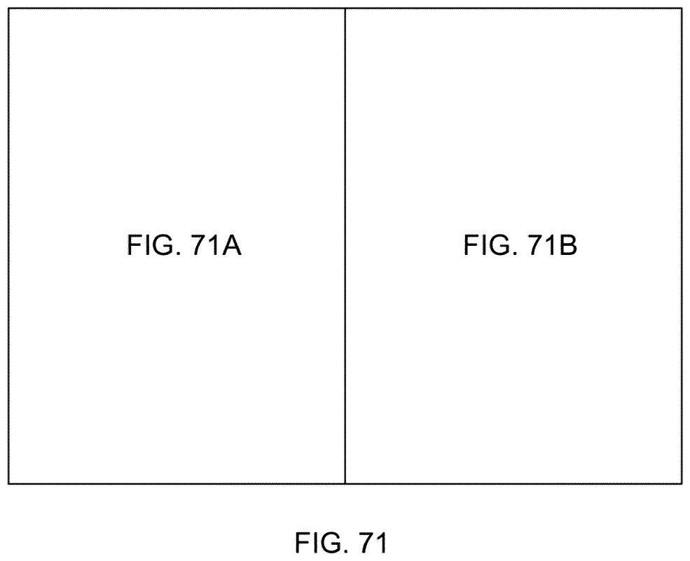

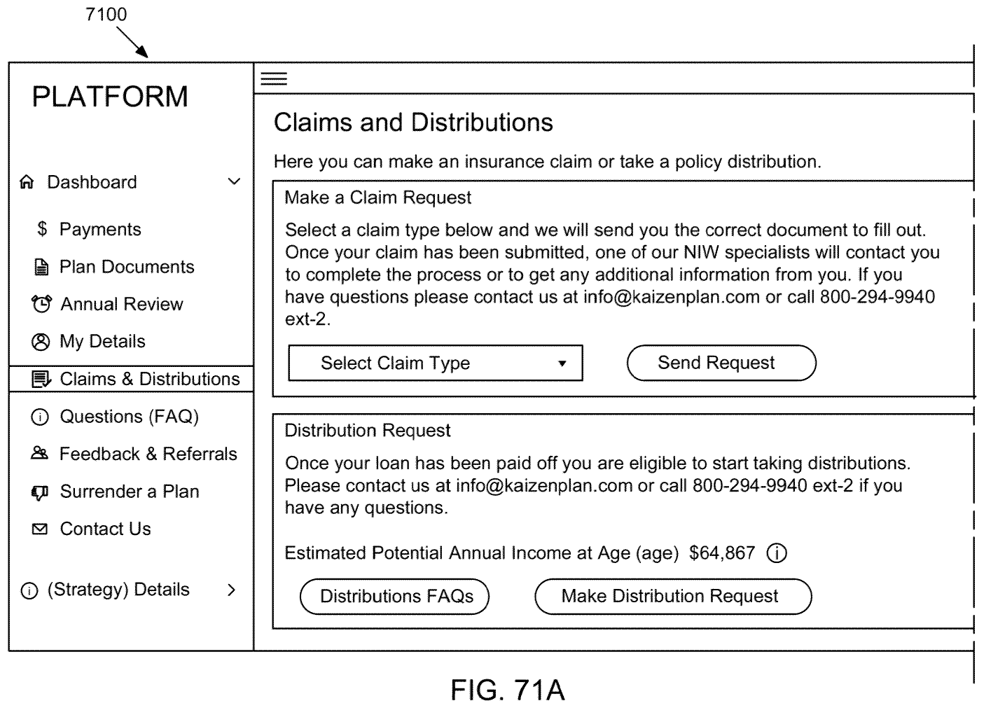

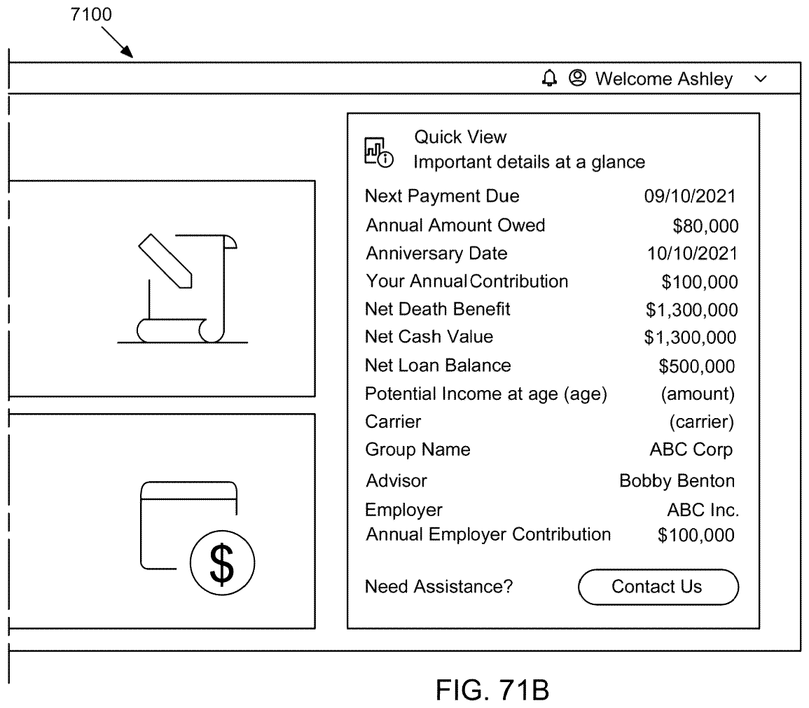

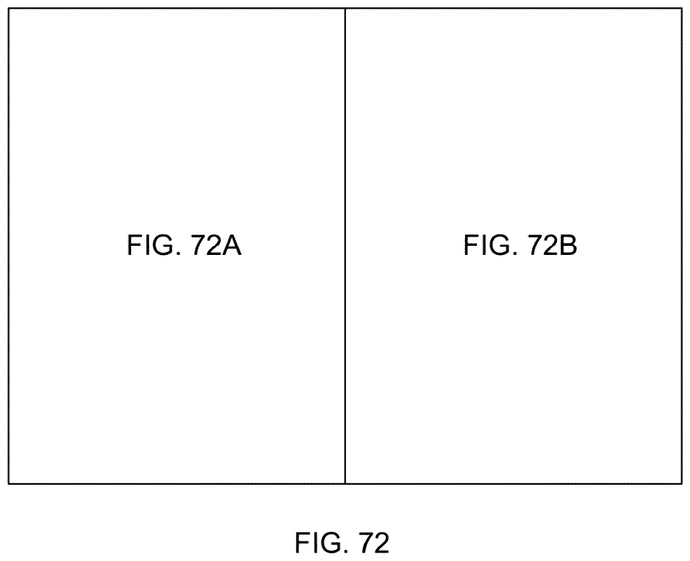

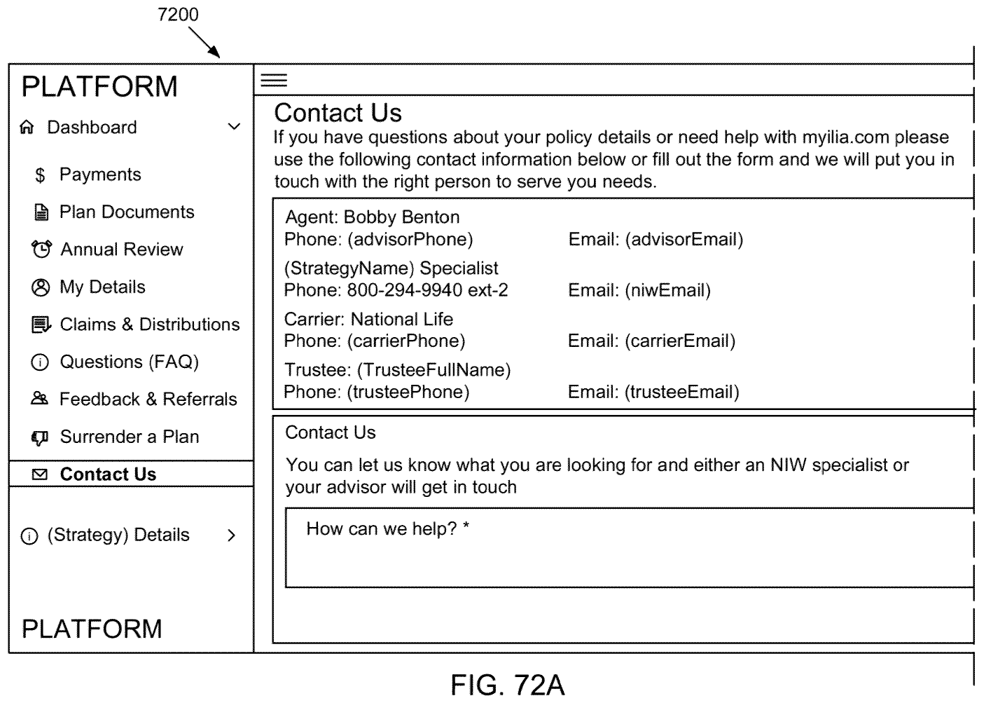

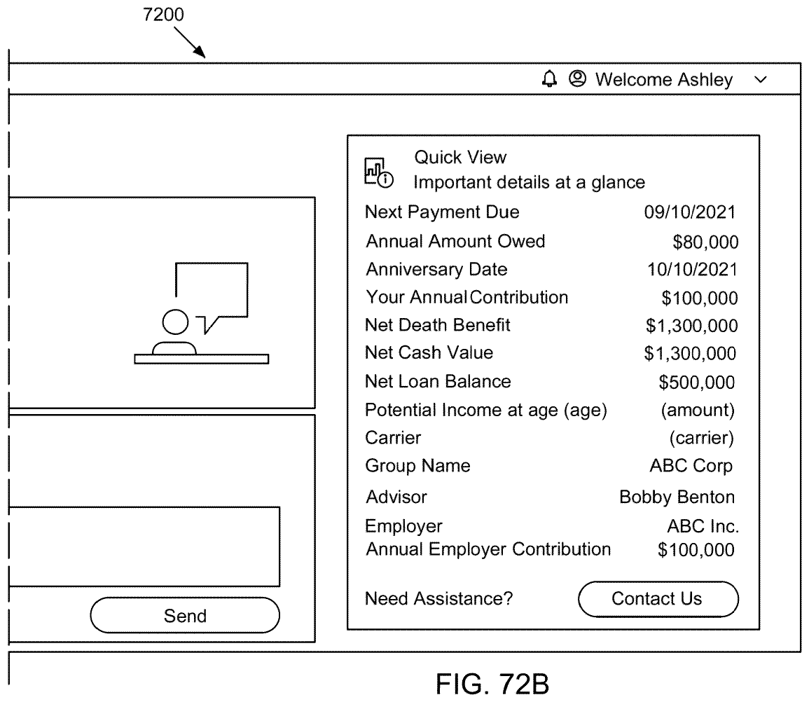

Referencing FIG. 71, an example initial interface 7100 for claims and distributions is depicted, divided into FIGS. 71A and 71B, and allowing a client user to begin the process of making a claim or taking a distribution, including interfaces to collect appropriate documentation, providing contact information, providing training materials, required notifications, or the like. In certain embodiments, the claims and distributions interface may additionally or alternatively depict adjustments to the performance of the plan based on the planned claim or distribution activity. Referencing FIG. 72, an example contact user interface 7200 is depicted, divided into FIGS. 72A, 72B, and allowing the client to readily contact any associated user of the platform, for example their agent, carrier, platform administrator, or the like. The contact information may be utilized outside the platform (e.g., calling the other user at the number depicted), or within the platform to take advantage of the process management tools of the platform (e.g., creating a notification and/or activity for the other user, with a due date or other criteria, where the platform can then track the response).

Previously known systems create illustrations for potential clients of wealth management products, but require that an expert analyst manually create and enter the data to create the illustration, and rely on significant manual input introducing the potential for error. Additionally, creating an illustration using live data, for example up-to-date information for coverage from insurers, financial terms for banks, financial performance for investment products, and/or users-specific data (e.g., age, gender, ratings such as health and credit ratings) requires additional research, data gathering, and manual data entry in previously known systems. Additionally, previously known systems are not accessible to the client or customer, and are not updated using live data once the financial plan is implemented (e.g., five years into the execution of the financial plan).

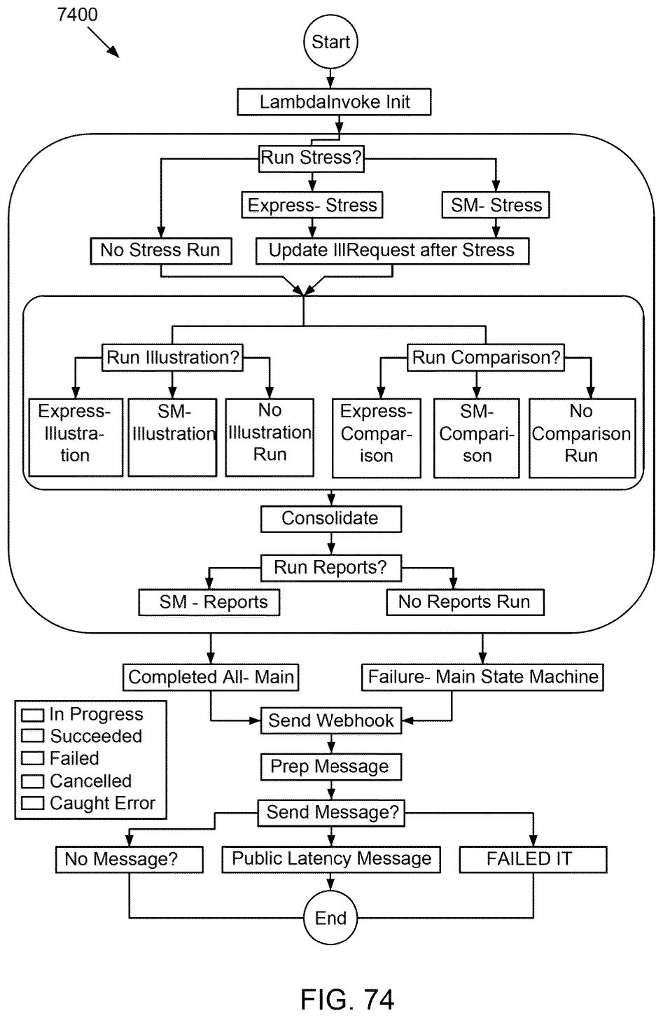

Referencing FIGS. 74-82, example and non-limiting operations and aspects of an automated smart illustration system are schematically depicted. The examples of FIGS. 74-82 may be performed by, and/or may embody at least in part, any controllers, circuits, computing devices, or the like, as set forth throughout the present disclosure, for example with illustration inputs provided using an illustrations interface circuit, intelligent illustration operations performed by an analytics interface circuit and/or analytics toolbox, and reports (e.g., to clients, agents, carriers, banks, etc.) provided by the illustrations interface circuit to the appropriate locations (e.g., communications, notifications, providing visualizations and/or summaries to an application interface, etc.).

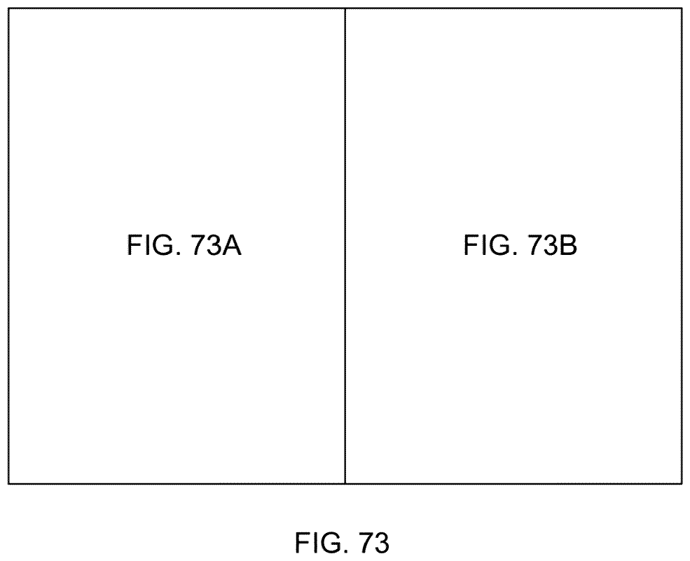

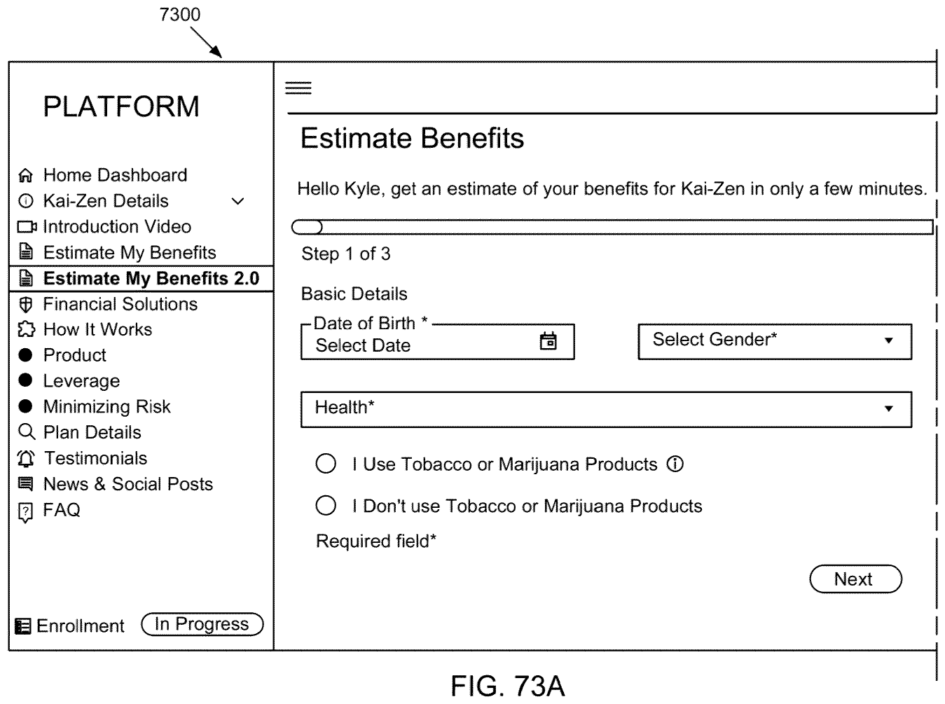

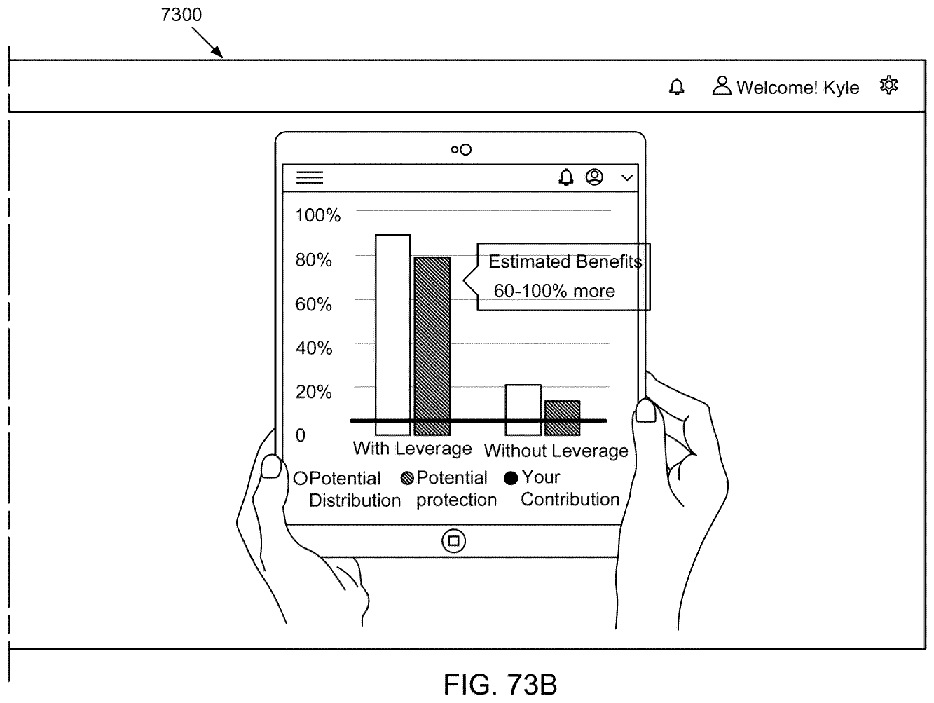

Referencing FIG. 73, an example benefits estimator interface 7300 is schematically depicted, divided into FIGS. 73A and 73B, allowing a client to get a preliminary estimate of the benefits of a plan enrollment, and to provide basic information to complete an initial illustration, for example an illustration to be provided to a client that is contemplating enrollment to a wealth management program, an agent determining the applicability of a program for a client, and/or an agent or the client determining the available benefits and performance of a program for the client. For example, the interface of FIG. 73 depicts the age, gender, health, and basic information such as an indication of tobacco use. In certain embodiments, the interface of FIG. 73 may include any other information that would assist in providing an informative initial illustration, such as credit ratings, income information, asset information, goals of the client (e.g., death benefit, charitable contribution targets, income generation, etc.), and/or omit one or more aspects depicted in the example of FIG. 73. In certain embodiments, the information on an interface such as FIG. 73 is tailored to the goals of the illustration—for example information that is more likely to inform a quick determination of the applicability of a program, information that is selective in determining whether a program is applicable to the client, or the like. In certain embodiments, the information available on interfaces such as in FIG. 73 is adjusted by an artificial intelligence (AI) and/or machine learning component, for example determining information that is highly selective of the applicability of a target program, information that correlates with successful enrollment, and/or information that correlates with successful implementation.

Referencing FIG. 74, an example workflow to perform illustration operations is schematically depicted. In certain embodiments, the workflow is executed by a controller or circuit of the present disclosure, and does not need to be accessed or even understood by the client, agent, or other user of the system. The example workflow interrogates providers for aspects of the program, for example insurers, banks, and/or investment entities, for example utilizing standardized data provided by the providers, exercising an API to interrogate provider systems and tools directly, utilizing provider performance models (e.g., built from previous provider interactions or implementations), or the like. The utilization of actual provider information to implement the program greatly enhances the resolution and reliability of the illustration, and allows for rapid generation of illustrations. The utilization of rapid and high quality illustrations provides for a number of benefits that are not available in previously known systems, for example allowing clients to quickly understand the benefits of a program, to adjust goals of the program to understand what is achievable and what inputs (e.g., client contributions) achieve what results, to get real-time performance updates including a comparison of actual performance relative to planned performance. Additionally, in certain embodiments, illustrations are stored and identified (e.g., with a dedicated identification parameter for each illustration), allowing greater reporting depth (e.g., comparing prior illustration performance to actual performance, which may be more informative than a single point of comparison, such as comparison of a dollar amount at a single point in time), and further allowing for greater reliability and visibility to corrections (e.g., when an input value is determined to be in error, for example a carrier premium amount, identification of illustrations as an object allows the relevant illustrations to be updated, and the relevant parties, such as clients, agents, etc., to receive notifications of the correction, and convenient access to updated illustrations based on the correction).

The example of FIG. 74 includes execution of a stress test on the illustration, for example testing a range of assumptions and/or potential negative events, that allows for the planning of the program to account for potential disturbances, to ensure that aspects of the plan are sufficiently funded (e.g., cash value versus loan amounts), or the like. The stress test includes, beyond what is available in previously known systems, tying the stress test information into illustrations, annual updates, and/or other communications to the client and/or an agent, performing the stress test on a greater range of disturbance criteria (e.g., retirement age, investment returns, life events, tax scenarios, contribution changes, etc.). The utilization of the smart illustration component allows for numerous permutations of the program inputs, where previously known systems are necessarily limited to a few scenarios that have to be carefully selected by an expert analyst.

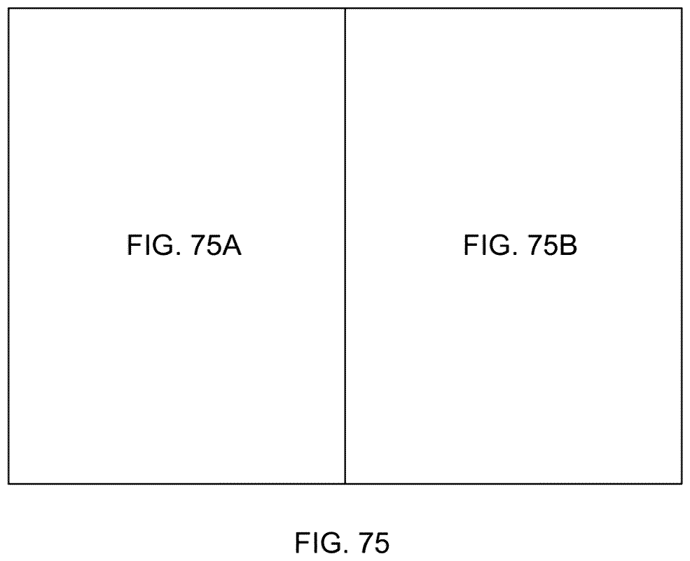

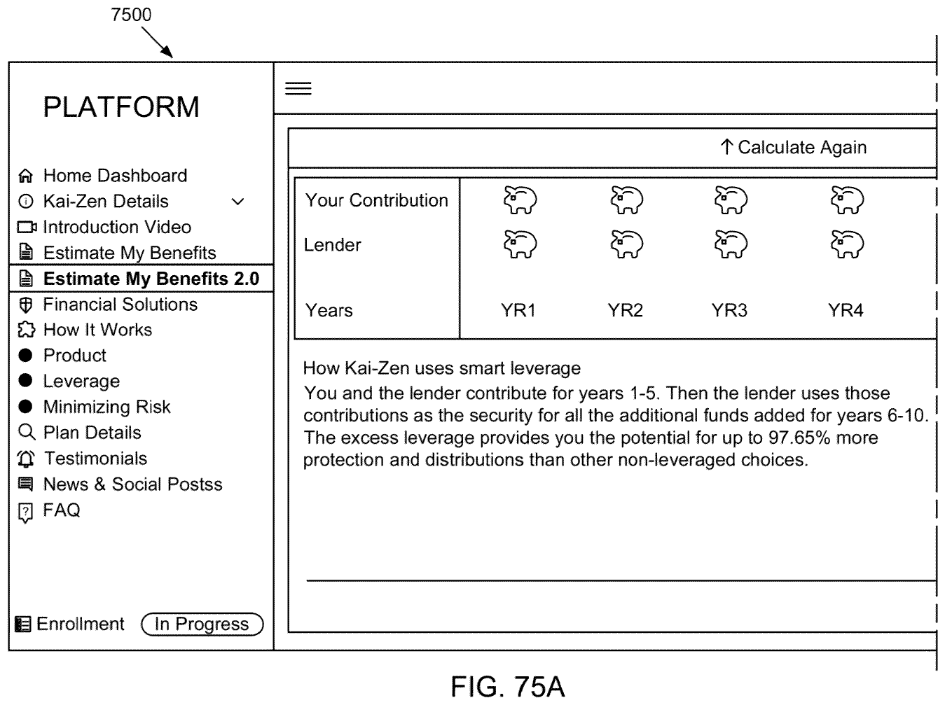

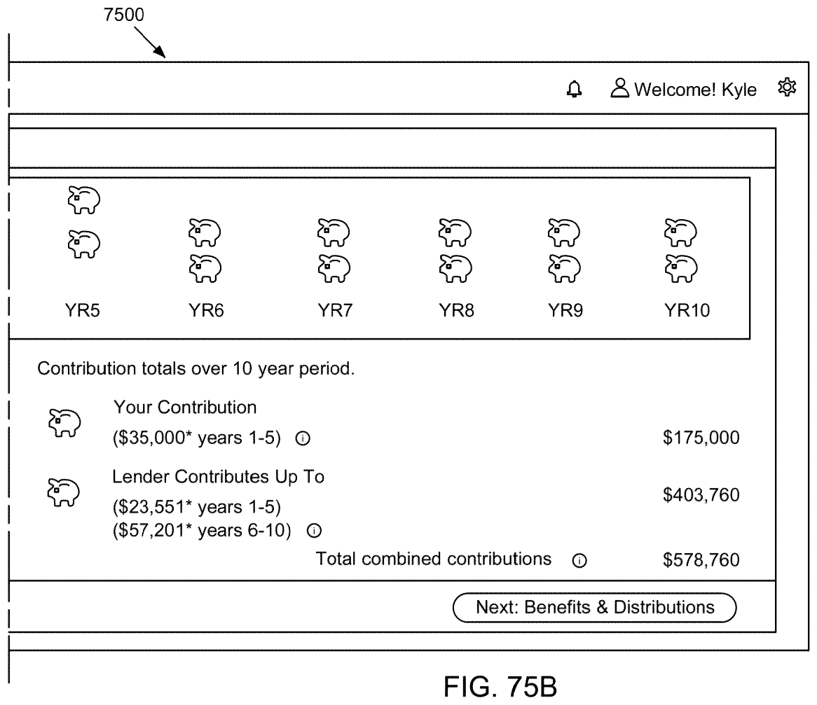

Referencing FIG. 75, an example high level illustration 7500, divided into FIGS. 75A and 75B, for example that may be presented to a client and/or an agent, showing financial aspects of the program over time. In the example of FIG. 75, a high level depiction of client contributions and lender contributions to the program is schematically depicted. Illustrations such as in FIG. 75 provide the client with an understandable view of the expected performance and consequences of the program.

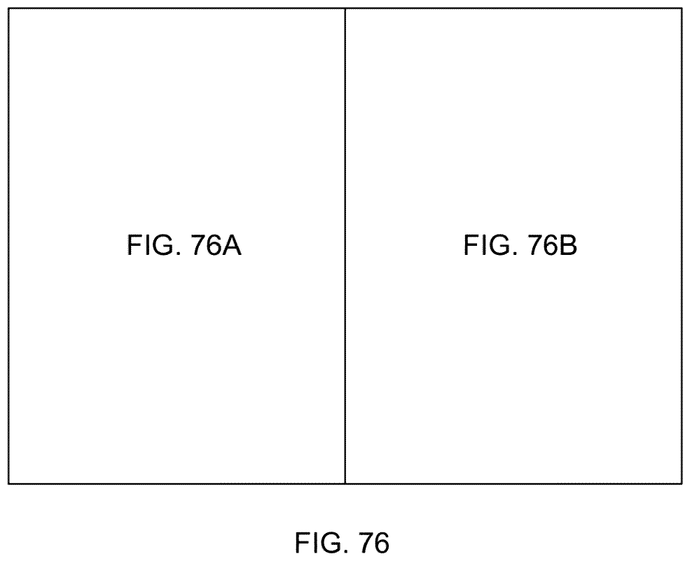

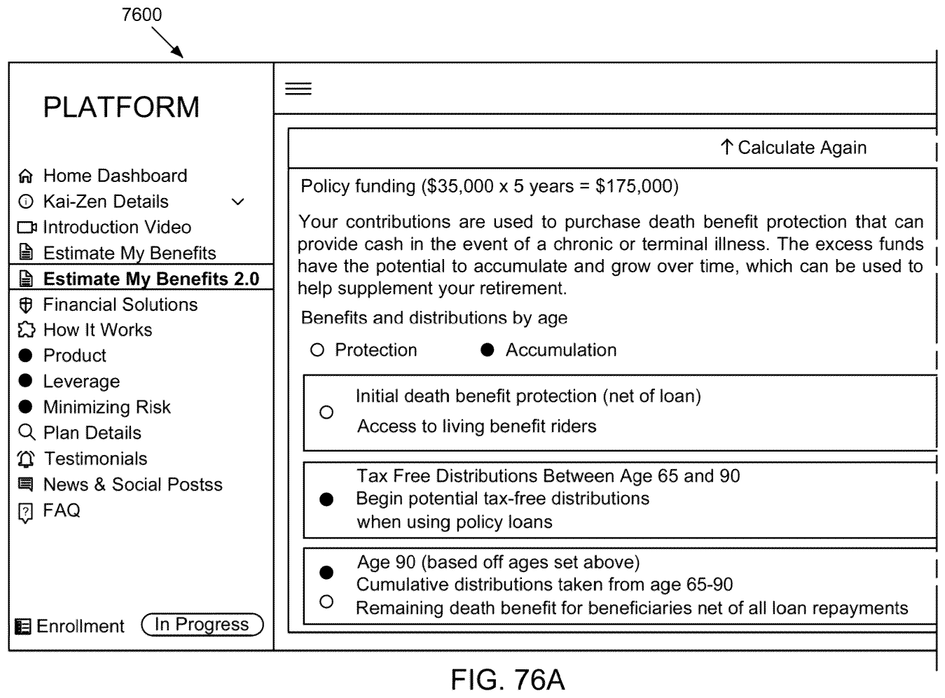

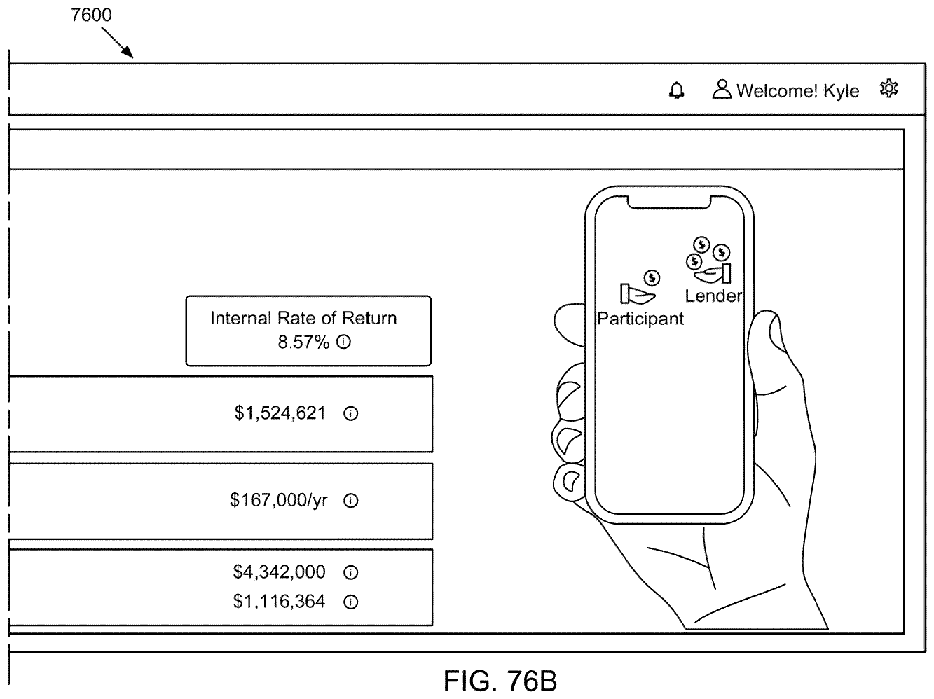

Referencing FIG. 76, an example high level illustration 7600, divided into FIGS. 76A and 76B, for example that may be presented to a client and/or an agent, showing financial aspects of the program over time. In the example of FIG. 14, a high level depiction of investment performance, death benefits, and income amounts, is schematically depicted.

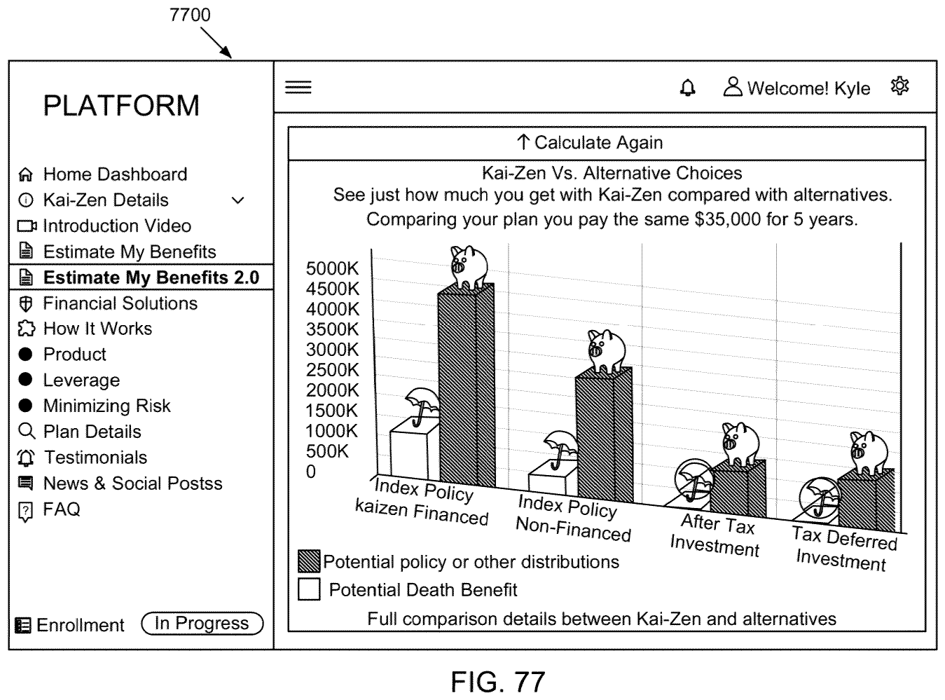

Referencing FIG. 77, an example high level illustration 7700, for example that may be presented to a client and/or an agent, showing comparative financial aspects of the program to other options (e.g., a baseline program, a control program, another configured program, etc.). In the example of FIG. 77, a comparison of death benefit and distributions for each program, for a fixed contribution amount, is schematically depicted. The example of FIG. 77 depicts similar information to the example of FIG. 76, in a table format.

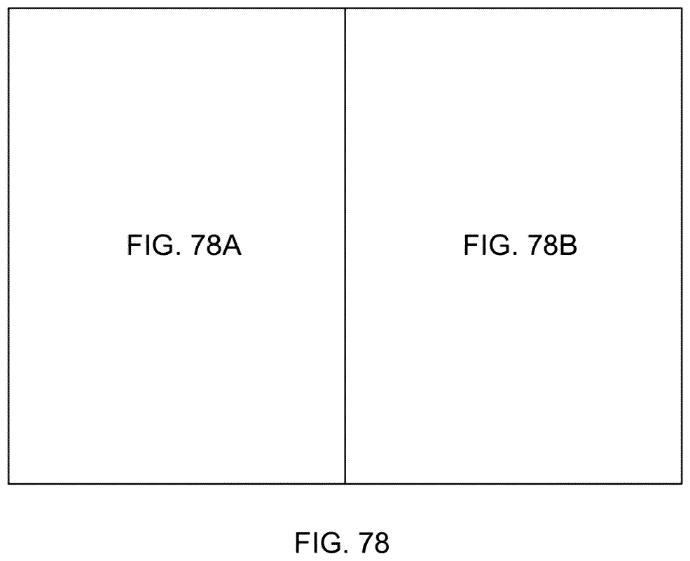

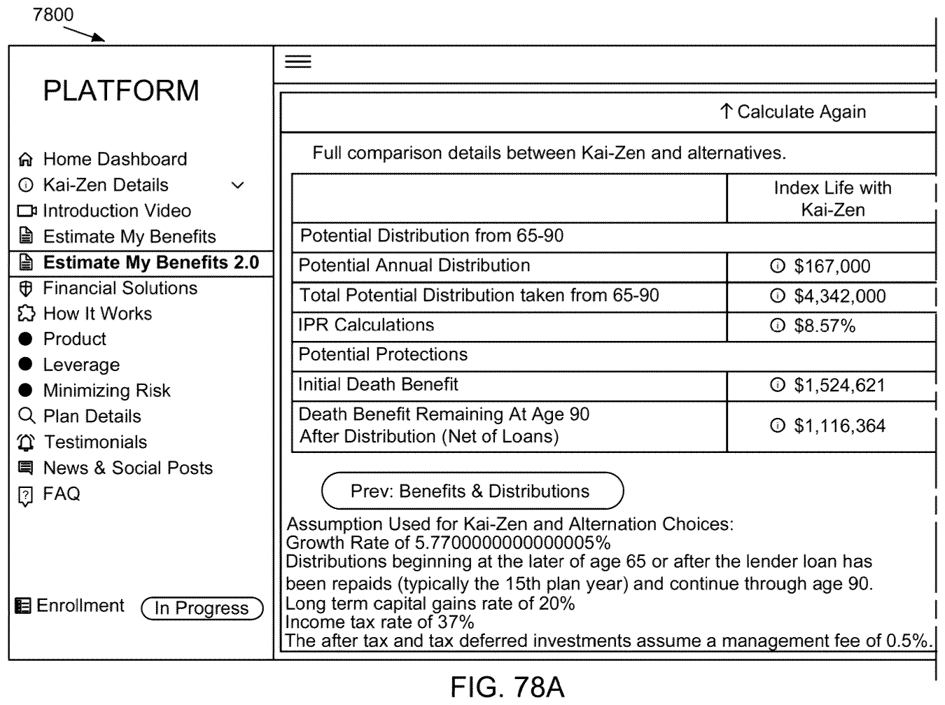

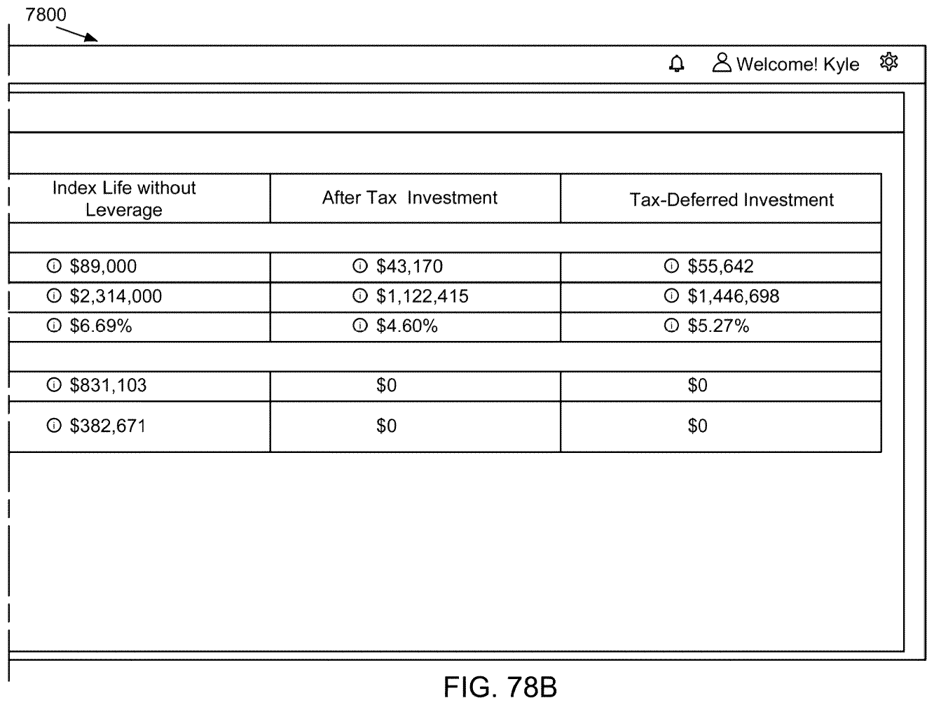

Referencing FIG. 78, an example comparative illustration 7800 is schematically depicted, divided into FIGS. 78A and 78B.

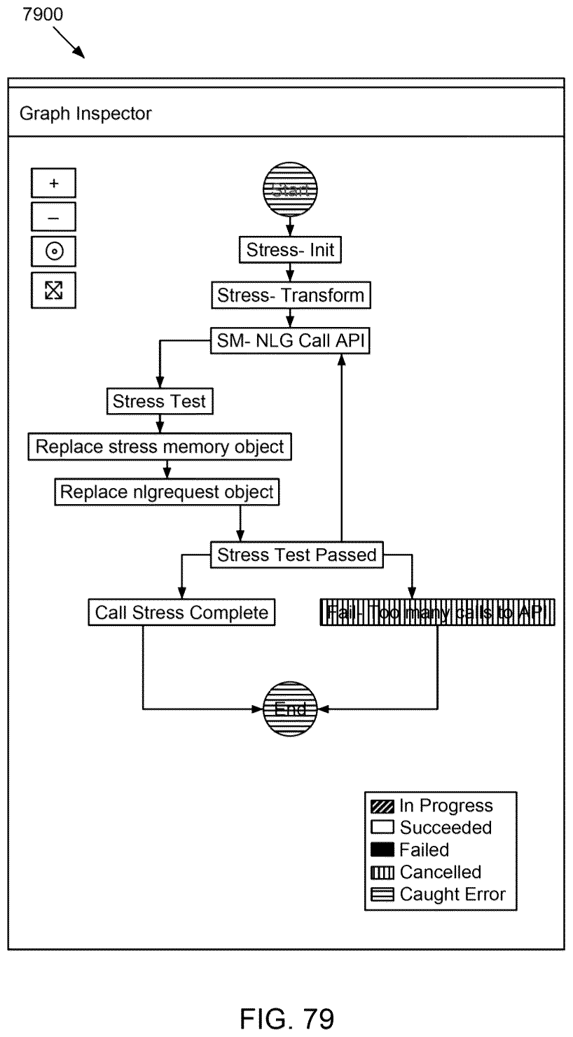

Referencing FIG. 79, an example workflow 7900 for performing the stress test is schematically depicted. The example of FIG. 79 performs API calls to get provider information (e.g., insurance rates, investment product data, etc.), and iterates through the workflow until a selected value converges (e.g., target death benefit, distribution amount, retirement age, contribution amount, etc.). In the example of FIG. 79, a successful stress test outputs information utilized in the illustration, such as actual death benefit, distribution amounts, low point amounts (e.g., the lowest position of cash versus loans, etc.), and/or any other information relevant to the stress test (e.g., highly sensitive parameters, risk points, etc.). In the example of FIG. 79, an unsuccessful stress test (e.g., inability to converge on the selected value, violation of an aspect such as a low point test, etc.) returns information, for example to the illustration interface, indicating that the planned program will not work, may not succeed if a disturbance occurs, or the like. In certain embodiments, the returned information for an unsuccessful stress test may include identifying parameters that prevented success of the stress test, for example contribution amounts and/or client characteristics, for example to assist the planner (e.g., an agent, financial analyst, or the client) to adjust the plan to make it successful.

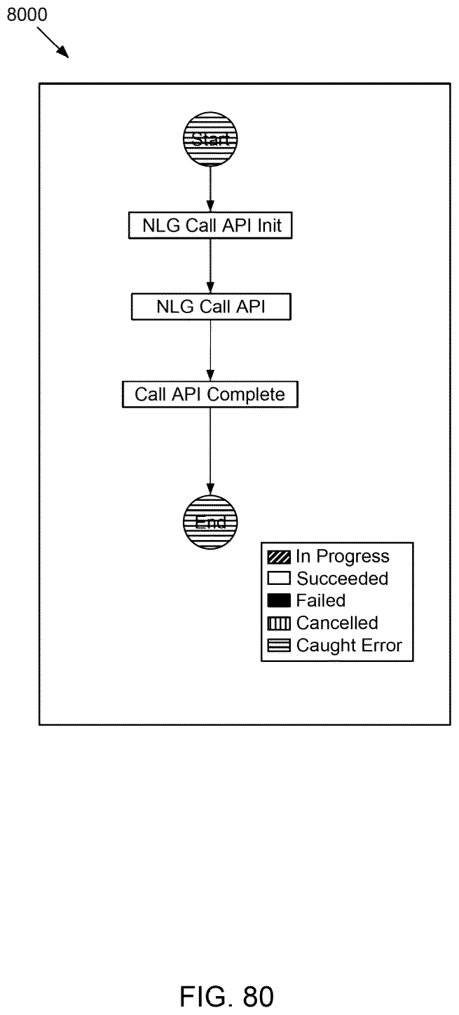

Referencing FIG. 80, an example API call 8000 is schematically depicted, for example which may be utilized to access carrier information, bank information, and/or investment provider information, to complete analysis for the illustration. In certain embodiments, such information may be retrieved by any method set forth in the present disclosure, for example accessing a data object scraped from provider information, accessing a model of provider performance, or the like.

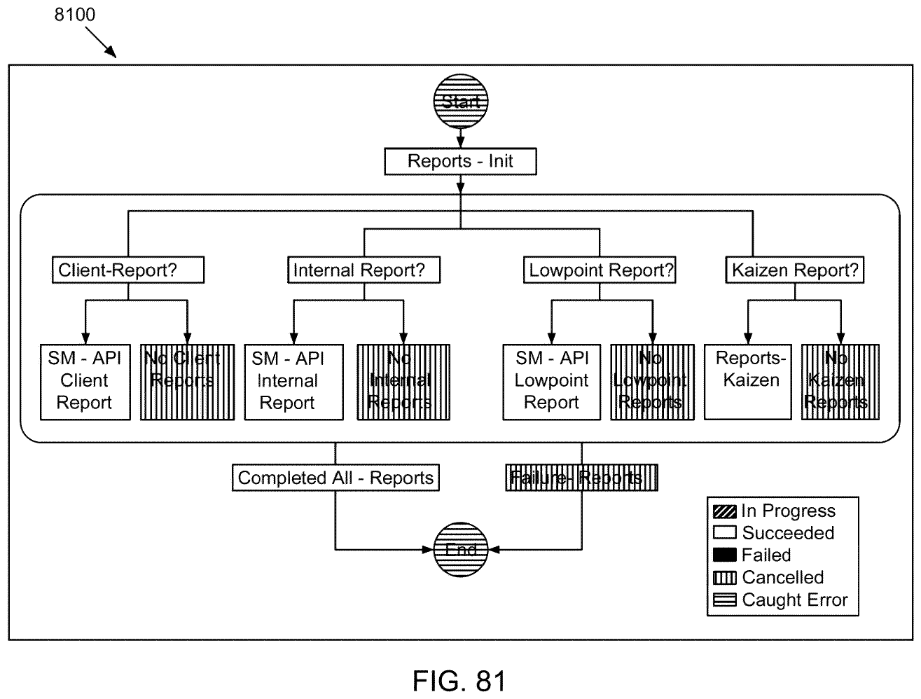

Referencing FIG. 81, an example of a workflow 8100 for providing a number of reports related to smart illustration generation is schematically depicted. The example reports are a non-limiting illustration. In the example of FIG. 19, the reports are generated in parallel, where a report of interest can be generated before other reports, and/or one or more reports may be omitted depending upon the purpose for generating a report, and/or the operations of the system that are calling the report generator. The example reports include a client report, for example providing an illustration that includes information of interest to the client, such as investment returns, death benefit amounts, distribution amounts, contribution amounts, or the like. The example reports include an internal report, which may include information that is in-depth or background information relative to the client's perspective, but that is useful for an analyst in post-processing of program performance (e.g., diagnosing why a plan performed well or poorly), that is useful for AI or ML operations for iterative improvement of plan elements, customizing plans for particular client characteristics, creating plans that are less sensitive to disturbances, etc. In certain embodiments, the internal report, and/or aspects of the internal report, may be stored anonymously, for example allowing utilization of plans and plan performance without exposing personally identifiable information (PII) for the relevant party (e.g., a client). The example reports include a low point report, for example depicting selected risk points or points of interest related to the plan, including for example a lowest cash point relative to loan amount. In certain embodiments, aspects of the low point report may be included on other reports, such as the client report. In certain embodiments, aspects of the low point report may be of interest to certain providers, such as a bank contributing a loan to the plan. The example reports include a Kaizen report, which is an example name for a program or plan, and which may be a report with any selected information, such as details of the plan performance, a summary of assumptions and/or inputs, and/or a comparison of the plan performance to other plans, such as a baseline plan, control plan, and/or an alternative plan. The reports may be generated, in whole or part, at any point in a wealth management program life cycle, such as before enrollment, post-enrollment, periodically during implementation, in response to a request, in response to a life event, or the like.

Referencing FIG. 82, a workflow 8200 for a test illustration is schematically depicted. In certain embodiments, a test illustration may be utilized to confirm any aspect of the entire system is still functioning as expected. For example, the test illustration may be implemented using a range of inputs (e.g., client characteristics, such as age, gender, retirement age, health and/or credit information, etc.), target providers (e.g., insurance carriers, banks, investment providers), and/or plan characteristics (e.g., investments, insurance products, loan products, etc.). The utilization of a test illustration allows for the platform to confirm the integrity of plan operations, for example allowing the system to quickly diagnose significant changes (e.g., in an insurance provider schedule). The test illustrations may be executed periodically (e.g., every 30 minutes, once a day, once a week, etc.), upon request, in response to events and/or inferred events (e.g., based on an indicated change from a provider, and/or based on a provider update schedule), and/or may include performing sequenced and/or cycled test illustrations for varying inputs, providers, and/or characteristics over time. Additionally or alternatively, test illustration scheduling may be varied according to test aspects, for example test illustrations to ensure target provider information is correct may be performed on a different schedule than test illustrations to ensure that plan characteristics are correct. Where the test illustration indicates that a plan aspect may not be correct, embodiments include performing updated illustrations for relevant clients (e.g., clients having a plan aspect that may be affected by the updated information determined from the test illustration), which may be performed immediately, before a next scheduled illustration event (e.g., an annual illustration, pre-enrollment illustration, etc.), and/or according to any other planned schedule. In certain embodiments, for example where an updated illustration indicates a significant change in some aspect of the plan for a particular client, embodiments herein include providing a notification (e.g., to a client or agent) that an aspect of the plan has changed, and providing the updated illustration to an interface for review by the client or agent.

Referencing FIG. 83, an example interface 8300 is depicted, divided into FIGS. 83A and 83B, that allows a client or agent to input plan information for preparing a plan and illustration—for example relevant time frames for life events such as retirement age, desired distribution years, and/or end-of-plan values. Referencing FIG. 84, an example report 8400, for example as a part of a client report, Kaizen report, or the like, is schematically depicted, divided into FIGS. 84A and 84B, and that provides a comparison of a plan outcome relative to a baseline plan outcome. In the example of FIG. 84, the report is provided based on a smart illustration utilizing real provider data and client characteristics, and further may be based upon a plan that has passed a stress test, allowing the client to rely upon the information from the report that is likely to be realistic—for example utilizing real information from providers, that is likely to be accepted by a lender, and the like.

Referencing FIG. 85, an example report 8500 includes performance data related to a plan, including data from a previous illustration combined with actual performance data according to the plan. In the example of FIG. 85, the identification and capturing of prior illustration information allows for longitudinal comparison, for example performance data over time, that provides superior information to a single point comparison (e.g., $332,000 actual cash value achieved versus $236,000 expected). Additionally or alternatively, performance of distinct plans may be compared (e.g., varying contributions, investment options, insurance carriers, etc.) in a report such as that depicted in FIG. 85.

Referencing FIG. 86, an example report 8600 includes performance data related to a plan, for example depicting performance of investments versus loans over the course of the plan. Referencing FIG. 87, an example report 8700 includes performance data related to a plan, for example depicting estimated versus actual death benefits available over the course of the plan. Referencing FIG. 88, an example report 8800 includes performance data related to a plan, which may be utilized as a client report for an annual review of the plan. The example report includes various high level information, for example loans, contributions, cash values, distributions, death benefits, etc. In certain embodiments, a user may interact with elements of the report in FIG. 88, or any other reports or illustrations throughout the present disclosure, to get detailed information about the report aspect, get a visualization about the report aspect, to understand and/or adjust assumptions, or the like. FIG. 88 is divided into FIGS. 88A and 88B for clarity of the depiction.

Example operations herein allow a user to get an illustration at any point in the life cycle of the wealth management platform and/or plan, for example a casual user interrogating a plan to determine whether it is a good fit, a user accessing the platform when considering an enrollment, during pre-enrollment and/or at any point in the enrollment process, and/or during plan implementation. Operations herein allow for the user to get live data for illustrations and reports, including data that is confirmed to be valid on a response cycle that is much faster than the decision response cycle for the plan. Operations herein allow for the user to access relevant documentation at any time during the plan life cycle, for example allowing convenient access to documentation many years after the plan is initiated. Operations herein allow for illustrations to be updated in real time, and to include stress testing and/or scenario testing for multiple inputs, providers, disturbances, client characteristics, and/or plan aspects. Operations herein allow for illustrations at all points in the life cycle to be created for all users on a platform, for example allowing for thousands of high resolution, high quality plan inputs to be created, kept live, and kept verified, over the life cycle of the relevant plans. Operations herein allow for the relevant reports and/or aspects of the illustration to be communicated to relevant entities (e.g., clients, agents, insurers, banks, investment providers, etc.) throughout enrollment and the life cycle of the plan, greatly improving enrollment rates, enrollment completion, and plan execution rates, and providing all related entities with greater confidence that the goals of the plan will be achieved, that the plan is performing according to the initial plan, and that risks associated with the plan are understood and being managed.

Referencing FIG. 93, an example system 20000 for providing scheduled access to a wealth planning platform is schematically depicted. Scheduled access, as utilized herein, includes providing access where aspects of the system and/or interactions with the system can be configured for the specific user, for example based upon the role of the user with the platform, related workflows that are performed on behalf of the user and/or where the user has some responsibility for as aspect of the workflow, based upon the user's inclusion within a group on the platform, based upon the user's inclusion within a tranche on the platform, and/or based upon user preferences. The example system 20000 includes a platform 102 having a number of circuits that are configured to perform operations of the system 20000. The example platform 102 includes an access initialization circuit 20002 that interprets one or more user class values for a user accessing the online platform 20000, where the platform 20000 includes a number of wealth management functions (e.g., enrolling users in a wealth management process, providing illustrations and/or updates for the user on the progress of enrollment, performance of investments and/or the overall plan, etc.). Example and non-limiting user class values 20006 include a client class (e.g., a user where wealth management functions are being performed on their behalf), an agent class (e.g., a user that invites client users, recommends products, and/or that has a responsibility for the client user), and/or an administrator class (e.g., a user having responsibility for processes, for example to ensure that agent users have the tools and access they need on the platform, and/or that is a part of an entity, such as an agent entity, that employs and/or is associated with the agent user, and/or a user that administers the platform as such, for example authorizing other users, ensuring the proper functionality of the platform, or the like). In certain embodiments, the access initialization circuit 20002 determines the class value 20006 for the user in any manner, for example accessing a memory value that defines the class value (e.g., set by an agent user, administrative user, or the like—for example as a part of inviting a new user to the platform), according to an access method to the platform (e.g., an invitation link to the platform, where accessing the link sets the class value for the user), according to a selection by the user (e.g., an administrative user that sets their own class value, for example to test the functionality and/or user experience of a client user on the platform).

Referencing FIG. 98, example and non-limiting user class values 20006 are schematically depicted. The particular user classes available on a platform 102 depend upon the specific platform 102, including which aspects are managed utilizing communication to external devices, such as interfacing with a carrier's application programming interface (API) to perform certain operations, versus having a carrier user on the platform 102 to perform carrier operations. In certain embodiments, available user class values 20006 include one or more of: a client class 20502 (e.g., beneficiary users of financial products on the platform); agent class 20504 (e.g., agents that invite clients to the platform, and/or that can perform certain operations on behalf of client users and/or to facilitate operations for client users); an administrator class 20506 (e.g., operational support, technical support, and/or management users for any other user class, and/or for platform operations); independent marketing organization (IMO) class 20508 (e.g., users associated with specific entities that invite client users and/or groups of client users to the platform); a financial institution class 20510 (e.g., users associated with insurance companies, banks, investment companies, underwriters, or the like, that may offer products and/or support products utilized in operations on the platform, such as in wealth management products and/or services); and/or carrier class 20512 (e.g., users associated with a carrier such as for an insurance product, annuity, or the like). In certain embodiments, a user may be included in more than one class, for example as a carrier user and a financial institution user. In certain embodiments, some class of user may involve some users on the platform, with some supporting parties separate from the platform (e.g., one insurance company on-platform with registered users, and another insurance company that is available for client users on the platform, but that does not have users on the platform, for example interacting with the platform through an API to that provider, through communications with the platform, or the like). The user class values depicted in FIG. 98 are non-limiting examples, and any other organizing concept may be available for classifying users—for example classification of users may be performed based on asset levels, demographics, user preference parameters (e.g., users preferring e-mail communications versus on-platform messaging), user risk descriptions, users that are using and/or contemplating particular products on the platform, user geography, etc. In certain embodiments, users may additionally or alternatively be related using user groups and/or tranches, which may be organized using distinct criteria from the user class value, and/or using the same criteria utilized for one or more user class values.

The example platform 102 further includes an access management circuit 20004 that determines a scheduled access profile 20010 in response to the user class value(s) 20006. In certain embodiments, the scheduled access profile 20010 is utilized to provide a consistent interface and user experience for the user, that gives the user access to functions that are relevant to that user, and that the user has permissions to utilize. The example platform 102 includes a user interface circuit 106 that implements a user interface 107, for example provided as a web portal, web site, mobile application, and/or dedicated application (e.g., installed on a user device), where the user accesses the user interface 107 from a device (and/or different devices at different times) that displays the user interface 107 to the user. The example user interface 107 includes at least a session menu region (e.g., displaying functions, reports, illustrations, and/or any other aspects of the platform available for selection by the user) and an activity region (e.g., generally the active portion providing the actual information and/or functions available according to selections made in the session menu region), where the scheduled access profile 20010 is utilized to define, limit, and/or adjust which options are available in the session menu region, information depicted in the activity region, and/or actions available in the activity region.

Referencing FIG. 94, an example scheduled access profile 20010 includes a permitted functions description 20012, for example indicating which wealth management functions of the platform are available to the user. For example, a client user may have functions related to the enrollment of the client user with a wealth management product, determining the status of the enrollment (e.g., which stage of the enrollment process is active, which stages are completed, which stages remain, and/or the status of the current stage of the enrollment process), determining the performance of investments and/or an overall financial plan, relevant upcoming dates of interest (e.g., maturity of assets, retirement dates, upcoming payments, etc.), and/or tracking performance of plans, assets, etc. against a planned performance. In another example, an agent user may have functions related to the enrollment of client users (e.g., for clients of the agent, and/or of an entity associated with the agent), related to the performance of the agent user (e.g., activities due from the agent user, completion rates and/or times of activities for which the agent user is responsible, performance history for enrollments, etc.), and/or access to analytics related to any aspect of the agent user with the platform. The example scheduled access profile 20010 optionally includes an initial display description 20014—for example providing a description of which menus and/or data is to be displayed initially to the user, the size and arrangement of the interface, which information is provided as a default, wealth management structures to be displayed, or the like. An example scheduled access profile 20010 includes a session data description 20016, for example tracking data between sessions—for example which menus are open, displayed, or selected, which information is depicted in the activity region, whether messages have been previously read, general session data such as time logged in, status values for the user, a display value indicative of the user class value, a set of bibliographic data corresponding to the user, and/or a set of account information related to the user. In certain embodiments, aspects of the scheduled access profile 20010 are applied as a default setting, with the history of user operations, user preferences selected, administrator overrides (e.g., an administrator that determines aspects that should be shown to a group of users, for example allowing an agent user's manager to proscribe elements of the interface, allowing an agent user to do so for a client user, and/or allowing a platform administrator to adjust the interface based on particular events, for particular users, and/or across the platform).

Referencing FIG. 95, an example permitted functions description 20012 includes a permitted wealth management functions description 20202—for example defining available wealth management functions on the platform that are permitted for the user. An example permitted functions description 20012 includes user related permissions 20204—for example functions that are available to the user based on aspects specific to that user, for example due to subscriptions, user preferences, and/or functions that are enabled or disabled by another user (e.g., a manager, agent, administrator, or the like). An example permitted functions description 20012 includes data related permissions 20206, for example specifying data values and/or types of data that are available for the user. Example data related permissions 20206 include data related to other users, specific types of data (e.g., assumptions in an illustration, personally identifiable information, etc.), client related data, agent related data, carrier related data, meta-data, historical data, and/or platform specific data (e.g., number of users logged in, execution cycles, log data, etc.). An example permitted functions description 20012 includes platform related permissions 20208, for example permissions to change the roles of other users, to override certain data (e.g., an enrollment stage), permissions to add users and/or users of a certain type (e.g., registering a new carrier user), and/or any other type of function related to operations of the platform. In certain embodiments, some users may be given permissions related to other users, for example allowing agent users to see and/or adjust permissions, interface parameters, or the like, of other agent users and/or of client users.

Referencing FIG. 96, example and non-limiting wealth management functions, which may be permitted or not permitted, and provided as examples that may be present in a permitted wealth management function 20202. The example permitted wealth management function 20202 includes one or more functions such as: a pre-enrollment screening process 20302 (e.g., operations to determine whether a user has an appropriate situation to begin an enrollment process for a wealth management product); an offer presentation interface 20304 (e.g., information to help the user understand whether a product is appropriate for them, as well as inform the user of available options, costs, time frames, or the like); an offer creation tool 20306 (e.g., allowing an agent user to create an offer for a client user, configured for the needs, goals, and priorities of the client user); an offer acceptance interface 20308 (e.g., allowing a client user to accept and/or re-configure an offer, to adjust goals or priorities reflected in the offer, etc.); a carrier product management interface 20310 (e.g., allowing a carrier user to configure a product, for example an insurance product, an annuity, and/or an investment vehicle—where the configuration includes aspect such as: what information should be communicated about a prospect for a product, available products including time ranges and/or value ranges, what information may need to be determined such as medical information and/or financial verification, etc.); an estimator integration interface 20312 (e.g., allowing a user to perform estimates for outcomes of a wealth management product, of a particular part of a product, or the like, and allowing the user to utilize default data, and/or to enter specific data such as age, income, profession, retirement goal dates, etc.); an estimator calculation interface 20314 (e.g., allowing the user to see estimate outcomes, to adjust assumptions, goals, target dates, contribution amounts, etc., to see the effect of these on outcomes, etc.); a client profile integration tool 20316 (e.g., allowing an agent user to set up a new client, and/or to set parameters for a default client—for example allowing the agent user to set up a range of examples to be utilized in client communications, and/or allowing a client user to adjust system parameters about the client, such as target dates, risk tolerance, etc.); a client questionnaire creation tool 20318 (e.g., allowing an agent user, administrator, carrier user, underwriter user, financial institution user, or the like, to set up a questionnaire that may be utilized with other relevant users, such as a client user, to determine whether enrollment for a particular wealth management product is a good fit for that user, whether the client user is eligible for particular products, etc.); a client questionnaire completion tool 20320 (e.g., allowing the relevant user, such as a client user, and/or another user operating on their behalf, to complete a questionnaire, for example utilized before initiating an enrollment, as a part of a stage of enrollment, or the like); an electronic signature interface tool 20322 (e.g., allowing users of any type to execute documents on the platform); an application completion tool 20324 (e.g., allowing users, such as client users or another user operating on their behalf, to complete an application, which may include deeper information, verified information, and/or additional information beyond that which may be determined during a screening process or on a questionnaire); an application review and approval tool 20326 (e.g., allowing an agent user to confirm whether an application is complete, whether the application indicates that enrollment or other processes should proceed, and/or allows the agent user to conveniently indicate aspects that need further information, appear to be correct, still need to be completed, and/or require verification—where the user interface 107 can provide an automatic notification, including potentially a link to the application or other convenient interface to correct, update, and/or complete the information identified in the application review process); a client management tool 20328 (e.g., allowing users to add, remove, and/or modify accounts for client users, to indicate analytics or other information that should be tracked for clients, to adjust permissions for clients, to adjust interface elements for the clients, and/or to change default settings for clients); a portfolio management tool 20330 (e.g., allowing a user to set up reports, displayed parameters, preferences for calculating and/or displaying portfolio related values such as asset mix, status of assets, or the like); and/or a payment processing tool 20332 (e.g., allowing a user to set up payment information, to get information about future payments, to make selection such as changing contribution timing and/or amounts, or the like). The example wealth management functions 20202 are non-limiting examples, and any other tools, operations, or functions throughout the present disclosure are contemplated herein as potential wealth management functions 20202 that may have permissions controlled by the platform 102 for relevant users. In certain embodiments, wealth management functions may be implemented as a hyperlink or other selectable (or clickable) function within the session menu region (e.g., listed in a menu and/or sub-menu) and/or within the activity region (e.g., as a link next to a graph, as a line item of information that can be selected for greater detail, or the like).

In certain embodiments, one or more wealth management functions may be implemented utilizing an associated wealth management structure—for example created as a part of the function, and/or that is utilized by the function. In certain embodiments, the user interface circuit 106 provides the user access to the wealth management structure on the user interface, for example by providing a view of the wealth management structure within an activity region of the user interface in response to a selection made by the user in the session menu region. Example wealth management structures may be a data structure (e.g., data related to the wealth management function stored in a data structure of any type), a visualization element (e.g., a table, graphic, graph, or the like), a view of data, and/or a link to another function, list of adjustable options, and/or access to a detailed view of some aspect displayed on the activity region. Referencing FIG. 97, example and non-limiting wealth management structures 20302 include elements such as: a wealth management analysis tool 20402 (e.g., allowing a user to request summaries, illustrations, visualizations, estimate outcomes, adjust assumptions, adjust risk descriptions, adjust interest rates, add or remove products or other aspects of a wealth management plan, etc.); wealth management data 20404 (e.g., showing current status of a portfolio for the user, comparison against plan, estimates based on adjusting parameters, certain values at points in time—such as low points, cash values, death benefits, tax benefits, etc.); an investment selection portal 20406 (e.g., adjusting investment mixes or directions, if applicable; adjusting contribution amounts and/or timing; adjusting target goals such as retirement date and/or estimated post-retirement life span, etc.); an enrollment status tool 20408 (e.g., showing an enrollment stage, progress, current user responsible, etc. for an enrollment process for a single user, and/or for a group of users such as client users associated with an agent user, with an entity for an agent user, for a defined group of users, and/or for a particular tranche); a financial report 20410 (e.g., financial reports for an agent user, an agent entity, a carrier, an underwriter, a group of users, a tranche, etc., where the financial report may include assets, amounts due, risk assessments, performance assessments, or the like); an interactive analytics portal 20412 (e.g., providing access to analytics for the user, which may be varied according to the particular user and/or another user within the scope of permissions available for viewing to the particular user, etc.); a user information modification tool 20414 (e.g., allowing a user to modify any parameters available for adjusting such as preferences, goals, targets, risk descriptions, contact information, notification settings, etc.); an enrollment stage description 20416 (e.g., allowing a user to see enrollment stages for one or more enrollment processes, for example for a particular user, a group of users, a tranche, etc.); and/or an enrollment document access tool 20418 (e.g., allowing a user to see, access, read, and/or sign documents for one or more enrollment processes, for example allowing the user to confirm whether documents have been submitted, to verify that execution is correct, to access documents for reference, or the like). In certain embodiments, one or more wealth management structures may be presented on the activity region, and/or in another region of the user interface.

An example user interface circuit 106 configures at least one feature within the user interface 107 in response to the user preferences description 20018. For example, the units for display, default data or visualizations to display, the ordering of menus, the size and/or location of areas and/or regions on the user interface 107, etc., may be configured based on the user preferences description 20018. An example and non-limiting user preferences description 20018 includes one or more aspects such as: a value indicative of a selected format (e.g., a layout selection, fonts utilized, size of display text, color scheme, etc.); a value indicative of a selection of data to initially display within the user interface; and/or a value indicative of a selection of display options for the user interface. An example and non-limiting user preferences description 20018 is stored in the data store 116 on the platform (and/or in communication with the platform), and/or stored on a device used by the user to access the platform (e.g., a laptop, desktop, tablet, mobile device, etc.).

An example user interface 107 includes an indication of the user class value of the user—for example allowing users that can operate in multiple user classes to readily confirm and/or be reminded of which user class they are operating as. An example user interface 107 includes a text label corresponding to the user class value(s), a color corresponding to the user class value(s) (e.g., where one color such as blue is utilized to indicate a client user, and another color such as black is utilized to indicate an agent user), and/or an image representative of the user class value(s).

Referencing FIG. 100, an example user interface circuit 206 implements the user interface within a display screen 20603, providing the session menu region 20609 in a first area of the display screen 20603, and an activity region 20611 in a second area of the display screen 20603. In certain embodiments, the first area and the second area have a vertical dimension, a horizontal dimension, and an anchor point, which may be adjusted to adjust the area utilized by the various regions 20609, 20611. In the example of FIG. 100, the display screen 20603 further includes a header area 20605, which may be utilized to display the user name, user class value(s) (where the display shows elements responsive to one or more user classes), and a second header region 20607, which may be utilized to help with navigation (e.g., showing which menu is currently active), to provide summary data (e.g., a current value indicating a status, performance against plan, etc.), and/or to provide quick links to common activities (e.g., actions that may be available in a menu, or not, actions that are commonly utilized based on the current state of the session menu and/or activity region, actions that are commonly utilized based on the user's history, and/or actions that are selected base on user preferences, defined by an administrator user, etc.).

An example platform determines the user class value 20006 in response to a user trait 20600 of the user, for example referencing FIG. 99. Example and non-limiting user traits 20600 that may be utilized to determine the user class value 20006 include one or more of: a profession 20602 of the user, a geographic location 20604 of the user, a social demographic 20606 of the user, an economic demographic 20606 of the user, a legal jurisdiction 20608 associated with the user, a risk profile 20610 of the user (e.g., specific risk attributes selected by or on behalf of the user, such as acceptable volatility, preference for certain asset types, uncertainty of parameters such as future income, etc.), a risk category 20610 of the user (e.g., a categorical description that groups the user with a general risk group, such as conservative, aggressive, etc.), a relationship of the user to a particular entity 20612, a subscription category 20614 of the user (e.g., on the platform, including to the platform generally, and/or for particular products and/or services on the platform), a membership indicator 20614 (e.g., registration status with the platform, and/or with particular entities, services, etc.), and/or a set of user selected features 20616 (e.g., keywords provided by and/or selected by the user and/or on behalf of the user).

An example access management circuit 20004 provides at least two levels of access to the platform 102 in response to the user class value(s) 20006. For example, a user may be capable of accessing the platform 102 in multiple roles—for example an administrator user that can select a role (e.g., to troubleshoot operations of the platform, to confirm or verify user experiences, etc.), and/or a user that holds multiple roles within the platform (e.g., an agent user that also acts as an administrator user for other agent users, and/or that is also a client user on the platform). the example access management circuit 20004 provides a first level of access including a scheduled access profile that includes a first set of permitted functions for one user class value 20006 for the user, and provides a second level of access including a different scheduled access profile that includes a second set of permitted functions for the second user class value 20006 for the user. In certain embodiments, a user may have distinct access levels based on the user device utilized to access the platform—for example providing a user class value 20006 that distinguishes between access from a mobile device (or mobile application) and access from a desktop or laptop (or access through a web portal and/or dedicated application on the desktop/laptop). In certain embodiments, a user may have distinct access levels based on login mechanism—for example providing a first access for simple login, and a second access for a more complete login (e.g., a login using two-factor authentication and/or multi-factor authentication). The utilization of multiple access levels for a given user allows for numerous benefits, including for example allowing an administrator to test and/or confirm user experiences, reducing the risk of inadvertent changes made by a user that might be accessing the platform from a public device and/or in less than ideal circumstances, allowing the user to provide some access to other users (e.g., an accountant, fiduciary, trustee, etc.) without the risk of those users making inadvertent changes, and/or reducing the impact of a potential security breach (e.g., providing reduced access for login methods that may be more likely to be intercepted). In certain embodiments, a first, lower level access, may allow access to a reduced set of permitted wealth management functions, and/or read-only access to one or more of the permitted wealth management functions, and a second, higher level access, may allow access to an expanded set of permitted wealth management functions, and/or read-write access to one or more of the permitted wealth management functions. In certain embodiments, a first level of access includes client facing functions within the online platform, and a second level of access includes administrative functions within the online platform. In certain embodiments, a first level of access is limited to functions that affect only the current user, and a second level of access permits functions that affect other users on the platform. In certain embodiments, a first level of access provides for redacted and/or partially redacted exposure of confidential and/or personally identifiable information, and a second level of access provides for full access to confidential and/or personally identifiable information. In certain embodiments, a first level of access permits the user to view a first limited subset of available platform data, and a second level of access permits the user to view a second more complete set of available platform data. In certain embodiments, a first level of access is provided to a user before registration on the platform, and a second level of access is provided to the user after registration on the platform.

An example access management circuit 20004 provides an access request value (e.g., as an approval request 20024) to a user in a first user class in response to a user in a second user class requesting access to the online platform 102. For example, a new client user (second user, in the example) may request access to the platform 102, where the access management circuit 20004 provides an access request value to another user (e.g., an agent user, or the first user in the example). Upon approval by the first user, the access management circuit 20004 permits access to the platform 102 for the second user.

An example platform 102 includes a user interconnection circuit (not shown) that automates at least one interaction within the online platform between a first user and a second user. Example and non-limiting interactions that may be automated include requesting approval for one of the users from the other user, providing a notification 22026 of significant activity on the platform for one of the users from the other user, handoff of an enrollment task from the first user to the second user, transferring data from the first user to the second user, and/or a notification 20026 of an action taken by the first user to the second user. In certain embodiments, the first user and second user may be in distinct user classes.

An example platform 102 includes an enrollment management circuit 108 that enrolls a new user on the platform in response to an enrollment request description 20020. The example enrollment request description 20020 may be provided by the new user (e.g., requesting access to the platform, and/or responding to an invitation to the platform), and/or by another user within the online platform (e.g., by an agent user and/or IMO user setting up the new user on the platform). In certain embodiments, the enrollment request description 20020 is provided by an enrollment interface (e.g., as an instance of the user interface 107) that permits a new user to request enrollment within the online platform. In certain embodiments, the enrollment interface is provided as an available interface for anyone (e.g., as an option on a web site for the platform), and/or created specifically for a given user (e.g., accessed via an invitation and/or link provided to the prospective new user). Example and non-limiting enrollment request description(s) 20020 include one or more of: at least one user class value for the new user, a new user contact value indicative of a contact method for communicating with the new user, an enrollment management value indicative of at least one user within the online platform assigned to approve the enrollment of the new user (e.g., an agent user to be contacted for permission); and/or an enrollment monitoring value indicative of at least one user within the online platform assigned to receive at least one status notification 20026 with respect to the enrollment of the new user within the online platform (e.g., can be set by an inviting agent user to get a notification when the new user responds to the invitation). An example enrollment request description 20020 includes a new user contact value (e.g., provided by the new user, and/or by an inviting agent user), and the enrollment management circuit 108 sends, responsive to the new user contact value, an invitation to the new user to enroll within the online platform 102.

In some aspects, the techniques described herein relate to an apparatus, wherein the at least one notification value is at least one of: a value indicative of an enrollment invitation sent to the new user by the enrollment management circuit; a value indicative of a receipt by the enrollment management circuit of a response to an enrollment invitation from the new user, a value indicative of the new user accessing the online platform responsive to an enrollment invitation sent by the enrollment management circuit; a value indicative of a commencement of an enrollment of the new user within the online platform; a value indicative of a rejection from the new user to an enrollment invitation sent by the enrollment management circuit; a value indicative of a failure of an enrollment of the new user within the online platform; or a value indicative of a successful enrollment of the new user within the online platform.

An example enrollment management circuit 108 determines a user data description 20022 for the new user. An example user data description 20022 may be determined according to one or more of: information supplied by the new user through the user interface; information supplied by an inviting user (e.g., an agent user providing the information on behalf of the new user); information related to the new user accessible from at least one publicly accessible online resource; and/or information related to the new user accessible from a third-party information database. Example user data description(s) 20022 include one or more aspects such as:

In some aspects, the techniques described herein relate to an apparatus, wherein the enrollment management circuit is further structured to determine the user data description utilizing at least one of: a goal value indicative of at least one wealth management goal of the new user, bibliographic information of the new user, and/or a beneficiary value indicative of at least one beneficiary of the new user.

Embodiments herein are described in relation to a wealth management platform, and/or a wealth planning platform. In certain embodiments, the wealth management platform implements wealth planning operations for client users, for example planning investment activities, obtaining life insurance, annuities, and the like, to provide planned resources available during retirement for the client user, and/or available resources for planned activities (e.g., contributions to charity or organizations, for inheritance, or the like) at the end of the plan (e.g., upon the death of the client user, and/or at a scheduled future date). In such embodiments, any investment and/or estate planning tools known in the art may be utilized, including without limitation: life insurance products (e.g., to provide a death benefit, and/or as a part of investment planning including potentially tax planning, providing liquid assets, etc.); investment products; annuities; and/or utilization of loans (e.g., to provide for leverage, and/or to provide liquidity timing to increase the options available for investment planning and sequencing). Without limitation, embodiments herein are applicable to, and provide benefits for, a number of other platform concepts, including for example: a real estate platform (e.g., planning the acquisition and/or disposition of real estate assets); an online data servicing platform (e.g., providing coordinated support for multiple individuals associated with a mix of entities and operating on a common workflow with deliverables sequenced to pass between different individuals over time and/or with stage of progression in the workflow); and/or a workflow control platform.

Referencing FIG. 101, an example procedure 20700 for implementing a user interface to provide scheduled access to different user classes on a wealth management platform is schematically depicted. The example procedure 20700 includes an operation 20702 to interpret at least one user class value for a user, and an operation 20704 to determine a scheduled access profile in response to the user class value(s). The example procedure 20700 further includes an operation 20706 to implement a user interface, providing scheduled access to a wealth management platform, in response to the scheduled access profile.

Referencing FIG. 102, an example procedure 20706 for providing scheduled access to a wealth management platform is schematically depicted. The example procedure 20706 includes an operation 20802 to display a hyperlink and/or executable object for each wealth management structured of permitted wealth management function(s) on the user interface, and an operation 20804 to provide user access to each wealth management structure within an activity region responsive to a selection of the hyperlink and/or executable object by the user. In certain embodiments, selection of the hyperlink and/or executable object is performed by the user in a menu region—for example a session menu region and/or a selected function menu region (e.g., a menu that is depicted for the user in response to a selection of a function on the user interface by the user).

Referencing FIG. 103, an example procedure 20706 for providing scheduled access to a wealth management platform is schematically depicted. The example procedure 20706 includes an operation 20902 to implement a user interface for a wealth management platform within a display screen, for example a display screen of a user device interfacing with the platform. The example procedure 20706 further includes an operation 20904 to provide a menu region in a first area of the display screen, and access to wealth management structure(s) in an activity region in a second area of the display screen.

Referencing FIG. 104, an example procedure 21000 for providing at least two different levels of access for a user to a wealth management platform is schematically depicted. The example procedure 21000 includes an operation 20704 to determine at least two levels of access for the user in response to a user class value (and/or values) of the user, and an operation 20706 to implement a user interface utilizing a scheduled access profile corresponding to a selected one of the at least two levels of access. The selected one of the at least two levels of access may be selected according to any operation set forth herein, for example and without limitation as set forth in FIGS. 93-99 and the related description.

Referencing FIG. 105, an example procedure 21200 to implement an enrollment process for a new user on a wealth management platform is schematically depicted. The example procedure 21200 includes an operation 21202 to interpret an enrollment request description, and an operation 21204 to implement an enrollment process of a new user into the online platform. An example enrollment process can include an enrollment process as set forth throughout the present disclosure, including an enrollment process for a wealth management operation, for example and without limitation, as set forth in relation to FIGS. 10, 40, and the related descriptions. Referencing FIG. 106, an example procedure 21300 to implement an enrollment process for a new user on a wealth management platform is schematically depicted. The example procedure 21300 includes an operation 21202 to interpret an enrollment request description for a first user (e.g., a new user), where the enrollment request description includes an enrollment management value. The example enrollment management value includes an indication of whether a permission is required, and/or another user that is authorized to provide enrollment permissions. The example procedure 21300 includes an operation 21302 to request approval for enrollment from a second user (e.g., an agent user associated with the first user) in response to the enrollment management value, and an operation 21204 to implement enrollment of the first user into the online platform based on an approval value provided in response to the requested approval. In certain embodiments, for example where the second user does not respond to the request approval, the enrollment may be initiated after a time period expires, may be terminated after the time period expires, the operation 21302 may be repeated (e.g., reminding the second user of the request), and/or the operation 21302 may be repeated but the request sent to a third user (e.g., another agent user, a manager for the second user, an administrative user, or the like).

Referencing FIG. 107, an example procedure 21400 for implementing an enrollment process for a user on a wealth management platform is schematically depicted. The example procedure 21400 includes an operation 21202 to interpret an enrollment request description, including an enrollment monitoring value. An example enrollment monitoring value includes monitoring parameters for the enrollment, including for example monitoring times, expected times for stages of the enrollment process, associated users (e.g., agent users and/or administrative users) for the enrollment process (e.g., utilized as the target for monitoring notifications for the enrollment process), or the like. The example procedure 21400 includes an operation 21204 to implement an enrollment of the first user (e.g., a new user) into the online platform based on an approval value (e.g., from a second user, such as an agent user) provided in response to the requested approval. The example procedure 21400 includes an operation 21402 to monitor the enrollment in response to the enrollment monitoring value—for example checking the time for completion of stages of the enrollment process, indications that the enrollment process is stalled (e.g., the stage has not progressed for a threshold period of time, which may vary according to nominal expectations for the particular stage, etc.), indications that a process step is incomplete, indications that the enrollment is at risk (e.g., based on certain events and/or patterns in the enrollment process, which may be informed by historical performance of enrollment execution for previous users and/or users sharing an attribute or user class value with the new user, that the enrollment may end up not being completed without intervention, and/or that the enrollment may not end up being completed by a target date without intervention), or the like. The example procedure 21400 includes an operation 21404 to determine whether the monitoring operations have detected a notifying incident. In response to operation 21404 indicating YES, the procedure 21400 includes operation 21406 to provide a notification in response to the monitoring, for example providing the notification to one or more users indicated in the enrollment monitoring value. In certain embodiments, some notifications may be provided to a default user (e.g., to an administrator user, and/or to a designated agent user, for example where the enrollment monitoring value does not specify a notification target), and/or some notifications may always be sent to certain users regardless of the enrollment monitoring value (e.g., a platform administrator user that specifies that all potentially stalled enrollment processes provide a notification to a selected user, including potentially the platform administrator user). Example an non-limiting notifications at operation 21406 include generating a notification value such as: a value indicative of an enrollment invitation set to the new user, a value indicative of a receipt of a response to an enrollment invitation from the new user, a value indicative of the new user accessing the online platform responsive to an enrollment invitation (e.g., based on the new user utilizing a link in the invitation, and/or matching the new user information with information provided in the enrollment invitation, such as a name, address, invitation code, phone number, or the like); a value indicative of a commencement of an enrollment of the new user (e.g., determined in response to a request by the new user, the completion of certain information by the new user such as a questionnaire, application, or account setup, etc.); a value indicative of a rejection from the new user to an enrollment invitation (e.g., determined according to explicit selections on the user interface, communications from the new user, and/or a delay period after confirmation that the invitation has been sent and/or received); a value indicative of a failure of an enrollment of the new user (e.g., based on rejection at a later stage after commencement, a determination that the new user is ineligible for at least a portion of a related wealth management plan, or the like); and/or a value indicative of a successful enrollment of the new user (e.g., based on the completion of a particular stage of the enrollment process, which may be the last stage, a latest stage where the new user has responsibility for completing some aspect of the stage, etc.). In response to operation 21404 indicating NO, the procedure 21400 includes operation 21408 to determine whether the enrollment process is complete. In response to operation 21408 indicating NO, the procedure 21400 returns to operation 21204 to continue implementing and monitoring the enrollment process.

It can be seen that the enrollment monitoring operations as set forth throughout the present disclosure, including without limitation in regard to procedure 21400, provide for a number of benefits relative to previously known systems, generate new data values that do not exist in previously known systems, and process data in a manner not known in previous systems, and that these aspects provide benefits to client users, agent users, carrier users, and the like. For example, monitoring operations herein allow for early intervention in an enrollment process, increasing the likelihood of the enrollment to be successful, and increasing the benefit to the client user—for example avoiding negative consequences from delay such as changes in rates, actuarial changes, reduced efficiency from delay that requires participating users in the enrollment from getting back up to speed in reviving a delayed process, improved financial performance by beginning investment operations at an earlier date, or the like. In another example, monitoring operations generate a number of new data values that are useful in tuning enrollment execution, for example the expected timing between stages, the types and content of communications that most efficiently recover an enrollment process and/or keep the enrollment process on track, and that can be utilized, in combination with notifications to responsible parties that are able to act on off-nominal enrollment events, to detect that enrollment processes have stalled or are at-risk, and to prioritize which enrollment processes on the platform could benefit from intervention.

It can be seen that the scheduled access operations as set forth throughout the present disclosure, including without limitation in regard to FIGS. 200-215 and the related descriptions, provide for a number of benefits relative to previously known systems, generate new data values that do not exist in previously known systems, and process data in a manner not known in previous systems, and that these aspects provide benefits to client users, agent users, carrier users, and the like. For example, scheduled access operations herein allow for users to readily view data elements such as enrollment progression, the status of enrollment activities, confirm that documentation is complete and correct, and view the benefits of the wealth management product for that user (e.g., the specific financial benefit to the client user, ensuring proper service for clients to the agent user, and/or tracking performance of agents for an agent manager, carrier, and/or administrative user). Additionally, users get notifications and information on the platform in a convenient location, and that highlights the aspects important to that user, reducing time to determine what the next steps are, to determine whether an off-nominal event has occurred, and to determine who to contact if the off-nominal event has occurred. Further, the scheduled access operations enhance the security of the platform and for users of the platform—for example limiting access to data and functions as needed by the specific user, and providing a familiar and consistent interface for the user, reducing the risk that the user will inadvertently send a message to the wrong location, provide login information to the wrong place (e.g., including to a phishing operation or other bad actor), lose documents, send documents to the wrong location, and/or lose track of an enrollment process or other workflow on the platform (e.g., which may increase the risk that the user makes a mistake in follow-up communications, reveals information when trying to escalate or contact other parties, and/or has a reduced awareness of security issues due to frustration of the user in completing workflow steps).

Referencing FIG. 108, an example system 21500 for creating and managing tranches on a wealth management platform 102 is schematically depicted. The example system 21500 includes a client addition circuit 21502 that interprets a client description 21508 for each one of a number of clients including users of an online platform 102, where the online platform 102 is maintains an organization of the clients into a number of tranches, each tranche including a group of the clients engaged in an enrollment process on the online platform 102. In certain embodiments, a tranche constituency and/or history 21518 data structure is utilized to store the relationships between the clients and the tranches. In the example, the tranche constituency 21518 indicates which clients in the enrollment process are associated with which tranches, and the optional tranche history 21518 indicates the history of the tranche(s) (e.g., which clients were previously within a given tranche) and/or the history of the clients(s) (e.g., which tranches was the client previously assigned to).

The example platform 102 includes a tranche assignment circuit 21504 that determines a tranche adjustment value 21509 (or values) in response to the client description 21508 for at least one of the clients in one of the plurality of tranches. An example tranche adjustment value 21509 includes a value such as: a value indicative of an operation to create a new tranche; a value indicative of an operation to eliminate a tranche (e.g., moving the remaining users to one or more other tranches, closing an empty tranche, and/or tracking the remaining users separately without being assigned to a tranche); a value indicative of an operation to move the client(s) from a first tranche to a second tranche; and/or a value indicative of an operation to remove at least one of the clients from a tranche. The example tranche assignment circuit 21504 executes one or more of the operations indicated by the tranche adjustment value(s) 21509, for example providing tranche adjustment operations 21510, which may include updating the tranche constituency 21518, notifying one or more users on the platform (e.g., an administrator user and/or an agent user) of the adjustment, and/or requesting permissions for an adjustment (e.g., to an administrator user, where the permissions may be omitted, limited to certain types of tranche adjustments, and/or performed for every tranche adjustment). The example platform 102 includes a platform analysis circuit 21506 that updates a tranche analytics profile 21512 in response to the execution of the operations indicated by the tranche adjustment value(s) 21509.

An example client addition circuit 21502 interprets a client description 21508 for a new client enrolling with the platform 102, where the tranche adjustment value 21509 includes a value indicative of an operation to add the new client to an existing one of the tranches, and/or creates a new tranche and assigns the new client to the new tranche. In a further example, operations include interpreting the client description 21508 in response to a client addition request 21514 provided by a user within the online platform, such as an agent user or an administrative user. In another example, operations include interpreting the client description 21508 in response to a client addition request 21514 provided by a user (e.g., the new user) accessing the platform 102 to request a wealth management product, service, or information on the platform (e.g., the user invited to the platform 102, and/or responding to an advertisement, search result, or the like to engage the platform 102).

An example tranche assignment circuit 21504 further structured updates the tranche adjustment value 21509 in response to the tranche analytics profile 21512. For example, the tranche assignment circuit 21504 may assign a client user to a tranche, for example based upon an enrollment date for the client user, or any other aspect as set forth herein. The addition of the client user to the tranche changes the tranche constituency 21518, and accordingly the tranche analytics profile 21512 may change (e.g., reference FIGS. 217-221 and the related description for examples of the tranche analytics profile 21512). In certain embodiments, the tranche assignment circuit 21504 adjusts the tranche constituency 21518 in response to tranche metrics 21520, for example to support any one or more of the various benefits herein related to tranche movement. Accordingly, example operations of the platform 102 include updating the tranche constituency 21518 to improve the tranche analytics profile 21512, and updating the tranche analytics profile 21512 to improve the tranche constituency 21518, and the operations can therefore be recursive. In certain embodiments, the recursive operations allow for iterative improvement in the tranche metrics 21520 and improved realization of various benefits of tranche movement operations herein. In certain embodiments, the tranche assignment circuit 21504 performs certain operations to limit potential negative consequences of the recursive adjustment-analytics operations (where present), for example applying a time delay to determine and/or apply tranche adjustment value(s) 21508, applying hysteresis to the addition and/or removal of users with tranches (e.g., increasing a threshold to move a user after the user has already moved, where the increase may be applied thereafter, and/or may decay or be removed over time), enforcing a minimum benefit threshold to perform tranche adjustments (e.g., to prevent dithering between tranches, etc.), and/or performing the adjustment-analytics operations periodically (e.g., once per hour, once per day, twice per week, etc.) rather than continuously.

Referencing FIG. 109, an example client description 21508 includes one or more values such as: an enrollment completion date target value 21602 (e.g., utilized to provide an initial tranche configuration intended for users to complete enrollment in a similar time frame, where the target date may be provided by the client user, an agent user, etc.); an enrollment stage value 21604 (e.g., utilized to provide an initial tranche configuration intended for users to progress to an enrollment stage of interest—for example approval of an application, in a similar time frame); an enrollment progression value 21606 (e.g., utilized to provide an initial tranche configuration intended for users to have a similar enrollment progression, for example based on the number of days expected between stages, etc.); an enrollment predicted completion date value 21608 (e.g., utilized to provide an initial tranche configuration intended for users to complete enrollment in a similar time frame, where the predicted completion date may be provided according to characteristics of the user, such as which products are contemplated, and/or the monetary value of those products—e.g., a plan involving a $500,000 life insurance policy may be expected to progress more quickly than another plan involving a $5,000,000 life insurance policy); and/or an enrollment financial value 21610 (e.g., utilized to provide an initial tranche configuration intended to assign users having similar financial information, utilizing similar financial instruments and/or financial entities in the plan, and/or providing an overall similar financial value between tranches). The predicted completion times may be determined utilizing any information throughout the present disclosure, including aspects such as historical performance for previous users having similar user class values (e.g., based on geography, demographics, professions, etc.), and/or based on performance of known entities associated with the plan (e.g., performance of a particular carrier that is likely to be utilized by the user, performance of an agent user associated with the client user, etc.). The predicted completion times may be updated at any time throughout the enrollment process, and accordingly the tranche metrics 21520 may be improved by applying tranche adjustment values 21509 as set forth herein. The selected elements of the client description(s) 21508 and the utilization of those elements for a particular embodiment can be utilized to promote various benefits of the capability to move users between branches, for example configuring tranches for simplified analytics, for example by promoting similar intra-tranche determinations (e.g., grouping users with similar financial products, related entities, complexity of the plan, etc.), and/or similar inter-tranche determinations (e.g., providing tranches with a consistent analytical workload, for example based on the number of users and/or plan complexity of those users within each tranche, which can make enrollment processing for the tranches more predictable, easier to schedule, and reduce processing cost). In certain embodiments, providing tranches having a similar overall financial value (e.g., the financial value of assets and/or contributions within the tranche, and/or the financial value of the tranche to stakeholders such as agent users, carrier users, agent entities, etc.) provides for improved operations of the platform 102, for example allowing an administrator user or other user within the platform 102 to commit consistent monitoring and intervention resources to each tranche, with a high confidence that such resources are appropriately allocated, reducing the need to perform triage or deeper analytics to determine where resources will be best allocated.

An example tranche analytics profile 21512 includes a tranche description for each tranche, each tranche description including an identification value for the tranche, and a client list value indicative of a group of clients organized within the tranche. In certain embodiments, the tranche analytics profile 21512 includes a tranche class value, for example providing a high level indication of the purpose of the tranche, one or more noteworthy characteristics of the tranche, or the like. Referencing FIG. 110, an example tranche analytics profile 21512 further includes one or more parameters such as: a tranche enrollment completion data target value 21702; a tranche enrollment stage value 21704; a tranche enrollment progression value 21706; a tranche enrollment predicted completion date value 21708; and/or or a tranche enrollment financial value 21710. Referencing FIG. 111, an example tranche analytics profile 21512 further includes one or more parameters such as: a financial target 21802 for the corresponding tranche; a completion date target 21804 for the corresponding tranche; an enrollment progression target 21806 for the corresponding tranche; a revenue goal 21808 for the corresponding tranche; and/or a time progression description 21810 (e.g., a trajectory, thresholds versus time, etc.) for any one or more of the foregoing. Referencing FIG. 112, an example tranche analytics profile 21512 further includes one or more parameters such as: a client tranche membership 21902 (e.g., a number of clients, client attributes, client user class values, etc., for example promoting similarity and/or configured variability of the tranche constituency); client tranche engagement 21904 (e.g., based on responsiveness of the client users, and/or preferred client communication methods); an enrollment progression target 21906 for the corresponding tranche; and/or a completion of enrollment stages 21908 for the tranche. Referencing FIG. 113, an example tranche analytics profile 21512 further includes one or more parameters such as: a total client count 22003 within the corresponding tranche; a total value of a financial indicator metric 22005 for all clients within the corresponding tranche; an average value of a financial indicator metric 22007 for all clients within the corresponding tranche; a minimum value of a financial indicator metric 22009 for all clients within the corresponding tranche; and/or a statistical property of a financial indicator metric 22011 for all clients within the corresponding tranche. Referencing FIG. 114, an example tranche analytics profile 21512 further includes one or more trait values shared by all clients (and/or a selected fraction of the clients) within the corresponding tranche, where the trait values include one or more of: an affiliation with a certain company 22102; an affiliation with a certain carrier 22104; a risk profile or risk profile category 22106; an investment profile 22108; a goal or set of goals 22110; a geographic location 22112; an enrollment date or enrollment period 22114; a target enrollment completion date 22116; and/or an enrollment completion date window 22118. The tranche analytics profile 21512 may be based on average values for client users in the tranche, based on aggregated values, and/or based on statistical descriptions such as median values, buckets (e.g., quintiles, quartiles, etc.), outliers (e.g., highest and/or lowest values), and/or variability descriptions (e.g., standard deviations, ranges, ranges between quintiles, etc.).

An example tranche assignment circuit 21504 determines the tranche adjustment value 21509 responsive to a tranche adjustment request (e.g., provided as a user communication 110) provided by a user of the online platform (e.g., an agent user and/or an administrative user). An example tranche assignment circuit 21504 determines the tranche adjustment value 21509 by performing at least one of: identifying at least one value of a client description 21508 of a client that aligns with at least one value of a tranche description (e.g., as a part of the tranche analytics profile 21512) of at least one tranche; a comparison of at least one of at least one tracking metric value 21520 or at least one performance statistic value for the tranche to at least one goal value for the tranche; and/or a comparison of a tracking metric value 21520, a performance statistic value, and/or at least one goal value for the tranche to at least one tranche adjustment request provided by a user of the online platform (e.g., allowing the user to adjust targets for the tranche).

An example tranche assignment circuit 21504 determines the tranche adjustment value 21509 in response to: a completion status value 21516 of at least one workflow process for a client within a tranche of the plurality of tranches as compared to an average completion status value of at least one workflow process for other clients in the tranche (e.g., placing the client user into a tranche having a similar overall progression to that of the user); a value indicative of an expected completion date of at least one workflow process for a client within a tranche as compared to a value indicative of an average expected completion date for of at least one workflow process for other clients in the tranche; and/or an assignment criteria value provided by a user of the online platform, where the assignment criteria value includes at least one of: a set of asset based criteria (e.g., allowing a user defined asset mix in the tranche), a set of time based criteria, or a set of product based tranche criteria (e.g., allowing a user defined product mix in the tranche).

An example tranche assignment circuit 21504 determines the tranche adjustment value 21509 such as to increase an overall efficiency of workflow processes for clients within the online platform. Example efficiency values include, without limitation, one or more aspects such as: time spent by an administrator user to monitor, support, and intervene in enrollment processes; consistency of analytical workloads between tranches; similarity of client counts between tranches; similarity of products utilized within a tranche; similarity of regulatory compliance criteria within a tranche (e.g., users sharing similar demographics, geography, and/or relevant jurisdictions may promote similarity in the appropriate regulatory compliance scheme); and/or similarity in overall financial value between tranches. In some aspects, the techniques described herein relate to an apparatus, wherein the overall efficiency is determined according to at least one criteria selected from: a number of execution operations of a wealth management platform 102 including the client addition circuit 21502, the tranche assignment circuit 21504, and the platform analysis circuit 21506 to support enrollment operations of client users on the platform; a tranche similarity value including a description of variability among the tranches; and/or an enrollment performance metric including a statistical description of enrollment completion times for client users on the platform. In certain embodiments, aspects that are deemed to be efficient for a particular embodiment will depend upon criteria specific for a given system, where such criteria will be readily understood by one of skill in the art having the benefit of the present disclosure and information normally available to that person when contemplating a particular system. Certain considerations for determining whether an aspect of tranche constituency promotes efficiency include, without limitation: cost for processing operations; cost for network communication operations; administrative user capacity and cost; applicable regulatory schemes (e.g., financial disclosure requirements, data privacy requirements, and/or financial product types included in plans); and/or the cost/benefit applicable to high speed of enrollment execution relative to capital and/or operating costs for the system.

An example tranche assignment circuit 21504 provides a notification (e.g., as a user communication 110) to a user of the online platform 102 of a determined tranche adjustment value 21509. An example notification includes a request for approval from the user to execute one or more operations indicated by the determined tranche adjustment value 21509. In a further example, the tranche assignment circuit 21504 executes the operations indicated by the determined tranche adjustment value 21509 only in response to an approval value provided by the user of the online platform 102 in response to the notification. An example tranche assignment circuit 21504 executes a portion of the operations indicated by the determined tranche adjustment value 21509 in response to the approval value indicating a partial approval of the determined tranche adjustment value 21509. An example tranche assignment circuit 21504 executes the operations indicated by the determined tranche adjustment value 21509 in response to an expiration of a selected time period after the notification, if the tranche assignment circuit 21504 receives no response from the user. An example notification is provided as a confirmation that one or more actions indicated by the determined tranche adjustment value 21509 have been executed. Example and non-limiting notifications include one or more communications such as: an email message, a text message, a message on a proprietary messaging application, a voice call notification, and/or an indication within a user interface 107 of the online platform 102.

An example platform analysis circuit 21506 updates at least one value of at a tranche description (e.g., as a part of the tranche analytics profile 21512) a tranche subsequent to the operations executed by the tranche assignment circuit 21504 to reflect any changes to tranche resulting from the operations. An example platform analysis circuit 21506 preserves data on metrics (e.g., as tranche metrics 21520) associated with the tranches over time, and tracks statistical information associated with tranches as clients are moved among the tranches. Storing the historical tranche metrics 21520 allows for iterative improvement operations, for example to improve tranche assignment and tranche adjustment values for executing future tranche related workflows on the platform 102.

An example platform analysis circuit 21506 preserves a tranche constituency history 21518 indicating which clients were assigned to which tranches. An example platform analysis circuit 21506 provides at least one tranche organization recommendation (e.g., as a user communication 110) to at least one user of the online platform 102 responsive to an analysis of tracked metrics 21520 corresponding the plurality of tranches.

Referencing FIG. 115, an example procedure 22000 for updating tranche analytics is schematically depicted. The example procedure 22000 includes an operation 22002 to interpret client descriptions, and an operation 22004 to determine tranche adjustment value(s) in response to the client descriptions. The example procedure 22000 includes an operation 22006 to create a new tranche, eliminate a tranche, add a client user to a tranche, remove a client user from a tranche, and/or move a client user between tranches as indicated by the tranche adjustment value(s). The example procedure 22000 includes an operation 22008 to update tranche analytics for one or more tranches in response to the indicated operation from the tranche adjustment value, and/or based upon inherent changes in the enrollment processes for client users within the tranche (e.g., based on progress for enrollment processes since the last tranche analytics profile was determined).

Operations of the system 21500 allow for the movement of clients between tranches, providing a number of benefits over previously known systems, for example allowing for coordinated completion of tranches, improvement of tranche analytics (e.g., grouping clients in tranches, for example using a similarity between clients and/or client attributes, which can reduce processing resources to perform analytics on the tranches), reduced enrollment process overhead (e.g., coordinating notifications, ease of tracking of enrollment stages within the tranche, ease of determining off-nominal enrollment progression within the tranche, etc.), and/or reducing the number of tranches (e.g., moving the last few clients out of a tranche, allowing for the closure of the tranche and consequent reduction in processing for the tranche, and/or reducing a display footprint for an administrator user responsible for monitoring tranches). Further, the optional tranche history 21518 improves the ability to perform post-processing of various operations throughout the present disclosure to incrementally improve operations—for example testing different communication schemes, enrollment stage monitoring and progression logic, determining whether enrollments are likely to be successful, or the like. The utilization of the tranche constituency and/or history 21518 provides these improvements in view of aspects herein that are not previously known, such as operations to move client users between tranches, to operate an enrollment process on a platform 102 that automatically integrates various stakeholders (e.g., agent users, carrier users, financial institution users, etc.) with the process on the platform, to configure user groups for common related operations on the platform, to provide customized illustrations and/or analytics to various stakeholders on the platform, and/or to provide longitudinal support to client users and/or agent users on the platform. Accordingly, operations for tranche management and/or creation as set forth herein provide a number of benefits to various users on a wealth management platform, generate new data values that did not exist in previously known systems (e.g., values utilized to determine tranche constituency for users, to track tranche constituency and/or history, and/or tranche analytics profile values), and process data in a manner not known in previous systems.

Referencing FIG. 116, an example system 22300 for creating and managing groups of users on a wealth management platform is schematically depicted. The example system 22300 includes a group management controller 22302 that includes a client addition circuit 21502 that receives a group addition request 22310 associated with an identified user, a group assignment circuit 22304 that adds the identified user to an existing user group 22312 within the online platform, and/or creates a new user group 22312, and adds the identified user to the new user group, responsive to the received group addition request 22310. The example group management controller 22302 depicts a client addition circuit 21502 as an example for clarity of the present description, but the constituency of a group is not limited to client users. In certain embodiments, any user on the platform of any type can be added to a group, and any set of users may be added to a group based on any user class value, user attribute, or any other criteria that is available on the platform and can be related to specific users. The example group management controller 22302 may be included, in whole or in part, as a part of any platform set forth throughout the present disclosure. The example group management controller 22302 includes a group execution circuit 22308 that performs a common group operation 22314 for users within the user group 22312, whether an existing user group or a new user group.

An example group analysis circuit 22306 determines group analytics 22318 for the existing user group or the new user group, and exposes the group analytics 22318 to at least one of a group administrator user, a responsible user, or a platform administrator user. Accordingly, the operations of the system 22300 allow for convenient monitoring and/or management of the group 22312.

An example group 22312 corresponds to a tranche on the platform. It will be noted that, in certain embodiments, a group 22312 can be created entirely separately from a tranche, and may be formed for reasons unrelated to tranche creation and/or management. In certain embodiments, for example even where a group 22312 and a tranche are utilized for a similar function, members of a group 22312 may be distributed across more than one tranche. For example, a group 22312 may start within a single tranche, but one or more members of the group may be moved due to tranche adjustment operations 21510. In another example, a group 22312 may be divided between multiple tranches, for example where the group size and/or constituency is such that multiple tranches are created to support the group 22312. In certain embodiments, group analytics 22318 may be tracked separately from, and/or in addition to, tranche analytics for a tranche related to the group 22312.

An example system 22300 includes the group addition request 22310 being provided by an authorized user within the online platform. For example, the authorized user may be a platform administrator user, and/or a person (and/or a role—for example a company may assign an e-mail address that represents the authorized user, which may be staffed by different people at different times) authorized to create groups 22312 on the platform. In certain embodiments, multiple users may be authorized to create groups 22312 on the platform, but the constituency of the groups 22312 may be limited according to permissions set for the authorized user. For example and without limitation, an agent user may be authorized to create groups 22312 among client users associated with the agent user. Similarly, a responsible user may be authorized to create groups 22312 among users within their scope of responsibility. For example, a responsible user for Carrier A may be authorized to create groups 22312 among agent users affiliated with Carrier A, but not authorized to create groups with other users (e.g., platform administrator users, and/or users affiliated with other Carriers).

An example identified user is a group administrator user, where the system 22300 further includes a group analysis circuit 22306 that determines group analytics 22318 for the relevant group 22312, and exposes the group analytics 22318 to the group administrator user.

An example group assignment circuit 22304 analyzes an organization of users within the user groups 22312 using a set of criteria to determine if a user group move is indicated (e.g., a group based on a user class value, where the user class value for one of the group members has changed), and moves at least one user from a first user group 22312 to a second user group 22312, and/or removes the at least one user from one of the groups 22312. In certain embodiments, operation to add, remove, and/or move users between groups 22312 are represented as group assignment operations 22316. In certain embodiments, the group assignment operations 22316 are responsive to the determined indication of a user group move.

In certain embodiments, a user may be a member of more than one user group 22312. In certain embodiments, user groups 22312 may be utilized to enforce permissions, interface layouts and/or formatting, menu content and/or layouts, and/or to set any permissions, interface elements, preferences, communication settings, notification settings, or the like, as set forth throughout the present disclosure. In certain embodiments, group settings may be applied permissively (e.g., the group member user can override these settings if desired) and/or as a predicate (e.g., the group member cannot override these settings). In certain embodiments, as group member users can be members of multiple groups 22312, settings provided by the groups may be incompatible. Accordingly, in certain embodiments a group hierarchy is applied, for example with a higher priority group setting overriding a lower priority group setting. In certain embodiments, conflict management is provided as an option to the group member user, allowing the group member user to select the preferred setting. In certain embodiments, conflict management is resolved using the nature of the setting, for example with a predicate setting taking priority over a permissive setting (or vice versa—for example depending upon a hierarchy of the two groups, a role of the group member user, permissions for the group member user, etc.). In certain embodiments, conflict management is resolved by disallowing certain group memberships, for example users can be assigned to Group A or Group B, but not both. In certain embodiments, conflict management is resolved according to a hierarchy of the group administrator user that provided the group addition request 22310, for example a platform administrator user may have a higher priority than a responsible user for an entity that engages the platform. In certain embodiments, compatible settings between multiple groups are all applied. In certain embodiments, groups 22312 are organized by category, and only a highest priority group 22312 within a category is applied (e.g., a workflow reporting category that tracks performance of the group members within a workflow, such as an enrollment process). In certain embodiments, unapplied groups 22312 are rejected—for example the prospective group member user is not added to the membership for an unapplied group 22312. In certain embodiments, unapplied groups 22312 are approved—for example the prospective group member user is added to the membership for the unapplied group 22312, but some or all of the settings of the group 22312 are not applied to that user, unless and until the higher priority group membership is removed, and/or the priority between the groups 22312 changes.

An example group 22312 corresponds to at least one attribute of users within the online platform. The attribute of the users for a group 22312 may include any attribute for users as set forth throughout the present disclosure. Referencing FIG. 117, in certain embodiments the attribute of the users for a group 22312 includes one or more of: a role on the platform 22404, a permissions on the platform 22406, a communication preference 22408 for the user, and/or an investment attribute 22410 for the user. Referencing FIG. 118, example and non-limiting investment attributes 22410 include one or more of: an enrollment date target 22502; a financial goal target 22504 (e.g., a time based, rate based, magnitude based, and/or product type based target); a financial risk profile 22506 (e.g., categorical, quantitative, volatility based, etc.); a retirement date target 22508; a life span estimate value 22510; and/or a financial product utilization value 22512 (e.g., grouping users according to financial products utilized, and/or financial products in a plan for the user). In certain embodiments, an example attribute of the users for a group 22312 includes one or more of: a common membership in a certain tranche; a common affiliation with a certain organization; a common affiliation with a certain agent or agency; a common affiliation with a certain carrier, a common affiliation with a certain underwriter, a common affiliation with a certain independent marketing organization (IMO); a common level of authority within or permissive access to the online platform; and/or a common association with a workflow within the online platform. An example system 22300 includes one or more groups 22312 organized by users sharing a common user class value.

An example group analysis circuit 22306 tracks a set of group metrics 22320 associated with each user group within the user groups 22312, for example tracking historical analytics, allowing for tracking of the groups 22312 over time, and accounting for the movement of members between groups (e.g., allowing the group analysis circuit 22306 to determine what the group analytics 22318 would be if the group constituency did not change). The group analytics 22318 and/or group metrics 22320 may be determined according to the purpose of the group 22312, for example determining whether workflow process targets (e.g., responsiveness to enrollment process operations) are met, determining whether applied interface elements are utilized and/or changed by group members, determining whether financial targets for the group are achieved, etc. Example and non-limiting group metrics 22320 (and/or group analytics 22318) include one or more success metrics for the group 22312, and/or performance metrics for the group 22312.

An example group assignment circuit 22304 automatically executes the group addition request 22310 by adding the identified user to an existing group, and/or creating a new user group for the identified user. An example group assignment circuit 22304 sends a notification to an authorized user within the online platform in response to the group addition request 22310, and only executes the group addition request 22310 upon receiving authorization from the authorized user.

An example common group operation 22314 includes at least one operation such as: tracking analytics for the existing user group or the new user group; providing a common notification to the existing user group or the new user group; providing a common interface to the existing user group or the new user group; enforcing a common platform rule for the existing user group or the new user group; and/or tracking enrollment statistics for the existing user group or the new user group. An example common group operation 22314 includes providing a common interface element to the existing user group or the new user group. Example common interface elements include aspects such as: a common menu; a common menu element; a common display setting; a common display organization; a common permissions setting; and/or a common preferences setting.

Referencing FIG. 119, an example procedure 22600 includes an operation 22602 to receive group addition request(s), and an operation 22604 to add an identified user to an existing group, or to create a new group for the identified user. The example procedure 22600 includes an operation 22606 to perform a common group operation for users in the existing group or the new group.

Referencing FIG. 120, an example procedure 22700 includes the operations of procedure 22600, and further includes an operation 22702 to determine group analytics for the existing group or the new group, and an operation 22704 to expose the group analytics to selected users on the platform. In certain embodiments, the selected users may include the authorized user that provided the group addition request, and/or may include a user designated by the authorized user in the group addition request.

Operations to utilize groups of users on the platform 102 provide for a number of benefits that are not available in previously known systems. The utilization of groups, including without limitation performing common workflows with the group, adjusting interfaces with the group, tracking analytics relevant to the group, and adjusting preferences and/or permissions with the group provide greatly enhance the working efficiency for a number of users on the platform 102, improve security on the platform 102, and promote computational efficiency for the platform 102. For example, an administrator user can evaluate various metrics on the platform for a related group of users, avoiding having to perform various filtering operations, evaluating a number of users that are not relevant to the analysis, or the like. Similarly, the administrator user can quickly apply changes to permissions for a group of users, simply by adjusting the properties of the user group. Further, the administrator can ensure that settings are correct, as they only have to make one change for the whole group and can therefore spend more time ensuring that the changes are correct, as well as eliminating a number of steps for a change that may introduce an error. An example administrator user can create a group with selected criteria, for example client users that are engaged in an enrollment process that is at-risk, and set up relevant monitoring and/or notifications to prioritize monitoring and/or intervention resources where they are likely to make a difference in the performance of the platform 102. Other users can benefit as well, for example an agent user can readily change interfaces, recommendations, send communications, or the like, to relevant client users, and the group for the agent user can be more sophisticated than “all clients.” For example, groups can be logically oriented around certain class values, attributes, or the like—for example providing communications, tutorials, or the like, to clients with a high risk tolerance, clients that prefer visual information to numerical information (or vice versa), or based on any other criteria using any information available to that user in the platform. Additionally, the fluid promotion of relevant informational communications, permissions adjustments, settings adjustments, or the like, promotes the ready adoption of best practices on the platform 102 to enhance the overall performance of the platform 102. In another example, a user on the platform that is responsible for a number of other users (a “responsible user”)—for example a manager for agent users, a company representative (e.g., an HR representative) responsible for company employees that are client users (and/or prospective client users), an administrator user for an entity outside of the platform 102 (e.g., a platform champion within a carrier, a financial institution, or the like), can readily manage (e.g., setting permissions, setting up and/or adjusting platform accounts, etc.), monitor (e.g., evaluate actions of the relevant users in workflows on the platform), and enhance (e.g., set up desired illustrations, analytics, data visualizations, interface layouts, text and/or graphic formatting, etc.) the platform experience for relevant users. Further, utilization of group creation and management tools allow responsible users on the platform to readily promote (and/or enforce) policies for their own entities—for example communication language, data visualizations, etc., and to configure groups more intelligently than “all users” for which they are responsible. For example, the responsible user can offer a number of interface settings, and classify users within their set of users as individual groups, readily applying the desired interface settings. In another example, a responsible user may group their users by any parameter, such as a user role or an accessibility parameter (e.g., visual impairment, color blindness, typing capability, etc.), and provide appropriate settings on the platform for each group.

Referencing FIG. 121, an example system 22800 for performing a group enrollment on a wealth management platform is schematically depicted. The example system 22800 includes a group enrollment controller 22802 having a client addition circuit 21502 that receives a group addition request 22310 associated with at least one identified user (e.g., a group administrator user, an agent user, and/or a responsible user for the client users of the group to be enrolled), and a group assignment circuit 22304 that adds at least one identified user to an existing enrollment group 22808 within an online platform, and/or that creates a new enrollment group 22808 and adds the at least one identified user to the new enrollment group 22808. The group assignment circuit 22304 adds the user to the group 22808 in response to the received group addition request 22310. the example group enrollment controller 22802 further includes an enrollment execution circuit 22804 that implements an enrollment of users (e.g., using enrollment operations 22806) within the existing enrollment group 22808, or the new enrollment group 22808. The invited group of client users can be related in any manner, generally according to the selection of the group by the inviting user. For example, the group of client users may be employees of an entity, where a wealth management plan implemented on the wealth management platform is offered to the group of employees. Any other relationship of the invited group of client users is contemplated herein, for example a group of client users invited by an agent user, a group of users attending an educational workshop, and/or members of an organization (e.g., an alumni group, union workers, etc.). The inviting user may be any user on the platform having sufficient authorization, for example a user working with a platform administrator to set up an enrollment plan where authorizations for the inviting user are included in the planning. In certain embodiments, the inviting user may be an HR representative and/or a benefits coordinator for the group of invited users. The permissions provided to the inviting user can be scheduled according to the relationship of the inviting user with the group of invited users. For example, where the inviting user has an informal relationship with the group of invited users (e.g., for an alumni group), the inviting user may have limited access to see information in the client descriptions 21508 (e.g., income, age, financial goals, etc.), and another authorized user may be involved in the enrollment process (e.g., an agent user and/or a platform administrator user). In the example, the group enrollment process may be an offered benefit for the group, but the inviting user may not have a significant interest in determining how many users of the invited group have actually enrolled or participated in the program. In another example, where the inviting user has a formal and/or employment relationship with the group of invited users (e.g., an HR representative for a company where employees of the company comprise the group of invited users), the inviting user may have significant permissions to see the client descriptions 21508, have significant control over the enrollment process, and have significant capability to see enrollment group analytics 22812 (e.g., enrollment statistics, participation, and/or stalled, at-risk, and/or off-nominal enrollment events). Accordingly, the inviting user may facilitate the enrollment and assist invited users in successfully enrolling, and have a significant interest in measuring the success of the group enrollment process. The examples are non-limiting, for example an informally related inviting user may have an interest in determining the success of the group enrollment process, for example to determine whether the benefit should continue to be offered. Depending upon the regulatory scheme applicable, the informally related inviting user may nevertheless have limited information, and may rely on voluntary surveys or other off-platform measures for the success of the group enrollment process. Nevertheless, an assisting user such as an agent user and/or a platform administrator user may have access to a more complete data set and/or the enrollment group analytics 22812, for example to ensure the group enrollment process is successful for the client users that participate.

An example enrollment group 22808 corresponds to a tranche on the platform. For example, the client users of the invited group may be placed into a same tranche, at least initially. The placement of the client users of the invited group into a same tranche may depend, at least in part, on the timing of the group addition requests 22310 for each user, and the invitation scheme for the invited users. For example, if the invitation is available for a limited time window, inclusion of the invited group into a same tranche may be useful. In another example, if the invitation is open on a continuing basis to members of the invited group, the client users accepting the invitations may be placed into whichever active tranches are being formed at the time, for example as set forth in FIGS. 108-115 and the related description. In certain embodiments, the user enrollment group 22808 may be distributed into more than one tranche, members of the group 22808 may be moved between tranches, and/or the enrollment group analytics 22812 may be tracked for the group regardless of the tranche distribution of the group 22808.

The example group enrollment controller 22802 includes a group analysis circuit 22306 that determines enrollment group analytics 22812 for the enrollment group 22808, and exposes the enrollment group analytics 22812 to an authorized user. In certain embodiments, the enrollment group analytics 22812 are exposed to the inviting user. In certain embodiments, the enrollment group analytics 22812 are exposed to an assisting user (e.g., an agent user and/or a platform administrator user), where the enrollment group analytics 22812 may additionally be exposed, in whole or part, to the inviting user, and/or the enrollment group analytics 22812 may be unavailable to the inviting user.

An example group analysis circuit 22306 tracks a set of metrics 22820 associated with the enrollment group 22808. The enrollment group metrics 22820 allow for tracking of the group analytics 22812 over time, as the constituency of the enrollment group 22808 changes, and allows for post processing of outcomes of the group enrollment process. In certain embodiments, for example where an invitation to the group is ongoing for a long period of time, the enrollment group metrics 22820 may become more informative about the enrollment process, assisting in configuring interfaces, enrollment communications, and/or determining when a particular enrollment for a client user is at-risk, than the relatively small corpus of data available in the enrollment group analytics 22812 at any given time, due to the relatively small percentage of the invited group that may be participating in an active enrollment process at any given time. In certain embodiments, the enrollment execution circuit 22804 provides a notification (e.g., as a user communication 110) to a group administrator (e.g., the inviting user and/or an assisting user) in response to the enrollment group metrics 22820 (and/or the enrollment group analytics 22812)—for example identifying enrollments for individual client users that are at-risk, stalled, or off-nominal, and/or providing overall data such as enrollment percentages, progression, or the like. Example and non-limiting enrollment group metrics 22820 include success metrics and/or performance metrics. Example and non-limiting notifications include an enrollment progress communication and/or an enrollment completion communication (e.g., scoped for individual client users, and/or for the user enrollment group 22808 as a whole).

An example group assignment circuit 22304 sends a notification to at least one authorized user within the online platform in response to the group addition request 22310, and only executes the group addition request 22310 upon receiving authorization from the at least one authorized user.

Example and non-limiting enrollment operations 22806 include one or more operations such as: tracking analytics for the existing enrollment group or the new enrollment group; providing a common notification to the existing enrollment group or the new enrollment group; providing a common interface to the existing enrollment group or the new enrollment group; enforcing a common platform rule for the existing enrollment group or the new enrollment group; or tracking enrollment statistics for the existing enrollment group or the new enrollment group. Additionally or alternatively, the enrollment operations 22806 include any other enrollment operations as set forth throughout the present disclosure, including at least: notifying a user on the platform of an activity due in the enrollment process; providing a user with documents and/or links related to an activity due in the enrollment process; providing a user with a reminder of an activity due in the enrollment process; providing a user with information related to an activity due in the enrollment process, for example client descriptions 21508 related to the activity (e.g., demographics, identifying information, medical information, financial risk and/or goal descriptions, etc.); and/or providing an escalation communication in response to a delay of an activity due in the enrollment process (e.g., providing a more urgent communication to a user, adjusting a communication mechanism such as sending a text as an escalation from a prior notification provided on the user interface 107, and/or providing a communication to another user such as a platform administrator user, and/or a manager user for the user that has the activity due).

An example enrollment execution circuit 22804 provides a common enrollment interface 22814 to the enrollment group 22808, for example to give users a consistent layout, and/or to identify an aspect of the relationship of the group (e.g., including a logo for a company in a header area 20605 or other location of the user interface 107, etc.). The utilization of a common enrollment interface 22814 can assist the client user in determining the invitation and/or enrollment process is legitimately provided by the inviting user and/or an associated entity, increasing confidence in the enrollment process for the client user. In certain embodiments, the common enrollment interface 22814 includes a common interface element such as: a common menu; a common menu element; a common display setting; a common display organization; a common permissions setting; and/or a common preferences setting.

An example enrollment execution circuit 22804 invites the identified user(s) to the user enrollment group 22808 using an email message, a text message, a message on a proprietary messaging application, a voice call notification, and/or an indication within a user interface within the online platform. An example enrollment execution circuit 22804 provides a link to the identified user(s) in the invitation, where the link connects the identified user(s) to the platform when selected or activated. An example enrollment execution circuit 22804 tracks the identified user(s) using an email read receipt, a response message from the identified user, and/or through activity on the online platform subsequent to the invitation. An example enrollment execution circuit 22804 implements enrollment of users by providing a group enrollment portal to the at least one identified user, for example as a dedicated instance of a user interface 107 configured for the invited users. An example group assignment circuit 22304 monitors the identified user(s) in response to operations of the identified user(s) within the group enrollment portal. An example group enrollment portal prompts the identified user(s) for information relevant to group enrollment, and the group assignment circuit 22304 selects at least one enrollment group 22808 in which to enroll the identified user(s) based at least in part on the information. For example, the platform may be implementing a number of group enrollment processes at any given time, and may utilize various aspects of user information, interactions with an invite, and/or interactions with a group portal, to determine which of the number of group enrollment processes is relevant to the identified user(s).

An example group addition request 22310 is generated explicitly by the identified user(s) via a selection within the group enrollment portal. An example group addition request 22310 is generated automatically by the group assignment circuit 22304 responsive to the at least one identified user visiting the group enrollment portal. An example group assignment circuit 22304 provides a notification to an authorized user within the online platform when the at least one identified user accesses the group enrollment portal. An example group assignment circuit 22304 selects at least one user group to add the at least one identified user to based on at least one attribute 22902 (e.g., reference FIG. 122) of the at least one identified user. Example and non-limiting attributes for selecting the at least one user group include, without limitation: a common membership in a certain tranche 22904, a common affiliation with a certain organization 22906, a common affiliation with a certain agent or agency 22908, a common affiliation with a certain carrier 22910, a common affiliation with a certain underwriter 22912, a common affiliation with a common independent marketing organization (IMO) 22914, a common level of authority within or permissive access to the online platform 22916, a common workflow within the online platform 22918, and/or a common user class 22920 within the online platform.

The utilization of a group enrollment controller 22802 to implement a group enrollment provides for a number of benefits on a wealth management platform of the present disclosure relative to previously known systems. The group enrollment process, and the operations of the group enrollment controller provide a convenient mechanism for a user to invite a large number of users to the platform, and to execute a configured enrollment process that provides for rapid enrollment with a high success rate for client users to complete the enrollment process. Additionally, various tools and aspects of embodiments of the platform set forth throughout the present disclosure can be leveraged with the group enrollment controller to enhance the experience of client users, allowing client users access to information about the financial products and wealth management plan, and ensure that the plan is a good fit for, and configured to meet the specific needs of each client user. For example, the client users of the invited group can include sub-groups within the invited group, according to user class values and attributes for the client users, allowing the client users to have an interface, configured enrollment process, and customized wealth management plan that meets their individual needs, while sharing the enrollment experience with other client users if desired. Additionally, the inviting user (e.g., a group administrator user, a responsible user, an agent user, etc.) can readily monitor the progress of enrollments, efficiently provide intervention where applicable, and focus on providing client users with customized help and communications for their needs.

Referencing FIG. 123, an example procedure 23000 for executing enrollment operations for a group are schematically depicted. The example procedure 23000 includes an operation 22602 to receive a group addition request, and an operation 22604 to add a user to an existing group, or to create a new group for the user, in response to the group addition request. The example procedure 23000 further includes an operation 23002 to execute enrollment operations for the group.

Referencing FIG. 124, an example procedure 23100 for providing group analytics to a user on a platform is schematically depicted. The example procedure 23100 includes the operations 22602, 22604, and further includes an operation 23002 to execute enrollment operations for the group, an operation 23102 to determine group analytics for the group, and an operation 23104 to expose the group analytics to at least one user on the platform.

Referencing FIG. 125, an example system 23200 for configuring an interface for a wealth planning platform for selectable user classes is schematically depicted. The example system 23200 includes a platform 102 including an access initialization circuit 20002 that interprets user class value(s) 20006 for a user accessing the online platform 102 having a number of wealth management functions, where the user class value(s) each correspond to at least one class of a number of user classes. An example number of user classes includes a client class, an agent class, and/or an administrator class. The platform 102 further includes an access management circuit 20004 that determines a wealth planning platform interface description 23202 in response to the user class value(s) 20006, and a user interface circuit 106 that implements a user interface 107 for the user in response to the wealth planning platform interface description 23202.

An example user interface 107 includes a session menu region (e.g., 20609), where the wealth platform interface description 23202 includes a session menu description 23204 for each user class value 20006. The example includes a session menu description 23204 for each user class value 20006, however one or more aspects, or all aspects, of a session menu description 23204 for two user class values 20006 may have a same value (e.g., the content, order, sizing, and/or placement of menus for those two user class values 20006 may be the same, or distinct). An example user class value 20006 includes a device display size, where the wealth planning platform interface description 23202 includes an interface size description 23206 defining a size of at least one region of the user interface 107.

Referencing FIG. 126, an example wealth planning platform interface description 23202 includes one or more aspects such as: a description of enabled menu content 23306; a description of enabled user preferences 23308 (e.g., default settings, and/or settings determined by classifying the user based on expressed user preferences 23308, which may extend to settings beyond those explicitly selected by the user—for example a user class value 20006 indicating that the user prefers certain types of menus, menu operation, window sizing or behavior, color schemes, etc.); enabled wealth management functions 23314 (e.g., based on functions that the user has permission to access, that will be useful to the user, that will be available to the user, etc.); a description of enabled illustration values 23312 (e.g., illustration types available, illustration presentation formats, time frames, comparisons, etc., and/or further including default values for these and/or selections available for these); an area layout 23316 (e.g., the size and/or position of areas on the user interface 107, adjustment interface types such as corner dragging, selection of options, etc.); a region layout 23318 (e.g., regions available, position of the regions within the areas of the user interface 107, adjustment interface types, selection of options, etc.); a header description value 23310 (e.g., content, formatting, position, etc. of header information, and/or including the presence and settings for a first and second header region, etc.); and/or an alert description value 23320 (e.g., the formatting, communication mechanism, trigger conditions, etc. for alerts on the user interface 107 and/or to be sent to user devices).

Referencing FIG. 127, an example procedure 23400 for implementing a user interface based on a user class value is schematically depicted. The example procedure 23400 includes an operation 23402 to interpret a user class value, an operation 23404 to determine a wealth planning platform interface description, and an operation 23406 to implement a user interface in response to the wealth planning platform interface description.

Referencing FIG. 128, an example procedure 23500 for implementing a user interface is schematically depicted. The example procedure 23406 includes an operation 23502 to implement a selected display size, an operation 23504 to apply selected region and/or area sizes and a selected layout, an operation 23506 to apply visibility and/or enablement for content of session menus, an operation 23508 to provide visibility and/or enablement of wealth management functions and/or illustrations, an operation 23510 to apply headers according to a header description value, an operation 23512 to apply enabled user preferences, and an operation 23514 to apply an alert schema according to an alert description value.

Referencing FIG. 129, an example system 23600 for selecting and utilizing distinct client engagement schemes for a wealth management platform is schematically depicted. The example platform 102 includes a client introduction circuit 23602 that interprets a client description 23606, a client information circuit 23604 that determines a client engagement scheme 23608 in response to the client description 23606, and a user interface circuit 106 that implements an engagement user interface 107 in response to the client engagement scheme 23608. The utilization of the system 23600 allows for configured engagement with a client, providing information configured for questions the client is likely to have, to address concerns the client is likely to have, and to provide these in an order that is likely to match the priorities of the client. In certain embodiments, the client description 23606 includes information and/or attributes of the client that are likely to be relevant to the type of information or concerns for the client, for example the client's demographic information, geography, relevant jurisdiction, the observed history of client interactions, or the like. Additionally or alternatively, history on the platform with other users sharing one or more class values and/or attributes with the client user may be utilized to inform the information requests, concerns, and/or priorities of the client. Additionally or alternatively, another user, for example an agent user, can configure the client engagement scheme 23608 for their clients based on class values and/or attributes of the client, which are determined by the client introduction circuit 23602 based on information obtained about the client. As the client user engages with the platform 102, the client description 23606 may be developed in real time, and that information may be utilized by the client information circuit 23604 to configure the client engagement scheme 23608 over time.

Referencing FIG. 130, a number of aspects of a client engagement scheme 23608 are depicted, any one or more of which may be present in certain embodiments. Example aspects include: an illustration description value 23702 (e.g., selecting assumptions, displayed time frames, displayed data values, and/or the depiction scheme—for example a table, graph, or other object, as well as the resolution thereon, for an illustration such as financial performance for a wealth management plan); a financial product type 23704 (e.g., which financial products to consider in developing a wealth management plan); information selection(s) 23706 (e.g., which information to present to the client, including financial education, financial product education, platform interaction training, etc.); engagement interface layout(s) 23708 (e.g., the size and/or layout of areas and/or regions on a user interface 107); client demographic value(s) 23710 (e.g., the default demographic information utilized for examples, and/or other information such as professions, income levels, etc. to be utilized in examples, scenarios, and/or training materials); client geography value(s) 23712 (e.g., geographic values to be utilized in examples, assumptions, or the like, for example to provide the client user with a familiar context, to make relevant tax assumptions, etc.); client history value(s) 23714 (e.g., configuring the client engagement scheme 23608 based on interactions with the client, for example pre-filling out client preferences, adjusting any other aspects of the engagement scheme, and/or inferring client interest in certain types of displays and/or certain types of information displayed based on the client history); client preference values 23716 (e.g., utilized similarly to, and/or as a part of the client history value(s) 23714, where client preferences expressed can be reflected in the engagement scheme, utilized to determine a user class value for the client, and/or to infer other preferences the client may have); and/or information sequencing 23718 (e.g. utilized to present information in an order that is likely to match the priorities of the client).

Referencing FIG. 131, an example illustration description value 23702 includes a number of aspects, any one or more of which may be present in certain embodiments. The example illustration description value 23702 includes one or more aspects such as: an illustration content value 23302 (e.g., which illustrations to provide, and/or which aspects of the illustration to present to the client user); an illustration layout value 23304 (e.g., the format of illustrations, the positioning of illustrations, the size of illustrations, etc.); and/or an illustration sequencing value 23303 (e.g., the order of presenting illustrations, how to display comparative illustrations such as various scenarios and/or illustrations determined based on risk events, etc., for example whether to present different illustrations sequentially and/or in what order, simultaneously, and/or combinations of these).

An example procedure for implementing an engagement user interface (not shown) is schematically described following. The example procedure includes an operation to interpret a client description, and an operation to determine a client engagement scheme in response to the client description. The example procedure includes an operation to implement an engagement user interface in response to the client engagement scheme.

Referencing FIG. 132, an example system 23900 for managing a workflow and promoting progress of the workflow on a wealth management platform 102 is schematically depicted. The example platform 102 is configured to operate a workflow comprising an enrollment process, for a client user enrolling in a wealth management product. The example platform 102 enhances the workflow for a number of different users on the platform 102, depending upon which contributors to the workflow are present as users on the platform. In certain embodiments, one or more contributors to the workflow may contribute without being users on the platform, for example with workflow contributions performed with various interactions with the platform 102, for example through an API to a supporting device and/or system, and/or via communications such as e-mail, text messages, or the like. In certain embodiments, one or more aspects from workflow contributors are performed directly by the platform 102, for example by modeling and/or estimating contribution elements from contributors for at least a part of the supporting operations. The distribution of workflow duties depend upon the configuration of the platform 102, the availability of information about the contributing systems, or the like. For example, a process step of the workflow may include determining the eligibility for client users for certain products, such as loans, life insurance products, and/or annuities, where the platform 102 may request approvals from a provider of those products either through direct messaging or an interface such as an API to the provider system, and/or the platform 102 may include models, estimates, and/or on-platform components (e.g., a component on the platform that is provided by and/or managed by the provider, that is capable to make direct offers of the products). An example workflow supported by the platform 102 is depicted in FIG. 40 and the related description (reference process steps 4006, 4008), including an enrollment process for a wealth management product. Another example workflow supported by the platform 102 is depicted in FIG. 10 (reference enrollment process 1002). An example wealth management product may utilize various financial products to provide for a target retirement income, a scheduled death benefit over relevant time periods, and/or residual wealth for disposal by the client user in late life and/or upon death. Example financial products may utilize, without limitation, life insurance policies, loans (e.g., for leverage, to provide liquidity, and/or to shift client contributions in time), annuities, and/or investment vehicles (managed or unmanaged). An enrollment process operates with a realistic estimate of available financial products, and related premiums, rates of return, variability, and the like, to determine a wealth management plan that has a realistic chance of being realizable. If estimates or other information sources for available financial products are not realistic, significant time is wasted as the process and plan is forced to iterate on offers until the solution converges to a plan that meets the financial goals of the client user. Further, enrollment process includes committing various providers (e.g., insurance companies, banks, etc.) to financial products in accordance with the plan, requiring various parties to contribute to steps in the workflow, with consequent hand-offs between parties, and potential delays introduced with each hand-off. An example process may include a screening of the client user to ensure that the financial goals of the client user are realistic, and the client user will be eligible for a range of financial products to support the plan. The example process may then include acquiring more specific information from the client user, for example utilizing questionnaires and/or a complete application process. The example process may then include getting specific offers from various financial providers, which may require actuarial analysis, medical tests, and/or follow up information from the client user before the financial providers can commit to provide the financial products in the plan. Finally, the process may include steps such as determining that the offered product mix is still consistent with the plan, acceptance of the offers from the client user, and setting up the client user for payment of ongoing contributions and the like. In the example process, there are numerous hand-offs between parties on the platform 102 and potentially off the platform 102, and at each step if the information is incomplete then significant delays are introduced. Determining an appropriate plan, checking the plan against actual financial products offered, and confirming that the plan is still viable based on various disturbances (e.g., stress testing, such as changes in interest rates, a downturn in the economy, a change in prevailing life insurance rates, a change in the client user's income, etc.) in presently known systems is performed directly by an expert user making a detailed analysis of the client user's situation. Such estimates for presently known systems require significant time with the expert, depending upon the complexity of the plan and the client user's situation, and can take from 15 minutes to several hours to complete an estimate. Additionally, the estimate needs to be updated several times, such as for initial planning, before direct communications with financial providers, and then in response to actual offers from financial providers. Each of these estimates introduces a hand-off in the process, to a limited pool of expert users, who have to reserve time to create, confirm, or update the plan. As a consequence, plans for current systems are expensive, have to be limited to accounting for a small set of predictable disturbances, add significant time delays to the overall process, and are limited in quality according to the available bandwidth of an appropriate expert.

Previously known systems to perform a process similar to the example process involve a significant number of delays, and typically take several weeks or longer to complete. The delays further complicate the process and can create positive feedback for delay, as information that is provided ages, parties lose interest, circumstances of any party may change over time, and any missed hand-off or stall in the process has to be diagnosed through investigation to determine which step in the process is active, and which party is responsible for completing the next step. Embodiments of the platform 102 to manage workflows and promote progression of the workflows are capable to reduce enrollment times significantly, for example supporting the completion of a process like the example within several days. Additionally, the platform 102 support increases visibility of the client user to the process, gives the client user greater control over the plan and final implementation, allows for detection and mitigation of process delays, and greatly increases the range and number of disturbances in the plan that can be accounted for.

The example wealth management platform 102 includes a client addition circuit 23902 that receives a client enrollment request 23906 associated with an identified user 23908 (e.g., a client user), and an enrollment management circuit 23904 that implements a wealth management enrollment process 23910 for the identified user in response to the client enrollment request 23906. The example wealth management platform 102 further includes a user interface circuit 106 that implements a user interface 107, and executes at least a portion of the wealth management enrollment process 23910 on the user interface 107.

Referencing FIG. 133, an example wealth management enrollment process 23910 includes a number of execution steps 24002 (e.g., reference FIGS. 10 and 40, and the related description), where the enrollment management circuit 23904 tracks an active step 24004, and where the user interface circuit 106 provides notifications (e.g, as enrollment process communications 23912) to relevant users in response to the tracking. In certain embodiments, communications 23912 to all users, for example an agent user, carrier user, the client user, and/or a financial institution user, are available directly on the platform 102, allowing each user to seamlessly access the available information to complete the step, and to perform the work for the step directly on the platform 102. For example, a carrier user can directly access relevant documents, such as the proposed plan, the user questionnaire, the user application, and/or test results (where applicable), without having to handle, transfer, or search for any documents. Further, the direct interaction of users with the platform 102 allows the enrollment management circuit 23904 to directly determine which process step is active, which user is responsible for completing the step, and even to determine which type of information may be preventing the user from completing the step (e.g., a carrier user that accesses the client questionnaire and then exits the step without completing it likely indicates that the questionnaire is missing some information). Further still, the granular process information available on the platform 102 allows the enrollment management circuit 23904 to improve the process over time, with specific information available on the slowest steps in the process that can be improved. Additionally, the enrollment management circuit 23904 has a greater corpus of data about the process execution, such that off-nominal processes can be readily detected (e.g., by parsing the differences in platform 102 interactions between fast, successful enrollment processes, and slower and/or less successful enrollment processes), stalled processes can be identified and diagnosed, and the statistical likelihood that the enrollment process will be completed (or will not be completed) can be determined immediately and with high certainty. Accordingly, interventions to recover a stalled or at-risk enrollment process can be implemented quickly, and with a greater likelihood of success. Further, communications with the identified user 23908, supporting documentation such as educational materials, and the like, can be configured to give a greater likelihood that complete and usable information is provided at each step of the process.

In certain embodiments, all users having a responsibility within the workflow can interact directly with the platform 102 to perform the relevant steps of the workflow. However, benefits of the platform 102 are still realized even if one or more users do not interact directly with the platform 102. In certain embodiments, at least the client user (e.g., identified user 23908) and at least one supporting user (e.g., an agent user and/or a platform administrator user) perform relevant operations of the workflow through direct interaction with the platform 102 (e.g., using the user interface 107).

In certain embodiments, planning operations, such as developing the plan, confirming the plan, double checking the plan after specific offers have been made from financial product providers, and/or stress testing of the plan, are similarly performed on the platform. For example, operations to provide a client illustration, depicted in FIGS. 79-82 and the related descriptions, perform a detailed analysis of the plan, can readily be updated at various steps in the process, and can be performed for multiple scenarios and/or stress tested against numerous potential disturbances. Further, the on-platform 102 planning operations depicted can utilize direct information from financial product providers, for example accessing an API, to provide higher quality estimates that are likely to match the real offers made at the relevant steps in the workflow. Additionally, the client illustration operations as depicted in FIGS. 79-82 can be performed within a few seconds, allowing for the plan to be updated at any time, whether within the workflow or outside of the workflow, allowing for rapid adjustment of the plan if some assumption or client information utilized in the plan changes. Further, a change in the client information can be detected immediately upon entry of that information by the client user on the platform, allowing the enrollment management circuit 23904 to adjust the plan, and creating a greater likelihood that the enrollment process will be successful, and will meet the client user's goals. In certain embodiments, where planning and/or illustration operations are not performed on the platform 102, the operations of the enrollment management circuit 23904 nevertheless provide for numerous benefits relative to previously known systems.

In certain embodiments, the wealth management enrollment process 23910 includes a number of execution steps distributed among a number of responsible users, where the number of responsible users includes the identified user 23908 as one of the users. In certain embodiments, the responsible users further include an agent user and/or a carrier user. In certain embodiments, the responsible users further include a financial entity user. An example enrollment management circuit 23904 determines an enrollment progress visualization 23914 (e.g., reference FIGS. 20-23, and 40), and the user interface circuit 106 provides the enrollment progress visualization 23914 to at least one of the responsible users.

In some aspects, the enrollment management circuit 23904 is further structured to determine an enrollment progress visualization 23914 for each of the client user and the agent user, and wherein the user interface circuit 106 is further structured to provide the respective enrollment progress visualization 23914 to each of the client user and the agent user. In some aspects, the enrollment management circuit 23904 is further structured to determine a stalled enrollment process indicator, and the user interface circuit 106 is structured to provide a notification to at least one user on the platform in response to the stalled enrollment process indicator. In some aspects, the enrollment management circuit 23904 is further structured to determine an at-risk enrollment process indicator, and the user interface circuit 106 is structured to provide a notification to at least one user on the platform in response to the at-risk enrollment process indicator. In some aspects, the enrollment management circuit 23904 is further structured to determine an off-nominal enrollment process indicator, and the user interface circuit 106 is structured to provide a notification to at least one user on the platform in response to the off-nominal enrollment process indicator.

Referencing FIG. 134, an example procedure 24100 for implementing a user interface and executing an enrollment process at least in part on the user interface is schematically depicted. The example procedure 24100 includes an operation 24102 to receive a client enrollment request, an operation 24104 to implement a wealth management enrollment process in response to the client enrollment request, and an operation 24106 to implement a user interface, and to execute at least a portion of a client enrollment process on the user interface.

Referencing FIG. 135, an example procedure 24200 to determine enrollment indicators for enrollment issues, and to provide a notification of the enrollment indicator to a user on a platform is schematically depicted. The example procedure 24200 includes an operation 24102 to receive a client enrollment request, an operation 24104 to implement a wealth management enrollment process in response to the client enrollment request, and an operation 24106 to implement a user interface, and execute at least a portion of the enrollment process on the user interface. The example procedure 24200 further includes an operation 24202 to determine an enrollment progress visualization, and to provide the enrollment progress visualization to at least one user on the platform, and an operation 24204 to determine enrollment indicators (e.g., a stalled enrollment, at-risk enrolment, and/or off-nominal enrollment), and to provide a notification to at least one user on the platform in response to the enrollment indicator(s).

Referencing FIG. 136, an example system 24300 for providing longitudinal servicing support on a wealth management platform 102 is schematically depicted. Previously known systems for providing wealth management services suffer from a number of drawbacks. For example, a client user may have a life event, want to change financial planning implementation, and/or need to update records for various purposes, such as for estate planning, developing a will, or the like. In many instances, these events may occur years after initial wealth management planning implementations have been completed. Example embodiments herein provide a platform 102 that resolves many of these issues, for example providing for convenient and immediate access to documents utilized during implementation of wealth management services. Additionally, embodiments herein provide for numerous data elements and/or documents that were never present in previously known systems. For example, embodiments herein have access to enrollment operations and dates, execution dates of documents, access to user specific data such as the age of the user, planning dates such as a planned retirement date, the date of completion of enrollment, and/or alternative plans developed during the enrollment process to respond to and/or mitigate events such as a downturn in the economy, change in interest rates, and/or a job loss. Accordingly, embodiments herein provide for significantly improved support over time after completion of an enrollment process.

The example platform 102 includes a client tracking circuit 24302 that interprets client wealth management information 24306, where the client wealth management information 24306 including an enrollment process record 24308 for each one of a number of client users. The example platform 102 further includes a client engagement circuit 24304 that interprets a client event value 24312 for at least one of the client users, and to determine a client support communication 24310 in response to the client event value 24312 and the client wealth management information 24306. The example platform 102 further includes a user interface circuit 106 structured to provide the client support communication 24310 to the at least one of the client users, for example on a user interface 107. In certain embodiments, the client event value 24312 is determined automatically, for example in response to the client user reaching a certain age (e.g., age 65, a retirement age, an age relevant to retirement planning such as age 55, which may vary according to the applicable laws for the client user), in response to the expiration of a predetermined period after the completion of a selected stage of a workflow and/or enrollment process associated with the platform—for example a stage associated with the execution of a document, a stage representing an initiation of the enrollment process, and/or a stage representing a completion of the enrollment process. In certain embodiments, the client event value 24312 is provided by the client user, for example as a request for a document, changing client information on the platform 102 indicating a marriage, divorce, retirement, change in profession, birth of child, change in address and/or relevant jurisdiction, or the like. In certain embodiments, communications between the platform 102 and the client user may be provided as user communications 24314 provided to and/or retrieved from the user interface 107.

An example user interface circuit 106 is further structured to implement the user interface 107 on a wealth management platform 102 (and/or in communication with the wealth management platform 102), and to provide the client support communication 24310 to the at least one of the client users on the user interface 107. An example client support communication 24310 further includes a client illustration 24402 (e.g., reference FIG. 137) for wealth management, for example an enrollment illustration 24502 (e.g., reference FIG. 138) (e.g., a preliminary illustration, and/or an updated illustration developed using the client questionnaire and/or client application), a previous illustration 24504 (e.g., an illustration developed at any time before the client event value 24312), a current illustration 24506 (e.g., a recent illustration, and/or an illustration developed in response to the client event value 24312), a combination of any one of the foregoing (e.g., two or more of the foregoing, and/or a hybrid illustration combining aspects of any one of the foregoing), and/or a comparison of any one of the foregoing (e.g., a comparison of illustrations 24508, for example to show performance over time versus predicted performance over time). An example client illustration includes a remedial action effectiveness value 24510 determined in response to the comparison illustration—for example where a remedial action was taken at a previous time (e.g., to respond to a disturbance such as an interest rate change, a client risk category change, a profession change, or the like), where the illustrations are compared to determine whether the remedial action had the intended effect and/or to quantify the effect of the remedial action. An example client support communication 24310 includes an action recommendation 24404 determined in response to a target financial goal compared to an achieved financial goal (e.g., recommending an action to be taken in response to a performance gap and/or over-performance of the wealth management plan). An example client support communication 24310 includes an action recommendation 24404 determined in response to the client event value 24312, for example recommending an action to preserve financial goals, and/or to adjust financial goals, in response to the client event value 24312—for example where the client event value 24312 is an event relevant to financial performance for the user, whether a positive or negative event. An example client support communication 24310 includes a document 24406, for example a document requested by the client user and/or indicated by the client event value 24312. An example client engagement circuit 24304 interprets the client event value 24312 in response to a document request from the client user—for example determining that a life event has occurred in response to the document requested, information available about the user (e.g., user age, profession, planning dates, etc.), and/or based on querying further information from the client user during support operations of the platform 102 for the client user.

An example user interface circuit 106 is further structured to provide the client support communication 24310 to an agent user, where the agent user is associated with the at least one of the client users (e.g., to allow the agent user to support the client user, and/or to provide visibility to the agent user of a potential client event value 24312 for the client user). An example client engagement circuit 24304 interprets the client event value 24312 in response to a periodic time value (e.g., checking in with the client user at selected times, every 5 years, every 10 years, etc.).

An example client engagement circuit 24304 is further structured to interpret the client event value 24312 according to a determination of a life event for the at least one of the client users in response to an attribute of the at least one of the client users, wherein the attribute includes at least one of: a geographic attribute, a demographic attribute, or a profession attribute. In certain embodiments, the client engagement circuit 24304 interprets the client event value 24312 in response to a comparison between an expected performance value and an actual performance value. Example and non-limiting expected performance values include one or more of: an original expected performance value, an enrollment confirmed expected performance value, and/or any preceding expected performance value.

Referencing FIG. 139, an example system 24600 for providing early enrollment screening operations is schematically depicted. An example platform 102 includes a client addition circuit 23902 structured to receive a client enrollment request 23906 associated with at least one identified user 23908; an enrollment management circuit 23904 structured to implement a wealth management enrollment process for the at least one identified user in response to the client enrollment request 23906; an enrollment verification circuit 24602 structured to determine a client screening value 24606, and wherein the enrollment management circuit 23904 is further structured to adjust the wealth management enrollment process 24604 in response to the client screening value 24606. The example platform 102 includes a user interface circuit 106 structured to implement a user interface 107, and to execute at least a portion of enrollment process communications 23912 on the user interface 107.

An example enrollment verification circuit 24602 determines the client screening value 24606 in response to client basic information 24608 provided by the at least one identified user—for example where the client basic information 24608 indicates the client may not be eligible for certain financial products, where the adjusted wealth management enrollment process 24604 includes determining a plan that omits those financial products, that requests further information from the client user before proceeding, and/or terminating the enrollment process.

An example enrollment verification circuit 24602 determines the client screening value 24606 in response to a client questionnaire response 24610 provided by the at least one identified user, for example where the client questionnaire response 24610 indicates the client may not be eligible for certain financial products, where the adjusted wealth management enrollment process 24604 includes determining a plan that omits those financial products, that requests further information from the client user before proceeding, and/or terminating the enrollment process

An example enrollment verification circuit 24602 determines the client screening value 24606 at a stage of the wealth management enrollment process where the only responsible user is the at least one identified user. For example, by performing screening operations before other users are responsible for actions in the workflow, the screening operations can be performed quickly and therefore maximize the efficiency in making early process adjustments, and/or commence determining further information early in the process, reducing the overall time to complete enrollment operations.

An example enrollment verification circuit 24602 determines the client screening value 24606 in response to a health estimate and/or a mortality estimate for the at least one identified user. In certain embodiments, the health estimate and/or mortality estimate is determined utilizing an artificial intelligence (AI) component, for example comparing available basic information, questionnaire information, user class values, and/or client descriptions to other client users on the platform, where the AI component determines effective parameters for determining the health estimate and/or the mortality estimate. In certain embodiments, the health estimate and/or mortality estimate can be utilized in determining an initial plan (e.g., improving the time to converge the plan into a realistic plan for the client user, and/or improving the likelihood that financial product providers will make an offer for financial products that matches the plan).

An example enrollment management circuit 23904 adjusts the wealth management enrollment process 24604 by changing an order of process stages—for example moving information gather stages up earlier in the process, and/or moving more selective stages (e.g., stages that are more likely to cause a failure of the plan to converge—for example to reduce the number of stages that must be completed before the success of the plan is determined).

An example enrollment management circuit 23904 adjusts the wealth management enrollment process 24604 by requesting additional information from the at least one identified user. An example enrollment management circuit 23904 adjusts the wealth management enrollment process 24604 by providing a notification to an agent user associated with the at least one identified user (e.g., allowing the agent user to intervene more quickly in the enrollment process, for example to increase the likelihood of success and/or to reduce the number of stages that must be executed before a termination). An example enrollment management circuit 23904 adjusts the wealth management enrollment process 24604 by providing a client screening description in the notification to the agent user (e.g., to give the agent user context for the potential issue, for example allowing the agent user to research options, prepare for information to be gathered, etc.). Example and non-limiting client screening description(s) include one or more of: a financial product that is unavailable for the at least one identified user, a financial product modification applicable for the at least one identified user, and/or an off-nominal client attribute (e.g., an attribute for the client user that is a statistical outlier, out of the norm, inconsistent with previously supplied information, and/or inconsistent with estimated information) of the at least one identified user.

Referencing FIG. 140, an example procedure 24700 for performing client screening for a user interface is schematically depicted. The example procedure 24700 includes an operation 24702 to receive a client enrollment request, and an operation 24704 to implement a wealth management enrollment process in response to the client enrollment request. The example procedure further includes an operation 24706 to determine a client screening value, an operation 24708 to adjust the wealth management enrollment process in response to the client screening value, and an operation 24710 to implement a user interface, and execute at least a portion of the enrollment process on the user interface.

Referencing FIG. 89, an example engagement predictor 10002 is schematically depicted. The example engagement predictor may be utilized with, in whole or part, a platform such as depicted in FIG. 1, and/or with any other systems, components, controllers, or the like as set forth in the present disclosure. In certain embodiments, the engagement predictor 10002, in whole or part, may interact with, be provided in communication with, and/or be included in a system with, any other systems, components, controllers, or the like as set forth in the present disclosure.

In one example, engagement predictor 10002 may be configured to analyze behavior and/or previous activity and/or engagement of users with the platform and may generate engagement predictions 10010 about future user engagements with the platform. In embodiments, successful engagement may be attributed to different stages, phases, configurations, or elements of the platform. The engagement predictor 10002 provides for several improvements over prior techniques. In one example, embodiments of the engagement predictor 10002 promote improved monitoring and allow early identification of technical issues. Monitoring engagement can help platform providers identify technical glitches, bugs, or confusing user interfaces, and address them proactively before they negatively impact the user experience. In many cases, a small technical glitch during an early stage (such as the enrollment stage) for a client may cause compounding effects in later stages. The compounding effects of a small technical glitch may not manifest themselves until later stages in the platform, where there may be an observed gradual reduction in client engagement. The later-stage manifestations may be impossible to detect with traditional methods that cannot evaluate and make predictions using activity and engagement from previous stages in the platform.

In another example, the engagement predictor 10002 may be configured to analyze behavior and/or previous engagement of users with the platform and may provide options and/or change the configuration of the platform to improve predicted client engagement. The engagement predictor 10002 provides several improvements over prior techniques. In one example, embodiments of the engagement predictor 10002 promote improved performance benchmarking. Monitoring engagement across the platform can help providers establish performance benchmarks, set goals for improvement, and measure the success of their efforts over time. The platform may be enabled to make small incremental changes in the platform configuration, make predictions about the effects of the changes, and observe the changes in a deployed configuration. The platform may independently test and verify the effectiveness of different configuration changes. In traditional settings, platform configuration changes are deployed as a group of changes as dictated by managerial decisions, and the impact and effects of changes cannot be attributed to individual changes or features.

The example engagement predictor 10002 includes a data agglomerating circuit 10006 configured to agglomerate activity data of one or more clients associated with the wealth planning platform. For example, the data agglomerating circuit 10006 may collect data from one or more databases that may be part of the platform or may be external data 10016. Collecting data may include copying the data to a local database 10026, linking to the data, summarizing the data, and the like. The data agglomerating circuit 10006 may collect data related to client engagement associated with the platform. The agglomerated data may include various user interactions and/or activity data associated with the platform and may include data such as the number of log-ins, session duration (such as the average time users spend on the platform per session, wherein longer session durations may indicate higher engagement levels), pageviews (number of page views or screen visits for different sections of the platform, such as account aggregation, goal setting, or investment management), feature usage (how often users interact with specific features of the platform, such as setting financial goals, rebalancing their portfolio, or using financial calculators), goal completion (the progress users make toward achieving their financial goals), user feedback and ratings, platform interaction (the number of clicks, scrolls, and navigation events), customer support inquiries, and/or referral and sharing activity (the number of referrals to friends/family and/or social media).

The engagement predictor 10002 may further include a client engagement controller 10004 that may be configured to process the agglomerated data and identify engagement trends, timelines, scores, and the like. For example, the client engagement controller 10004 may use the interactions data to determine engagement scores associated with each of the interactions. The engagement predictor 10002 may further include an event-resolving circuit 10008 configured to resolve events from the agglomerated activity data. Resolved events may include events related to platform configuration 10018 and may include different phases or stages associated with the platform. Events may include attribution to different teams or agents associated with each team. Events may include attribution to user interface elements or a span of time associated with an activity such as registration and onboarding (e.g., creating an account on the platform, and providing their personal and financial information), account aggregation (e.g., aggregating data from various financial accounts, such as bank accounts, investments, retirement accounts, and loans), financial goal setting (e.g., when users set specific, measurable financial goals, such as saving for retirement, buying a house, or funding a child's education), risk assessment (e.g., evaluating tolerance based on factors like age, investment horizon, and financial objectives), financial plan creation, investment management (e.g., building and manage their investment portfolios, including research, investment strategies, and asset allocation guidance), monitoring and tracking (e.g., monitoring financial progress on the platform, including tracking their net worth, investment performance, and progress toward financial goals), plan adjustments and updates (e.g., facilitating updates to financial plans and investment strategies), and/or reporting and analysis (e.g., providing with periodic reports and analytics on their financial progress).

The event-resolving circuit 10008 may be configured to resolve events by attributing the activity according to platform configurations 10018 that were enabled or active for the client. Platform configurations 10018 may include a history of enabled features (e.g., which graphical user interfaces and illustrations that were presented to the client), responsible parties associated with each phase or stage (e.g., agents, managers), active products, and the like for each client. The platform configurations 10018 may change in time and may be associated with a time span each configuration was active for each user. The event-resolving circuit 10008 may be configured to attribute activity data to the features of a configuration using a time stamp associated with the data elements of the activity data and the time span of each active configuration. The event-resolving circuit 10008 may be configured to determine the causation for the activity data. The event-resolving circuit 10008 may be configured to determine features of a configuration that may be attributed to features or events associated with a configuration. In one example, the event-resolving circuit 10008 may include a trained model to provide a score of the events and features of the configuration that may be attributed to the activity of the client. The trained model may be a neural network that is trained on the histories of configurations and user activity data. In another example, the event-resolving circuit 10008 may communicate with an analytics controller 10020 to select an analytics toolbox 10022 to compute correlations between events and configurations.

In embodiments, the event-resolving circuit 10008 is further configured to correlate the activity data with a milestone of the client. In some cases, milestones may not directly correspond to events associated with a configuration of the platform. A milestone may correspond to a status set in the client profile and may include aspects such as a time anniversary, a return threshold value, the age of the client, and the like.

The example engagement predictor 10002 may further include an analytics controller circuit 10020 configured to interpret a provider analytics toolbox 10022 and determine engagement analytics for the resolved events. An example output of the analytics controller may include engagement rating for resolved events. Engagement rating may include value that can be interpreted as a contribution of an event to the engagement of the client with the platform. In one example, the engagement rating may be generated for clients that engaged with the platform (e.g., enrolled in services with the platform) and may include a value or another indicator for each event that is indicative of the impact of the event leading to engagement of the client with the platform. The indicators for the engagement of the events may be provided on an agent interface as a timeline or other display, thereby providing an indication of which events (e.g., team members, agents, interface elements, active configurations, etc.) had an impact on eventual engagement.

In another example, the engagement rating may be generated for clients that did not engage with the platform (e.g., did not enroll in services with the platform) and may include a value or another indicator for each event that is indicative of a gap in event engagement between the recorded event engagement and nominal event engagement (e.g. average, median, etc.). The indicators for the engagement of the events may be provided on an agent interface as a timeline or other display, thereby providing an indication of which events (e.g., team members, agents, interface elements, active configurations, etc.) had a deficiency that may have caused the client not to engage with the platform.

The agent interface may further be configured to provide additional statistics and analytics related to engagement, activity data, client profile data, and the like. Analytics may be selected from the user interface. The analytics controller 10020 may be configured to receive the indication of a selection of analytics from a set of analytics of the provider analytics toolbox 10022. The provider analytics toolbox 10022 may include options for determining at least one of a census, value, growth, versus plan, progression statistics, completion statistics, and forecasting. The provider analytics toolbox 10022 may include options for identifying data anomalies and options for grouping and filtering. In embodiments, options in the provider analytics toolbox 10022 may be restricted by permission levels associated with user type. A user interface may be configured to filter options of the analytics toolbox based on at least one of a user class, a user permission, a user location, or a user status of a user accessing the user interface.

In embodiments, the analytics controller 10020 may be configured to generate engagement analytics of a plurality of clients. The engagement analytics may be displayed to a provider and/or agent showing engagement trends and events attributed to the engagement or lack thereof. In embodiments, trends in the deficiencies may be highlighted to an agent and used to investigate potential glitches or errors in the platform.

The example engagement predictor 10002 may further include engagement predicting models 10028 configured to generate engagement predictions 10010 from the engagement analytics. In one example, engagement predictions 10010 may be generated to provide a prediction (e.g., a probability) that a client will engage or continue engaging with the platform. The engagement predicting model(s) 10028 may generate predictions based on user histories 10014. The engagement predicting mode(s) 10028 may be trained on the histories and engagement outcomes and may include trained artificial intelligence models. The engagement predictions 10010 may be provided on an agent interface to show the status of unengaged clients allowing an agent or provider to view and forecast engagement from clients. The predicted engagement may be a probability value, a score (e.g., a relative value in the range of 1-100), a qualitative rating (e.g., low, high, etc.). The predicted engagement may be provided as a value relative to a baseline engagement for at least one of the plurality of stages. The baseline engagement may be set as a goal in the platform and the predicted engagement may indicate how far the engagement is from a goal. The baseline goals may be specified on different granularities and may be different for different user groups, profiles, products, and the like.

In one embodiment, the engagement predicting models 10028 may be configured to identify pending clients (e.g., clients that have not yet engaged) and identify required metrics for next events that are likely to cause the client to engage with the platform. The metrics for the next events may be provided on an agent interface and may provide action actionable elements or suggestions to improve the metrics. For example, a client may have low activity for initial events associated with registration and onboarding to the platform. The engagement predicting models 10028 may show a low engagement prediction (e.g. client unlikely to engage with the platform or product) for the user based on the user attributes and current activity data. The engagement predicting models 10028 may be further used to predict what metrics are needed for the upcoming events to change the engagement prediction to that of likely engagement prediction. For example, the predicted metrics may indicate a specific level of activity with events associated with the goal-setting stage. The required metrics for the goal-setting stage may be provided to an agent with suggestions to send the client reminders and educational material, and/or use other tools to meet the required metrics for the likely engagement prediction.

Referencing FIG. 90, another example engagement predictor 10102 is schematically depicted. The engagement predictor 10102 may be configured to determine engagement predictions 10010 and determine platform configurations 10018 that may improve or optimize the engagement predictions 10010. The example engagement predictor 10102 may include a configuration management circuit 10103 that may be configured to provide suggestions for configurations and/or change a platform configuration to improve the engagement predictions. The engagement predictor 10102 may be configured to select one or more predefined platform configurations 10018 and/or modify elements of the predefined platform configurations 10018. The engagement predictor 10102 may be configured to process the engagement predictions 10010, user attributes 10012, and platform configurations 10018 and provide alternative configurations 10104. The alternative configurations 10104 may be one of the platform configurations 10018 that are previously generated and/or approved. The alternative configurations 10104 may be a new configuration and, in some cases, may require review and approval from an administrative user such as an agent for deployment. Alternative configurations 10104 may include changes in the configuration that include one or more of a change in the next event (e.g., alternating a goal-setting stage and an education stage), a change in illustration types, a change in communications (e.g., email, messages, etc.), a change in a graphical user interface, and/or the like.

The configuration management circuit 10103 may be configured to determine a configuration of the wealth planning platform enabled for the client and identify a plurality of stages of the configuration. The configuration management circuit 10103 may be configured to map the resolved events to the plurality of stages. The mapping may be analyzed to identify aspects of the configuration that corresponded to high activity for the client. The identified aspects of the configuration may be used by a model to adjust the configuration. In embodiments, the configuration management circuit 10103 may include one or more of a trained model, a heuristic model, a lookup table, and the like

Referencing FIG. 91, an example method 10200 for predicting client engagement with a wealth planning platform is schematically depicted. The method may be implemented, in whole or part, on a platform such as depicted in FIGS. 1, 100, and 101, and/or with any other systems, components, controllers, or the like as set forth in the present disclosure.

An example method 10200 may include a step for agglomerating activity data of a client associated with the wealth planning platform 10202. The activity data may be collected from a plurality of internal and/or external data sources and may include user actions. Agglomerating may include normalizing, filtering, and/or transforming the data. The method 10200 may further include a step for resolving events from the activity data of the client 10204. In one example, step 10204 may include correlating the activity data to a configuration and/or events associated with a configuration of the platform. The method 10200 may further include the step of interpreting a provider analytics toolbox and determining engagement analytics for the resolved events 10206. In one example, step 10206 may include determining statistics, ratings, and/or scores for the activities for the events with respect to a baseline. The method may further include the step of predicting the client engagement from the engagement analytics 10208 and implementing a user interface, the user interface providing a display of the predicted engagement and the determined engagement analytics 10210. In one example, step 10208 may include predicting a likelihood, a score, or other indicators indicative of the probability that a client will engage with the platform by committing funds, purchasing a financial product, and the like. Step 10208 may include comparing client activity and/or profile data to historical data of other clients, their activity data, and their engagements using models and may include statistical models, trained artificial intelligence models, heuristic models, and the like.

In one example, step 10206 may include providing receiving an indication of a selection of analytics from a set of analytics of the provider analytics toolbox. The provider analytics toolbox may include options for information including at least one of a census, value, growth, versus plan, progression statistics, completion statistics, data anomalies, and/or forecasting. The provider analytics toolbox may include options for information including at least one of a census, value, growth, versus plan, progression statistics, completion statistics, data anomalies, and/or forecasting as well as the option to group and filter any of the provided statistics and options by permissions, groups, user status, and the like.

Referencing FIG. 92, an example method 10300 for predicting client engagement and adjusting a configuration in response to the predicted engagement with a wealth planning platform is schematically depicted. The method may be implemented, in whole or part, on a platform such as depicted in FIGS. 1, 100, and 101, and/or with any other systems, components, controllers, or the like as set forth in the present disclosure.

An example method 10300 may include the steps of agglomerating activity data of a client associated with the wealth planning platform 10302, resolving events from the activity data of the client 10304, and interpreting a provider analytics toolbox and determining engagement analytics for the resolved events 10306. The method 10300 may further include the step of predicting the client engagement from the engagement analytics 10308. The method 10300 may further include the steps of determining a configuration of the wealth planning platform enabled for the client 10310, predicting changes in the engagement analytics in response to a change to a second configuration of the wealth planning platform 10312, and deploying the second configuration to the wealth planning platform for the client in response to the changes in the engagement analytics showing increased engagement 10314.

Referencing FIG. 141, an example apparatus 10400 for customization of an interface for a wealth planning platform is schematically depicted. The example apparatus 10400 may be utilized with, in whole or part, a platform such as depicted in FIG. 1, and/or with any other systems, components, controllers, or the like as set forth in the present disclosure. In certain embodiments, the apparatus 10400, in whole or part, may interact with, be provided in communication with, and/or be included in a system with, any other systems, components, controllers, or the like as set forth in the present disclosure.

In one example, apparatus 10400 may be configured to generate illustrations and customize an interface with the illustrations. The apparatus 10400 provides for several improvements over prior techniques. In one example, embodiments of apparatus 10400 promote improved privacy for customized interfaces. Interfaces can be dynamically generated and/or modified using private elements of a data profile of a user. The dynamic generation and modifications of illustrations may be discarded after being provided to a user, thereby allowing customized interfaces that cannot be directly viewed by others. Known methods of customization of interfaces with illustrations require a manual or supervised (e.g., by an agent) illustration generation and are not appropriate for use when private data. Manual and supervised generation requires disclosure of private data to a third party and cannot provide the same benefits provided by the apparatus and methods disclosed herein.

The example apparatus 10400 includes a stress test controller 10402 and may include a data agglomerating circuit 10412 configured to agglomerate and identify user-specific data of the wealth planning platform. For example, the data agglomerating circuit 10412 may collect data related to personal information (e.g., demographic data, address, occupation, etc.), financial information (e.g., income, expenses, assets, liabilities, etc.), investment information (e.g., existing investments such as stocks, bonds, mutual funds, and real estate), retirement and pension information (e.g., retirement accounts, pension plans, social security, etc.), tax information (e.g., tax filing status, deductions, and credits), financial goals (e.g., short-term and long-term financial goals such as buying a home, funding education, or saving for retirement), and/or risk tolerance (e.g., investment preferences, risk exposure, etc.). Data may be collected from internal databases and external sources 10408, such as external financial institutions. For some users, at least one user-specific data may be private data. Private data may be identified as private based on a designation from the user, based on the source of the data, based on the type of the data, and the like. For example, goals for the user may be designed as private if the user does not want any other user or agents to view the data or analysis related to the data.

The example apparatus 10400 includes a stress parameter prediction circuit 10410 configured to predict, based on the user-specific data, a set of user-specific stress-test parameters. Stress-test parameters may include parameters such as interest rates, equity market fluctuations, currency fluctuations, inflation rates, unemployment rates, economic growth rates, commodity prices, liquidity conditions, geopolitical events, and the like. Stress-test parameters used to define stress scenarios during stress testing. These parameters may be adjusted to simulate extreme or adverse market conditions that could have a significant impact on a user's financial plan or investment portfolio. The selection of stress test parameters may depend on the user's financial profile, investment objectives, risk tolerance, the nature of the investments, prevailing market conditions, and/or the like. In embodiments, the stress parameter prediction circuit 10410 may include one or more of trained models (e.g., neural networks, machine learning models, etc.), heuristic models, lookup tables, and the like. In embodiments, the stress parameter prediction circuit 10410 may provide at least a subset of the user-specific data to a trained model, such as a machine model. The trained model may generate a score for the plurality of stress test parameters wherein the score is indicative of the relevance of the parameters to the user. In some cases, the highest-scoring parameters may be selected.

The example apparatus 10400 includes a stress test scenario generation circuit 10416 configured to generate a stress test scenario based on the stress-test parameters. A stress test scenario is a hypothetical situation, or a situation mirroring historical data, that models conditions that could have a significant impact on a user's financial plan, or investment portfolio. Stress test scenarios can be used to assess the resilience and stability of a financial plan, or investment strategy, under challenging circumstances. In embodiments, multiple stress test scenarios can be generated to capture a range of potential risks and evaluate the user's financial plan or investment portfolio under various hypothetical and/or historical conditions.

The example apparatus 10400 includes a simulation circuit 10414 configured to simulate the stress test scenario to determine effects on the user-specific data. The simulation circuit may perform calculations to calculate the performance of the user's financial plan or investment portfolio under the stress test scenarios considering the stress parameters. The simulation circuit 10414 may include or employ financial models, statistical techniques, and/or historical data to estimate the potential impact of the stress scenarios. The simulation circuit 10414 may be configured to assess the effects or impacts of the stress scenarios on the user's financial situation, such as portfolio value, ability to meet financial goals or potential losses. The simulation circuit 10414 may involve calculating various risk measures, such as Value at Risk (VaR) or Conditional Value at Risk (CVaR), to quantify the potential downside risk.

The example apparatus 10400 includes a user interface circuit 10418 configured to update a user-specific interface 10428. The user interface circuit 10418 includes an illustration automation circuit 10420 that is configured to cause the generation of an illustration 10422 in response to the simulation of the stress test scenario. The illustration may include a depiction of the determined effects from the simulations. The user interface circuit 10418 may be configured to embed the illustration in interface 10428. In embodiments, the user interface circuit 10418 may communicate with an external illustration generations circuit 10424. The external illustration generations circuit 10424 may be controlled or configured by a third party.

Illustrations 10422 may include a visual representation and/or a numerical example that demonstrates the simulated effects. The illustrations can include charts and graphs such as line charts, bar charts, or pie charts, and data projections, data tables, text descriptions, figures, and the like. Illustrations may be formatted as images, HTL, vector graphics, spreadsheet data, and/or another appropriate format. Generated illustrations may be validated to ensure they accurately represent the users scenario analysis effects. This step may involve cross-checking, comparing results to historical data of similar users, and/or reviewing the illustrations by administrators. The illustration automation circuit 10420 may include an Illustration validation circuit 10430 that can be used to confirm that illustrations models are operating as expected. The illustration validation circuit 10430 may validate models and illustrations by testing an illustration model against known or expected outputs. The illustration validation circuit 10430 may be configured to generate a test illustration by providing a test prompt to an illustration model and comparing features of the test illustration to a set of expected features. If the set of features of the test illustration matches the set of expected features, the illustration model is validated.

Illustrations 10422 may be generated using a plurality of models and the generated illustrations may include a combination of the outputs of the plurality of models. In embodiments, illustrations may be generated by a plurality of parallel models that generate separate illustration elements that are combined to generate a combined illustration. In embodiments, illustrations may be generated by a plurality of models arranged in series wherein illustrations are sequentially modified as they are processed by each model. In some embodiments, illustrations may be generated by a plurality of models that are arranged in a combination of series and parallel configurations. The arrangement of models may be configured by the illustration automation circuit 10420 and may be based on user attributes 10404 availability of models, user preferences, user selections, user histories 10406, and the like. Illustrations 10422 may be saved in a datastore 10426 for future retrieval and/or manipulation.

The user interface circuit 10418 may include elements for receiving selections of information options and/or selections of sensitive parameters for the simulations and illustrations. The interface may cause the user interface circuit 10502 to update the illustrations based on changes in selections. The user interface circuit 10418 may be configured to monitor user interaction with the interface in response to the illustrations and update the user-specific stress-test parameters in response to the user interaction. For example, users interactions related to a stress-parameter may indicate user interest in a class of stress parameters.

Referencing FIG. 142, an example apparatus 10500 for customization of an interface for a wealth planning platform is schematically depicted. The user interface circuit 10502 of apparatus 10500 may include a prompt generation circuit 10504. In embodiments, illustrations may be generated using generative artificial intelligence models. The illustration automation circuit 10420 may be configured to generate a prompt that is used by a generative model to generate the illustration, an element of the illustration, and/or a modification of an illustration. A prompt may include a string of text and/or numbers that may describe aspects of the illustration. A prompt may be composed by the illustration automation circuit 10420 and may include aspects of the simulation results, user attributes 10404, and other data. In one example, a generative model may be used to modify an illustration to highlight the results of a simulation. A generated illustration may be processed by a generative model according to a prompt that may indicate how to modify the illustration to highlight the results of the simulation. For example, illustrations related a simulation that indicated that investments are resilient to interest rate fluctuations may be modified to add colors, images, and/or other enhancements that portray a positive outcome. A prompt may be composed by the prompt generation circuit 10504 to modify an illustration with cheerful colors, images, and the like. In another example, illustrations related a simulation that indicated that investments are vulnerable to interest rate fluctuations may be modified to add colors, images, and/or other enhancements that portray a negative outcome. A prompt may be composed by the prompt generation circuit 10504 to modify an illustration with alerting colors, images, and the like.

The example apparatus 10500 may include a privacy management circuit 10508 for facilitating the generation and management of illustrations with private data. In embodiments, illustrations may be generated for, or using private data of a user. The private data of the user may be defined in a user profile 10506 and may be data that is personal to a user that the user does not want agents or others to view or analyze. For example, user profile 10506 may include data related to private financial goals or motivations specified by a user, such as an indication that the user has a goal of buying a boat from the investments. In embodiments, illustrations may be modified by one or more models based on private data before being available to the user. The privacy management circuit 10508 may be configured to manage the modifications. In one example, the privacy management circuit 10508 may be configured to identify private data in the user profile 10506. Upon identification of the private data, the privacy management circuit 10508 may be configured to determine if the private data is applicable to generated illustrations and if applicable, may cause the user interface circuit 10502 to modify the illustrations according to the private data before they are provided to the user. The illustrations that include private data may be configured to be generated dynamically and marked so that they are not saved in the datastore 10426. The privacy management circuit 10508 may manage illustrations modified with private data and delete illustrations in the datastore 10426 that are identified to include private data. In one example, the privacy management circuit 10508 may identify the private data in the user profile 10506 (e.g., the user's desire to buy a boat) and modify illustrations by including images, text, and/or other elements related to boats. For example, modifications of illustrations may include images of boats in graph bars, including marine-themed backgrounds, and the like. The privacy management circuit 10508 may be configured to generate a prompt for a generative model to modify images in accordance with the private data.

Referencing FIG. 143, an example method 10600 for customization of an interface for a wealth planning platform is schematically depicted. The method may be implemented, in whole or part, on a platform such as depicted in FIGS. 1, 141, and 142, and/or with any other systems, components, controllers, or the like as set forth in the present disclosure.

An example method 10600 may include a step for identifying user-specific data of the wealth planning platform 10602. The activity data may be collected from a plurality of internal and/or external data sources. The method 10600 may further include a step of predicting, based on the user-specific data, a set of user-specific stress-test parameters 10604. In one example, step 10604 may include predicting using a trained model. The method 10600 may further include the step of generating a stress-test scenario based on the stress-test parameters 10606. The method may further include the step of simulating the stress test scenario to determine effects on the user-specific data 10608, a step of generating an illustration in response to the simulating, the illustration comprising a depiction of the determined effects 10610, and a step of embedding the illustration in the interface. Users may provide additional selections of information options and/or selections of sensitive parameters that may be subject to stress testing. Aspects of stress-testing may, in some cases, depend on the permission parameters of the user requesting the interface and/or the permissions of the user data. In some cases, models, scenarios, and data may be restricted based on permissions and may limit what analysis and stress-testing may be generated.

Referencing FIG. 144, an example method 10700 for customization of an interface for a wealth planning platform is schematically depicted is schematically depicted. The method may be implemented, in whole or part, on a platform such as depicted in FIGS. 1, 104, and 105, and/or with any other systems, components, controllers, or the like as set forth in the present disclosure.

An example method 10700 may include the steps of identifying user-specific data of the wealth planning platform 10702, predicting, based on the user-specific data, a set of user-specific stress-test parameters 10704, generating a stress test scenario based on the stress-test parameters 10706, and simulating the stress test scenario to determine effects on the user-specific data 10708. The method 10700 may include the step of generating a prompt for an illustration. The prompt may include user profile data and a description of the determined effects 10710. The prompt may be provided to an illustration model such as a generative model to generate or modify an existing illustration and the illustration can be embedded in the interface 10712. The prompt may be generated to describe an illustration that include financial data, trend graphs, predictions, suggestions, and the like. In some embodiments, a prompt may include a desired mood for the illustration that may cause a generative model to modify, update, or add elements to the illustration that reflect the mood. In embodiments of method 10700, analysis of the stress test may be provided that is relative to a performance baseline. The performance baseline may be defined by a user, agent, and/or derived from historical data.

Referencing FIG. 145, an example apparatus 10800 for customization of an agent interface for a wealth planning platform is schematically depicted. The example apparatus 10800 may be utilized with, in whole or part, a platform such as depicted in FIG. 1, and/or with any other systems, components, controllers, or the like as set forth in the present disclosure. In certain embodiments, the apparatus 10800, in whole or part, may interact with, be provided in communication with, and/or be included in a system with, any other systems, components, controllers, or the like as set forth in the present disclosure.

In one example, apparatus 10800 may be configured to generate agent illustrations and customize an agent interface with the illustrations. The apparatus 10800 provides several improvements over prior techniques. In one example, embodiments of apparatus 10800 promote improved adaptability of analysis methods to agent visualizations. Agent illustrations, which may provide visualization, can be generated for a range of different analyses. Previous methods of providing agent illustrations require customization of models for each type of analysis to generate illustrations. Previous methods require constant maintenance and updating of illustration models for the agent interface each time a new visualization or analysis is added. The methods and systems described herein allow for more adaptable illustration models and may be used for a wide range of analyses without requiring updating for each change.

The example apparatus 10800 includes a data agglomerating circuit 10816 configured to agglomerate and identify data from one or more interfaces, databases of the platform, external databases, and the like. The data agglomerating circuit 10816 may agglomerate data such as agent user data of the wealth planning platform, selections of information options, selections of analysis parameters, and/or permission parameters. Selections of data may be received from a user interface via a user interface circuit 10810, directly from a user, via an API, via a specification document (e.g., a text document, XML specification, etc.), and/or the like. Agent user data may include data related to clients of the agent and/or other clients of the platform. Agent user data may include the number of clients in the enrollment pipeline, status (e.g., average number, buckets, etc) of those clients in the enrollment pipeline, anomaly data (e.g., data indicating a user is stuck, delayed, didn't get approval at a step in the platform), source of the anomaly (e.g., stuck at Stage 2, and who is currently the hold-up), revenue in the pipeline (including uncertainty due to average closure performance), and/or the like. Information options may further include statistics for at least one of enrollment, client progression, revenue, or enrolled assets.

The example apparatus 10800 includes an analytics circuit 10814 configured to interpret an agent analytics toolbox 10818 and generate an analytics report 10820. The analytics report 10820 may be generated for the agent user data 10808, the received selections, and/or the permission parameters. An analytics report may include illustrations, data, and elements that include information related to: client segmentation. (e.g., common characteristics or behaviors of clients), portfolio performance (e.g., metrics such as return on investment (ROI), risk-adjusted returns, and benchmark comparisons), client risk profiles (e.g., risk tolerance levels and investment preferences), asset allocation, agent performance (e.g., statistics regarding new client acquisition, assets under management, revenue generation, client retention), and the like.

The agent analytics toolbox 10818 may be a collection of elements and may include tools, techniques, algorithms, and software components that facilitate the analysis, interpretation, and visualization of data. The agent analytics toolbox 10818 may include one or more different types of elements and may include one or more of data preprocessing tools (e.g., functions and methods to clean, preprocess, and transform raw data into a suitable format for analysis), statistical techniques/algorithms, machine learning algorithms (supervised and unsupervised learning techniques, such as regression, classification, clustering, and dimensionality reduction), time series analysis, network analysis tools, and/or text analysis. In embodiments, an agent analytics toolbox 10818 may include a plurality of the elements of each type where each element may be configured for different types of data, configured to generate different output, and/or configured for different permission parameters.

In embodiments, the agent analytics toolbox 10818 may be a smart analytics toolbox that automatically determines the appropriate tools and analysis techniques for the type of data, selected outputs, information options 10802, permission parameters 10806, and/or analysis parameters 10804. In embodiments, the agent analytics toolbox 10818 may include feature engineering tools configured to extract relevant features from the input data to address the requirements of the analysis. Feature engineering tools may include creating new data features, combining existing features, or selecting a subset of features to reduce dimensionality. For example, user data may be inconsistent and may include different types of data. Different types of data may be manipulated by combining existing features of data to create a new data element that is derived from different types of data but represents an equivalent meaning. In one example, clients data for income and expenses may include a large number of different separate entries that may differ from client to client. Feature engineering may be used to create a new data element related to “disposable income” by subtracting the different expenses from the different income data elements for each client. This new data element may be applicable to more algorithms of the agent analytics toolbox 10818 than the original data elements.

In embodiments, the agent analytics toolbox 10818 may include features to customize the algorithm and tools for the data. the algorithm's parameters, assumptions, or structure to better accommodate the specific characteristics of the input data. The features may include features to adjust hyperparameters, select a different model architecture, or incorporate domain-specific knowledge into the algorithm.

The example apparatus 10800 includes a user interface circuit 10810 configured to implement an agent interface 10822 which may provide a display of the analytics report. In one example, the user interface circuit may be configured to update the user interface with an illustration for the analytics report. As described herein, illustrations may include text, graphics, a trend graph, and other features. The user interface circuit 10810 may include elements for receiving selections of information options and/or permission parameters.

Referencing FIG. 146, an example apparatus 10900 for customization of an interface for a wealth planning platform is schematically depicted. The example apparatus 10900 includes an illustration automation 10812 circuit configured to compose a prompt 10904 descriptive of the analytics report. In embodiments, prompt 10904 may be provided to an illustration automation model(s) 10902 to generate the illustration. Models 10902 may be generative models that generate illustrations from a text prompt as described herein with respect to other embodiments. The illustration automation circuit is further configured to receive baseline data and compose the prompt to include a description of comparisons of the analytics report to the baseline data. The illustration automation circuit 10810 is further configured to compose the prompt to include a qualitative description of a desired reaction to the analytics report. For example, an analytics report may indicate positive results with respect to baseline data. The qualitative description may reflect the positive results in a prompt to instruct models 10902 to generate illustrations with cheerful colors or images showing positive progress.

Referencing FIG. 147, an example method 11000 for customization of an interface for a wealth planning platform is schematically depicted. The method may be implemented, in whole or part, on a platform such as depicted in FIGS. 1, 145, and 146, and/or with any other systems, components, controllers, or the like as set forth in the present disclosure.

An example method 11000 may include a step for identifying agent user data of the wealth planning platform 11002. The activity data may be collected from a plurality of internal and/or external data sources. The method 11000 may further include a step of receiving selections of information options, receiving selections of analysis parameters, and/or receiving permission parameters 11104, 11106, 11108. The method 11100 may further include the step of interpreting an agent analytics toolbox to generate an analytics report for the agent user data, the received selections, and the permission 11010. The method 11000 may further include the step of implementing an agent interface, the agent interface providing a display of the analytics report.

Referencing FIG. 148, an example apparatus 11100 for customization of an interface for a carrier in a wealth planning platform is schematically depicted. The example apparatus 11100 may be utilized with, in whole or part, a platform such as depicted in FIG. 1, and/or with any other systems, components, controllers, or the like as set forth in the present disclosure. In certain embodiments, the apparatus 11100, in whole or part, may interact with, be provided in communication with, and/or be included in a system with, any other systems, components, controllers, or the like as set forth in the present disclosure.

In one example, apparatus 11100 may be configured to provide drill-down interfaces for selected features 11102. The apparatus 11100 provides for several improvements over prior techniques. In one example, embodiments of apparatus 11100 promote the improved performance of analysis of client data.

The example apparatus 11100 includes a data agglomerating circuit 11118 configured to identify client data 11104 of the wealth planning platform. The apparatus 11100 further includes an analytics circuit 11112 configured to interpret a carrier analytics toolbox 11114 to generate an analytics report 11116 for the client data. The example apparatus 11100 includes a user interface circuit 11120 configured to implement a carrier interface 111006, the carrier interface providing a display of the analytics report 11116. In one example, analytics report may include a report on asset summaries or a report on revenue by agents. In another example, the analytics report includes statistics for at least one of enrollment, client progression, revenue, or enrolled assets.

In embodiments, the analytics circuit 11112 may be configured to interpret the carrier analytics toolbox based on a permission parameter that may be associated with the carrier. The permission parameter may limit or dictate what analysis features are available to the carrier from the carrier analytics toolbox 11114.

The user interface circuit 11120 is further configured to receive a selection of a feature of the analytics report from the carrier interface 11106 and update the carrier interface 11106 with an illustration 11110 of the selected feature. In one example, the illustration may include drill-down data for the selected feature. The illustration may be generated in response to the selection or the illustration may be previously generated and retrieved as a saved snapshot.

Referencing FIG. 149, an example apparatus 11200 for customization of an interface for a carrier in a wealth planning platform is schematically depicted. The apparatus 11200 may include the elements of apparatus 11100 wherein the user interface circuit 11120 is further configured to compose a prompt 11204 descriptive of the analytics report provide the prompt to an illustration automation circuit 11108 to generate the illustration. The prompt may cause a trained generative model to generate an illustration for a drill-down view of the feature.

Referencing FIG. 150, an example method 11300 for customization of an interface for a carrier in a wealth planning platform is schematically depicted. The method may be implemented, in whole or part, on a platform such as depicted in FIGS. 1, 148, and 149 and/or with any other systems, components, controllers, or the like as set forth in the present disclosure.

An example method 11300 may include the steps of identifying client data of the wealth planning platform 11302 and interpreting a carrier analytics toolbox to generate an analytics report for the client data 11304. The method may further include the steps of implementing a carrier interface, the carrier interface providing a display of the analytics report 11306 and receiving a selection of a feature of the analytics report from the carrier interface 11308. The method 11300 may further include the step of interpreting the carrier analytics toolbox to generate an illustration for the selected feature 11310. In one example, the illustration may show drill-down view of the feature. The method 11300 may further include updating the carrier interface with the illustration 11312.

Referencing FIG. 151, an example apparatus 11400 for customization of an interface for an administrator in a wealth planning platform is schematically depicted. The example apparatus 11400 may be utilized with, in whole or part, a platform such as depicted in FIG. 1, and/or with any other systems, components, controllers, or the like as set forth in the present disclosure. In certain embodiments, the apparatus 11400, in whole or part, may interact with, be provided in communication with, and/or be included in a system with, any other systems, components, controllers, or the like as set forth in the present disclosure.

In one example, apparatus 11400 may be configured to provide snapshots of previous illustrations provided to clients. The apparatus 11400 provides for several improvements over prior techniques. In one example, embodiments of apparatus 11400 promote improved analysis of client actions and decisions by providing tools to review and analyze data provided to a client.

The example apparatus 11400 includes a data agglomerating circuit 11420 configured to collect and/or identify data such as administrator data 11402 (which may include permissions, preferences, activity data, etc.). The data agglomerating circuit 11420 may be configured to receive selections of a time interval 11404 for client data (from a user interface or other specification) and identify illustration snapshots 11408 for the client data for the time interval. Illustration snapshot 11408 may be data that was saved each time a new illustration was provided to a client. The snapshot may include the complete illustration, the timing of the illustration, data regarding how the illustration was generated, client interactions with the illustration, and the like.

The example apparatus 11400 includes an illustration management circuit 11412 configured to generate illustration summaries 11414 for the illustration snapshots 11408. Summaries may be generated based on the specifications and preferences of administrator data 11402. Illustration summaries 11414 may be a filtered or simplified version of each illustration snapshot 11408. The example apparatus 11400 further includes an analytics circuit 11416 configured to interpret an administrator analytics toolbox 11422 to identify client events 11418 from the client data that correspond to the illustration snapshots 11408. In one example, client events may include actions taken by a client, a start of a phase in a wealth planning platform, and/or an end of a phase in the wealth planning platform.

The example apparatus 11400 includes a user interface circuit 11410 configured to implement an administrator interface 11406. The administrator interface 11406 may provide for display of the summaries of the illustrations and the client events. The administrator interface 11406 may be configured to allow efficient analysis of the events and corresponding illustrations. In one example, the user interface circuit 11410 is further configured receive a selection of summary of a first snapshot of the illustration to update the administrator interface with a detailed view of the snapshot allowing the administrator to drill down into the elements of the illustration. In one example, the detailed view of the snapshot may include additional analysis of the illustration to indicate likely elements of the illustration that may have caused an event.

In some cases, the user interface circuit 11410 may maintain a record of illustrations provided to a client. The illustration management circuit 11412 may be configured to analyze a record of illustrations provided to a client in the time interval 11404 and identify, using the record, missing snapshots of illustrations. In some cases, an analysis may indicate no missing snapshots. In some cases, the illustration management circuit 11412 may analyze the record to determine a reason why a snapshot was not saved. In some cases, the snapshot may have included data designed as private by the client and not saved. The illustration management circuit 11412 may be configured to recreate the missing snapshots of illustrations and generate a summary for each of the missing snapshots. In embodiments, the record of illustrations may include data regarding the models used to generate the illustrations, sources of data used for the illustrations, parties associated with the illustrations, and the like. Regeneration of the illustrations may include initiating the models with the data indicated in the record. In some cases, the regeneration of illustrations may require a batch process and may not be completed in real-time. When missing snapshots cannot be quickly replicated, the administrator interface may include a visualization with placeholders for the missing snapshots.

The analytics circuit 11416 may be further configured to interpret the administrator analytics toolbox 11422 to identify relationships between the client events 11418 and features of the illustrations. In one example, the analytics circuit 11416 may be used to identify correlations or causality between the illustrations and user events 11418. The administrator interface 11406 may be configured to provide visualizations of the identified relationships. For example, the administrator interface 11406 may include a timeline visualization of the summaries and events and the determined causality.

Referencing FIG. 152, an example method 11500 for customization of an interface for an administrator in a wealth planning platform is schematically depicted. The method may be implemented, in whole or part, on a platform such as depicted in FIGS. 1, and 151 and/or with any other systems, components, controllers, or the like as set forth in the present disclosure.

An example method 11500 may include the steps of identifying administrator data of the wealth planning platform 11502, receiving selections of a time interval for client data 11504, and identifying snapshots of illustrations for the client data for the time interval 11506; The method 11500 may further include the steps of generating a summary for each of the snapshots of illustrations 11508 and interpreting an administrator analytics toolbox to identify client events from the client data that correspond to the snapshots of illustrations 11510. The method 11500 may further include the step of implementing an administrator interface based on parameters in the administrator data, the administrator interface providing a display of the summaries of the illustrations and the client events 11512.

The methods and systems described herein may be deployed in part or in whole through a machine having a computer, computing device, processor, circuit, and/or server that executes computer readable instructions, program codes, instructions, and/or includes hardware configured to functionally execute one or more operations of the methods and systems herein. The terms computer, computing device, processor, circuit, and/or server, (“computing device”) as utilized herein, should be understood broadly.

An example computing device includes a computer of any type, capable to access instructions stored in communication thereto such as upon a non-transient computer readable medium, whereupon the computer performs operations of the computing device upon executing the instructions. In certain embodiments, such instructions themselves comprise a computing device. Additionally or alternatively, a computing device may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Network and/or communication resources include, without limitation, local area network, wide area network, wireless, internet, or any other known communication resources and protocols. Example and non-limiting hardware and/or computing devices include, without limitation, a general-purpose computer, a server, an embedded computer, a mobile device, a virtual machine, and/or an emulated computing device. A computing device may be a distributed resource included as an aspect of several devices, included as an interoperable set of resources to perform described functions of the computing device, such that the distributed resources function together to perform the operations of the computing device. In certain embodiments, each computing device may be on separate hardware, and/or one or more hardware devices may include aspects of more than one computing device, for example as separately executable instructions stored on the device, and/or as logically partitioned aspects of a set of executable instructions, with some aspects comprising a part of one of a first computing device, and some aspects comprising a part of another of the computing devices.

Certain operations described herein include interpreting, receiving, and/or determining one or more values, parameters, inputs, data, or other information (“receiving data”). Operations to receive data include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first receiving operation may be performed, and when communications are restored an updated receiving operation may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g., where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

While the disclosure has been disclosed in connection with certain embodiments shown and described in detail, various modifications and improvements thereon will become readily apparent to those skilled in the art. Accordingly, the spirit and scope of the present disclosure is not to be limited by the foregoing examples but is to be understood in the broadest sense allowable by law.

What is claimed is:

1. A system, comprising:
a group enrollment controller, comprising:
a client addition circuit configured to receive a group addition request associated with at least one identified user,
a group assignment circuit configured to add the at least one identified user to an existing enrollment group within an online platform or create a new enrollment group and add the at least one identified user to the new enrollment group, responsive to the received group addition request; and
an enrollment execution circuit structured to implement enrollment of users within the existing enrollment group or the new enrollment group.

2. The system of claim 1, wherein the existing enrollment group or the new enrollment group corresponds to a tranche on the platform.

3. The system of claim 1, wherein users assigned to the existing enrollment group or the new enrollment group are assigned to a plurality of tranches on the platform.

4. The system of claim 3, further comprising a group analysis circuit structured to determine group analytics for the existing enrollment group or the new enrollment group, and to expose the group analytics to at least one of a group administrator user or a platform administrator user.

5. The system of claim 1, further comprising a group analysis circuit structured to determine group analytics for the existing enrollment group or the new enrollment group, and to expose the group analytics to at least one of a group administrator user or a platform administrator user.

6. The system of claim 1, wherein the group addition request is a communication from an authorized user within the online platform.

7. The system of claim 1, wherein the identified user is a group administrator user, the system further comprising a group analysis circuit structured to determine group analytics for the existing enrollment group or the new enrollment group, and to expose the group analytics to the group administrator user.

8. The system of claim 1, further comprising a group analysis circuit structured to track a set of metrics associated with the existing enrollment group or the new enrollment group.

9. The system of claim 8, wherein the set of metrics includes at least one of success metrics or performance metrics.

10. The system of claim 9, wherein the enrollment execution circuit is further structured to provide a notification to a group administrator user in response to the set of metrics.

11. The system of claim 10, wherein the notification comprises at least one communication selected from:
an enrollment progress communication; or
an enrollment completion communication.

12. The system of claim 1, wherein, responsive to receiving the group addition request, the group assignment circuit sends a notification to at least one authorized user within the online platform and only executes the group addition request upon receiving authorization from the at least one authorized user.

13. The system of claim 1, wherein the implementing enrollment comprises at least one operation selected from among:
tracking analytics for the existing enrollment group or the new enrollment group;
providing a common notification to the existing enrollment group or the new enrollment group;
providing a common interface to the existing enrollment group or the new enrollment group;
enforcing a common platform rule for the existing enrollment group or the new enrollment group; or
tracking enrollment statistics for the existing enrollment group or the new enrollment group.

14. The system of claim 1, wherein the implementing enrollment comprises providing a common interface element to the existing enrollment group or the new enrollment group.

15. The system of claim 14, wherein the common interface element comprises at least one of:
a common menu;
a common menu element;
a common display setting;
a common display organization;
a common permissions setting; or
a common preferences setting.

16. The system of claim 1, wherein the enrollment execution circuit is further configured to invite the at least one identified user to the existing enrollment group or the new enrollment group using at least one of an email message, a text message, a message on a proprietary messaging application, a voice call notification, or indication within a user interface within the online platform.

17. The system of claim 16, wherein the enrollment execution circuit is further structured to link the at least one identified user to the online platform via a hyperlink contained within the invitation.

18. The system of claim 16, wherein the enrollment execution circuit is further structured to track the at least one identified user using at least one of an email read receipt, a response message from the identified user, or through activity on the online platform subsequent to the invitation.

19. The system of claim 1, wherein the enrollment execution circuit implements enrollment of users by providing a group enrollment portal to the at least one identified user.

20. The system of claim 19, wherein the group assignment circuit is further structured to monitor the at least one identified user in response to operations of the at least one identified user within the group enrollment portal.

21. The system of claim 20, wherein the group enrollment portal prompts the at least one identified user for information relevant to group enrollment and the group assignment circuit selects at least one enrollment group in which to enroll the at least one identified user based at least in part on the information.

22. The system of claim 19, wherein the group addition request is generated explicitly by the at least one identified user via a selection within the group enrollment portal.

23. The system of claim 19, wherein the group addition request is generated automatically by the group assignment circuit responsive to the at least one identified user visiting the group enrollment portal.

24. The system of claim 20, wherein the group assignment circuit provides a notification to an authorized user within the online platform when the at least one identified user accesses the group enrollment portal.

25. The system of claim 24, wherein the group addition request is generated by the authorized user.

26. The system of claim 1, wherein the group assignment circuit selects at least one user group to add the at least one identified user to based on at least one attribute of the at least one identified user.

27. The system of claim 26, wherein the at least one attribute includes at least one of a common membership in a certain tranche, a common affiliation with a certain organization, a common affiliation with a certain agent or agency, a common affiliation with a certain carrier, a common affiliation with a certain underwriter, a common affiliation with a common independent marketing organization (IMO), a common level of authority within or permissive access to the online platform, a common workflow within the online platform, or a common user class within the online platform.
